(19) United States
(12) Patent Application Publication
(10) Pub. No.: US 2025/0116020 A1
(43) Pub. Date: Apr. 10, 2025

(54) MULTIMETALLIC CATALYSTS

(71) Applicant: MATTIQ, Inc., Skokie, IL (US)

(72) Inventors: Andrey IVANKIN, Chicago, IL (US); Jordan H. SWISHER, Chicago, IL (US); Alexander P. MANTIS, Brookfield, IL (US); Sari M. ZERAH, Chicago, IL (US); Carolin B. WAHL, Evanston, IL (US); Kevin J. KLUNDER, Chicago, IL (US); Jaime E. AVILES ACOSTA, Chicago, IL (US); Sarah M. REHN, Chicago, IL (US)

(21) Appl. No.: 18/911,069

(22) Filed: Oct. 9, 2024

Related U.S. Application Data
(60) Provisional application No. 63/543,175, filed on Oct. 9, 2023.
(60) Provisional application No. 63/561,430, filed on Mar. 5, 2024.
(60) Provisional application No. 63/639,095, filed on Apr. 26, 2024.

(51) Int. Cl. C25B 11/091

(52) U.S. Cl. CPC C25B 11/091

(57) ABSTRACT

The present disclosure includes catalysts, including electrocatalysts. Mixed metal electrocatalyst materials can include Ru, W, Mo, and/or Pd which can be applied to reduce the need for Ir, while exhibiting desirable performance.

### CROSS-REFERENCE TO RELATED APPLICATION

This application claims priority to U.S. Provisional Application Ser. No. 63/543,175, filed on Oct. 9, 2023, Ser. No. 63/561,430, filed Mar. 3, 2024, Ser. No. 63/639,095, filed Apr. 26, 2024, the entire contents of which are incorporated herein by reference.

### TECHNICAL FIELD

The present disclosure concerns catalytic compounds. More specifically, the present disclosure concerns electrocatalytic compounds.

### SUMMARY

The present application discloses one or more of the features recited in the appended claims and/or the following features which, alone or in any combination, may comprise patentable subject matter.

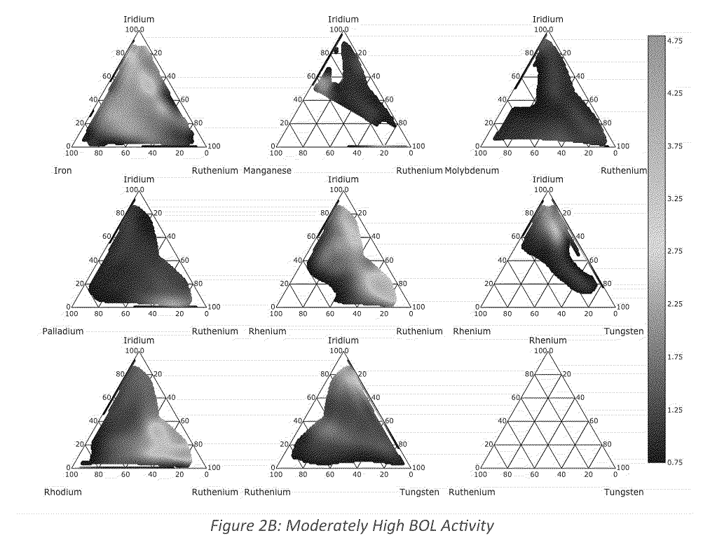

According to an aspect of the present disclosure an electrocatalyst can include a multimetallic including a first metallic as Ir; and at least one other metallic selected from the group consisting of W, Mo, Re, Ru, Fe, Pd, Rh, Mn, and Cr. In some embodiments, the composition of the catalyst and the atomic ratio of the metallics may be defined from at least one of those disclosed within the collection of the Tables 1-19 and FIGS. 2A-22.

In some embodiments, one or more metallics within the catalyst may be oxidized. Oxidation or lack thereof may affect the performance of the catalyst under different testing conditions. The oxide may vary in crystallinity from amorphous to fully crystalline. The crystallinity of the oxide may affect the performance of the catalyst under different testing conditions. A ratio of oxide to metallic may be fully oxidized, partially oxidized, or fully metallic. The oxide may be created via thermal annealing, calcination, chemically, or electrochemically.

In some embodiments, an electrocatalyst can include a mixed single crystallographic phase nanomaterial comprising elements. In other embodiments, the electrocatalyst material can include a multiphase mixed nanomaterial comprising elements.

In some embodiments, the catalyst may be unsupported, or supported on carbon, silicon carbide, alumina, silica, titanium, titania, tungsten, tungsten oxide, antimony, tantalum, platinum, niobium oxide, indium tin oxide, fluorine-doped tin oxide, graphene. In some embodiments, the catalyst may contain up to 10 atomic % of additional elements, such as Pt, Os, Ta, Ce, Ba, Hf, In, Sn, Sb, Au, Ag, Sr, Y, Sc, Nb, La, Pr, Sm, Cu; and in some embodiments, may include other elements. In some embodiments, the catalyst may contain up to 10 atomic % of additional elements, such as Ni and Co excluding compositions exclusively comprised of Ir, Ru, Ni, and Co.

In some embodiments, the surface of the electrocatalyst may be nanostructured. In some embodiments, the mixed metallics or mixed metal oxides may be synthesized via at least one of melt fusion, templated thermal decomposition. In some embodiments, the catalyst may be synthesized via other means such as colloidal synthesis, polymer pen lithography, sol-gel hydrolysis, electrodeposition, and/or spray pyrolysis.

According to another aspect of the presenting disclosure, a method of catalyzing electrochemical reaction may include providing a multimetallic including at least two metallics, wherein a first of the metallics is Ir, and one or more other metallics of the at least two metallics are from the group consisting of W, Mo, Re, Ru, Fe, Pd, Rh, Mn, and Cr; and applying the multimetallic as a catalyst in a reaction. In some embodiments, the composition of the catalyst and the atomic ratio of the metallics may be defined from at least one of those disclosed within the collection of the Tables 1-19 and FIGS. 2A-22.

In some embodiments, one or more metallics within the catalyst may be oxidized. The oxide may have crystallinity within the range from amorphous to fully crystalline. A ratio of oxide to metallic may be fully oxidized, partially oxidized, or fully metallic. The oxide may be created via thermal annealing, calcination, chemically, or electrochemically. The catalyst may unsupported, or supported on carbon, silicon carbide, alumina, silica, titanium, titania, tungsten, tungsten oxide, niobium, niobium oxide, indium tin oxide, zirconium, tantalum, antimony, platinum, fluorine-doped tin oxide, graphene; and in some embodiments, may include other elements.

In some embodiments, the catalyst may contain up to 10 atomic % of additional elements, such as Pt, Os, Ta, Ce, Ba, Hf, In, Sn, Sb, Au, Ag, Sr, Y, Sc, Nb, La, Pr, Sm, Cu. The catalyst may contain up to 10 atomic % of additional elements, such as Ni and Co excluding compositions exclusively comprised of Ir, Ru, Ni, and Co.

In some embodiments, the surface of the catalyst may be nanostructured. The mixed metallics or mixed metal oxides may be synthesized via at least one of melt fusion templated thermal decomposition. In some embodiments, the catalyst may be synthesized via other means such as colloidal synthesis, polymer pen lithography, sol-gel hydrolysis, electrodeposition, and/or spray pyrolysis.

According to another aspect of the present disclosure, a method of catalyzing electrochemical reaction may include providing a multimetallic including at least two metallics, wherein a first metallic of the at least two metallics is Ru, and one or more other metallics of the at least two metallics are from the group consisting of W, Mo, Re, Ir, Fe, Pd, Rh, Mn, and Cr; and applying the multimetallic as a catalyst in a reaction. In some embodiments, applying the catalyst in a reaction may include applying the catalyst for Oxygen Evolution Reaction (OER). The OER reaction may be an acidic OER. In some embodiments, the OER reaction may be an alkaline OER.

In some embodiments, applying the catalyst in a reaction may include applying the catalyst for hydrogen generation and/or oxidation. Applying the catalyst in a reaction may include applying the catalyst for oxygen generation and reduction. Applying the catalyst in a reaction may include applying the catalyst for CO₂ conversion. For example, conversion may include CO₂ conversion for various products including but not limited to carbon monoxide, ethylene, methanol, ethanol, urea, acetonitrile, cyanides, and more. Applying the catalyst in a reaction may include applying the catalyst for biomass conversion. For example, biomass conversion may include conversion to organic products including but not limited to biomass-derived furfural conversions such as hydroxymethyl furfural oxidation, biomass-derived polyol conversions such as glycerol or glucose oxidations, or lignin-derivative conversions such as the depolymerization of lignin.

In some embodiments, applying the catalyst in a reaction may include applying the catalyst for hydrogenation and/or de-hydrogenation. Applying the catalyst in a reaction may include applying the catalyst for organic oxidation reactions. Applying the catalyst in a reaction may include applying the catalyst for the generation of halogen gases. For example, halogen gases may include chlorine, bromine, and/or iodine.

In some embodiments, applying the catalyst in a reaction may include applying the catalyst for ammonia generation and/or conversion. Applying the catalyst in a reaction may include applying the catalyst for gas purification. Applying the catalyst in a reaction may include applying the catalyst for deoxygenation, dehydrogenation, and/or CO₂ cleaning.

In some embodiments, applying the catalyst in a reaction may include applying the catalyst for gas purification. Applying the catalyst in a reaction may include electroplating, electrowinning, or wastewater purification.

According to another aspect of the present disclosure, a method of catalyzing non-electrochemical reaction may comprise a multimetallic of two or more elements, wherein a first metallic thereof is Ir, and one or more other metallics thereof are from the group consisting of W, Mo, Re, Ru, Fe, Pd, Rh, Mn, and Cr; and applying the catalyst in a reaction. In some embodiments, the composition of the catalyst and the atomic ratio of the metallics may be defined from at least one of those disclosed within the collection of the Tables 1-19 and FIGS. 2A-22.

In some embodiments, one or more metallics within the catalyst may be oxidized. The oxide may vary in crystallinity within the range from amorphous to fully crystalline. A ratio of oxide to metallic may be fully oxidized, partially oxidized, or fully metallic. The oxide may be created via thermal annealing, calcination, chemically, or electrochemically.

In some embodiments, the catalyst may be unsupported, supported on carbon, silicon carbide, alumina, silica, titanium, titania, tungsten, tungsten oxide, niobium oxide, indium tin oxide, fluorine-doped tin oxide, graphene. In some embodiments, the catalyst may contain up to 10 atomic % of additional elements, such as Pt, Os, Ta, Ce, Ba, Hf, In, Sn, Sb, Au, Ag, Sr, Y, Sc, Nb, La, Pr, Sm, Cu; and in some embodiments, may include other elements. The catalyst may contain up to 10 atomic % of additional elements, such as Ni and Co excluding compositions exclusively comprised of Ir, Ru, Ni, and Co.

In some embodiments, the surface of the catalyst may be nanostructured. The mixed metallics or mixed metal oxides may be synthesized via at least one of melt fusion templated thermal decomposition. In some embodiments, the catalyst may be synthesized via other means such as colloidal synthesis, polymer pen lithography, sol-gel hydrolysis, electrodeposition, and/or spray pyrolysis.

According to another aspect of the present disclosure, a method of catalyzing non-electrochemical reaction may comprise providing a multimetallic comprising two or more elements, wherein the first metallic thereof is Ru, and one or more other metallic thereof is from the group consisting of W, Mo, Re, Ir, Fe, Pd, Rh, Mn, and Cr; and applying the catalyst in a reaction. In some embodiments, applying the catalyst in a reaction may include applying the catalyst for CO₂ or CO conversion. For example, CO₂ or CO conversion may include conversion to various products including but not limited to carbon monoxide, ethylene, methanol, ethanol, urea, acetonitrile, cyanides, methane, and more. Applying the catalyst in a reaction includes applying the catalyst for biomass conversion to organic products. For example, biomass conversion may include but not be limited to biomass-derived furfural conversions such as hydroxymethyl furfural oxidation, biomass-derived polyol conversions such as glycerol or glucose oxidations, or lignin-derivative conversions such as the depolymerization of lignin.

In some embodiments, applying the catalyst in a reaction may include applying the catalyst for hydrogenation and/or de-hydrogenation. Applying the catalyst in a reaction may include applying the catalyst for organic oxidation reactions. Applying the catalyst in a reaction may include applying the catalyst for ammonia generation and/or conversion. In some embodiments, applying the catalyst in a reaction may include applying the catalyst for gas purification.

According to another aspect of the present disclosure, an electrocatalyst may include a multimetallic of two or more metallics, wherein a first metallic of the two or more metallics is Ru; and one or more other metallics of the two or more metallic is selected from the group consisting of W, Mo, Re, Ir, Fe, Pd, Rh, Mn, and Cr. In some embodiments, the composition of the catalyst and the atomic ratio of the metallics may be defined from at least one of those disclosed within the collection of the Tables 1-19 and FIGS. 2A-22.

In some embodiments, one or more metallics within the catalyst may be oxidized. The oxide may vary in crystallinity within a range from amorphous to fully crystalline. A ratio of oxide to metallic may be fully oxidized, partially oxidized, or fully metallic. The oxide may be created via thermal annealing, calcination, chemically, or electrochemically. The catalyst may be unsupported, or supported on carbon, silicon carbide, alumina, silica, titanium, titania, tungsten, tungsten oxide, niobium oxide, indium tin oxide, fluorine-doped tin oxide, graphene; and in some embodiments, may include other elements.

In some embodiments, the catalyst may contain up to 10 atomic % of additional elements, such as Pt, Os, Ta, Ce, Ba, Hf, In, Sn, Sb, Au, Ag, Sr, Y, Sc, Nb, La, Pr, Sm, Cu. The catalyst may contain up to 10 atomic % of additional elements, such as Ni and Co excluding compositions exclusively comprised of Ir, Ru, Ni, and Co.

In some embodiments, the surface of the catalyst may be nanostructured. The mixed metallics or mixed metal oxides may be synthesized via at least one of melt fusion templated thermal decomposition. In some embodiments, the catalyst may be synthesized via other means such as colloidal synthesis, polymer pen lithography, sol-gel hydrolysis, electrodeposition, and/or spray pyrolysis.

According to another aspect of the present disclosure, an Oxygen Evolution Reaction (OER) catalyst may comprise a first metallic, wherein the first metallic is a platinum group metal; and one or more other metallics, wherein concentration of each of the one or more other metallics is less than about 95% of atomic ratio. In some embodiments, the catalyst may be represented by M1XM2Y, wherein M1 represents the first metallic, M2 represents a second metallic of the one or more other metallics, X+Y=100%, and each of X and Y is equal to or less than about 95% of atomic ratio.

In some embodiments, the catalyst may be represented by M1XM2YM3Z, where M1 represents the first metallic, M2 represents a second metallic of the one or more other metallics, M3 represents a third metallic of the one or more other metallics, X+Y+Z=100%, and each of X, Y, and Z is equal to or less than about 95% of atomic ratio. In some embodiments, M1 may be Ir or Ru; and wherein M2 may be selected from the group consisting of W, Mo, Re, Ru, Fe, Pd, Rh, Mn, and Cr.

In some embodiments, M1 may be Ir or Ru; wherein M2 may be an element selected from the group consisting of W, Mo, Re, Ru, Fe, Pd, Rh, Mn, and Cr; and wherein M3 may be selected from the group consisting of W, Re, Mo, Fe, Pd, Rh, Mn, and Cr. In some embodiments, M1 may be Ir; wherein M2 may be Ru or Re; and wherein M3 may be selected from the group consisting of Re, Mo, W, Fe, Pd, Cr, Mn, and Rh.

In some embodiments, the catalyst may be an acidic OER catalyst. The catalyst may further comprise a support. The support may be doped SiC.

According to another aspect of the present disclosure, a method of catalyzing reaction may include providing a catalyst including a first metallic, wherein the first metallic is a platinum group metal, and one or more other metallics, wherein concentration of each of the one or more other metallics is less than about 95% of atomic ratio; and applying the catalyst in a reaction. In some embodiments, applying the catalyst in a reaction may include applying the catalyst for Oxygen Evolution Reaction (OER). The OER reaction may be an acidic OER. The OER reaction may be an alkaline OER.

In some embodiments, applying the catalyst in a reaction may include applying the catalyst for hydrogen generation and/or oxidation. Applying the catalyst in a reaction may include applying the catalyst for oxygen generation and reduction. Applying the catalyst in a reaction may include applying the catalyst for CO₂ conversion. Applying the catalyst in a reaction may include applying the catalyst for biomass conversion. Applying the catalyst in a reaction may include applying the catalyst for hydrogenation and/or de-hydrogenation.

In some embodiments, applying the catalyst in a reaction may include applying the catalyst for ammonia generation and/or conversion. Applying the catalyst in a reaction may include applying the catalyst for gas purification. Applying the catalyst in a reaction may include applying the catalyst for deoxygenation, dehydrogenation, and/or CO₂ cleaning.

According to another aspect of the present disclosure, a catalyst may comprise a first metallic, wherein the first metallic is a platinum group metal, excluding Ir; and one or more other metallics, wherein the catalyst is represented by M1XM2Y, wherein M1 represents the first metallic, M2 represents a second metallic of the one or more other metallics, X+Y=100%, and each of X and Y is equal to or less than about 95% of atomic ratio. M2 may be selected from the group consisting of W, Mo, Re, Fe, Pd, Rh, Mn, Cr.

According to another aspect of the present disclosure, a catalyst may comprise a first metallic, wherein the first metallic is a platinum group metal, excluding Ir; and one or more other metallics, wherein the catalyst is represented by M1XM2YM3Z, where M1 represents the first metallic, M2 represents a second metallic of the one or more other metallics, M3 represents a third metallic of the one or more other metallics, X+Y+Z=100%, and each of X, Y, and Z is equal to or less than about 95% of atomic ratio. M2 may be an element selected from the group consisting of W, Mo, Re, Fe, Pd, Rh, Mn, and Cr, and wherein M3 may be selected from the group consisting of W, Re, Mo, Fe, Pd, Rh, Mn, and Cr.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION

The detailed description particularly refers to the accompanying figures in which:

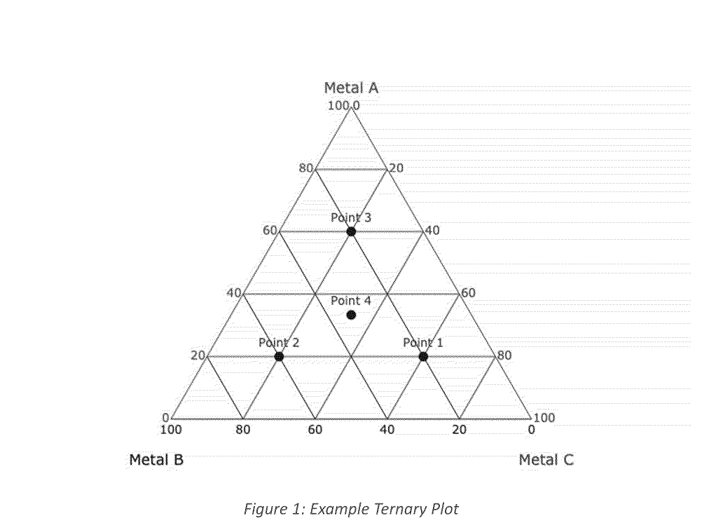

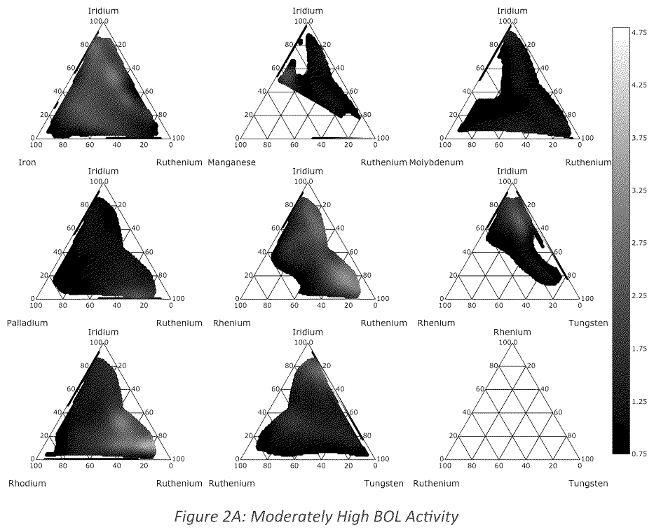

FIG. 1 is an example of a ternary plot.

FIGS. 2A & 2B are each a graphical depiction of catalyst material sample combinations indicating moderately high Beginning of Life (BOL) activity according to illustrative embodiments, in black & white and color, respectively;

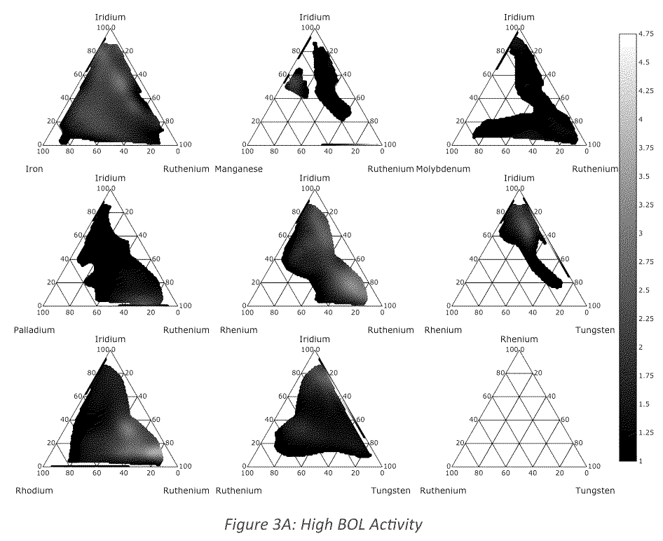

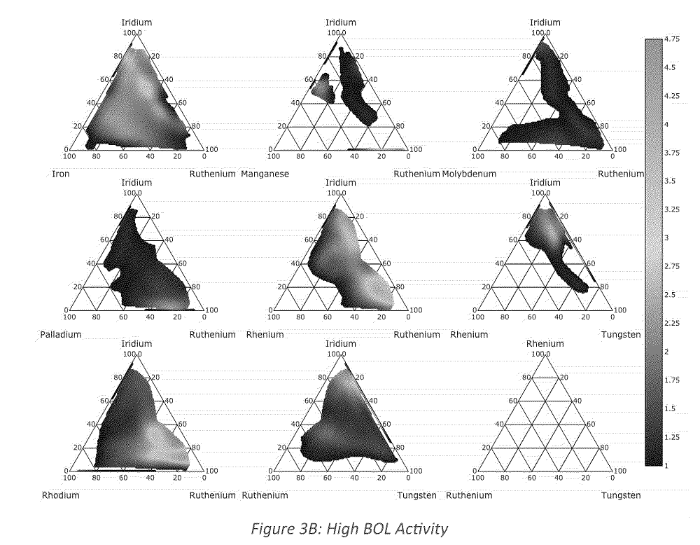

FIGS. 3A & 3B are each a graphical depiction of catalyst material sample combinations indicating high Beginning of Life (BOL) activity according to illustrative embodiments, in black & white and color, respectively;

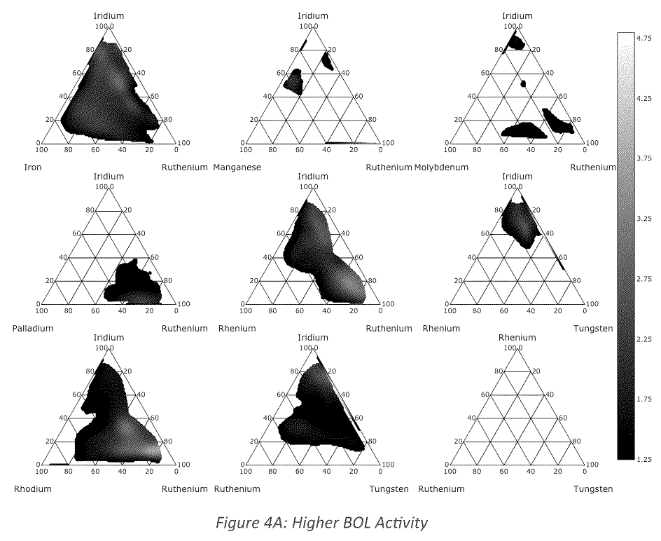

FIGS. 4A & 4B are each a graphical depiction of catalyst material sample combinations indicating higher Beginning of Life (BOL) activity according to illustrative embodiments, in black & white and color, respectively;

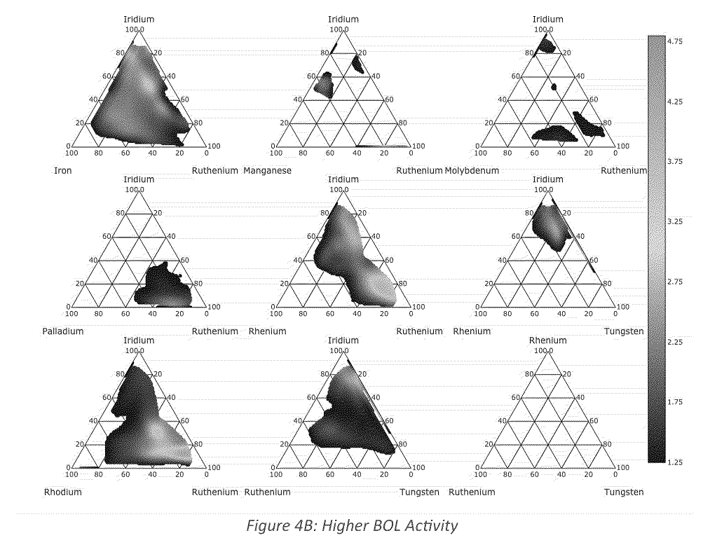

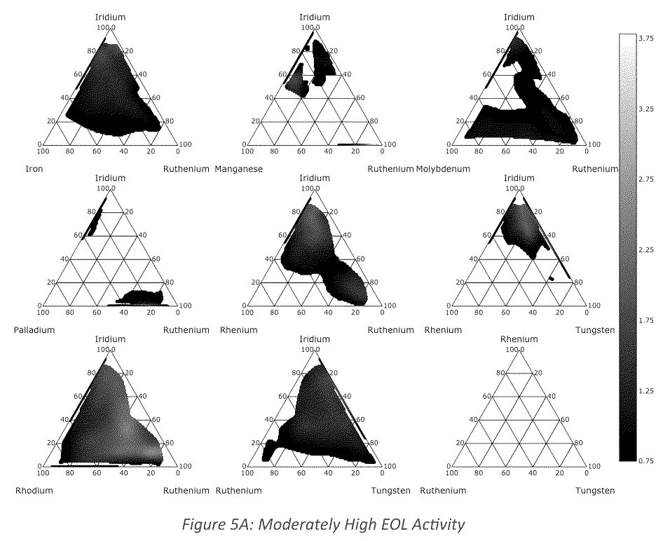

FIGS. 5A & 5B are each a graphical depiction of catalyst material sample combinations indicating moderately high End of Life (EOL) activity according to illustrative embodiments, in black & white and color, respectively;

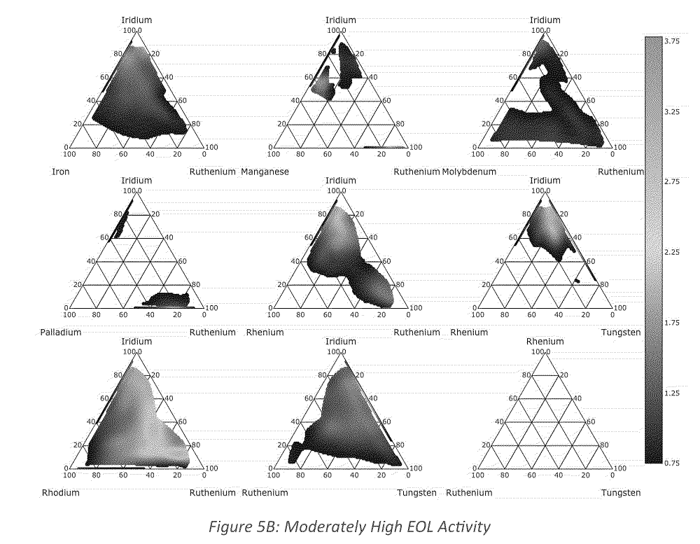

FIGS. 6A & 6B are each a graphical depiction of catalyst material sample combinations indicating high End of Life (EOL) activity according to illustrative embodiments, in black & white and color, respectively;

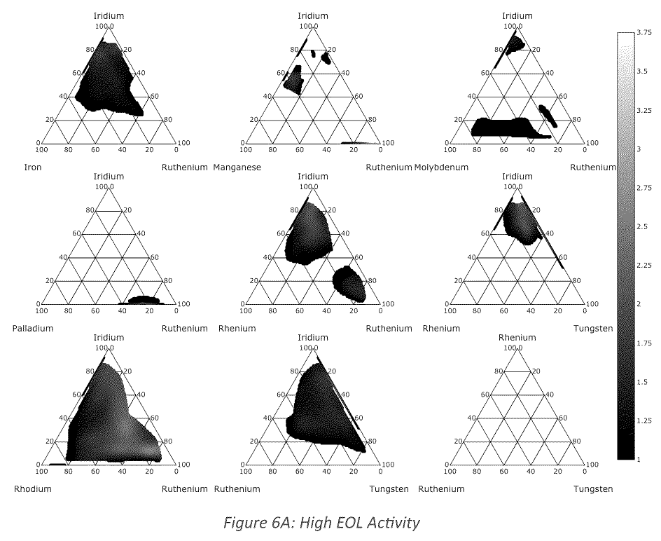

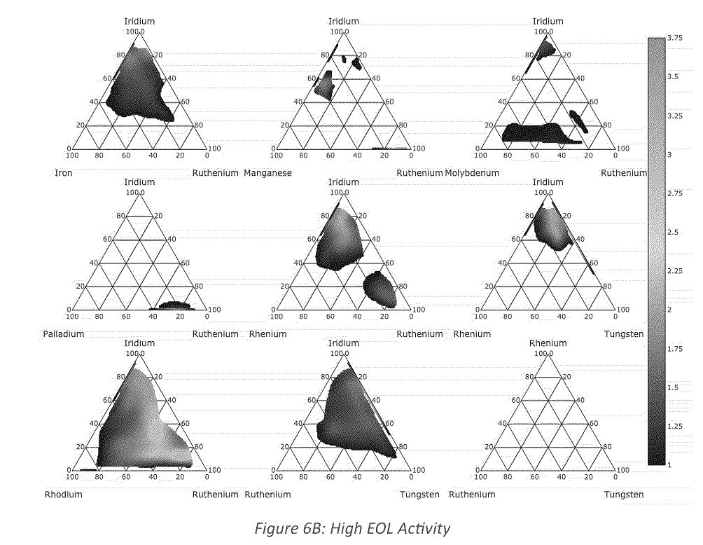

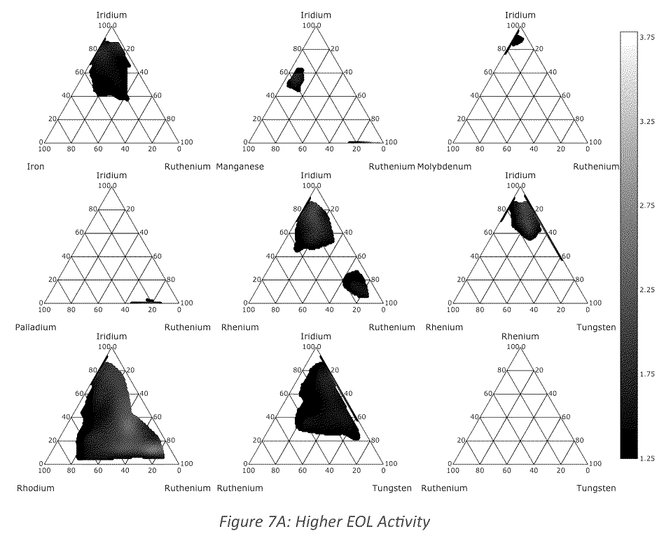

FIGS. 7A & 7B are each a graphical depiction of catalyst material sample combinations indicating higher End of Life (EOL) activity according to illustrative embodiments, in black & white and color, respectively;

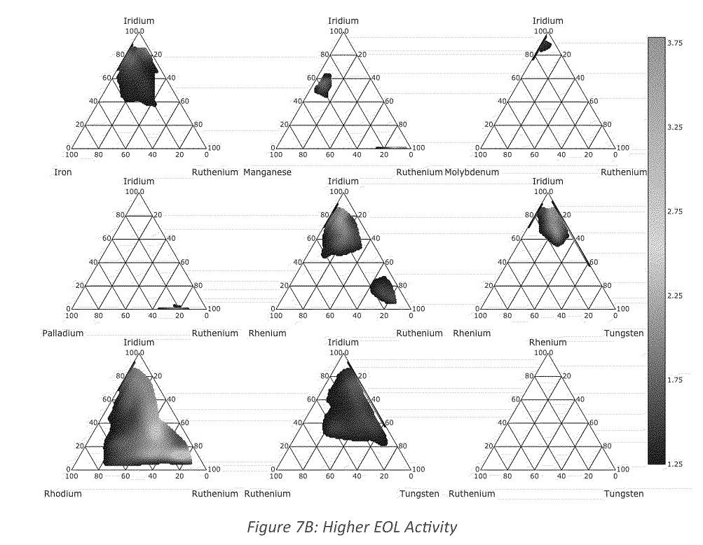

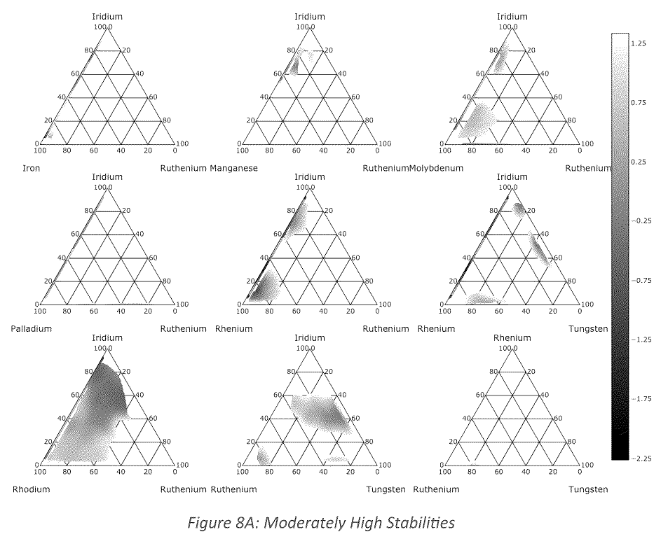

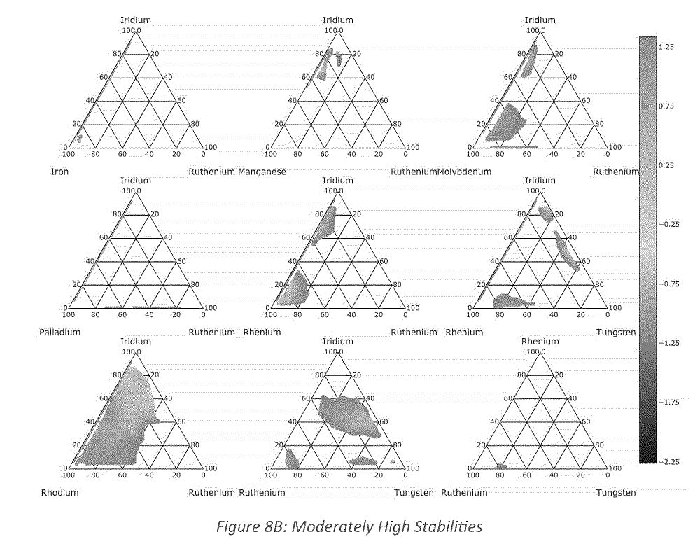

FIGS. 8A & 8B are each a graphical depiction of catalyst material sample combinations indicating moderately high stability according to illustrative embodiments, in black & white and color, respectively;

FIGS. 9A & 9B are each a graphical depiction of catalyst material sample combinations indicating high stability according to illustrative embodiments, in black & white and color, respectively;

FIGS. 10A & 10B are each a graphical depiction of catalyst material sample combinations indicating higher stability according to illustrative embodiments, in black & white and color, respectively;

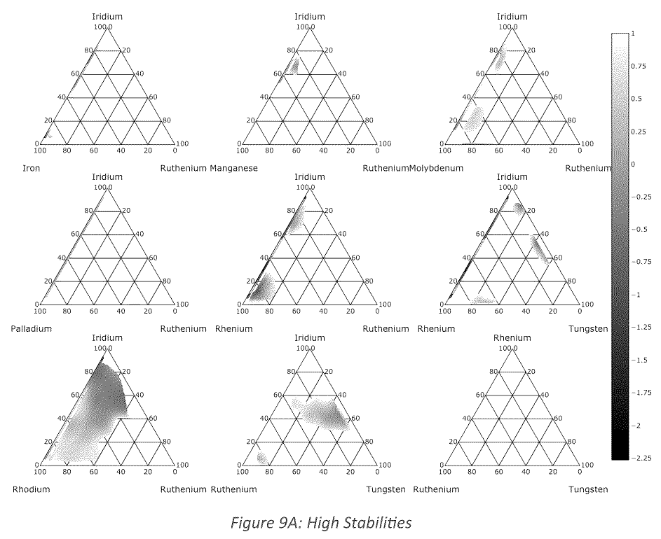

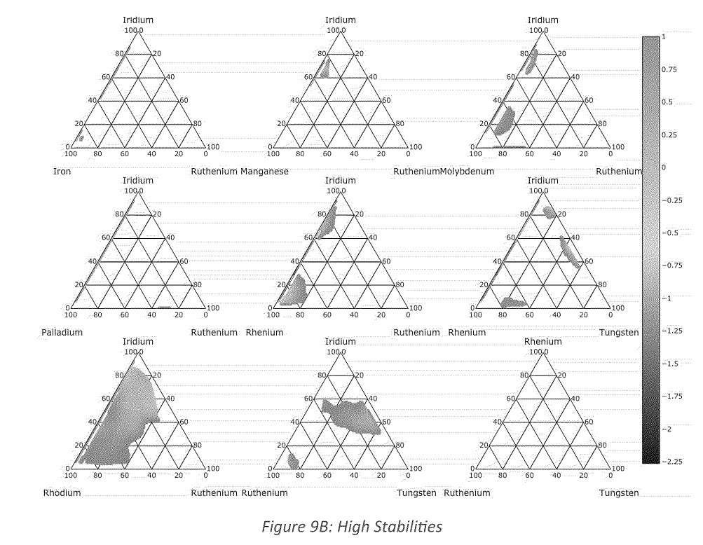

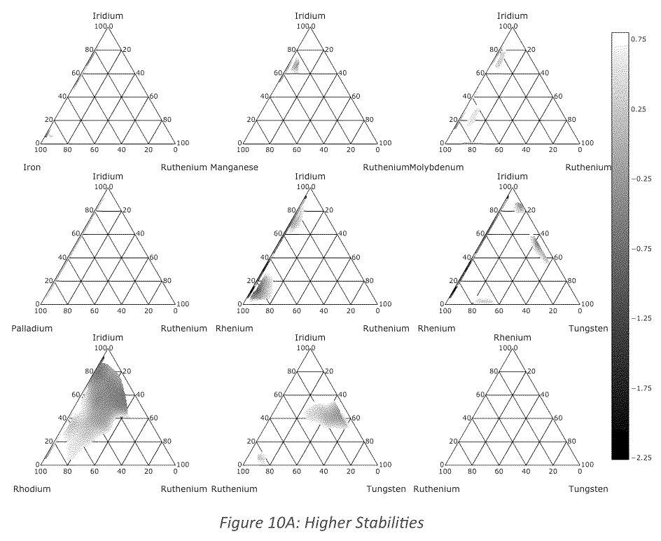

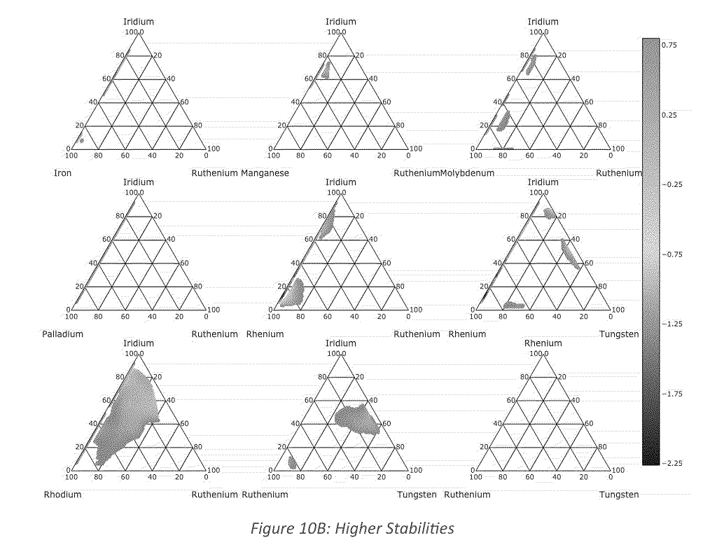

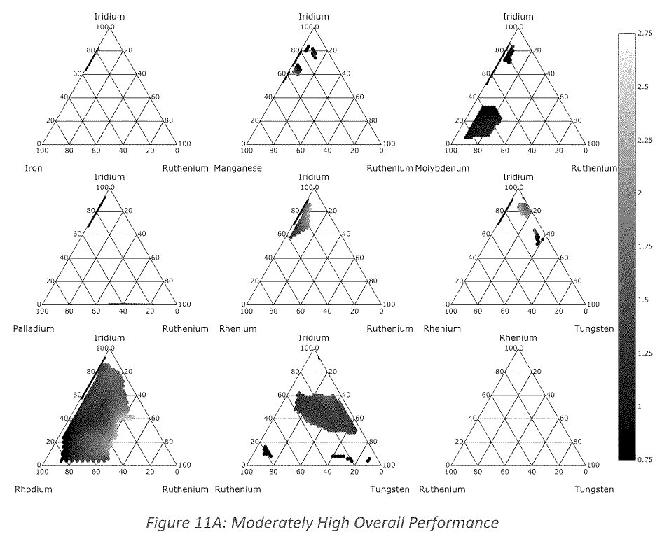

FIGS. 11A & 11B are each a graphical depiction of catalyst material sample combinations indicating moderately high overall performance according to illustrative embodiments, in black & white and color, respectively;

FIGS. 12A & 12B are each a graphical depiction of catalyst material sample combinations indicating high overall performance according to illustrative embodiments, in black & white and color, respectively;

FIGS. 13A & 13B are each a graphical depiction of catalyst material sample combinations indicating higher overall performance according to illustrative embodiments, in black & white and color, respectively; and

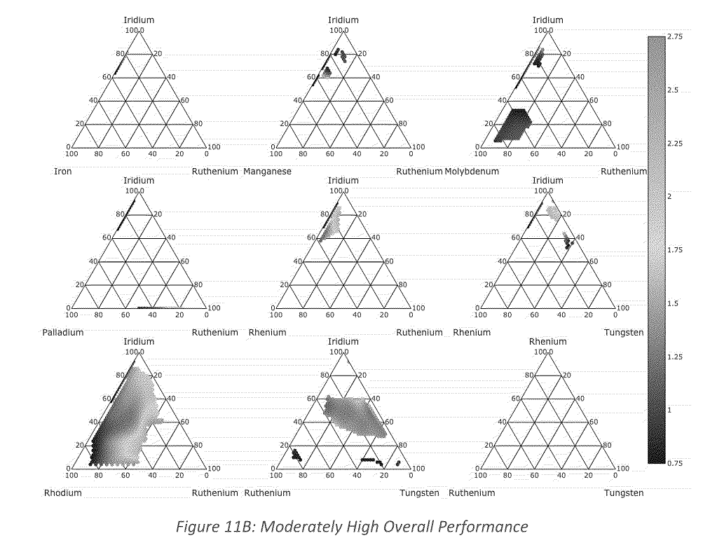

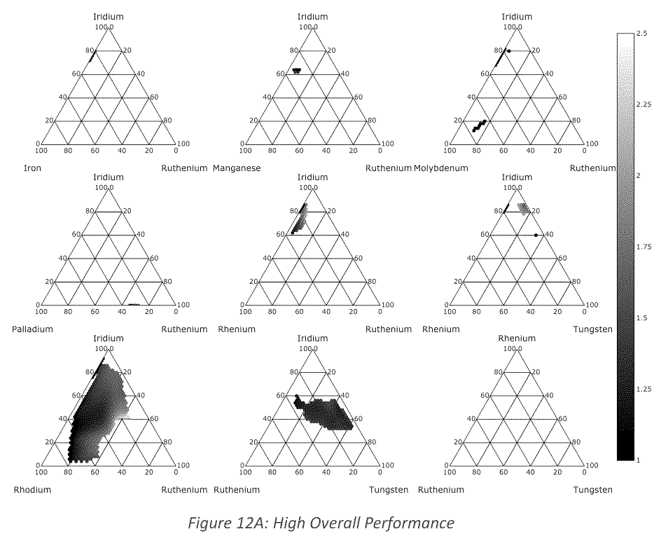

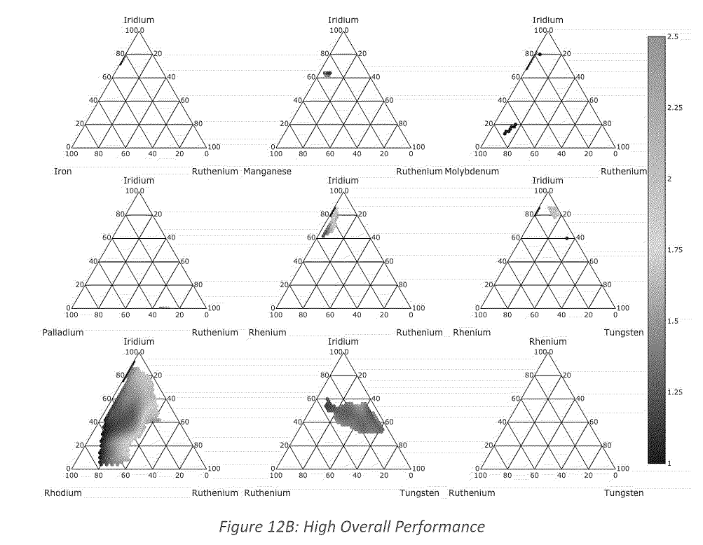

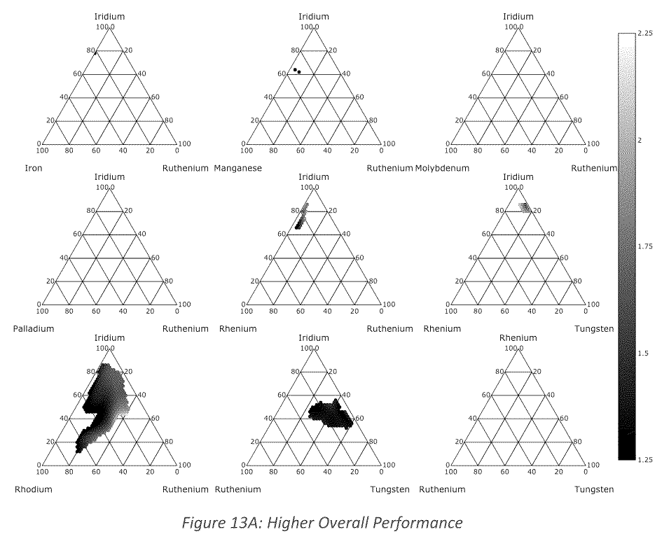

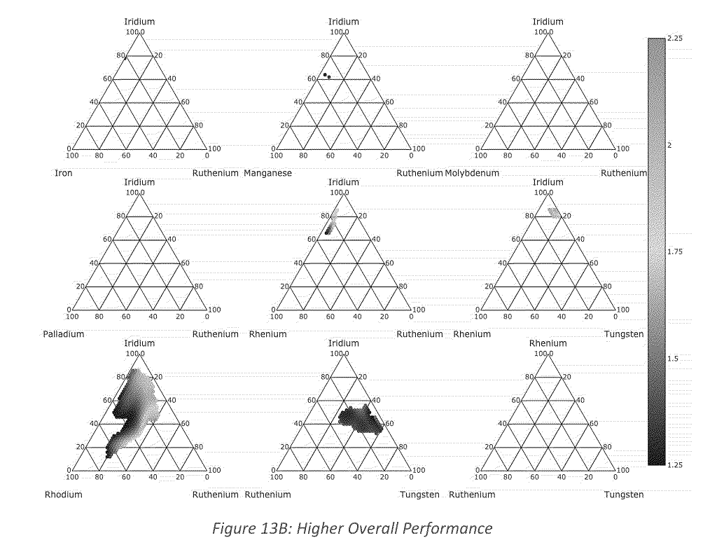

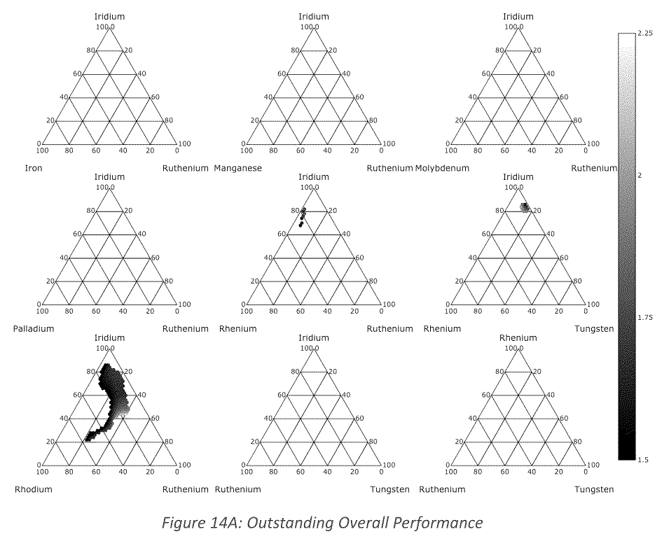

FIGS. 14A & 14B are each a graphical depiction of catalyst material sample combinations indicating outstanding overall performance according to illustrative embodiments, in black & white and color, respectively.

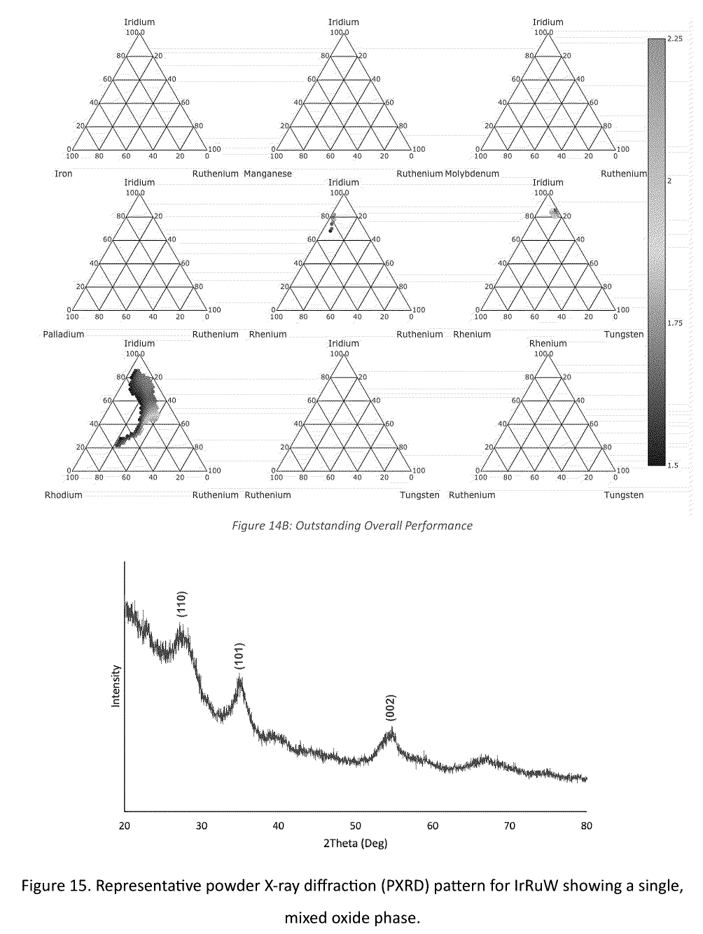

FIG. 15 is a representative powder x-ray diffraction (PXRD) plot from a representative novel catalyst sample, indexed to a single crystallographic phase, according to the illustrative embodiment.

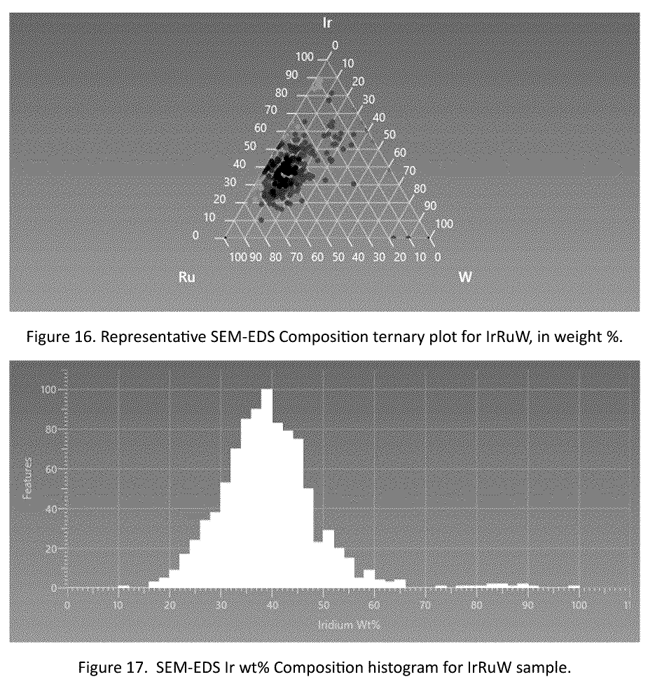

FIG. 16 is a graphical depiction of the composition collected by scanning electron microscopy coupled with energy dispersive x-ray spectroscopy (SEM-EDS) from a representative novel catalyst sample according to the illustrative embodiment.

FIG. 17 is a graphical depiction of the distribution of iridium (wt %) from a representative novel catalyst sample according to the illustrative embodiment.

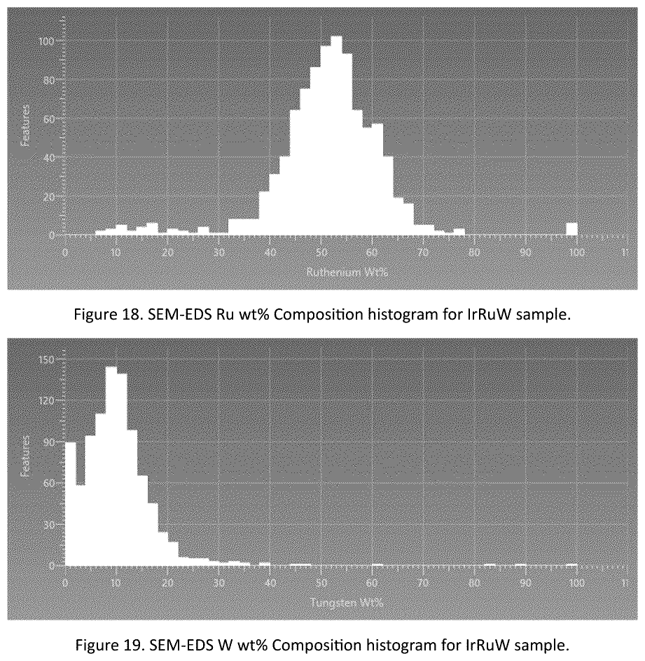

FIG. 18 is a graphical depiction of the distribution of ruthenium (wt %) from a representative novel catalyst sample according to the illustrative embodiment.

FIG. 19 is a graphical depiction of the distribution of tungsten (wt %) from a representative novel catalyst sample according to the illustrative embodiment.

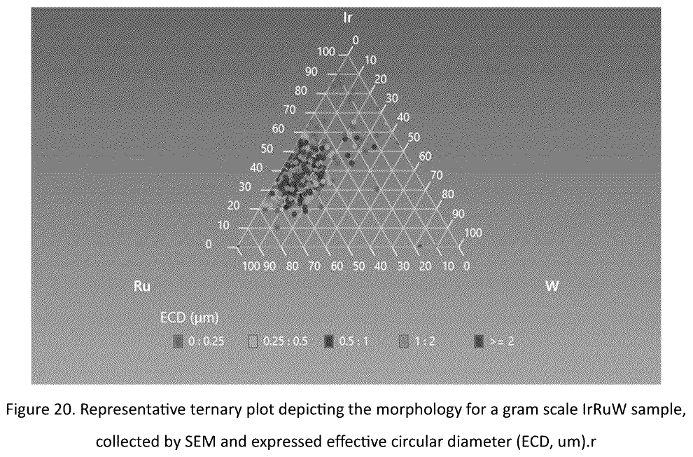

FIG. 20 is a graphical depiction of the effective circular diameter (ECD) in μm collected by scanning electron microscopy (SEM) from a novel catalyst sample according to the illustrative embodiment.

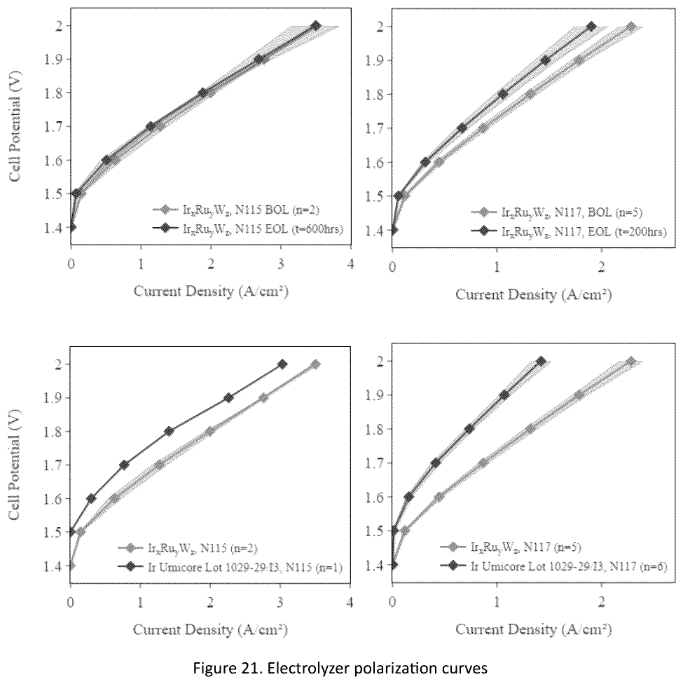

FIG. 21 is a collection of PEM electrolyzer linear polarization curves from novel catalyst samples according to the illustrative embodiment.

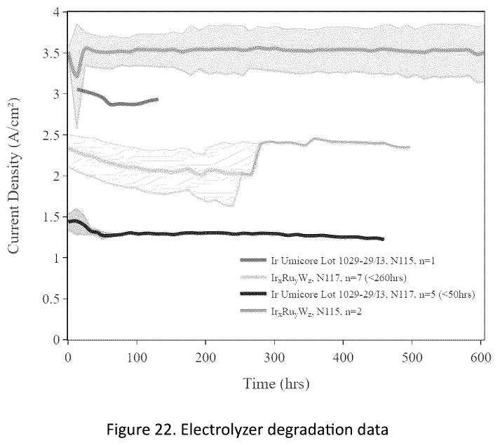

FIG. 22 is a collection of PEM electrolyzer degradation data from novel catalyst and benchmark samples according to the illustrative embodiment.

### DETAILED DESCRIPTION

With the boom in sustainable technologies, particularly in renewable fuels and chemicals, green hydrogen is surging across the globe as an attractive alternative to traditional sources of hydrogen. One method of producing green hydrogen requires polymer electrolyte membrane (PEM) electrolyzers, wherein a proton-conducting membrane serves as the electrolyte that separates the anode and cathode.

In such reactors, the anode performs the oxygen evolution reaction (OER), which oxidizes water into O₂ and H⁺. While the protons subsequently travel across the membrane towards the cathode for the subsequent hydrogen evolution reaction (HER), the pH at the anode is low, leading to conditions that are quite harsh and can benefit from robust anode catalyst materials.

At low pH and oxidative potentials, there are few materials that are both a) stable under those conditions (as indicated by Pourbaix diagrams), and b) active OER catalysts. In the PEM electrolysis industry, the standard anode material is iridium oxide (IrOₓ), as it is both a reasonably active OER catalyst and also suitably stable under the harsh acidic and oxidative conditions. Iridium, however, is one of the world's most expensive raw materials, and annual production of iridium falls well short of the projected need given the current growth of the PEM water electrolysis market. Therefore, an iridium alternative that is sufficiently stable and active in PEM water electrolyzers can enable PEM water electrolyzer growth without severe hampering from supply chain limitations.

Alloying of metals and metal oxides is a promising strategy for enhancing the performance of electrocatalysts toward OER. When two or more metals or oxides alloy, the geometric and/or electronic properties of active sites can change. These property changes can lower the binding energy of intermediates and, as such, lower the overpotential necessary to run the reaction and/or to stabilize the lattice under acidic conditions.

Platinum group metals (PGMs), such as iridium (Ir) and ruthenium (Ru), can act as electrocatalysts for the acidic OER. IrOₓ has a comparatively lower electrocatalytic activity but is significantly more stable at low pH and high oxidative potentials. Consequently, many alloy OER electrocatalysts are based on Ir or Ru.

Among the discoveries of the present disclosure, combinations of Ir and/or Ru with a wide range of elements of various electronic and/or geometric characteristics in two, three, or more element combinations can be applied. Such combination can yield low-Ir or Ir-free catalysts with similar or enhanced performance compared with IrOₓ in terms of activity, stability, or both. Traditional electrocatalysts of mixed composition are often comprised of multiple phases due to fundamental principles underlying the material formation and oxidation processes. Of these, one phase is generally more active towards a given reaction and is thus desired as a formation target. Examples of suitable elements for combination include W, Mo, Re, Fe, Pd, Mn, Rh, Cr referred to herein as “other elements”.

Using polymer pen lithography, combinations were synthesized of bi- and trimetallic, M₁^{X}M₂^{Y} and M₁^{X}M₂^{Y}M₃^{Z}. For these compositions, X, Y, Z are at. % (atomic ratio, % of the total number of atoms are Mᵢ atoms) and X+Y=100% for bimetallic compositions and X+Y+Z=100% for trimetallic compositions. The catalyst candidate materials were selected from the elements mentioned above with 1 at. % step change.

In the illustrative embodiment, catalyst materials were supported on doped SiC. However, in some embodiments, other supports may be applied, e.g., carbon, alumina, silica, titania, tungsten oxide, niobium oxide, indium tin oxide, fluorine-doped indium tin oxide, etc., or no support can be applied.

In addition, presented catalyst materials were first synthesized as zero-valent metallic nanostructures and subsequently thermally oxidized. However, alternative synthesis approaches could be taken to achieve compositionally-similar materials. Such compositionally-similar materials may have the same or different oxidation states, shape, phase, and/or nanostructuring.

The catalyst materials were examined for their beginning of life (BOL) and end of life (EOL) OER activity. In the illustrative embodiment, the materials were examined using high throughput scanning electrochemical methods. However, the electrochemical performance of the synthesized materials could also be measured by other means, such as rotating disk electrode (RDE) testing, half-cell testing, electrolyzer testing, etc.

In the illustrative embodiment, the beginning of life (BOL) activity of catalysts toward acidic oxygen evolution reaction (OER) was measured (via chronoamperometry) as current generated by the catalysts when subjected, for example, to constant voltage of 2 V versus reversible hydrogen electrode (RHE) in 0.3 M HClO₄ normalized to an IrOₓ standard, however, in some embodiments, other protocols can be applied to establish the BOL of catalysts.

In the illustrative embodiment, the end of life (EOL) activity of catalysts toward acidic oxygen evolution reaction (OER) was measured (via chronoamperometry) as current generated by the catalyst when subjected, for example, to constant voltage of 2 V versus reversible hydrogen electrode (RHE) in 0.3 M HClO₄ normalized to an IrOₓ standard, after accelerated stress testing (AST) of the catalysts. The AST protocol can, for example, involve subjecting the catalysts to constant voltage of 1.8 V versus reversible hydrogen electrode (RHE) for 1 hour in 0.1 M HClO₄. However, in some embodiments, other EOL activity measurement and AST protocols can be applied.

In the illustrative embodiment, the stability of catalysts toward acidic oxygen evolution reaction (OER) was calculated as (EOL_{catalyst}−BOL_{catalyst})/BOL_{catalyst} normalized (EOL_{IrOx}−BOL_{IrOx})/BOL_{IrOx}, however, in some embodiments, other formulas can be applied to establish the stability of catalysts.

Using melt fusion and/or templated thermal decomposition, combinations were synthesized of bi- and trimetallic M₁^{X}M₂^{Y} and M₁^{X}M₂^{Y}M₃^{Z}. For these compositions, X, Y, and Z are at % (atomic ratio, % of the total number of atoms are Mi atoms) and X+Y=100% for bimetallic compositions and X+Y+Z+100% for trimetallic compositions These compositions were selected for gram scale synthesis from promising high throughput results.

In the illustrative embodiment, electrocatalyst materials were unsupported. However, in some embodiments, supports may be applied, e.g. carbon, alumina, titanium, titania, niobium, niobium oxide, zirconium, tantalum, antimony, silicon carbide, tungsten, platinum; and in some embodiments support may include other elements.

In addition, presented catalyst materials were first synthesized as direct mixed metal oxides, as well as zero-valent mixed metallic nanostructures that were subsequently thermally oxidized. However, alternative synthesis approaches could be taken to achieve compositionally similar materials. Such compositionally similar materials may have the same or different oxidation states, global morphology, and/or nanostructuring.

The catalyst materials were examined for the beginning of life (BOL), accelerated stress test (AST) performance, and end of life (EOL) OER activity. In the illustrative embodiment, materials were examined using small scale electrolyzer testing. However, the electrochemical performance of synthesized materials could also be measured by other means, such as rotating disk electrode (RDE) testing, half-cell testing, droplet electrochemistry, etc.

In the illustrative embodiment, the beginning of life (BOL) activity of catalysts toward acidic oxygen evolution reaction (OER) was determined from PEM electrolyzer polarization data at the onset of OER after break-in and benchmarked against an IrOx standard. However, in some embodiments, other protocols can be applied to establish the BOL of electrocatalysts.

In the illustrative embodiment, the performance of the novel catalyst toward acidic oxygen evolution reaction (OER) during accelerated stress testing (AST) was measured with square wave cycling and potential holds at 2 V vs RHE. The AST protocol can, for example, involve square wave voltammetry cycling potentials at 2 V and 1.45 V for 30 seconds, each. However, in some embodiments, other protocols and measurements can be applied for AST.

In certain cases, variable calcination conditions have been performed on the same material composition to achieve differences in particle size, morphology, crystallinity, etc.

In certain cases, the compositional distribution can be broad or narrow, with the most optimal being dependent on the material composition.

In certain cases, the size of the material can be small (sub-100 nm particles) or larger (micron-scale), with broad and narrow size distributions. The optimal size distribution can vary depending on the material and other testing parameters.

Each of the compositions described herein can be prepared such that comprising elements form a single mixed phase. Each of the compositions described herein can also be prepared such that multiple mixed phases are formed. Each of the compositions described herein can be prepared such that no mixed (single element) phases are formed. Each of the compositions described herein can also be prepared such that comprising elements form one mixed phase with additional single element phases present.

A typical melt fusion synthetic protocol is as follows:
catalyst precursor solution is prepared by dissolving metal precursor powders in requisite organic solvents (isopropanol, chloroform, acetonitrile, etc.) to achieve the desired ratio and concentration. This solution is combined with a large excess of either sodium nitrate alone or with accompanying salts (1-100× relative to catalyst precursor mass) to generate a slurry, dried while mixing, and transferred to an appropriate furnace crucible/boat. The precursor/salt mixture is annealed in a tube furnace in air at 350-600° C. for 1-4 hours and allowed to cool to room temperature before removal. Crude catalyst powder is then processed via several rounds of sonication, centrifugation, and washing with ultrapure water to remove excess salt and subsequently dried.

A typical templated thermal decomposition synthetic protocol is as follows:
metal precursors are dissolved in requisite organic solvents (isopropanol, chloroform, acetonitrile, etc.) to achieve the desired ratio and concentration. A finely ground inorganic salt powder (potassium sulfate, potassium chloride, sodium chloride, etc.) in the ratio of 100-2000× the mass of the dissolved metal precursors is then added to the solution to form a slurry. This slurry is dried while mixing, transferred to an appropriate furnace crucible/boat and annealed at 300-600° C. for 0.5-6 hours in either air or hydrogen in a tube furnace, with optional following calcination steps. Crude catalyst powder is then processed via several rounds of sonication, centrifugation, and washing with ultrapure water to remove excess salt and subsequently dried.

Electrocatalyst powders are characterized by scanning electron microscopy with energy-dispersive x-ray spectroscopy (SEM-EDS) and powder x-ray diffraction (PXRD). SEM-EDS indicates the material composition and homogeneity for each sample. PXRD indicates the crystallographic characteristics of each powder sample.

Electrocatalyst powders are tested via ex-situ three-electrode methods, as well as 5 cm2 PEM electrolyzer tests.

A typical ex-situ three-electrode testing protocol is as follows:
catalyst powder is dispersed in a mixture of water and alcohol solvents at a concentration of 0.5-4 mg/mL. A dispersion of ionomer is then added in 0.1-12 wt % relative to catalyst powder. The mixture is sonicated for 30-90 minutes, and then applied to electrodes (glassy carbon, gold, etc.) via ultrasonicating spray deposition. The electrodes are then loaded into a three-electrode cell with 0.1-1.0 M perchloric acid and stirred vigorously. Cyclic voltammograms are run in a non-Faradaic potential regime to measure capacitance, then linear sweep voltammograms are run from 1.1-1.8 V vs. RHE to measure the OER activity. Chronoamperometry is then performed at 1.65 V vs. RHE for 5-800 minutes, followed by repeat linear sweep voltammograms. Underpotential deposition of metals (Hg, Pb, etc.) is performed to determine electrochemically active surface area (ECSA).

In some cases, alternative testing protocols can be utilized in place of chronoamperometry, including chronopotentiometry and cyclic voltammetry.

A typical PEM electrolyzer testing protocol is as follows:
catalyst powder is dispersed in a mixture of water and alcohol solvents at a concentration of 0.4-5 mg/mL. A dispersion of ionomer is then added in a 3-25 wt % relative to catalyst powder. The mixture is sonicated for 30-90 minutes, and then applied to ion exchange membranes (with Pt/C already loaded on the opposite side) with a loading of 0.1-1 mg of catalyst powder per cm2. The catalyst coated membrane is assembled into a PEM electrolyzer cell with platinized Ti porous transport layers (anode) and carbon paper porous transport layers (cathode) and PTFE spacers. Ultrapure water (80° C.) is then circulated through the anode flow fields at 100 mL/min, and the assembled cell is preconditioned by a galvanostatic hold at 0.2 A/cm2 for 1 hour, a galvanostatic hold at 1 A/cm2 for 1 hour, a potentiostatic hold at 2 V for 30 minutes. After preconditioning, a polarization curve is collected by holding 1.3-2 V with 0.1 V steps for 5 minutes. Square wave voltammetry is then performed by holding the cell potential at 2 V for 30 seconds, 1.45 V for 30 seconds, and repeating. Every 12 hours, polarization curves are collected.

In some cases, alternative accelerated stress testing protocols can be utilized in place of square wave voltammetry, including constant voltage hold or triangle wave.

Using these methodologies, we have synthesized and validated several promising samples for acidic OER within the combinatorial materials space of Ir—Cr—Ru—Rh—W—Mn—Mo—Fe—Pd—Re.

Electrocatalysts described in Tables 1-19 and FIGS. 1-22 have been synthesized at either chip-scale or gram scale using a variety of techniques, including polymer pen lithography, melt fusion or templated thermal decomposition. Tables 1-17 and FIGS. 2A-14B pertain to chip-scale data. Tables 18-19 and FIGS. 15-22 pertain to gram scale data.

Tables 1-1 and FIGS. 2A-14B summarize the results for high throughput, chip-based experiments screening many example compositions from within the material space listed above. Tables 18-19 and FIGS. 15-22 pertain to gram scale data.

Referring to FIG. 1, an example figure is provided to describe how to read the data presented in FIG. 2-14. Each metal and its corresponding axis are shown where the values along the axis indicate the compositional percentage for that metal. Metal A, Metal B, and Metal C are shown in red, blue, and green, respectively. The interior gridlines also correspond to the axis of its color. Four points are depicted as examples. Point 1 indicates where the composition is 20% Metal A, 20% Metal B, and 60% Metal C. Point 2 indicates where the composition is 20% Metal A, 60% Metal B, and 20% Metal C. Point 3 indicates where the composition is 60% Metal A, 20% Metal B, and 20% Metal C. Point 4 indicates where the compositions are all equivalent and is 33.3% Metal A, 33.3% Metal B, and 33.3% Metal C.

Tables 1-13 show the compositional ranges and corresponding performance for the respective criteria. Columns listed as Metal A, Metal B, and Metal C show the metal's name. The columns Metal A Min at %, Metal B Min at %, and Metal C Min at % show the lower compositional percentage range for Metal A, Metal B, and Metal C respectively in the material space. The columns Metal A Max at %, Metal B Max at %, and Metal C Max at % show the upper compositional percentage range for Metal A, Metal B, and Metal C respectively in the material space.

Referring to Tables 1-3 and 10-13, the columns Upper Metal A Relative BOL Activity at Min at %, Upper Metal B Relative BOL Activity at Min at %, and Upper Metal C Relative BOL Activity at Min at % show the highest Relative Beginning of Life (BOL) activity at the lowest compositional range for Metal A, Metal B, and Metal C respectively. The columns Upper Metal A Relative BOL Activity at Max at %, Upper Metal B Relative BOL Activity at Max at %, and Upper Metal C Relative BOL Activity at Max at % show the highest Relative BOL activity at the highest compositional range for Metal A, Metal B, and Metal C respectively. Higher values indicate better Relative BOL activity. Referring to values in Table 1, Row 2 as an example. The compositional range is 2-86 at % for Iridium, 3-88 at % for Iron, and 2-87 at % for Ruthenium. The Upper Metal A Relative BOL Activity at Min at % value of 1.3169 is the highest Relative BOL activity for materials with 2 at % Iridium. The Upper Metal A Relative BOL Activity at Max at % value of 2.2804 is the highest Relative BOL activity for materials with 86 at % Iridium. The Upper Metal B Relative BOL Activity at Min at % value of 2.5291 is the highest Relative BOL activity for materials with 3 at % Iron. The Upper Metal B Relative BOL Activity at Max at % value of 0.8190 is the highest Relative BOL activity for materials with 88% Iron. The Upper Metal C Relative BOL Activity at Min at % value of 2.7708 is the highest Relative BOL activity for materials with 2 at % Ruthenium. The Upper Metal C Relative BOL Activity at Max at % value of 0.8058 is the highest Relative BOL activity for materials with 87 at % Ruthenium.

Referring to Tables 4-6, the columns Upper Metal A Relative EOL Activity at Min at %, Upper Metal B Relative EOL Activity at Min at %, and Upper Metal C Relative EOL Activity at Min at % show the highest Relative End of Life (EOL) activity at the lowest compositional range for Metal A, Metal B, and Metal C respectively. The columns Upper Metal A Relative EOL Activity at Max at %, Upper Metal B Relative EOL Activity at Max at %, and Upper Metal C Relative EOL Activity at Max at % show the highest Relative EOL activity at the highest compositional range for Metal A, Metal B, and Metal C respectively. Higher values indicate better Relative EOL activity.

Referring to Tables 7-9, the columns Upper Metal A Relative Stability at Min at %, Upper Metal B Relative Stability at Min at %, and Upper Metal C Relative Stability at Min % show the best Relative Stability at the lowest compositional range for Metal A, Metal B, and Metal C respectively. The columns Upper Metal A Relative Stability at Max at %, Upper Metal B Stability Activity at Max at %, and Upper Metal C Relative Stability at Max at % show the best Relative Stability at the highest compositional range for Metal A, Metal B, and Metal C respectively. Lower values indicate better Relative Stability.

Referring to FIGS. 2A-4B, a depiction of Beginning of Life (BOL) activity of samples is shown indicating the level of electrocatalytic activity of given ratios according to shading or coloring, for figures A & B respectively, as indicated by the corresponding range bar. The BOL level of activity is illustratively embodied as the activity toward acidic oxygen evolution reaction (OER) of electrocatalysts composed of one, two, or three elements mixed at a given ratio from the Ir—Cr—Ru—Rh—W—Mn—Mo—Fe—Pd material space defined by the triangular shape for each combination. Each triangle represents a specific metallic compositional space identified with elemental labels at the vertices with the position of a datapoint within a triangle correlating to the atomic % ratio of the elements within the material tested and the shade or color of the datapoint corresponding to the activity (measured in current) measured via chronoamperometry for a given material normalized to an IrOₓ standard, where a value of 1 is equal to the activity of IrOₓ, a value >1 is more active than IrOₓ, and a value <1 is less active than IrOₓ. In FIGS. 2A, 3A, and 4A, the black and white colorscale indicate the Relative BOL performance where white indicates higher relative performance and black indicates lower relative performance. In FIGS. 2B, 3B, and 4B, the black to orange colorscale indicate the Relative BOL performance where orange indicates higher relative performance and black indicates lower relative performance. FIGS. 2A & 2B depict material combinations that have a moderately high BOL activity, defined as ≥75% of the BOL activity of pure IrOₓ, FIGS. 3A & 3B depict material combinations that have a high BOL activity, defined as ≥100% of the BOL activity of pure IrOₓ, and FIGS. 4A & 4B depict material combinations that have higher BOL activity, defined as ≥125% of the BOL activity of pure IrOₓ. The data presented in FIGS. 2A&B, 3A&B, and 4A&B is summarized in Tables 1, 2, and 3, respectively, wherein the ranges of compositions that have moderately high, high, and higher BOL activities are summarized in Tables 1, 2, and 3, respectively, as well as the specific material and material performance near to the extent of each range.

Referring to FIGS. 5A-7B, a depiction of End of Life (EOL) activity of samples is shown indicating the level of activity of given ratios according to shading or coloring, for figures A & B respectively, as indicated in the corresponding range bar. The EOL level of activity is illustratively embodied as the activity toward acidic oxygen evolution reaction (OER) of electrocatalysts composed of one, two, or three elements mixed at a given ratio from the Ir—Cr—Ru—Rh—W—Mn—Mo—Fe—Pd material space. Each triangle represents a specific metallic compositional space identified with elemental labels at the vertices with the position of a datapoint within a triangle correlating to the atomic % ratio of the elements within the material tested and the shade or color of the datapoint corresponding to the activity (measured in current) measured via chronoamperometry for a given material normalized to an IrOₓ standard, where a value of 1 is equal to the activity of IrOₓ, a value >1 is more active than IrOₓ, and a value <1 is less active than IrOₓ. In FIGS. 5A, 6A, and 7A, the black and white colorscale indicate the Relative EOL performance where white indicates higher relative performance and black indicates lower relative performance. In FIGS. 5B, 6B, and 7B, the black to orange colorscale indicate the Relative EOL performance where orange indicates higher relative performance and black indicates lower relative performance. FIGS. 5A&B depict material combinations that have a moderately high EOL activity, defined as ≥75% of the EOL activity of pure IrOₓ, FIGS. 6A&B depict material combinations that have a high EOL activity, defined as ≥100% of the EOL activity of pure IrOₓ, and FIGS. 7A&B depict material combinations that have higher EOL activity, defined as ≥125% of the EOL activity of pure IrOₓ. The data presented in FIGS. 5A&B, 6A&B, and 7A&B is summarized in Tables 4, 5, and 6, wherein the ranges of compositions that have moderately high, high, and higher EOL activities are summarized in Table 4, 5, and 6, respectively, as well as the specific material and material performance near the extent of each range.

The EOL activity was measured after the materials were subjected to accelerated stress testing (AST) conditions. Although in the illustrative embodiment, the AST protocol applied chronoamperometry at an oxidative potential in acidic electrolyte for a set period of time, in some embodiments, any suitable AST protocol may be applied (e.g., chronopotentiometry, potential/current pulsing, square-wave voltammetry, cyclic voltammetry, etc.). Each measurement was benchmarked against pure IrOₓ synthesized and measured in the same batch of samples.

Referring now to FIGS. 8A-10B, a depiction of stability of samples is shown indicating the level of activity of given ratios according to shading or coloring, for figures A & B respectively, as indicated in the corresponding range bar. The stability is illustratively embodied as the reduction in activity toward acidic oxygen evolution reaction (OER) of electrocatalysts composed of one, two, or three elements mixed at a given ratio from the Ir—Cr—Ru—Rh—W—Mn—Mo—Fe—Pd material space. For example, a more stable material will retain more activity from BOL to EOL measurements, whereas a less stable material will lose more activity from BOL to EOL measurements. In FIGS. 8A-10B, each triangle represents a specific metallic compositional space identified with elemental labels at the vertices with the position of a datapoint within a triangle correlating to the atomic % ratio of the elements within the material tested and the shade or color of the datapoint corresponding to the relative stability (measured in the change in current from BOL to EOL) measured via chronoamperometry for a given material normalized to an IrOₓ standard, where a value of 1 is equal to the stability of IrOₓ, a value >1 is less stable than IrOₓ, and a value <1 is more stable than IrOₓ. FIGS. 8A&B depict material combinations that have a moderately high stability, defined as ≥75% of the stability of pure IrOₓ, FIGS. 9A&B depict material combinations that have a high stability, defined as ≥100% of the stability of pure IrOₓ, and FIGS. 10A&B depict material combinations that have higher stability, defined as ≥125% of the stability of pure IrOₓ. The data presented in FIGS. 8A&B, 9A&B, and 10A&B is summarized in Tables 7, 8, and 9, respectively, wherein the ranges of compositions that have moderately high, high, and higher stability are summarized in Table 7, 8, and 9, respectively, as well as the specific material and material performance near the extent of each range.

Although the other elements were applied in the illustrative embodiment, in some embodiments still other components could feasibly be added and/or substituted for other components, such as Pt, Os, Ta, Ce, Ba, Hf, In, Sn, Sb, Au, Ag, Sr, Y, Sc, Nb, La, Pr, Sm, Cu, and others. In some embodiments, catalyst materials may be synthesized not via polymer pen lithography but via other means, such as Adams Fusion, colloidal synthesis, spray pyrolysis, etc.

FIGS. 11A&B, 12A&B, and 13A&B and respectively corresponding Tables 10, 11, and 12, indicate compositions of Ir- and/or Ru-containing polyelemental nanocatalysts that outperform IrOₓ at least in two dimensions.

Referring to FIGS. 11A&B, 12A&B, and 13A&B, a depiction of moderately high overall performing, high overall performing, and higher overall performing samples is shown indicating the level of electrocatalytic activity of given ratios according to shading or coloring, for figure A & B respectively, as indicated in the corresponding range bar. The overall level of activity is illustratively embodied as the activity toward acidic oxygen evolution reaction (OER) of electrocatalysts composed of one, two, or three elements mixed at a given ratio from the Ir—Cr—Ru—Rh—W—Mn—Mo—Fe—Pd material space defined by the triangular shape for each combination. Each triangle represents a specific metallic compositional space identified with elemental labels at the vertices with the position of a datapoint within a triangle correlating to the atomic % ratio of the elements within the material tested and the shade or color of the datapoint corresponding to the activity (measured in current) measured via chronoamperometry for a given material normalized to an IrOₓ, where a value of 1 is equal to the activity or stability of IrOₓ, a value >1 is more active or less stable than IrOₓ, and a value <1 is less active or more stable than IrOₓ. FIGS. 11A&B depict material combinations that have a moderately high overall performance, defined as having both a BOL activity ≥75% of pure IrOₓ and a stability ≥75% of pure IrOₓ. FIGS. 12A&B depict material combinations that have a high overall performance, defined as having both a BOL activity ≥100% of pure IrOₓ and a stability ≥100% of pure IrOₓ. FIG. 13A&B depict material combinations that have a higher overall performance, defined as both a BOL activity ≥125% of pure IrOₓ and a stability ≥125% of pure IrOₓ. The data presented in FIGS. 11A&B, 12A&B, and 13A&B is summarized in Tables 10, 11, and 12, wherein the ranges of compositions that have moderately high, high, and higher overall performance are summarized in Table 10, 11, and 12, respectively, as well as the specific material and material performance near the extent of each range.

Referring to FIGS. 14A&B, a depiction of activity of outstanding overall performing samples is shown indicating the level of electrocatalytic activity of given ratios according to shading or coloring, for figure A & B respectively, as indicated in the corresponding range bar. The overall level of activity is illustratively embodied as the activity toward acidic oxygen evolution reaction (OER) of electrocatalysts composed of one, two, or three elements mixed at a given ratio from the Ir—Cr—Ru—Rh—W—Mn—Mo—Fe—Pd material space defined by the triangular shape for each combination. Each triangle represents a specific metallic compositional space identified with elemental labels at the vertices with the position of a datapoint within a triangle correlating to the atomic % ratio of the elements within the material tested and the shade or color of the datapoint corresponding to the activity (measured in current) measured via chronoamperometry for a given material normalized to an IrOₓ standard, where a value of 1 is equal to the activity or stability of IrOₓ, a value >1 is more active or less stable than IrOₓ, and a value <1 is less active or more stable than IrOₓ. FIGS. 14A&B depict material combinations that have an outstanding overall performance, defined as having a BOL activity ≥150% of pure IrOₓ and a stability ≥150% of pure IrOₓ. The data presented in FIGS. 14A&B is summarized in Table 13, wherein the ranges of compositions that have outstanding overall performance are summarized in Table 13, as well as the specific material and material performance near the extent of each range.

Tables 14-17 indicate specific compositions that demonstrate moderately high, high, higher and outstanding overall performance, namely, that perform well or outperform IrOₓ in both BOL activity and stability. Table 14 indicates specific compositions that demonstrate moderately high overall performance, namely, that have a BOL activity ≥75% of pure IrOₓ and a stability ≥75% of pure IrOₓ. Table 15 indicates specific compositions that demonstrate high overall performance, namely, that have a BOL activity ≥100% of pure IrOₓ and a stability ≥100% of pure IrOₓ. Table 16 indicates specific compositions that demonstrate higher overall performance, namely, that have a BOL activity ≥125% of pure IrOₓ and a stability ≥125% of pure IrOₓ. Table 17 indicates specific compositions that demonstrate outstanding overall performance, namely, that have a BOL activity ≥150% of pure IrOₓ and a stability ≥150% of pure IrOₓ.

The material compositions listed in Tables 1-9 and those depicted in FIGS. 2A-10B are binned to atomic % increments of 1%, however, intermediate compositions within 1% steps are also expected to have similar performance if the compositions fall within the defined ranges.

The material compositions listed in Tables 10-17 and those depicted in FIGS. 11A-14B are binned to atomic % increments of 2%, however intermediate compositions within 2% steps are also expected to have similar performance if the compositions fall within the defined ranges.

Referring now to FIG. 15, a depiction of a standard powder x-ray diffraction (PXRD) pattern obtained from a representative sample of the novel catalyst. PXRD is a powerful analytical technique used to identify the crystalline phases of a material, based on unique combinations of identifying peaks. In other embodiments, other characterization techniques can be used to determine the crystallographic phases of a material. Peak position for PXRD spectra is dependent on radiation source. A copper source is used in the present embodiment. In other embodiments, other radiation sources may be used. The specific composition of this particular sample is Ir_{0.27}Ru_{0.66} W_{0.07}, represented as the molar ratio of the three metal components. The peaks present in this example spectrum have been analyzed and indexed to a single crystallographic phase of the space group P4_2/mnm. These data correspond to the sample listed in Table 19 Row 80.

Referring now to FIG. X, a depiction of the compositional profile of a representative sample of the novel catalyst, expressed as wt %, as measured by scanning electron microscopy coupled with energy-dispersive x-ray spectroscopy (SEM-EDS). SEM-EDS is a coupled analytical technique that yields simultaneous information about the structure and chemical composition of a sample and is used in this embodiment. In other embodiments, other techniques or combinations of techniques can also be used to gain structure and chemical composition of catalyst materials. In the present embodiment, SEM-EDS is used in an automated fashion to collect data from hundreds of features to produce a compositional ternary plot such as the example (wt %). The specific composition of this particular sample is Ir_{0.27}Ru_{0.66} W_{0.07}, represented as the molar ratio of the three metal components. These data correspond to the sample listed in Table 19 Row 80.

Referring now to FIGS. 17-19, a collection of depictions of the compositional distribution of the catalyst sample represented by the ternary plot in FIG. 16. Specifically, FIG. 17X is a histogram that depicts the distribution of Ir across hundreds of features in the catalyst sample (wt %). FIG. 18 is a histogram that depicts the distribution of Ru across hundreds of features in the catalyst sample (wt %). FIG. 19 is a histogram that depicts the distribution of W across hundreds of features in the catalyst sample (wt %). The overall composition of this particular sample as a molar ratio is Ir_{0.27}Ru_{0.66} W_{0.07}. These data correspond to the sample listed in Table 19 Row 80.

Referring now to FIG. 20, a depiction of the morphological profile of a representative sample of the novel catalyst, expressed the effective circular diameter (ECD) in μm, as measured by scanning electron microscopy (SEM). ECD is a method for expressing the size of features from images such as those gathered by SEM. In any given image, the area of an irregular object in frame can be used to calculate the diameter of a theoretical circle of the same area, this value being the ECD (μm). In the illustrative embodiment, SEM is used in an automated fashion to collect data from hundreds of features produce a structural ternary plot such as the example. These data correspond to the sample listed in Table 19 Row 79.

Referring now to FIG. 21, a depiction of novel catalyst PEM electrolyzer performance, where the beginning of life (BOL activity) is reported as A/cm2 at 2 V vs RHE on a linear polarization curve. Two different commercial membranes (Nafion115, Nafion117) were used as the substrate to prepare the novel catalyst for device testing. The upper left panel depicts the average PEM electrolyzer BOL and EOL (post-600 hours accelerated stress testing) activity of two IrₓRu_{y}W_{z} samples with compositions in the preferred ranges on thin N115 ionomer membrane. The lower left panel depicts the average PEM electrolyzer BOL activity of the above IrₓRu_{y}W_{z} samples with compositions in the preferred ranges compared against the BOL activity of the pure Ir benchmark (Umicore Lot 1029-29/13) on thin N115 ionomer membrane. The upper right panel depicts the average PEM electrolyzer BOL and EOL (post-200 hours accelerated stress testing) activity of two IrₓRu_{y}W_{z} samples of preferred composition on thick N117 ionomer membrane. The lower right panel depicts the average PEM electrolyzer BOL activity of the above IrₓRu_{y}W_{z} samples with compositions in the preferred ranges compared against the BOL activity of the pure Ir benchmark (Umicore Lot 1029-29/13) on thick N117 ionomer membrane. In all instances, shading about the data lines depicts the standard deviation of the individual linear polarization curves used to generate the average performance line.

Referring now to FIG. 22, a depiction novel catalyst PEM electrolyzer performance, where the degradation rate is evaluated as percentage of the BOL current density lost per hour of test. Durations are reported in hours. Two different commercial membranes (Nafion115, Nafion117) were used as the substrate to prepare the novel catalyst for device testing. The dark teal line depicts the average degradation of the pure Ir benchmark (Umicore Lot 1029-29/13) on thick N117 ionomer membrane. The yellow line depicts the average degradation of the IrₓRu_{y}W_{z} samples of preferred composition on thick N117 ionomer membrane. The red line depicts the average degradation of the pure Ir benchmark (Umicore Lot 1029-29/13) on thin N115 ionomer membrane. The orange line depicts the average degradation of the IrₓRu_{y}W_{z} samples of preferred composition on thin N115 ionomer membrane. In all instances, shading about the data lines depicts the standard deviation of the degradation curves used to generate the average performance line.

Although the above listed materials were discovered as promising catalyst alternatives to IrOₓ specifically for the acidic OER, they can also be used in other applications.

The use of Novel Catalyst for Oxygen Evolution in Other Industrial Electrochemical Processes.

Anodes for oxygen evolution are widely used in different industrial electrolysis applications, several of which pertain to the field of electrometallurgy, covering a wide range in terms of applied current density, which can be very low (for instance, a few hundred A/m such as the case of electrowinning processes) or also very high (for instance in high-speed electroplating, which can operate in excess of 10 kA/m referred to the anodic surface). Another field of application of oxygen-evolving anodes is cathodic protection under impressed current.

An anode formulation suitable for anodic oxygen evolution in many traditional industrial electrochemical processes comprises a titanium substrate and a catalytic coating consisting of oxides of iridium and tantalum with a molar composition referred to the metals of 60-70% Ir and 30-40% Ta. In some cases (for instance to be able to operate with very acidic or otherwise corrosive electrolytes), it can be advantageous to interpose an intermediate protective layer between titanium substrate and catalytic coating. For example, such a layer may include titanium and tantalum oxides with molar composition of 80% Ti and 20% Ta referred to the metals. This type of electrode can be prepared in different ways, for example, by thermal decomposition of precursor solution at high temperature, for instance 400° C. to 600° C. For a mixed element electrocatalyst, these preparation methods may lead to a multiphase catalytic coating. In many of these applications, the specific loading of iridium in the catalytic layer exceeds 0.5 mg/cm2, often reaching 5 mg/cm2, which is up to 10 times higher than the loading used in PEM electrolysis.

Electrodes with a composition in the specified preferred range can satisfy the needs of several industrial applications, both at low and at high current density, with reasonable operative lifetimes. The economy of some manufacturing processes, especially in the field of metallurgy (for instance copper deposition in galvanic processes for the production of printed circuits and copper foil) nevertheless can require electrodes of increasingly high duration, combined with a suitably reduced oxygen evolution potential even at higher current density. The potential of oxygen evolution can, in fact, be one of the main factors in determining the process operative voltage, and thus, the overall energy consumption.

Moreover, the operative lifetime of anodes cased on noble metals or oxides thereof on metal substrates can be remarkable reduced in the presence of particularly aggressive contaminants, which can establish accelerated phenomena of corrosion or of anode surface pollution. It has, therefore, been evidenced the need for oxygen-evolving anodes characterized by a low oxygen evolution overpotential and by higher operative lifetimes even in particularly critical process conditions, such as a high current density and/or the presence of particularly aggressive electrolytes, for instance, due to the presence of contaminant species, and low or no dependence on Ir.

Anodes for oxygen evolution can be accelerated stress tested by, for example, subjecting the electrodes to constant current density of 3 A/cm2 in 1-1.5 M H₂SO₄ at a temperature of 60° C. and measuring the deactivation time (the operating time required to observe a potential increase of, for example, 1 V).

Similarities in the harshness of the operating conditions suggest that the low-Ir oxygen evolving catalysts which were discovered could replace or reduce Ir not only in PEM water electrolysis, but also other industrial electrochemical applications as suggested above.

Although the above listed materials were discovered as promising electrocatalysts alternative to IrOₓ specifically for the acidic OER, the compositions of the present invention, including each of the preferred embodiments, can also be used in other applications, such as:

### Electrode Coatings for Electrodeposition Process

Electrodeposition is a well-established industrial tool, particularly in electrometallurgy, for the controllable extraction and plating of metals and alloys. The quality of electrodeposited films, including adhesion and uniformity, is highly dependent on harsh operating conditions, such as current density, pH, and temperature, in addition to the local morphology of the electrode. IrOₓ has been employed as an electrode material in some industrial electrodeposition processes, due to its durability. Electrodes fabricated from the disclosed novel electrocatalyst can be used in electrodeposition processes in place of IrOₓ or other noble/transition/platinum group metals where appropriate

### Electrode Coatings for Electrowinning

Electrowinning is the electrodeposition of metals from an ore leach solution containing metal ions. It is important for the industrial purification of metals and can involve harsh conditions, such as high current density and temperature, as well as low pH. IrOₓ has been employed as an electrode material in some industrial electrowinning processes due to its durability. Electrodes fabricated from the disclosed novel electrocatalyst can be used in electrowinning processes in place of IrOₓ or other noble/transition/platinum group metals where appropriate.

### Electrode Coatings for Electroplating

Electroplating is a well-established industrial tool, particularly in electrometallurgy, for the controllable extraction and plating of metals and alloys. The quality of electroplated films, including adhesion and uniformity, is highly dependent on potentially harsh operating conditions, such as high current density and temperature, along with low pH. IrOₓ has been employed as an electrode material in some industrial electroplating processes, due to its durability. Electrodes fabricated from the disclosed novel electrocatalyst can be used in electroplating processes in place of IrOₓ or other noble/transition/platinum group metals where appropriate.

### Electrode Coatings for Chlorine Production

The chlorine evolution reaction (CER) is a critical anodic reaction in chlor-alkali electrolysis and is utilized at industrial scales. Typically, pure noble metal electrocatalysts are used. Operation of the reaction can occur in both neutral and acidic pH, but both are prone to competing side reactions, such as the oxygen evolution reaction (OER). Including other elements, such as those included in the disclosed novel catalyst, can help mitigate these factors. Electrodes fabricated from the disclosed novel electrocatalyst can be utilized for CER and other halogen generating applications in place of IrOₓ or other noble/transition/platinum group metals where appropriate.

### Electrocatalysts for Hydrogen Generation and Oxidation

The hydrogen evolution reaction (HER) and the hydrogen oxidation reaction (HOR) are critical to the future of hydrogen fuel. HOR rate is hindered under alkaline conditions. Therefore, the reaction is typically performed under acidic conditions and requires the use of robust and scarce IrOₓ. Electrodes fabricated from the disclosed novel electrocatalyst can be utilized for HER/HOR applications in place of IrOₓ or other noble/transition/platinum group metals where appropriate.

### Electrocatalysts for Oxygen Generation and Reduction

The oxygen evolution reaction (OER) and the oxygen reduction reaction (ORR) are core steps of many systems for energy conversion and storage but are prone to sluggish kinetics and multielectron transfer processes. Platinum and other platinum group metal (PGM) based materials are typically employed for OER/ORR. Electrodes fabricated from the disclosed novel electrocatalyst can be utilized for OER/ORR applications in place of IrOₓ or other noble/transition/platinum group metals where appropriate.

### Electrocatalysts for CO₂ Conversion

The electrocatalytic conversion of CO₂ is one potential approach to lessen anthropogenic contributions to atmospheric CO₂ and store excess renewable electricity as chemical energy in fuels. Various noble and transition metal catalysts have been developed for electrocatalytic CO₂ conversion, but it can be hindered by poor energy efficiency, reaction selectivity, and overall conversion rate. Electrodes fabricated from the disclosed novel electrocatalyst may be applied for electrocatalytic CO₂ conversion reactions in place of noble/transition/platinum group metals where appropriate.

### Electrocatalysts for Biomass Conversion

Selective and efficient electrochemical conversion of biomass derivatives can provide an economically viable and scalable approach to storing renewable energy. Both biomass conversion and OER involve nucleophilic reactions. Therefore, the selection of materials for biomass conversion is primarily based on effective OER electrocatalysts such as IrO₂ and others. Electrodes fabricated from the disclosed novel electrocatalyst may be applied for electrocatalytic biomass conversion reactions in place of noble/transition/platinum group metals where appropriate.

### Catalysts for Hydrogenation and De-Hydrogenation

Electrocatalytic hydrogenation (ECH) and dehydrogenation reactions produce high value chemicals from organic feedstocks and water. These reactions can be limited by the low solubility of reagents in aqueous conditions and electrical losses in organic conditions. Generally, noble and platinum group metals are employed for these reactions. Electrodes fabricated from the disclosed novel electrocatalyst may be applied for electrocatalytic hydrogenation/dehydrogenation reactions in place of noble/transition/platinum group metals where appropriate.

### Catalysts for Ammonia Generation and Conversion

Ammonia is a fundamental chemical used in many industrial applications and has historically been generated by CO₂ emitting processes. The development of electrocatalytic generation of clean ammonia enables a route to decentralized ammonia production at room temperature from local renewable energy. Nitrate reduction reaction (NRR) produces ammonia from nitrate ions, abundantly found in polluted groundwater and industrial wastewater, using noble metal-based catalysts. Electrodes fabricated from the disclosed novel electrocatalyst may be applied for electrocatalytic ammonia generation and conversion reactions in place of noble/transition/platinum group metals where appropriate.

### Catalysts for Gas Purification, Among Others Dexoygenation, Dehydrogenation, CO₂ Cleaning

Electrocatalytic reactions like those described above, among others, can be employed for gas purification. For instance, H₂ streams generated from OER typically contain O₂ at unsafe levels. Platinum group metal electrocatalysts can be employed to remove O₂ selectively from H₂ streams. Additionally, flue gas produced from industrial combustion can contain significant amounts of CO₂ and is a target for capture and utilization. However, the gas also contains notable impurities, such as SO₂, that can poison the active sites of ideal electrocatalysts. Electrodes fabricated from the disclosed novel electrocatalyst may be applied for electrocatalytic gas purification reactions in place of noble/transition/platinum group metals where appropriate.

### Electrocatalysts for Organic Oxidation Reactions

Electrooxidation of organic compounds can leverage local green electricity to produce high value chemicals from organic feedstocks and water. These reactions have been limited by the lack of stable and efficient electrocatalyst materials. Electrodes fabricated from the disclosed novel electrocatalyst may be applied for electrocatalytic hydrogenation/dehydrogenation reactions in place of noble/transition/platinum group metals where appropriate.

### Specific Material Spaces Synthesized:

IrW
IrMo
IrRe
RuW
RuMo
RuRe
IrRuW
IrRuRe
IrRuMo
IrWRe
RuWRe
IrFe
RuFe
IrRuFe
IrPd
RuPd
IrRuPd
IrRh
RuRh
IrRuRh
IrMn
RuMn
IrRuMn
IrCr
RuCr
IrRuCr

The tables provided hereinafter include:
TABLE 1 is a description of catalyst material sample combinations indicating moderately high Beginning of Life (BOL) activity according to illustrative embodiments;
TABLE 2 is a description of catalyst material sample combinations indicating high Beginning of Life (BOL) activity according to illustrative embodiments;
TABLE 3 is a description of catalyst material sample combinations indicating higher Beginning of Life (BOL) activity according to illustrative embodiments;
TABLE 4 is a description of catalyst material sample combinations indicating moderately high End of Life (EOL) activity according to illustrative embodiments;
TABLE 5 is a description of catalyst material sample combinations indicating high End of Life (EOL) activity according to illustrative embodiments;
TABLE 6 is a description of catalyst material sample combinations indicating higher End of Life (EOL) activity according to illustrative embodiments;
TABLE 7 is a description of catalyst material sample combinations indicating moderately high stability according to illustrative embodiments;
TABLE 8 is a description of catalyst material sample combinations indicating high stability according to illustrative embodiments;
TABLE 9 is a description of catalyst material sample combinations indicating higher stability according to illustrative embodiments;
TABLE 10 is a description of catalyst material sample combinations indicating moderately high overall performance according to illustrative embodiments;
TABLE 11 is a description of catalyst material sample combinations indicating high overall performance according to illustrative embodiments;
TABLE 12 is a description of catalyst material sample combinations indicating higher overall performance according to illustrative embodiments;
TABLES 13 is a description of catalyst material sample combinations indicating outstanding overall performance according to illustrative embodiments; and
TABLES 14-17 are descriptions of specific catalyst material sample compositions selected from the combinations indicated in Tables 10-13 indicating moderately high, high, higher, and outstanding overall performance according to illustrative embodiments.
TABLE 18 shows ranges of preferred catalyst material sample combinations based on performance of gram scale samples according to illustrative embodiments. For each constituent element, the minimum (min at %) and maximum (max at %) composition values encompass the preferred ranges. All at % values are generated from hundreds of features measured by SEM-EDS.
TABLE 19 is a description of various individual novel catalyst material combinations including samples with PEM electrolyzer performance meeting or exceeding that of the commercial Ir catalyst (Umicore Ir Lot 1029-29/13). For each constituent element, the average at % composition values are reported for individual samples. The deviation for these values describes the average deviation for any given feature in a sample and are reported as the minimum (min at %) and maximum (max at %) composition values where applicable for each element. All at % values and deviations are generated from hundreds of features measured by SEM-EDS. Structural information is gathered by SEM for each sample as the effective circular diameter (ECD). ECD expresses the size of irregular objects in an image by calculating the diameter of a theoretical circle of the same area as the object. Catalyst powders are loaded onto glassy carbon electrodes and screened for OER activity in three electrode tests by linear sweep voltammetry (1.1-1.8 V vs. RHE and reported as μA/μg at 1.8 V vs. RHE) and durability by chronoamperometry (1.65 V vs. RHE for 5-800 minutes and reported as % loss in activity post-hold). Finally, catalysts are applied as an anode material to an ionomer membrane, where the loading is measured as mg/cm² and the membrane resistance (HFR) is measured in mΩ, and subsequently tested in a PEM electrolyzer station. PEM electrolyzer BOL activity is determined via linear sweep and reported as A/cm² at 2.0 V vs RHE. PEM electrolyzer degradation rates are only reported for catalysts tested under respective accelerated stress testing conditions (i.e. square wave, SqW) for longer than 50 hours.

TABLE 1
Moderately High BOL Activity

| | | | | | | | | | Upper | Upper | Upper | Upper | Upper | Upper |
|---|---|---|---|---|---|---|---|---|---|---|---|---|---|---|
| | | | | | | | | | Metal A | Metal A | Metal B | Metal B | Metal C | Metal C |
| | | | | | | | | | Relative | Relative | Relative | Relative | Relative | Relative |
| | | | Metal | Metal | Metal | Metal | Metal | Metal | BOL | BOL | BOL | BOL | BOL | BOL |
| | | | A | A | B | B | C | C | Activity | Activity | Activity | Activity | Activity | Activity |
| | | | Min | Max | Min | Max | Min | Max | @ | @ | @ | @ | @ | @ |
| Metal A | Metal B | Metal C | % | % | % | % | % | % | Min % | Max % | Min % | Max % | Min % | Max % |
| Iridium | Iron | None | 27 | 91 | 9 | 73 | 0 | 0 | 0.7540 | 1.1169 | 1.1169 | 0.7540 | | |
| Iridium | Iron | Ruthenium | 2 | 86 | 3 | 88 | 2 | 87 | 1.3169 | 2.2804 | 2.5291 | 0.8190 | 2.7708 | 0.8058 |
| Iridium | Manganese | None | 54 | 96 | 4 | 46 | 0 | 0 | 1.0065 | 0.9125 | 0.9125 | 1.0065 | | |
| Iridium | Manganese | Ruthenium | 18 | 89 | 2 | 46 | 3 | 79 | 0.7673 | 0.9860 | 1.3482 | 1.4811 | 0.8931 | 0.7673 |
| Iridium | Moly- | None | 51 | 96 | 4 | 49 | 0 | 0 | 0.7639 | 1.4483 | 1.4483 | 0.7639 | | |
| | bdenum | | | | | | | | | | | | | |
| Iridium | Moly- | Ruthenium | 2 | 91 | 2 | 86 | 2 | 90 | 1.0261 | 1.5437 | 1.0269 | 0.8868 | 1.5437 | 1.1248 |
| | bdenum | | | | | | | | | | | | | |
| Iridium | Palladium | None | 56 | 92 | 8 | 44 | 0 | 0 | 0.7555 | 0.8121 | 0.8121 | 0.7555 | | |
| Iridium | Palladium | Ruthenium | 2 | 86 | 5 | 79 | 2 | 85 | 2.4675 | 1.0865 | 1.2125 | 0.7658 | 1.1558 | 1.8924 |
| Iridium | Rhenium | None | 62 | 91 | 9 | 38 | 0 | 0 | 0.7762 | 0.9242 | 0.9242 | 0.7762 | | |
| Iridium | Rhenium | Ruthenium | 2 | 86 | 5 | 59 | 2 | 85 | 1.8705 | 2.0178 | 3.0556 | 0.7633 | 1.7953 | 2.8357 |
| Iridium | Rhenium | Tungsten | 13 | 86 | 2 | 43 | 2 | 76 | 0.8124 | 1.9268 | 1.8709 | 0.7560 | 1.8595 | 0.7819 |
| Iridium | Rhodium | None | 47 | 92 | 8 | 53 | 0 | 0 | 0.7529 | 1.0520 | 1.0520 | 0.7529 | | |
| Iridium | Rhodium | Ruthenium | 2 | 86 | 5 | 90 | 2 | 85 | 1.0594 | 1.5315 | 3.0135 | 0.7845 | 1.4621 | 2.1894 |
| Iridium | Ruthenium | Tungsten | 4 | 86 | 2 | 82 | 5 | 92 | 0.8762 | 2.1926 | 2.6927 | 0.7800 | 1.8902 | 0.8762 |
| Iridium | Tungsten | None | 18 | 92 | 8 | 82 | 0 | 0 | 0.7704 | 1.3898 | 1.3898 | 0.7704 | | |
| Iron | Ruthenium | None | 8 | 47 | 53 | 92 | 0 | 0 | 0.9078 | 0.7613 | 0.7613 | 0.9078 | | |
| Manganese | Ruthenium | None | 4 | 46 | 54 | 96 | 0 | 0 | 4.2278 | 0.9374 | 0.9374 | 4.2278 | | |
| Moly- | Ruthenium | None | 6 | 7 | 93 | 94 | 0 | 0 | 0.7548 | 0.7523 | 0.7523 | 0.7548 | | |
| bdenum | | | | | | | | | | | | | | |
| Palladium | Ruthenium | None | 8 | 53 | 47 | 92 | 0 | 0 | 1.0605 | 0.7660 | 0.7660 | 1.0605 | | |
| Rhodium | Ruthenium | None | 25 | 93 | 7 | 75 | 0 | 0 | 0.7596 | 1.8887 | 1.8887 | 0.7596 | | |

TABLE 2
High BOL Activity

| | | | | | | | | | Upper | Upper | Upper | Upper | Upper | Upper |
|---|---|---|---|---|---|---|---|---|---|---|---|---|---|---|
| | | | | | | | | | Metal A | Metal A | Metal B | Metal B | Metal C | Metal C |
| | | | | | | | | | Metal | Relative | Relative | Relative | Relative | Relative |
| | | | Metal | Metal | Metal | Metal | Metal | Metal | BOL | BOL | BOL | BOL | BOL | BOL |
| | | | A | A | B | B | C | C | Activity | Activity | Activity | Activity | Activity | Activity |
| | | | Min | Max | Min | Max | Min | Max | @ | @ | @ | @ | @ | @ |
| Metal A | Metal B | Metal C | % | % | % | % | % | % | Min % | Max % | Min % | Max % | Min % | Max % |

| | | | | | | | | | | | | | | |
|---|---|---|---|---|---|---|---|---|---|---|---|---|---|---|
| Iridium | Iron | None | 64 | 91 | 9 | 36 | 0 | 0 | 1.0260 | 1.1169 | 1.1169 | 1.0260 | | |
| Iridium | Iron | Ruthenium | 2 | 86 | 3 | 85 | 2 | 85 | 1.3169 | 2.2804 | 2.5291 | 1.0578 | 2.7708 | 1.0597 |
| Iridium | Manganese | None | 54 | 92 | 8 | 46 | 0 | 0 | 1.0065 | 1.0334 | 1.0334 | 1.0065 | | |
| Iridium | Manganese | Ruthenium | 22 | 87 | 2 | 46 | 4 | 62 | 1.0522 | 1.0030 | 1.3482 | 1.4811 | 1.8037 | 1.0199 |
| Iridium | Moly- | None | 66 | 96 | 4 | 34 | 0 | 0 | 1.0167 | 1.4483 | 1.4483 | 1.0167 | | |
| | bdenum | | | | | | | | | | | | | |
| Iridium | Moly- | Ruthenium | 2 | 91 | 2 | 80 | 2 | 90 | 1.0261 | 1.5437 | 1.0269 | 1.0214 | 1.5437 | 1.1248 |
| | bdenum | | | | | | | | | | | | | |
| Iridium | Palladium | None | 74 | 89 | 11 | 26 | 0 | 0 | 1.0080 | 1.0142 | 1.0142 | 1.0080 | | |
| Iridium | Palladium | Ruthenium | 2 | 86 | 5 | 58 | 2 | 85 | 2.4675 | 1.0865 | 1.2125 | 1.0075 | 1.1558 | 1.8924 |
| Iridium | Rhenium | None | 72 | 90 | 10 | 28 | 0 | 0 | 1.0151 | 1.2219 | 1.2219 | 1.0151 | | |
| Iridium | Rhenium | Ruthenium | 2 | 86 | 5 | 54 | 2 | 85 | 1.8705 | 2.0178 | 3.0556 | 1.0680 | 1.7953 | 2.8357 |
| Iridium | Rhenium | Tungsten | 16 | 86 | 2 | 33 | 2 | 72 | 1.0026 | 1.9268 | 1.8709 | 1.0225 | 1.8595 | 1.0078 |
| Iridium | Rhodium | None | 63 | 92 | 8 | 37 | 0 | 0 | 1.0004 | 1.0520 | 1.0520 | 1.0004 | | |
| Iridium | Rhodium | Ruthenium | 2 | 86 | 5 | 78 | 2 | 85 | 1.0594 | 1.5315 | 3.0135 | 1.0246 | 1.4621 | 2.1894 |
| Iridium | Ruthenium | Tungsten | 9 | 86 | 2 | 70 | 5 | 86 | 1.0341 | 2.1926 | 2.6927 | 1.0152 | 1.8902 | 1.0002 |
| Iridium | Tungsten | None | 26 | 92 | 8 | 74 | 0 | 0 | 1.0143 | 1.3898 | 1.3898 | 1.0143 | | |
| Manganese | Ruthenium | None | 4 | 44 | 56 | 96 | 0 | 0 | 4.2278 | 1.0223 | 1.0223 | 4.2278 | | |
| Palladium | Ruthenium | None | 8 | 43 | 57 | 92 | 0 | 0 | 1.0605 | 1.0031 | 1.0031 | 1.0605 | | |
| Rhodium | Ruthenium | None | 37 | 93 | 7 | 63 | 0 | 0 | 1.0120 | 1.8887 | 1.8887 | 1.0120 | | |

TABLE 3
Higher BOL Activity

| | | | | | | | | | Upper | Upper | Upper | Upper | Upper | Upper |
|---|---|---|---|---|---|---|---|---|---|---|---|---|---|---|
| | | | | | | | | | Metal A | Metal A | Metal B | Metal B | Metal C | Metal C |
| | | | | | | | | | Relative | Relative | Relative | Relative | Relative | Relative |
| | | | Metal | Metal | Metal | Metal | Metal | Metal | BOL | BOL | BOL | BOL | BOL | BOL |
| | | | A | A | B | B | C | C | Activity | Activity | Activity | Activity | Activity | Activity |
| | | | Min | Max | Min | Max | Min | Max | @ | @ | @ | @ | @ | @ |
| Metal A | Metal B | Metal C | % | % | % | % | % | % | Min % | Max % | Min % | Max % | Min % | Max % |
| Iridium | Iron | None | 69 | 90 | 10 | 31 | 0 | 0 | 1.3133 | 1.6903 | 1.6903 | 1.3133 | | |
| Iridium | Iron | Ruthenium | 2 | 86 | 3 | 75 | 2 | 81 | 1.3169 | 2.2804 | 2.5291 | 1.3044 | 2.7708 | 1.2510 |
| Iridium | Manganese | None | 81 | 88 | 12 | 19 | 0 | 0 | 1.2572 | 1.2579 | 1.2579 | 1.2572 | | |
| Iridium | Manganese | Ruthenium | 43 | 77 | 2 | 46 | 4 | 32 | 1.3978 | 1.2854 | 1.3482 | 1.4811 | 1.8037 | 1.2622 |
| Iridium | Moly- | None | 78 | 96 | 4 | 22 | 0 | 0 | 1.2605 | 1.4483 | 1.4483 | 1.2605 | | |
| | bdenum | | | | | | | | | | | | | |
| Iridium | Moly- | Ruthenium | 6 | 91 | 3 | 57 | 2 | 86 | 1.5255 | 1.5437 | 1.3043 | 1.2637 | 1.5437 | 1.2674 |
| | bdenum | | | | | | | | | | | | | |
| Iridium | Palladium | Ruthenium | 2 | 38 | 6 | 49 | 42 | 85 | 2.4675 | 1.2559 | 1.4474 | 1.2834 | 1.2631 | 1.8924 |
| Iridium | Rhenium | None | 77 | 89 | 11 | 23 | 0 | 0 | 1.2547 | 1.3336 | 1.3336 | 1.2547 | | |
| Iridium | Rhenium | Ruthenium | 2 | 86 | 5 | 51 | 2 | 85 | 1.8705 | 2.0178 | 3.0556 | 1.3100 | 1.7953 | 2.8357 |
| Iridium | Rhenium | Tungsten | 49 | 86 | 2 | 27 | 2 | 36 | 1.2755 | 1.9268 | 1.8709 | 1.2839 | 1.8595 | 1.2711 |
| Iridium | Rhodium | None | 79 | 90 | 10 | 21 | 0 | 0 | 1.2559 | 1.2600 | 1.2600 | 1.2559 | | |
| Iridium | Rhodium | Ruthenium | 3 | 86 | 5 | 71 | 2 | 85 | 1.2690 | 1.5315 | 3.0135 | 1.2782 | 1.4621 | 2.1894 |
| Iridium | Ruthenium | Tungsten | 13 | 86 | 2 | 61 | 5 | 80 | 1.2778 | 2.1926 | 2.6927 | 1.2516 | 1.8902 | 1.2777 |
| Iridium | Tungsten | None | 31 | 92 | 8 | 69 | 0 | 0 | 1.2571 | 1.3898 | 1.3898 | 1.2571 | | |
| Manganese | Ruthenium | None | 4 | 40 | 60 | 96 | 0 | 0 | 4.2278 | 1.2556 | 1.2556 | 4.2278 | | |
| Palladium | Ruthenium | None | 12 | 36 | 64 | 88 | 0 | 0 | 1.3008 | 1.2551 | 1.2551 | 1.3008 | | |
| Rhodium | Ruthenium | None | 81 | 93 | 7 | 19 | 0 | 0 | 1.2640 | 1.8887 | 1.8887 | 1.2640 | | |

TABLE 4
Moderately High EOL Activity

| | | | | | | | | | Upper | Upper | Upper | Upper | Upper | Upper |
|---|---|---|---|---|---|---|---|---|---|---|---|---|---|---|
| | | | | | | | | | Metal A | Metal A | Metal B | Metal B | Metal C | Metal C |
| | | | | | | | | | Relative | Relative | Relative | Relative | Relative | Relative |
| | | | Metal | Metal | Metal | Metal | Metal | Metal | EOL | EOL | EOL | EOL | EOL | EOL |
| | | | A | A | B | B | C | C | Activity | Activity | Activity | Activity | Activity | Activity |
| | | | Min | Max | Min | Max | Min | Max | @ | @ | @ | @ | @ | @ |
| Metal A | Metal B | Metal C | % | % | % | % | % | % | Min % | Max % | Min % | Max % | Min % | Max % |
| Iridium | Iron | None | 49 | 91 | 9 | 51 | 0 | 0 | 0.7543 | 0.8981 | 0.8981 | 0.7543 | | |
| Iridium | Iron | Ruthenium | 9 | 86 | 3 | 69 | 2 | 79 | 0.7599 | 1.5535 | 1.945 | 0.7551 | 1.7934 | 0.7782 |
| Iridium | Manganese | None | 54 | 96 | 4 | 46 | 0 | 0 | 0.9737 | 0.7766 | 0.7766 | 0.9737 | | |
| Iridium | Manganese | Ruthenium | 42 | 89 | 2 | 46 | 3 | 34 | 0.8491 | 0.8238 | 1.0482 | 1.2647 | 0.8408 | 0.7744 |
| Iridium | Moly- | None | 50 | 96 | 4 | 50 | 0 | 0 | 0.7605 | 1.3223 | 1.3223 | 0.7605 | | |
| | bdenum | | | | | | | | | | | | | |
| Iridium | Moly- | Ruthenium | 2 | 91 | 2 | 86 | 2 | 90 | 0.8133 | 1.4226 | 0.8433 | 0.8606 | 1.4226 | 0.8798 |
| | bdenum | | | | | | | | | | | | | |
| Iridium | Palladium | None | 58 | 92 | 8 | 42 | 0 | 0 | 0.7555 | 0.8727 | 0.8727 | 0.7555 | | |
| Iridium | Palladium | Ruthenium | 2 | 82 | 7 | 43 | 2 | 85 | 1.3094 | 0.7581 | 0.7662 | 0.7513 | 0.7766 | 1.0977 |
| Iridium | Rhenium | None | 55 | 92 | 8 | 45 | 0 | 0 | 0.7631 | 0.8431 | 0.8431 | 0.7631 | | |
| Iridium | Rhenium | Ruthenium | 2 | 86 | 5 | 55 | 2 | 85 | 0.9596 | 1.9835 | 1.5307 | 0.7633 | 1.9053 | 1.4679 |
| Iridium | Rhenium | Tungsten | 23 | 86 | 2 | 31 | 2 | 63 | 0.75 | 2.0892 | 2.0701 | 0.7838 | 1.5369 | 0.75 |
| Iridium | Rhodium | None | 40 | 92 | 8 | 60 | 0 | 0 | 0.7575 | 1.4852 | 1.4852 | 0.7575 | | |
| Iridium | Rhodium | Ruthenium | 2 | 86 | 5 | 85 | 2 | 85 | 0.7675 | 1.904 | 2.0754 | 0.7711 | 1.8598 | 1.4403 |
| Iridium | Ruthenium | Tungsten | 4 | 86 | 2 | 85 | 5 | 92 | 0.7954 | 1.3987 | 1.6248 | 0.7914 | 1.2003 | 0.7821 |
| Iridium | Tungsten | None | 25 | 92 | 8 | 75 | 0 | 0 | 0.7668 | 1.346 | 1.346 | 0.7668 | | |
| Manganese | Ruthenium | None | 4 | 32 | 68 | 96 | 0 | 0 | 3.4976 | 0.795 | 0.795 | 3.4976 | | |
| Palladium | Ruthenium | None | 8 | 51 | 49 | 92 | 0 | 0 | 0.9398 | 0.7558 | 0.7558 | 0.9398 | | |
| Rhodium | Ruthenium | None | 45 | 93 | 7 | 55 | 0 | 0 | 0.7599 | 1.214 | 1.214 | 0.7599 | | |

TABLE 5
High EOL Activity

| | | | | | | | | | Upper | Upper | Upper | Upper | Upper | Upper |
|---|---|---|---|---|---|---|---|---|---|---|---|---|---|---|
| | | | | | | | | | Metal A | Metal A | Metal B | Metal B | Metal C | Metal C |
| | | | | | | | | | Relative | Relative | Relative | Relative | Relative | Relative |
| | | | Metal | Metal | Metal | Metal | Metal | Metal | EOL | EOL | EOL | EOL | EOL | EOL |
| | | | A | A | B | B | C | C | Activity | Activity | Activity | Activity | Activity | Activity |
| | | | Min | Max | Min | Max | Min | Max | @ | @ | @ | @ | @ | @ |
| Metal A | Metal B | Metal C | % | % | % | % | % | % | Min % | Max % | Min % | Max % | Min % | Max % |
| Iridium | Iron | None | 62 | 90 | 10 | 38 | 0 | 0 | 1.0268 | 1.1656 | 1.1656 | 1.0268 | | |
| Iridium | Iron | Ruthenium | 25 | 86 | 3 | 54 | 2 | 62 | 1.0208 | 1.5535 | 1.9450 | 1.0063 | 1.7934 | 1.0042 |
| Iridium | Manganese | None | 55 | 89 | 11 | 45 | 0 | 0 | 1.0208 | 1.0342 | 1.0342 | 1.0208 | | |
| Iridium | Manganese | Ruthenium | 43 | 79 | 2 | 46 | 4 | 27 | 1.0017 | 1.0111 | 1.0482 | 1.2647 | 1.4443 | 1.0720 |
| Iridium | Moly- | None | 66 | 96 | 4 | 34 | 0 | 0 | 1.0127 | 1.3223 | 1.3223 | 1.0127 | | |
| | bdenum | | | | | | | | | | | | | |
| Iridium | Moly- | Ruthenium | 6 | 91 | 3 | 79 | 2 | 71 | 1.1192 | 1.4226 | 1.0211 | 1.0057 | 1.4226 | 1.0015 |
| | bdenum | | | | | | | | | | | | | |
| Iridium | Palladium | Ruthenium | 2 | 6 | 12 | 33 | 64 | 85 | 1.3094 | 1.0181 | 1.0374 | 1.0083 | 1.0083 | 1.0977 |
| Iridium | Rhenium | None | 65 | 91 | 9 | 35 | 0 | 0 | 1.0184 | 1.0816 | 1.0816 | 1.0184 | | |
| Iridium | Rhenium | Ruthenium | 3 | 86 | 5 | 49 | 2 | 85 | 1.0689 | 1.9835 | 1.5307 | 1.0100 | 1.9053 | 1.4679 |
| Iridium | Rhenium | Tungsten | 52 | 86 | 2 | 26 | 2 | 39 | 1.0311 | 2.0892 | 2.0701 | 1.0456 | 1.5369 | 1.0161 |
| Iridium | Rhodium | None | 61 | 92 | 8 | 39 | 0 | 0 | 1.0108 | 1.4852 | 1.4852 | 1.0108 | | |
| Iridium | Rhodium | Ruthenium | 4 | 86 | 5 | 78 | 2 | 85 | 1.1604 | 1.9040 | 2.0754 | 1.0329 | 1.8598 | 1.4403 |
| Iridium | Ruthenium | Tungsten | 12 | 86 | 2 | 54 | 5 | 82 | 1.0033 | 1.3987 | 1.6248 | 1.0031 | 1.2003 | 1.0015 |
| Iridium | Tungsten | None | 32 | 92 | 8 | 68 | 0 | 0 | 1.0190 | 1.3460 | 1.3460 | 1.0190 | | |
| Manganese | Ruthenium | None | 4 | 28 | 72 | 96 | 0 | 0 | 3.4976 | 1.0648 | 1.0648 | 3.4976 | | |
| Palladium | Ruthenium | None | 10 | 42 | 58 | 90 | 0 | 0 | 1.0453 | 1.0179 | 1.0179 | 1.0453 | | |
| Rhodium | Ruthenium | None | 83 | 93 | 7 | 17 | 0 | 0 | 1.0086 | 1.2140 | 1.2140 | 1.0086 | | |

TABLE 6
Higher EOL Activity

| | | | | | | | | | Upper | Upper | Upper | Upper | Upper | Upper |
|---|---|---|---|---|---|---|---|---|---|---|---|---|---|---|
| | | | | | | | | | Metal A | Metal A | Metal B | Metal B | Metal C | Metal C |
| | | | | | | | | | Relative | Relative | Relative | Relative | Relative | Relative |
| | | | Metal | Metal | Metal | Metal | Metal | Metal | EOL | EOL | EOL | EOL | EOL | EOL |
| | | | A | A | B | B | C | C | Activity | Activity | Activity | Activity | Activity | Activity |
| | | | Min | Max | Min | Max | Min | Max | @ | @ | @ | @ | @ | @ |
| Metal A | Metal B | Metal C | % | % | % | % | % | % | Min % | Max % | Min % | Max % | Min % | Max % |
| Iridium | Iron | None | 68 | 89 | 11 | 32 | 0 | 0 | 1.2782 | 1.3056 | 1.3056 | 1.2782 | | |
| Iridium | Iron | Ruthenium | 37 | 86 | 3 | 40 | 2 | 43 | 1.2507 | 1.5535 | 1.9450 | 1.2510 | 1.7934 | 1.2543 |
| Iridium | Manganese | Ruthenium | 45 | 63 | 29 | 46 | 4 | 15 | 1.3250 | 1.3463 | 1.3707 | 1.2647 | 1.4443 | 1.2524 |
| Iridium | Moly- | None | 77 | 96 | 4 | 23 | 0 | 0 | 1.2592 | 1.3223 | 1.3223 | 1.2592 | | |
| | bdenum | | | | | | | | | | | | | |
| Iridium | Moly- | Ruthenium | 84 | 91 | 4 | 13 | 2 | 7 | 1.2532 | 1.4226 | 1.2985 | 1.2532 | 1.4226 | 1.2985 |
| | bdenum | | | | | | | | | | | | | |
| Iridium | Palladium | Ruthenium | 2 | 3 | 19 | 22 | 75 | 79 | 1.3094 | 1.2528 | 1.2742 | 1.2528 | 1.2528 | 1.2742 |
| Iridium | Rhenium | None | 71 | 90 | 10 | 29 | 0 | 0 | 1.2744 | 1.3105 | 1.3105 | 1.2744 | | |
| Iridium | Rhenium | Ruthenium | 6 | 86 | 5 | 42 | 2 | 85 | 1.4679 | 1.9835 | 1.5307 | 1.2624 | 1.9053 | 1.4679 |
| Iridium | Rhenium | Tungsten | 55 | 86 | 2 | 22 | 2 | 33 | 1.2614 | 2.0892 | 2.0701 | 1.2570 | 1.5369 | 1.2578 |
| Iridium | Rhodium | None | 69 | 92 | 8 | 31 | 0 | 0 | 1.2679 | 1.4852 | 1.4852 | 1.2679 | | |
| Iridium | Rhodium | Ruthenium | 5 | 86 | 5 | 72 | 2 | 85 | 1.4353 | 1.9040 | 2.0754 | 1.2820 | 1.8598 | 1.4403 |
| Iridium | Ruthenium | Tungsten | 22 | 86 | 2 | 48 | 6 | 70 | 1.2635 | 1.3987 | 1.6248 | 1.2505 | 1.2599 | 1.2564 |
| Iridium | Tungsten | None | 38 | 92 | 8 | 62 | 0 | 0 | 1.2856 | 1.3460 | 1.3460 | 1.2856 | | |
| Manganese | Ruthenium | None | 4 | 25 | 75 | 96 | 0 | 0 | 3.4976 | 1.2667 | 1.2667 | 3.4976 | | |
| Palladium | Ruthenium | None | 14 | 35 | 65 | 86 | 0 | 0 | 1.3408 | 1.2997 | 1.2997 | 1.3408 | | |

TABLE 7
Moderately High Stability

| | | | | | | | | | Upper | Upper | Upper | Upper | Upper | Upper |
|---|---|---|---|---|---|---|---|---|---|---|---|---|---|---|
| | | | | | | | | | Metal A | Metal A | Metal B | Metal B | Metal C | Metal C |
| | | | Metal | Metal | Metal | Metal | Metal | Metal | Relative | Relative | Relative | Relative | Relative | Relative |
| | | | A | A | B | B | C | C | Stability | Stability | Stability | Stability | Stability | Stability |
| | | | Min | Max | Min | Max | Min | Max | @ | @ | @ | @ | @ | @ |
| Metal A | Metal B | Metal C | % | % | % | % | % | % | Min % | Max % | Min % | Max % | Min % | Max % |
| Iridium | Iron | None | 7 | 90 | 10 | 93 | 0 | 0 | −1.7453 | 1.3092 | 1.3092 | −1.7453 | | |
| Iridium | Iron | Ruthenium | 6 | 10 | 86 | 89 | 4 | 5 | 1.1755 | 1.1363 | 1.1363 | 0.4756 | 0.4756 | 1.1755 |
| Iridium | Manganese | None | 54 | 84 | 16 | 46 | 0 | 0 | −0.0610 | 1.3152 | 1.3152 | −0.0610 | | |
| Iridium | Manganese | Ruthenium | 59 | 84 | 9 | 34 | 3 | 15 | 1.2905 | 1.3077 | 1.3205 | 1.1794 | 1.1866 | 1.3232 |
| Iridium | Moly- | None | 14 | 92 | 8 | 86 | 0 | 0 | −0.1906 | 1.3311 | 1.3311 | −0.1906 | | |
| | bdenum | | | | | | | | | | | | | |
| Iridium | Moly- | Ruthenium | 7 | 87 | 10 | 86 | 3 | 27 | 1.1063 | 1.3171 | 1.3171 | 1.1548 | 0.9256 | 1.3103 |
| | bdenum | | | | | | | | | | | | | |
| Iridium | Palladium | None | 7 | 92 | 8 | 93 | 0 | 0 | 0.5901 | 0.6081 | 0.6081 | 0.5901 | | |
| Iridium | Rhenium | None | 7 | 92 | 8 | 93 | 0 | 0 | −1.1900 | −1.2337 | −1.2337 | −1.1900 | | |
| Iridium | Rhenium | Ruthenium | 4 | 86 | 10 | 92 | 2 | 21 | 0.6725 | 0.9303 | 1.0891 | 0.6725 | 0.4337 | 1.2586 |
| Iridium | Rhenium | Tungsten | 2 | 86 | 2 | 83 | 7 | 61 | 0.8098 | −0.1822 | −0.3226 | 1.3038 | 1.3119 | 1.2519 |
| Iridium | Rhodium | None | 7 | 92 | 8 | 93 | 0 | 0 | −1.6458 | −1.1609 | −1.1609 | −1.6458 | | |
| Iridium | Rhodium | Ruthenium | 4 | 86 | 5 | 92 | 2 | 46 | 1.3081 | −0.3277 | −0.1340 | 1.3081 | −0.5218 | 1.1870 |
| Iridium | Ruthenium | Tungsten | 2 | 62 | 4 | 85 | 6 | 88 | 0.8273 | 1.2807 | 1.1737 | 0.3397 | 1.0576 | 1.3037 |
| Iridium | Tungsten | None | 92 | 92 | 8 | 8 | 0 | 0 | 1.1657 | 1.1657 | 1.1657 | 1.1657 | | |
| Molybdenum | Ruthenium | None | 53 | 86 | 14 | 47 | 0 | 0 | 1.3191 | 0.4579 | 0.4579 | 1.3191 | | |
| Palladium | Ruthenium | None | 18 | 72 | 28 | 82 | 0 | 0 | 1.3250 | 1.3097 | 1.3097 | 1.3250 | | |
| Rhenium | Ruthenium | Tungsten | 2 | 3 | 75 | 81 | 17 | 23 | 1.2360 | 1.2764 | 1.3291 | 1.3289 | 1.3289 | 1.3291 |

TABLE 8
High Stability

| | | | | | | | | | Upper | Upper | Upper | Upper | Upper | Upper |
|---|---|---|---|---|---|---|---|---|---|---|---|---|---|---|
| | | | | | | | | | Metal A | Metal A | Metal B | Metal B | Metal C | Metal C |
| | | | Metal | Metal | Metal | Metal | Metal | Metal | Relative | Relative | Relative | Relative | Relative | Relative |
| | | | A | A | B | B | C | C | Stability | Stability | Stability | Stability | Stability | Stability |
| | | | Min | Max | Min | Max | Min | Max | @ | @ | @ | @ | @ | @ |
| Metal A | Metal B | Metal C | % | % | % | % | % | % | Min % | Max % | Min % | Max % | Min % | Max % |
| Iridium | Iron | None | 7 | 86 | 14 | 93 | 0 | 0 | −1.7453 | 0.8960 | 0.8960 | −1.7453 | | |
| Iridium | Iron | Ruthenium | 7 | 9 | 87 | 89 | 4 | 4 | 0.4756 | 0.9542 | 0.9542 | 0.4756 | 0.4756 | 0.4756 |
| Iridium | Manganese | None | 54 | 74 | 26 | 46 | 0 | 0 | −0.0610 | 0.8885 | 0.8885 | −0.0610 | | |
| Iridium | Manganese | Ruthenium | 61 | 75 | 21 | 33 | 4 | 9 | 0.8756 | 0.9669 | 0.9669 | 0.9242 | 0.4329 | 0.6877 |
| Iridium | Moly- | None | 14 | 88 | 12 | 86 | 0 | 0 | −0.1906 | 0.9802 | 0.9802 | −0.1906 | | |
| | bdenum | | | | | | | | | | | | | |
| Iridium | Moly- | Ruthenium | 12 | 83 | 14 | 79 | 3 | 16 | 0.9838 | 0.9256 | 0.9256 | 0.9577 | 0.9256 | 0.9722 |
| | bdenum | | | | | | | | | | | | | |
| Iridium | Palladium | None | 7 | 92 | 8 | 93 | 0 | 0 | 0.5901 | 0.6081 | 0.6081 | 0.5901 | | |
| Iridium | Rhenium | None | 7 | 92 | 8 | 93 | 0 | 0 | −1.1900 | −1.2337 | −1.2337 | −1.1900 | | |
| Iridium | Rhenium | Ruthenium | 4 | 86 | 11 | 92 | 2 | 18 | 0.6725 | 0.9303 | 0.9303 | 0.6725 | 0.4337 | 0.9203 |
| Iridium | Rhenium | Tungsten | 2 | 86 | 2 | 79 | 9 | 59 | 0.8098 | −0.1822 | −0.3226 | 0.9398 | 0.6948 | 0.8162 |
| Iridium | Rhodium | None | 7 | 92 | 8 | 93 | 0 | 0 | −1.6458 | −1.1609 | −1.1609 | −1.6458 | | |
| Iridium | Rhodium | Ruthenium | 5 | 86 | 5 | 90 | 2 | 44 | 0.9023 | −0.3277 | −0.1340 | 0.8013 | −0.5218 | 0.9560 |
| Iridium | Ruthenium | Tungsten | 2 | 58 | 5 | 85 | 7 | 63 | 0.8273 | 0.9121 | 0.6119 | 0.3397 | 0.7042 | 0.9811 |
| Moly- | Ruthenium | None | 64 | 86 | 14 | 36 | 0 | 0 | 0.9819 | 0.4579 | 0.4579 | 0.9819 | | |
| bdenum | | | | | | | | | | | | | | |
| Palladium | Ruthenium | None | 27 | 34 | 66 | 73 | 0 | 0 | 0.9743 | 0.9870 | 0.9870 | 0.9743 | | |

TABLE 9
Higher Stability

| | | | | | | | | | Upper | Upper | Upper | Upper | Upper | Upper |
|---|---|---|---|---|---|---|---|---|---|---|---|---|---|---|
| | | | | | | | | | Metal A | Metal A | Metal B | Metal B | Metal C | Metal C |
| | | | Metal | Metal | Metal | Metal | Metal | Metal | Relative | Relative | Relative | Relative | Relative | Relative |
| | | | A | A | B | B | C | C | Stability | Stability | Stability | Stability | Stability | Stability |
| | | | Min | Max | Min | Max | Min | Max | @ | @ | @ | @ | @ | @ |
| Metal A | Metal B | Metal C | % | % | % | % | % | % | Min % | Max % | Min % | Max % | Min % | Max % |
| Iridium | Iron | None | 7 | 85 | 15 | 93 | 0 | 0 | −1.7453 | 0.7604 | 0.7604 | −1.7453 | | |
| Iridium | Iron | Ruthenium | 7 | 8 | 88 | 89 | 4 | 4 | 0.4756 | 0.7053 | 0.7053 | 0.4756 | 0.4756 | 0.4756 |
| Iridium | Manganese | None | 54 | 73 | 27 | 46 | 0 | 0 | −0.0610 | 0.7721 | 0.7721 | −0.0610 | | |
| Iridium | Manganese | Ruthenium | 62 | 74 | 22 | 32 | 4 | 9 | 0.6877 | 0.7637 | 0.7637 | 0.7091 | 0.4329 | 0.6877 |
| Iridium | Moly- | None | 14 | 86 | 14 | 86 | 0 | 0 | −0.1906 | 0.7818 | 0.7818 | −0.1906 | | |
| | bdenum | | | | | | | | | | | | | |
| Iridium | Moly- | Ruthenium | 17 | 80 | 16 | 75 | 4 | 11 | 0.7649 | 0.7547 | 0.7547 | 0.7649 | 0.3963 | 0.7789 |
| | bdenum | | | | | | | | | | | | | |
| Iridium | Palladium | None | 7 | 92 | 8 | 93 | 0 | 0 | 0.5901 | 0.6081 | 0.6081 | 0.5901 | | |
| Iridium | Rhenium | None | 7 | 92 | 8 | 93 | 0 | 0 | −1.1900 | −1.2337 | −1.2337 | −1.1900 | | |
| Iridium | Rhenium | Ruthenium | 4 | 85 | 13 | 92 | 2 | 16 | 0.6725 | 0.7283 | 0.7283 | 0.6725 | 0.4337 | 0.7369 |
| Iridium | Rhenium | Tungsten | 3 | 86 | 2 | 77 | 9 | 58 | 0.3860 | −0.1822 | −0.3226 | 0.7915 | 0.6948 | 0.6201 |
| Iridium | Rhodium | None | 7 | 92 | 8 | 93 | 0 | 0 | −1.6458 | −1.1609 | −1.1609 | −1.6458 | | |
| Iridium | Rhodium | Ruthenium | 6 | 86 | 5 | 78 | 2 | 43 | 0.7907 | −0.3277 | −0.1340 | 0.7997 | −0.5218 | 0.7491 |
| Iridium | Ruthenium | Tungsten | 3 | 56 | 5 | 85 | 7 | 61 | 0.7645 | 0.7725 | 0.6119 | 0.3397 | 0.7042 | 0.7132 |
| Moly- | Ruthenium | None | 73 | 86 | 14 | 27 | 0 | 0 | 0.7846 | 0.4579 | 0.4579 | 0.7846 | | |
| bdenum | | | | | | | | | | | | | | |
| Iridium | Iron | None | 7 | 85 | 15 | 93 | 0 | 0 | −1.7453 | 0.7604 | 0.7604 | −1.7453 | | |

TABLE 10
Moderately High Overall Performance

| | | | | | | | | | Upper | Upper | Upper | Upper | Upper | Upper |
|---|---|---|---|---|---|---|---|---|---|---|---|---|---|---|
| | | | | | | | | | Metal A | Metal A | Metal B | Metal B | Metal C | Metal C |
| | | | | | | | | | Relative | Relative | Relative | Relative | Relative | Relative |
| | | | Metal | Metal | Metal | Metal | Metal | Metal | BOL | BOL | BOL | BOL | BOL | BOL |
| | | | A | A | B | B | C | C | Activity | Activity | Activity | Activity | Activity | Activity |
| | | | Min | Max | Min | Max | Min | Max | @ | @ | @ | @ | @ | @ |
| Metal A | Metal B | Metal C | % | % | % | % | % | % | Min % | Max % | Min % | Max % | Min % | Max % |
| Iridium | Iron | None | 64 | 82 | 18 | 36 | 0 | 0 | 0.7718 | 1.4621 | 1.4621 | 0.7718 | | |
| Iridium | Manganese | None | 54 | 80 | 20 | 46 | 0 | 0 | 0.7991 | 1.0949 | 1.0949 | 0.7991 | | |
| Iridium | Manganese | Ruthenium | 60 | 84 | 10 | 34 | 4 | 14 | 1.6739 | 0.8931 | 1.0261 | 1.5582 | 1.5582 | 1.0443 |
| Iridium | Moly- | None | 52 | 86 | 14 | 48 | 0 | 0 | 0.7815 | 1.4341 | 1.4341 | 0.7815 | | |
| | bdenum | | | | | | | | | | | | | |
| Iridium | Moly- | Ruthenium | 6 | 84 | 12 | 86 | 4 | 26 | 0.9727 | 1.3006 | 1.3006 | 0.8868 | 1.3006 | 1.0745 |
| | bdenum | | | | | | | | | | | | | |
| Iridium | Palladium | None | 68 | 92 | 8 | 32 | 0 | 0 | 0.7590 | 0.8213 | 0.8213 | 0.7590 | | |
| Iridium | Rhenium | None | 70 | 90 | 10 | 30 | 0 | 0 | 0.7738 | 0.9063 | 0.9063 | 0.7738 | | |
| Iridium | Rhenium | Ruthenium | 58 | 86 | 10 | 38 | 2 | 12 | 1.1605 | 2.0660 | 2.0660 | 1.1605 | 1.7953 | 2.0432 |
| Iridium | Rhenium | Tungsten | 52 | 86 | 2 | 10 | 8 | 40 | 0.8489 | 2.0517 | 1.8709 | 0.8489 | 2.1302 | 0.9797 |
| Iridium | Rhodium | None | 58 | 92 | 8 | 42 | 0 | 0 | 0.7661 | 1.0723 | 1.0723 | 0.7661 | | |
| Iridium | Rhodium | Ruthenium | 4 | 86 | 4 | 84 | 2 | 46 | 1.4854 | 1.6477 | 1.7151 | 0.7936 | 1.4621 | 2.5072 |
| Iridium | Ruthenium | Tungsten | 4 | 62 | 4 | 82 | 6 | 88 | 0.8961 | 1.3454 | 1.5688 | 0.7648 | 0.8655 | 0.9298 |
| Iridium | Tungsten | None | 92 | 92 | 8 | 8 | 0 | 0 | 1.4190 | 1.4190 | 1.4190 | 1.4190 | | |
| Palladium | Ruthenium | None | 18 | 50 | 50 | 82 | 0 | 0 | 1.8884 | 0.8267 | 0.8267 | 1.8884 | | |

TABLE 11
High Overall Performance

| | | | | | | | | | Upper | Upper | Upper | Upper | Upper | Upper |
|---|---|---|---|---|---|---|---|---|---|---|---|---|---|---|
| | | | | | | | | | Metal A | Metal A | Metal B | Metal B | Metal C | Metal C |
| | | | | | | | | | Relative | Relative | Relative | Relative | Relative | Relative |
| | | | Metal | Metal | Metal | Metal | Metal | Metal | BOL | BOL | BOL | BOL | BOL | BOL |
| | | | A | A | B | B | C | C | Activity | Activity | Activity | Activity | Activity | Activity |
| | | | Min | Max | Min | Max | Min | Max | @ | @ | @ | @ | @ | @ |
| Metal A | Metal B | Metal C | % | % | % | % | % | % | Min % | Max % | Min % | Max % | Min % | Max % |
| Iridium | Iron | None | 72 | 80 | 20 | 28 | 0 | 0 | 1.0305 | 1.4055 | 1.4055 | 1.0305 | | |
| Iridium | Manganese | Ruthenium | 62 | 64 | 28 | 32 | 4 | 8 | 1.4430 | 1.2705 | 1.0976 | 1.4430 | 1.2705 | 1.3504 |
| Iridium | Moly- | None | 68 | 82 | 18 | 32 | 0 | 0 | 1.0464 | 1.2822 | 1.2822 | 1.0464 | | |
| | bdenum | | | | | | | | | | | | | |
| Iridium | Moly- | Ruthenium | 12 | 80 | 16 | 76 | 4 | 16 | 1.0093 | 1.0013 | 1.0013 | 1.0093 | 1.0013 | 1.0301 |
| | bdenum | | | | | | | | | | | | | |
| Iridium | Rhenium | None | 80 | 86 | 14 | 20 | 0 | 0 | 1.0162 | 1.0505 | 1.0505 | 1.0162 | | |
| Iridium | Rhenium | Ruthenium | 62 | 86 | 12 | 34 | 2 | 8 | 1.2214 | 1.7808 | 1.7808 | 1.2214 | 1.7953 | 1.9410 |
| Iridium | Rhenium | Tungsten | 60 | 86 | 2 | 6 | 8 | 34 | 1.0623 | 2.0517 | 1.8709 | 2.0517 | 2.0517 | 1.0623 |
| Iridium | Rhodium | None | 76 | 92 | 8 | 24 | 0 | 0 | 1.0005 | 1.0723 | 1.0723 | 1.0005 | | |
| Iridium | Rhodium | Ruthenium | 4 | 86 | 4 | 76 | 2 | 44 | 1.4745 | 1.6477 | 1.7151 | 1.1065 | 1.4621 | 2.3374 |
| Iridium | Ruthenium | Tungsten | 32 | 60 | 4 | 36 | 8 | 62 | 1.4202 | 1.2465 | 1.4798 | 1.2417 | 1.2465 | 1.3386 |
| Palladium | Ruthenium | None | 28 | 34 | 66 | 72 | 0 | 0 | 1.7586 | 1.3511 | 1.3511 | 1.7586 | | |

TABLE 12
Higher Overall Performance

| | | | | | | | | | Upper | Upper | Upper | Upper | Upper | Upper |
|---|---|---|---|---|---|---|---|---|---|---|---|---|---|---|
| | | | | | | | | | Metal A | Metal A | Metal B | Metal B | Metal C | Metal C |
| | | | | | | | | | Relative | Relative | Relative | Relative | Relative | Relative |
| | | | Metal | Metal | Metal | Metal | Metal | Metal | BOL | BOL | BOL | BOL | BOL | BOL |
| | | | A | A | B | B | C | C | Activity | Activity | Activity | Activity | Activity | Activity |
| | | | Min | Max | Min | Max | Min | Max | @ | @ | @ | @ | @ | @ |
| Metal A | Metal B | Metal C | % | % | % | % | % | % | Min % | Max % | Min % | Max % | Min % | Max % |
| Iridium | Iron | None | 78 | 78 | 22 | 22 | 0 | 0 | 1.3217 | 1.3217 | 1.3217 | 1.3217 | | |
| Iridium | Manganese | Ruthenium | 62 | 64 | 30 | 32 | 4 | 8 | 1.3504 | 1.2705 | 1.3504 | 1.2705 | 1.2705 | 1.3504 |
| Iridium | Rhenium | Ruthenium | 66 | 86 | 12 | 30 | 2 | 6 | 1.4865 | 1.7808 | 1.7808 | 1.2620 | 1.7953 | 1.8970 |
| Iridium | Rhenium | Tungsten | 80 | 86 | 2 | 6 | 8 | 18 | 1.9556 | 2.0517 | 1.8709 | 2.0517 | 2.0517 | 1.8709 |
| Iridium | Rhodium | Ruthenium | 12 | 86 | 4 | 68 | 2 | 40 | 1.3555 | 1.6477 | 1.7151 | 1.2608 | 1.4621 | 2.1723 |
| Iridium | Ruthenium | Tungsten | 32 | 56 | 4 | 32 | 24 | 60 | 1.3882 | 1.4337 | 1.4614 | 1.4031 | 1.3291 | 1.3495 |

TABLE 13
Outstanding Overall Performance

| | | | | | | | | | Upper | Upper | Upper | Upper | Upper | Upper |
|---|---|---|---|---|---|---|---|---|---|---|---|---|---|---|
| | | | | | | | | | Metal A | Metal A | Metal B | Metal B | Metal C | Metal C |
| | | | | | | | | | Relative | Relative | Relative | Relative | Relative | Relative |
| | | | Metal | Metal | Metal | Metal | Metal | Metal | BOL | BOL | BOL | BOL | BOL | BOL |
| | | | A | A | B | B | C | C | Activity | Activity | Activity | Activity | Activity | Activity |
| | | | Min | Max | Min | Max | Min | Max | @ | @ | @ | @ | @ | @ |
| Metal A | Metal B | Metal C | % | % | % | % | % | % | Min % | Max % | Min % | Max % | Min % | Max % |
| Iridium | Rhenium | Ruthenium | 68 | 82 | 16 | 26 | 2 | 6 | 1.5449 | 1.7458 | 1.7458 | 1.5449 | 1.7458 | 1.6410 |
| Iridium | Rhenium | Tungsten | 80 | 86 | 2 | 6 | 10 | 16 | 1.9556 | 1.8681 | 1.7816 | 2.0481 | 2.0481 | 1.9218 |
| Iridium | Rhodium | Ruthenium | 22 | 86 | 4 | 56 | 4 | 40 | 1.6230 | 1.6477 | 1.7151 | 1.5574 | 1.5474 | 2.1723 |

TABLE 14
Moderately High Overall Performance Data

| | | | Metal A | Metal B | Metal C | Relative | Relative | Relative |
|---|---|---|---|---|---|---|---|---|
| Metal A | Metal B | Metal C | Composition | Composition | Composition | BOL | EOL | Stability |
| Iridium | Rhodium | Ruthenium | 40 | 18 | 42 | 2.5910 | 2.4382 | 1.3095 |
| Iridium | Rhodium | Ruthenium | 40 | 16 | 44 | 2.5720 | 2.4178 | 1.2958 |
| Iridium | Rhodium | Ruthenium | 40 | 20 | 40 | 2.5421 | 2.4159 | 1.2396 |
| Iridium | Rhodium | Ruthenium | 40 | 14 | 46 | 2.5072 | 2.3502 | 1.3286 |
| Iridium | Rhodium | Ruthenium | 38 | 24 | 38 | 2.4656 | 2.3110 | 1.3291 |
| Iridium | Rhodium | Ruthenium | 40 | 22 | 38 | 2.4288 | 2.3428 | 1.1859 |
| Iridium | Rhodium | Ruthenium | 42 | 12 | 46 | 2.3967 | 2.3113 | 1.1870 |
| Iridium | Rhodium | Ruthenium | 42 | 16 | 42 | 2.3706 | 2.3860 | 0.9596 |
| Iridium | Rhodium | Ruthenium | 42 | 18 | 40 | 2.3476 | 2.3756 | 0.9305 |
| Iridium | Rhodium | Ruthenium | 42 | 14 | 44 | 2.3374 | 2.3558 | 0.9529 |
| Iridium | Rhodium | Ruthenium | 30 | 30 | 40 | 2.2959 | 2.1709 | 1.2846 |
| Iridium | Rhodium | Ruthenium | 34 | 28 | 38 | 2.2882 | 2.1831 | 1.2400 |
| Iridium | Rhodium | Ruthenium | 42 | 20 | 38 | 2.2864 | 2.3346 | 0.8855 |
| Iridium | Rhodium | Ruthenium | 26 | 32 | 42 | 2.2765 | 2.1323 | 1.3323 |
| Iridium | Rhenium | Ruthenium | 82 | 12 | 6 | 2.2668 | 2.1410 | 1.2909 |
| Iridium | Rhenium | Ruthenium | 76 | 16 | 8 | 2.2320 | 2.1470 | 1.1979 |
| Iridium | Rhenium | Ruthenium | 80 | 14 | 6 | 2.2294 | 2.1701 | 1.1395 |
| Iridium | Rhodium | Ruthenium | 24 | 34 | 42 | 2.2213 | 2.0854 | 1.3209 |
| Iridium | Rhodium | Ruthenium | 18 | 40 | 42 | 2.2164 | 2.0778 | 1.3281 |
| Iridium | Rhodium | Ruthenium | 40 | 24 | 36 | 2.2161 | 2.2239 | 0.9712 |
| Iridium | Rhodium | Ruthenium | 16 | 42 | 42 | 2.1989 | 2.0721 | 1.3026 |
| Iridium | Rhodium | Ruthenium | 28 | 32 | 40 | 2.1966 | 2.1100 | 1.2059 |
| Iridium | Rhodium | Ruthenium | 38 | 26 | 36 | 2.1870 | 2.1715 | 1.0317 |
| Iridium | Rhodium | Ruthenium | 42 | 22 | 36 | 2.1822 | 2.2595 | 0.8075 |
| Iridium | Rhenium | Tungsten | 78 | 8 | 14 | 2.1738 | 2.0993 | 1.1675 |
| Iridium | Rhodium | Ruthenium | 44 | 16 | 40 | 2.1723 | 2.3422 | 0.5661 |
| Iridium | Rhodium | Ruthenium | 32 | 30 | 38 | 2.1631 | 2.1143 | 1.1185 |
| Iridium | Rhenium | Ruthenium | 72 | 18 | 10 | 2.1487 | 2.0496 | 1.2420 |
| Iridium | Rhodium | Ruthenium | 26 | 34 | 40 | 2.1483 | 2.0685 | 1.1937 |
| Iridium | Rhenium | Tungsten | 80 | 8 | 12 | 2.1413 | 2.1060 | 1.0761 |
| Iridium | Rhodium | Ruthenium | 24 | 36 | 40 | 2.1353 | 2.0397 | 1.2336 |
| Iridium | Rhenium | Ruthenium | 78 | 16 | 6 | 2.1324 | 2.1353 | 0.9917 |
| Iridium | Rhodium | Ruthenium | 22 | 38 | 40 | 2.1319 | 2.0170 | 1.2824 |
| Iridium | Rhodium | Ruthenium | 14 | 44 | 42 | 2.1306 | 2.0247 | 1.2605 |
| Iridium | Rhenium | Tungsten | 82 | 8 | 10 | 2.1302 | 2.1032 | 1.0630 |
| Iridium | Rhenium | Tungsten | 84 | 8 | 8 | 2.1302 | 2.0160 | 1.2801 |
| Iridium | Rhodium | Ruthenium | 44 | 18 | 38 | 2.1283 | 2.3164 | 0.5361 |
| Iridium | Rhodium | Ruthenium | 20 | 40 | 40 | 2.1207 | 2.0083 | 1.2779 |
| Iridium | Rhodium | Ruthenium | 18 | 42 | 40 | 2.1041 | 2.0015 | 1.2556 |
| Iridium | Rhenium | Tungsten | 76 | 6 | 18 | 2.0957 | 2.0218 | 1.1849 |
| Iridium | Rhodium | Ruthenium | 36 | 28 | 36 | 2.0932 | 2.1060 | 0.9643 |
| Iridium | Rhodium | Ruthenium | 44 | 20 | 36 | 2.0889 | 2.2728 | 0.5209 |
| Iridium | Rhenium | Ruthenium | 74 | 18 | 8 | 2.0797 | 2.0639 | 1.0385 |
| Iridium | Rhodium | Ruthenium | 30 | 32 | 38 | 2.0796 | 2.0638 | 1.0394 |
| Iridium | Rhodium | Ruthenium | 16 | 44 | 40 | 2.0668 | 1.9846 | 1.2087 |
| Iridium | Rhenium | Ruthenium | 86 | 10 | 4 | 2.0660 | 2.0054 | 1.1523 |
| Palladium | Ruthenium | None | 22 | 78 | 0 | 2.0631 | 2.0025 | 1.1542 |
| Iridium | Rhenium | Tungsten | 86 | 6 | 8 | 2.0517 | 2.1710 | 0.6948 |
| Iridium | Rhenium | Tungsten | 84 | 6 | 10 | 2.0481 | 2.1946 | 0.6247 |
| Iridium | Rhenium | Tungsten | 78 | 6 | 16 | 2.0456 | 2.0979 | 0.8639 |
| Iridium | Rhodium | Ruthenium | 24 | 38 | 38 | 2.0451 | 1.9743 | 1.1816 |
| Iridium | Rhenium | Ruthenium | 68 | 20 | 12 | 2.0432 | 1.9279 | 1.2962 |
| Iridium | Rhodium | Ruthenium | 26 | 36 | 38 | 2.0394 | 2.0016 | 1.0973 |
| Iridium | Rhodium | Ruthenium | 28 | 34 | 38 | 2.0391 | 2.0283 | 1.0279 |
| Iridium | Rhodium | Ruthenium | 22 | 40 | 38 | 2.0369 | 1.9491 | 1.2263 |
| Iridium | Rhodium | Ruthenium | 20 | 42 | 38 | 2.0200 | 1.9326 | 1.2271 |
| Palladium | Ruthenium | None | 20 | 80 | 0 | 2.0179 | 1.9270 | 1.2370 |
| Iridium | Rhodium | Ruthenium | 14 | 46 | 40 | 2.0145 | 1.9560 | 1.1524 |
| Palladium | Ruthenium | None | 24 | 76 | 0 | 2.0136 | 1.9848 | 1.0746 |
| Iridium | Rhenium | Ruthenium | 76 | 18 | 6 | 2.0123 | 2.0624 | 0.8695 |
| Iridium | Rhenium | Ruthenium | 84 | 12 | 4 | 2.0099 | 1.9969 | 1.0294 |
| Iridium | Rhodium | Ruthenium | 34 | 30 | 36 | 2.0043 | 2.0464 | 0.8863 |
| Iridium | Rhenium | Ruthenium | 82 | 14 | 4 | 2.0035 | 2.0284 | 0.9316 |
| Iridium | Rhodium | Ruthenium | 12 | 46 | 42 | 2.0034 | 1.9237 | 1.2087 |
| Iridium | Rhodium | Ruthenium | 18 | 44 | 38 | 1.9982 | 1.9286 | 1.1826 |
| Iridium | Rhenium | Tungsten | 78 | 4 | 18 | 1.9976 | 1.9854 | 1.0281 |
| Iridium | Rhodium | Ruthenium | 42 | 24 | 34 | 1.9967 | 2.1482 | 0.6018 |
| Iridium | Rhodium | Ruthenium | 46 | 14 | 40 | 1.9965 | 2.3121 | 0.1666 |
| Iridium | Rhenium | Ruthenium | 70 | 20 | 10 | 1.9961 | 1.9468 | 1.1288 |
| Iridium | Rhodium | Ruthenium | 46 | 16 | 38 | 1.9956 | 2.3008 | 0.1938 |
| Iridium | Rhenium | Tungsten | 82 | 6 | 12 | 1.9781 | 2.1481 | 0.5480 |
| Iridium | Rhodium | Ruthenium | 40 | 26 | 34 | 1.9754 | 2.0937 | 0.6859 |
| Iridium | Rhodium | Ruthenium | 44 | 22 | 34 | 1.9750 | 2.1906 | 0.4269 |
| Iridium | Rhodium | Ruthenium | 46 | 18 | 36 | 1.9743 | 2.2761 | 0.1944 |
| Iridium | Rhodium | Ruthenium | 16 | 46 | 38 | 1.9719 | 1.9262 | 1.1217 |
| Iridium | Rhenium | Tungsten | 80 | 6 | 14 | 1.9556 | 2.1173 | 0.5661 |
| Iridium | Rhodium | Ruthenium | 24 | 40 | 36 | 1.9510 | 1.9142 | 1.0973 |
| Iridium | Rhodium | Ruthenium | 22 | 42 | 36 | 1.9507 | 1.8920 | 1.1574 |
| Iridium | Rhodium | Ruthenium | 26 | 38 | 36 | 1.9450 | 1.9400 | 1.0118 |
| Iridium | Rhenium | Ruthenium | 72 | 20 | 8 | 1.9410 | 1.9659 | 0.9320 |
| Iridium | Rhodium | Ruthenium | 32 | 32 | 36 | 1.9406 | 2.0045 | 0.8246 |
| Iridium | Rhodium | Ruthenium | 20 | 44 | 36 | 1.9325 | 1.8804 | 1.1414 |
| Iridium | Rhodium | Ruthenium | 28 | 36 | 36 | 1.9241 | 1.9596 | 0.8987 |
| Iridium | Rhenium | Tungsten | 80 | 4 | 16 | 1.9218 | 2.0562 | 0.6148 |
| Iridium | Rhenium | Ruthenium | 66 | 22 | 12 | 1.9209 | 1.8232 | 1.2661 |
| Iridium | Rhodium | Ruthenium | 14 | 48 | 38 | 1.9202 | 1.8959 | 1.0660 |
| Iridium | Rhodium | Ruthenium | 46 | 20 | 34 | 1.9190 | 2.2184 | 0.1799 |
| Iridium | Rhodium | Ruthenium | 30 | 34 | 36 | 1.9146 | 1.9791 | 0.8206 |
| Iridium | Rhodium | Ruthenium | 38 | 28 | 34 | 1.9126 | 2.0322 | 0.6716 |
| Iridium | Rhodium | Ruthenium | 48 | 12 | 40 | 1.9120 | 2.3067 | −0.0841 |
| Iridium | Rhodium | Ruthenium | 18 | 46 | 36 | 1.9111 | 1.8707 | 1.1107 |
| Iridium | Rhenium | Ruthenium | 80 | 16 | 4 | 1.9109 | 1.9891 | 0.7832 |
| Palladium | Ruthenium | None | 26 | 74 | 0 | 1.9078 | 1.9067 | 1.0028 |
| Iridium | Rhodium | Ruthenium | 48 | 16 | 36 | 1.9030 | 2.2823 | −0.0524 |
| Iridium | Rhenium | Ruthenium | 74 | 20 | 6 | 1.8970 | 1.9815 | 0.7652 |
| Iridium | Rhodium | Ruthenium | 48 | 14 | 38 | 1.8935 | 2.2982 | −0.1219 |
| Palladium | Ruthenium | None | 18 | 82 | 0 | 1.8884 | 1.7715 | 1.3250 |
| Iridium | Rhodium | Ruthenium | 24 | 42 | 34 | 1.8835 | 1.8717 | 1.0328 |
| Iridium | Rhodium | Ruthenium | 16 | 48 | 36 | 1.8797 | 1.8600 | 1.0550 |
| Iridium | Rhodium | Ruthenium | 12 | 48 | 40 | 1.8796 | 1.8417 | 1.1057 |
| Iridium | Rhodium | Ruthenium | 22 | 44 | 34 | 1.8770 | 1.8519 | 1.0703 |
| Iridium | Rhodium | Ruthenium | 10 | 46 | 44 | 1.8750 | 1.7719 | 1.2897 |
| Iridium | Rhenium | Tungsten | 80 | 2 | 18 | 1.8709 | 1.9668 | 0.7309 |
| Iridium | Rhenium | Ruthenium | 68 | 22 | 10 | 1.8699 | 1.8418 | 1.0788 |
| Iridium | Rhenium | Tungsten | 86 | 4 | 10 | 1.8681 | 2.1080 | 0.3199 |
| Iridium | Rhodium | Ruthenium | 48 | 18 | 34 | 1.8665 | 2.2467 | −0.0691 |
| Iridium | Rhodium | Ruthenium | 26 | 40 | 34 | 1.8637 | 1.8859 | 0.9373 |
| Iridium | Rhodium | Ruthenium | 20 | 46 | 34 | 1.8596 | 1.8354 | 1.0682 |
| Iridium | Rhodium | Ruthenium | 50 | 12 | 38 | 1.8562 | 2.3026 | −0.2620 |
| Iridium | Rhodium | Ruthenium | 36 | 30 | 34 | 1.8462 | 1.9769 | 0.6285 |
| Iridium | Rhodium | Ruthenium | 14 | 50 | 36 | 1.8430 | 1.8405 | 1.0069 |
| Iridium | Rhodium | Ruthenium | 50 | 14 | 36 | 1.8403 | 2.2855 | −0.2703 |
| Iridium | Rhodium | Ruthenium | 44 | 24 | 32 | 1.8368 | 2.0876 | 0.2778 |
| Iridium | Rhodium | Ruthenium | 12 | 50 | 38 | 1.8367 | 1.8286 | 1.0231 |
| Iridium | Rhodium | Ruthenium | 18 | 48 | 34 | 1.8359 | 1.8219 | 1.0399 |
| Iridium | Rhodium | Ruthenium | 28 | 38 | 34 | 1.8352 | 1.9031 | 0.8057 |
| Iridium | Rhodium | Ruthenium | 46 | 22 | 32 | 1.8345 | 2.1376 | 0.1302 |
| Iridium | Rhenium | Tungsten | 82 | 4 | 14 | 1.8335 | 2.0740 | 0.3055 |
| Iridium | Rhodium | Ruthenium | 50 | 16 | 34 | 1.8284 | 2.2613 | −0.2430 |
| Iridium | Rhodium | Ruthenium | 22 | 46 | 32 | 1.8176 | 1.8247 | 0.9790 |
| Iridium | Rhodium | Ruthenium | 48 | 20 | 32 | 1.8174 | 2.1751 | −0.0372 |
| Iridium | Rhodium | Ruthenium | 52 | 12 | 36 | 1.8155 | 2.2853 | −0.3589 |
| Iridium | Rhodium | Ruthenium | 24 | 44 | 32 | 1.8145 | 1.8377 | 0.9314 |
| Iridium | Rhenium | Ruthenium | 78 | 18 | 4 | 1.8138 | 1.9309 | 0.6585 |
| Iridium | Rhodium | Ruthenium | 16 | 50 | 34 | 1.8122 | 1.8128 | 0.9981 |
| Iridium | Rhodium | Ruthenium | 10 | 48 | 42 | 1.8106 | 1.7548 | 1.1609 |
| Iridium | Rhodium | Ruthenium | 42 | 26 | 32 | 1.8086 | 2.0259 | 0.3657 |
| Iridium | Rhodium | Ruthenium | 30 | 36 | 34 | 1.8049 | 1.9156 | 0.6777 |
| Iridium | Rhodium | Ruthenium | 34 | 32 | 34 | 1.8027 | 1.9433 | 0.5905 |
| Iridium | Rhenium | Ruthenium | 70 | 22 | 8 | 1.8015 | 1.8550 | 0.8426 |
| Iridium | Rhodium | Ruthenium | 26 | 42 | 32 | 1.8005 | 1.8485 | 0.8585 |
| Iridium | Rhodium | Ruthenium | 52 | 14 | 34 | 1.8000 | 2.2656 | −0.3575 |
| Iridium | Rhodium | Ruthenium | 20 | 48 | 32 | 1.7999 | 1.8081 | 0.9760 |
| Iridium | Rhenium | Ruthenium | 84 | 14 | 2 | 1.7953 | 1.9024 | 0.6869 |
| Iridium | Rhodium | Ruthenium | 50 | 18 | 32 | 1.7939 | 2.2106 | −0.2198 |
| Iridium | Rhenium | Tungsten | 84 | 4 | 12 | 1.7895 | 2.0695 | 0.1635 |
| Iridium | Rhodium | Ruthenium | 32 | 34 | 34 | 1.7870 | 1.9250 | 0.5945 |
| Iridium | Rhenium | Ruthenium | 66 | 24 | 10 | 1.7838 | 1.7394 | 1.1314 |
| Iridium | Rhodium | Ruthenium | 14 | 52 | 34 | 1.7821 | 1.7923 | 0.9698 |
| Iridium | Rhenium | Tungsten | 82 | 2 | 16 | 1.7816 | 2.0486 | 0.2092 |
| Iridium | Rhenium | Ruthenium | 86 | 12 | 2 | 1.7808 | 1.8730 | 0.7283 |
| Iridium | Rhodium | Ruthenium | 52 | 16 | 32 | 1.7804 | 2.2278 | −0.3200 |
| Iridium | Rhodium | Ruthenium | 54 | 12 | 34 | 1.7794 | 2.2605 | −0.4189 |
| Iridium | Rhodium | Ruthenium | 54 | 10 | 36 | 1.7786 | 2.2651 | −0.4354 |
| Iridium | Rhodium | Ruthenium | 18 | 50 | 32 | 1.7778 | 1.7861 | 0.9753 |
| Iridium | Rhodium | Ruthenium | 24 | 46 | 30 | 1.7725 | 1.8194 | 0.8609 |
| Iridium | Rhodium | Ruthenium | 22 | 48 | 30 | 1.7689 | 1.8071 | 0.8866 |
| Iridium | Rhenium | Ruthenium | 72 | 22 | 6 | 1.7664 | 1.8771 | 0.6713 |
| Palladium | Ruthenium | None | 28 | 72 | 0 | 1.7586 | 1.7738 | 0.9543 |
| Iridium | Rhodium | Ruthenium | 54 | 14 | 32 | 1.7584 | 2.2281 | −0.4019 |
| Iridium | Rhodium | Ruthenium | 28 | 40 | 32 | 1.7583 | 1.8467 | 0.7309 |
| Iridium | Rhodium | Ruthenium | 40 | 28 | 32 | 1.7566 | 1.9613 | 0.3851 |
| Iridium | Rhodium | Ruthenium | 12 | 52 | 36 | 1.7561 | 1.7614 | 0.9840 |
| Iridium | Rhodium | Ruthenium | 20 | 50 | 30 | 1.7545 | 1.7847 | 0.9097 |
| Iridium | Rhodium | Ruthenium | 56 | 10 | 34 | 1.7535 | 2.2415 | −0.4607 |
| Iridium | Rhodium | Ruthenium | 16 | 52 | 32 | 1.7527 | 1.7679 | 0.9545 |
| Iridium | Rhodium | Ruthenium | 26 | 44 | 30 | 1.7481 | 1.8202 | 0.7832 |
| Iridium | Rhodium | Ruthenium | 10 | 50 | 40 | 1.7464 | 1.7246 | 1.0659 |
| Iridium | Rhenium | Ruthenium | 82 | 16 | 2 | 1.7458 | 1.8842 | 0.5827 |
| Iridium | Rhodium | Ruthenium | 56 | 12 | 32 | 1.7397 | 2.2175 | −0.4416 |
| Iridium | Rhodium | Ruthenium | 12 | 54 | 34 | 1.7364 | 1.7510 | 0.9559 |
| Iridium | Rhodium | Ruthenium | 52 | 18 | 30 | 1.7308 | 2.1635 | −0.3124 |
| Iridium | Rhodium | Ruthenium | 22 | 50 | 28 | 1.7302 | 1.8024 | 0.7805 |
| Iridium | Rhodium | Ruthenium | 54 | 16 | 30 | 1.7300 | 2.1857 | −0.3826 |
| Iridium | Rhenium | Ruthenium | 64 | 26 | 10 | 1.7276 | 1.6451 | 1.2507 |
| Iridium | Rhodium | Ruthenium | 14 | 54 | 32 | 1.7268 | 1.7457 | 0.9426 |
| Iridium | Rhodium | Ruthenium | 50 | 20 | 30 | 1.7266 | 2.1213 | −0.1997 |
| Iridium | Rhodium | Ruthenium | 48 | 22 | 30 | 1.7251 | 2.0774 | −0.0717 |
| Iridium | Rhodium | Ruthenium | 18 | 52 | 30 | 1.7234 | 1.7473 | 0.9272 |
| Iridium | Rhodium | Ruthenium | 24 | 48 | 28 | 1.7216 | 1.8006 | 0.7580 |
| Iridium | Rhodium | Ruthenium | 30 | 38 | 32 | 1.7188 | 1.8545 | 0.5830 |
| Iridium | Rhodium | Ruthenium | 56 | 14 | 30 | 1.7166 | 2.1836 | −0.4278 |
| Iridium | Rhenium | Ruthenium | 76 | 20 | 4 | 1.7161 | 1.8641 | 0.5451 |
| Iridium | Rhodium | Ruthenium | 80 | 4 | 16 | 1.7151 | 2.0390 | 0.0086 |
| Iridium | Rhodium | Ruthenium | 76 | 4 | 20 | 1.7131 | 2.0601 | −0.0632 |
| Iridium | Rhodium | Ruthenium | 58 | 10 | 32 | 1.7121 | 2.1959 | −0.4831 |
| Iridium | Rhodium | Ruthenium | 78 | 4 | 18 | 1.7113 | 2.0405 | −0.0096 |
| Iridium | Rhodium | Ruthenium | 78 | 6 | 16 | 1.7109 | 2.0476 | −0.0327 |
| Iridium | Rhodium | Ruthenium | 46 | 24 | 30 | 1.7084 | 2.0217 | 0.0379 |
| Iridium | Rhodium | Ruthenium | 76 | 6 | 18 | 1.7082 | 2.0535 | −0.0608 |
| Iridium | Rhodium | Ruthenium | 74 | 4 | 22 | 1.7081 | 2.0657 | −0.0987 |
| Iridium | Rhodium | Ruthenium | 28 | 42 | 30 | 1.7074 | 1.8119 | 0.6788 |
| Iridium | Rhodium | Ruthenium | 74 | 6 | 20 | 1.7062 | 2.0646 | −0.1023 |
| Iridium | Rhodium | Ruthenium | 10 | 52 | 38 | 1.7061 | 1.7045 | 1.0050 |
| Iridium | Rhodium | Ruthenium | 80 | 6 | 14 | 1.7058 | 2.0326 | −0.0052 |
| Iridium | Rhodium | Ruthenium | 20 | 52 | 28 | 1.7054 | 1.7627 | 0.8238 |
| Iridium | Rhodium | Ruthenium | 38 | 30 | 32 | 1.7045 | 1.9060 | 0.3767 |
| Iridium | Rhodium | Ruthenium | 26 | 46 | 28 | 1.7032 | 1.7961 | 0.7124 |
| Iridium | Rhodium | Ruthenium | 72 | 6 | 22 | 1.7013 | 2.0717 | −0.1424 |
| Iridium | Rhodium | Ruthenium | 58 | 12 | 30 | 1.7007 | 2.1711 | −0.4517 |
| Iridium | Rhodium | Ruthenium | 82 | 6 | 12 | 1.6997 | 2.0201 | 0.0106 |
| Iridium | Rhodium | Ruthenium | 76 | 8 | 16 | 1.6990 | 2.0633 | −0.1255 |
| Iridium | Rhodium | Ruthenium | 74 | 8 | 18 | 1.6987 | 2.0701 | −0.1475 |
| Iridium | Rhenium | Ruthenium | 68 | 24 | 8 | 1.6980 | 1.7420 | 0.8637 |
| Iridium | Rhodium | Ruthenium | 78 | 8 | 14 | 1.6980 | 2.0543 | −0.1014 |
| Iridium | Rhodium | Ruthenium | 16 | 54 | 30 | 1.6956 | 1.7202 | 0.9238 |
| Iridium | Rhodium | Ruthenium | 72 | 8 | 20 | 1.6948 | 2.0768 | −0.1830 |
| Iridium | Rhodium | Ruthenium | 72 | 4 | 24 | 1.6947 | 2.0608 | −0.1340 |
| Iridium | Rhodium | Ruthenium | 24 | 50 | 26 | 1.6936 | 1.8023 | 0.6633 |
| Iridium | Rhodium | Ruthenium | 80 | 8 | 12 | 1.6907 | 2.0343 | −0.0665 |
| Iridium | Rhodium | Ruthenium | 60 | 8 | 32 | 1.6906 | 2.1742 | −0.5012 |
| Iridium | Ruthenium | Tungsten | 58 | 10 | 32 | 1.6885 | 1.6139 | 1.2300 |
| Iridium | Rhodium | Ruthenium | 56 | 16 | 28 | 1.6873 | 2.1369 | −0.3986 |
| Iridium | Rhodium | Ruthenium | 76 | 10 | 14 | 1.6861 | 2.0623 | −0.1709 |
| Iridium | Rhodium | Ruthenium | 32 | 36 | 32 | 1.6848 | 1.8572 | 0.4578 |
| Iridium | Rhodium | Ruthenium | 22 | 52 | 26 | 1.6844 | 1.7846 | 0.6877 |
| Iridium | Rhodium | Ruthenium | 74 | 10 | 16 | 1.6839 | 2.0680 | −0.1973 |
| Iridium | Rhodium | Ruthenium | 82 | 8 | 10 | 1.6837 | 2.0191 | −0.0454 |
| Iridium | Rhodium | Ruthenium | 78 | 10 | 12 | 1.6829 | 2.0471 | −0.1358 |
| Iridium | Rhodium | Ruthenium | 72 | 10 | 18 | 1.6827 | 2.0715 | −0.2127 |
| Iridium | Rhenium | Tungsten | 84 | 2 | 14 | 1.6827 | 2.0593 | −0.1746 |
| Iridium | Rhodium | Ruthenium | 58 | 14 | 28 | 1.6826 | 2.1416 | −0.4317 |
| Iridium | Rhodium | Ruthenium | 70 | 8 | 22 | 1.6813 | 2.0744 | −0.2271 |
| Iridium | Rhodium | Ruthenium | 70 | 10 | 20 | 1.6787 | 2.0781 | −0.2490 |
| Iridium | Rhodium | Ruthenium | 80 | 10 | 10 | 1.6779 | 2.0356 | −0.1188 |
| Iridium | Rhodium | Ruthenium | 84 | 8 | 8 | 1.6770 | 2.0222 | −0.0804 |
| Iridium | Rhodium | Ruthenium | 60 | 10 | 30 | 1.6767 | 2.1476 | −0.4739 |
| Iridium | Rhodium | Ruthenium | 54 | 18 | 28 | 1.6754 | 2.1069 | −0.3515 |
| Iridium | Rhodium | Ruthenium | 44 | 26 | 30 | 1.6751 | 1.9554 | 0.1219 |
| Iridium | Manganese | Ruthenium | 60 | 32 | 8 | 1.6739 | 1.5792 | 1.2516 |
| Iridium | Rhodium | Ruthenium | 60 | 12 | 28 | 1.6736 | 2.1303 | −0.4321 |
| Iridium | Rhodium | Ruthenium | 70 | 12 | 18 | 1.6735 | 2.0878 | −0.2994 |
| Iridium | Rhodium | Ruthenium | 12 | 56 | 32 | 1.6729 | 1.6917 | 0.9412 |
| Iridium | Rhodium | Ruthenium | 10 | 54 | 36 | 1.6727 | 1.6818 | 0.9717 |
| Iridium | Rhodium | Ruthenium | 68 | 12 | 20 | 1.6727 | 2.0899 | −0.3093 |
| Iridium | Rhodium | Ruthenium | 14 | 56 | 30 | 1.6726 | 1.6964 | 0.9254 |
| Iridium | Rhodium | Ruthenium | 36 | 32 | 32 | 1.6723 | 1.8752 | 0.3602 |
| Iridium | Rhodium | Ruthenium | 18 | 54 | 28 | 1.6719 | 1.7121 | 0.8736 |
| Iridium | Rhodium | Ruthenium | 68 | 8 | 24 | 1.6705 | 2.0778 | −0.2798 |
| Iridium | Rhodium | Ruthenium | 8 | 48 | 44 | 1.6697 | 1.5995 | 1.2201 |
| Iridium | Rhodium | Ruthenium | 70 | 6 | 24 | 1.6694 | 2.0526 | −0.2051 |
| Iridium | Rhodium | Ruthenium | 68 | 10 | 22 | 1.6692 | 2.0798 | −0.2910 |
| Iridium | Rhodium | Ruthenium | 72 | 12 | 16 | 1.6673 | 2.0748 | −0.2830 |
| Iridium | Rhodium | Ruthenium | 74 | 12 | 14 | 1.6667 | 2.0653 | −0.2555 |
| Iridium | Rhodium | Ruthenium | 66 | 10 | 24 | 1.6646 | 2.0888 | −0.3376 |
| Iridium | Rhodium | Ruthenium | 66 | 12 | 22 | 1.6645 | 2.0881 | −0.3355 |
| Iridium | Rhodium | Ruthenium | 82 | 10 | 8 | 1.6642 | 2.0300 | −0.1538 |
| Iridium | Ruthenium | Tungsten | 60 | 6 | 34 | 1.6638 | 1.5658 | 1.3092 |
| Iridium | Rhodium | Ruthenium | 76 | 12 | 12 | 1.6638 | 2.0465 | −0.2075 |
| Iridium | Rhodium | Ruthenium | 34 | 34 | 32 | 1.6629 | 1.8608 | 0.3731 |
| Iridium | Rhodium | Ruthenium | 78 | 12 | 10 | 1.6618 | 2.0387 | −0.1907 |
| Iridium | Rhodium | Ruthenium | 26 | 48 | 26 | 1.6606 | 1.7788 | 0.6261 |
| Iridium | Rhodium | Ruthenium | 66 | 8 | 26 | 1.6606 | 2.0872 | −0.3482 |
| Iridium | Rhodium | Ruthenium | 62 | 10 | 28 | 1.6605 | 2.1143 | −0.4342 |
| Iridium | Rhodium | Ruthenium | 52 | 20 | 28 | 1.6595 | 2.0598 | −0.2665 |
| Iridium | Rhodium | Ruthenium | 64 | 12 | 24 | 1.6586 | 2.0912 | −0.3689 |
| Iridium | Rhodium | Ruthenium | 64 | 10 | 26 | 1.6584 | 2.0959 | −0.3847 |
| Iridium | Rhodium | Ruthenium | 60 | 14 | 26 | 1.6582 | 2.1058 | −0.4166 |
| Iridium | Rhodium | Ruthenium | 20 | 54 | 26 | 1.6576 | 1.7332 | 0.7608 |
| Iridium | Ruthenium | Tungsten | 58 | 12 | 30 | 1.6566 | 1.5893 | 1.2106 |
| Iridium | Rhodium | Ruthenium | 62 | 12 | 26 | 1.6560 | 2.1000 | −0.4073 |
| Iridium | Rhenium | Ruthenium | 80 | 18 | 2 | 1.6558 | 1.8345 | 0.4337 |
| Iridium | Rhodium | Ruthenium | 64 | 8 | 28 | 1.6551 | 2.1018 | −0.4166 |
| Iridium | Rhodium | Ruthenium | 8 | 50 | 42 | 1.6542 | 1.6186 | 1.1128 |
| Iridium | Rhodium | Ruthenium | 62 | 8 | 30 | 1.6540 | 2.1231 | −0.4888 |
| Iridium | Rhodium | Ruthenium | 30 | 40 | 30 | 1.6508 | 1.7965 | 0.5358 |
| Iridium | Rhodium | Ruthenium | 28 | 44 | 28 | 1.6498 | 1.7653 | 0.6282 |
| Iridium | Rhodium | Ruthenium | 10 | 56 | 34 | 1.6497 | 1.6642 | 0.9537 |
| Iridium | Rhodium | Ruthenium | 68 | 6 | 26 | 1.6488 | 2.0520 | −0.2834 |
| Iridium | Rhodium | Ruthenium | 58 | 16 | 26 | 1.6487 | 2.0880 | −0.3980 |
| Iridium | Rhodium | Ruthenium | 86 | 8 | 6 | 1.6477 | 2.0034 | −0.1332 |
| Iridium | Rhodium | Ruthenium | 12 | 58 | 30 | 1.6458 | 1.6667 | 0.9334 |
| Iridium | Rhodium | Ruthenium | 62 | 14 | 24 | 1.6447 | 2.0782 | −0.3832 |
| Iridium | Rhodium | Ruthenium | 16 | 56 | 28 | 1.6428 | 1.6792 | 0.8836 |
| Iridium | Rhodium | Ruthenium | 80 | 12 | 8 | 1.6426 | 2.0283 | −0.2322 |
| Iridium | Rhenium | Ruthenium | 70 | 24 | 6 | 1.6410 | 1.7559 | 0.6324 |
| Iridium | Rhodium | Ruthenium | 50 | 22 | 28 | 1.6390 | 2.0091 | −0.1859 |
| Iridium | Rhodium | Ruthenium | 84 | 10 | 6 | 1.6361 | 2.0065 | −0.1883 |
| Iridium | Rhodium | Ruthenium | 64 | 14 | 22 | 1.6351 | 2.0549 | −0.3475 |
| Iridium | Rhodium | Ruthenium | 76 | 14 | 10 | 1.6341 | 2.0270 | −0.2616 |
| Iridium | Rhodium | Ruthenium | 74 | 14 | 12 | 1.6337 | 2.0270 | −0.2635 |
| Iridium | Rhenium | Tungsten | 86 | 2 | 12 | 1.6313 | 2.0424 | −0.3226 |
| Iridium | Rhodium | Ruthenium | 56 | 18 | 26 | 1.6279 | 2.0505 | −0.3622 |
| Iridium | Rhodium | Ruthenium | 66 | 14 | 20 | 1.6269 | 2.0384 | −0.3274 |
| Iridium | Rhodium | Ruthenium | 72 | 14 | 14 | 1.6268 | 2.0290 | −0.2976 |
| Iridium | Rhodium | Ruthenium | 42 | 28 | 30 | 1.6267 | 1.8883 | 0.1561 |
| Iridium | Rhodium | Ruthenium | 60 | 16 | 24 | 1.6245 | 2.0482 | −0.3688 |
| Iridium | Ruthenium | Tungsten | 58 | 8 | 34 | 1.6233 | 1.5747 | 1.1562 |
| Iridium | Rhodium | Ruthenium | 22 | 54 | 24 | 1.6230 | 1.7369 | 0.6313 |
| Iridium | Rhodium | Ruthenium | 24 | 52 | 24 | 1.6220 | 1.7496 | 0.5859 |
| Iridium | Rhodium | Ruthenium | 68 | 14 | 18 | 1.6218 | 2.0307 | −0.3232 |
| Iridium | Rhodium | Ruthenium | 70 | 14 | 16 | 1.6210 | 2.0285 | −0.3192 |
| Iridium | Rhodium | Ruthenium | 78 | 14 | 8 | 1.6210 | 2.0274 | −0.3159 |
| Iridium | Rhodium | Ruthenium | 10 | 58 | 32 | 1.6195 | 1.6373 | 0.9423 |
| Iridium | Ruthenium | Tungsten | 60 | 14 | 26 | 1.6188 | 1.5277 | 1.2952 |
| Iridium | Rhodium | Ruthenium | 18 | 56 | 26 | 1.6177 | 1.6746 | 0.8155 |
| Iridium | Rhenium | Ruthenium | 74 | 22 | 4 | 1.6152 | 1.7911 | 0.4255 |
| Iridium | Ruthenium | Tungsten | 38 | 36 | 26 | 1.6143 | 1.5297 | 1.2709 |
| Iridium | Rhodium | Ruthenium | 8 | 52 | 40 | 1.6141 | 1.6021 | 1.0393 |
| Iridium | Rhodium | Ruthenium | 82 | 12 | 6 | 1.6140 | 2.0036 | −0.2671 |
| Iridium | Rhodium | Ruthenium | 14 | 58 | 28 | 1.6126 | 1.6435 | 0.8995 |
| Iridium | Rhodium | Ruthenium | 48 | 24 | 28 | 1.6124 | 1.9490 | −0.0967 |
| Iridium | Rhodium | Ruthenium | 28 | 46 | 26 | 1.6117 | 1.7476 | 0.5571 |
| Iridium | Rhenium | Ruthenium | 66 | 26 | 8 | 1.6082 | 1.6285 | 0.9307 |
| Iridium | Rhodium | Ruthenium | 26 | 50 | 24 | 1.6060 | 1.7410 | 0.5578 |
| Iridium | Rhodium | Ruthenium | 8 | 54 | 38 | 1.6060 | 1.6078 | 0.9941 |
| Iridium | Rhodium | Ruthenium | 62 | 16 | 22 | 1.6037 | 2.0141 | −0.3429 |
| Iridium | Rhodium | Ruthenium | 32 | 38 | 30 | 1.6036 | 1.7940 | 0.3767 |
| Palladium | Ruthenium | None | 30 | 70 | 0 | 1.6031 | 1.6238 | 0.9322 |
| Iridium | Ruthenium | Tungsten | 56 | 10 | 34 | 1.6026 | 1.5938 | 1.0289 |
| Iridium | Rhodium | Ruthenium | 72 | 16 | 12 | 1.6014 | 1.9853 | −0.2583 |
| Iridium | Rhodium | Ruthenium | 74 | 16 | 10 | 1.6010 | 1.9840 | −0.2554 |
| Iridium | Rhodium | Ruthenium | 54 | 20 | 26 | 1.5980 | 1.9972 | −0.3108 |
| Iridium | Ruthenium | Tungsten | 56 | 12 | 32 | 1.5978 | 1.5812 | 1.0487 |
| Iridium | Rhodium | Ruthenium | 70 | 16 | 14 | 1.5952 | 1.9871 | −0.2894 |
| Iridium | Rhodium | Ruthenium | 80 | 14 | 6 | 1.5933 | 2.0004 | −0.3410 |
| Iridium | Rhodium | Ruthenium | 30 | 42 | 28 | 1.5933 | 1.7376 | 0.5228 |
| Iridium | Rhodium | Ruthenium | 58 | 18 | 24 | 1.5932 | 2.0023 | −0.3474 |
| Iridium | Rhodium | Ruthenium | 20 | 56 | 24 | 1.5914 | 1.6813 | 0.7037 |
| Iridium | Rhodium | Ruthenium | 64 | 16 | 20 | 1.5908 | 1.9936 | −0.3288 |
| Iridium | Rhodium | Ruthenium | 76 | 16 | 8 | 1.5895 | 1.9909 | −0.3254 |
| Iridium | Rhodium | Ruthenium | 8 | 56 | 36 | 1.5870 | 1.5958 | 0.9710 |
| Iridium | Rhodium | Ruthenium | 68 | 16 | 16 | 1.5862 | 1.9827 | −0.3117 |
| Iridium | Rhodium | Ruthenium | 10 | 60 | 30 | 1.5853 | 1.6054 | 0.9333 |
| Iridium | Rhodium | Ruthenium | 66 | 16 | 18 | 1.5835 | 1.9826 | −0.3226 |
| Iridium | Rhodium | Ruthenium | 8 | 58 | 34 | 1.5829 | 1.5964 | 0.9552 |
| Iridium | Rhodium | Ruthenium | 40 | 30 | 30 | 1.5813 | 1.8333 | 0.1638 |
| Iridium | Rhodium | Ruthenium | 16 | 58 | 26 | 1.5771 | 1.6233 | 0.8462 |
| Iridium | Rhodium | Ruthenium | 78 | 16 | 6 | 1.5740 | 1.9901 | −0.3876 |
| Iridium | Ruthenium | Tungsten | 58 | 14 | 28 | 1.5736 | 1.5255 | 1.1596 |
| Iridium | Rhodium | Ruthenium | 12 | 60 | 28 | 1.5733 | 1.6007 | 0.9087 |
| Iridium | Ruthenium | Tungsten | 40 | 36 | 24 | 1.5732 | 1.5048 | 1.2215 |
| Iridium | Rhodium | Ruthenium | 72 | 18 | 10 | 1.5728 | 1.9384 | −0.2199 |
| Iridium | Rhodium | Ruthenium | 70 | 18 | 12 | 1.5724 | 1.9416 | −0.2322 |
| Iridium | Rhodium | Ruthenium | 46 | 26 | 28 | 1.5722 | 1.8798 | −0.0281 |
| Iridium | Rhodium | Ruthenium | 34 | 36 | 30 | 1.5700 | 1.7919 | 0.2581 |
| Iridium | Ruthenium | Tungsten | 54 | 4 | 42 | 1.5688 | 1.4759 | 1.3081 |
| Iridium | Rhodium | Ruthenium | 24 | 54 | 22 | 1.5680 | 1.7051 | 0.5412 |
| Iridium | Rhenium | Ruthenium | 64 | 28 | 8 | 1.5674 | 1.5393 | 1.0907 |
| Iridium | Rhodium | Ruthenium | 52 | 22 | 26 | 1.5667 | 1.9411 | −0.2540 |
| Iridium | Rhodium | Ruthenium | 60 | 18 | 22 | 1.5663 | 1.9633 | −0.3301 |
| Iridium | Rhodium | Ruthenium | 68 | 18 | 14 | 1.5649 | 1.9430 | −0.2679 |
| Iridium | Rhodium | Ruthenium | 74 | 18 | 8 | 1.5639 | 1.9497 | −0.2947 |
| Iridium | Rhodium | Ruthenium | 8 | 60 | 32 | 1.5602 | 1.5770 | 0.9435 |
| Iridium | Manganese | Ruthenium | 62 | 34 | 4 | 1.5582 | 1.5049 | 1.1794 |
| Iridium | Rhodium | Ruthenium | 22 | 56 | 22 | 1.5574 | 1.6737 | 0.6082 |
| Iridium | Rhodium | Ruthenium | 38 | 32 | 30 | 1.5558 | 1.8035 | 0.1645 |
| Iridium | Ruthenium | Tungsten | 36 | 34 | 30 | 1.5555 | 1.4941 | 1.2073 |
| Iridium | Rhodium | Ruthenium | 56 | 20 | 24 | 1.5553 | 1.9442 | −0.3122 |
| Iridium | Rhodium | Ruthenium | 66 | 18 | 16 | 1.5522 | 1.9339 | −0.2906 |
| Iridium | Rhodium | Ruthenium | 18 | 58 | 24 | 1.5520 | 1.6213 | 0.7652 |
| Iridium | Rhodium | Ruthenium | 28 | 48 | 24 | 1.5507 | 1.6960 | 0.5048 |
| Iridium | Rhodium | Ruthenium | 62 | 18 | 20 | 1.5506 | 1.9403 | −0.3191 |
| Iridium | Rhodium | Ruthenium | 76 | 18 | 6 | 1.5502 | 1.9550 | −0.3704 |
| Iridium | Rhodium | Ruthenium | 36 | 34 | 30 | 1.5493 | 1.7904 | 0.1833 |
| Iridium | Rhodium | Ruthenium | 86 | 10 | 4 | 1.5474 | 1.9176 | −0.2558 |
| Iridium | Rhodium | Ruthenium | 70 | 20 | 10 | 1.5463 | 1.8958 | −0.1861 |
| Iridium | Rhodium | Ruthenium | 14 | 60 | 26 | 1.5455 | 1.5839 | 0.8697 |
| Iridium | Rhodium | Ruthenium | 26 | 52 | 22 | 1.5452 | 1.6924 | 0.4999 |
| Iridium | Rhenium | Ruthenium | 68 | 26 | 6 | 1.5449 | 1.6443 | 0.6621 |
| Iridium | Rhodium | Ruthenium | 64 | 18 | 18 | 1.5445 | 1.9292 | −0.3075 |
| Iridium | Ruthenium | Tungsten | 60 | 16 | 24 | 1.5419 | 1.4725 | 1.2297 |
| Iridium | Rhenium | Tungsten | 64 | 6 | 30 | 1.5419 | 1.4686 | 1.2494 |
| Iridium | Rhodium | Ruthenium | 68 | 20 | 12 | 1.5417 | 1.8968 | −0.2090 |
| Iridium | Ruthenium | Tungsten | 58 | 6 | 36 | 1.5409 | 1.5282 | 1.0398 |
| Iridium | Rhodium | Ruthenium | 30 | 44 | 26 | 1.5403 | 1.6914 | 0.4842 |
| Iridium | Rhodium | Ruthenium | 32 | 40 | 28 | 1.5391 | 1.7242 | 0.3628 |
| Iridium | Rhodium | Ruthenium | 72 | 20 | 8 | 1.5375 | 1.9012 | −0.2416 |
| Iridium | Rhodium | Ruthenium | 8 | 62 | 30 | 1.5371 | 1.5571 | 0.9318 |
| Iridium | Ruthenium | Tungsten | 54 | 12 | 34 | 1.5367 | 1.5718 | 0.8790 |
| Iridium | Rhenium | Ruthenium | 62 | 30 | 8 | 1.5359 | 1.4565 | 1.2681 |
| Iridium | Rhodium | Ruthenium | 10 | 62 | 28 | 1.5334 | 1.5583 | 0.9149 |
| Iridium | Rhodium | Ruthenium | 66 | 20 | 14 | 1.5315 | 1.8943 | −0.2435 |
| Iridium | Ruthenium | Tungsten | 56 | 14 | 30 | 1.5302 | 1.5243 | 1.0203 |
| Iridium | Rhodium | Ruthenium | 50 | 24 | 26 | 1.5299 | 1.8767 | −0.1893 |
| Iridium | Ruthenium | Tungsten | 56 | 8 | 36 | 1.5289 | 1.5506 | 0.9202 |
| Iridium | Ruthenium | Tungsten | 54 | 10 | 36 | 1.5281 | 1.5805 | 0.8185 |
| Iridium | Rhodium | Ruthenium | 84 | 12 | 4 | 1.5280 | 1.9107 | −0.3148 |
| Iridium | Rhodium | Ruthenium | 20 | 58 | 22 | 1.5271 | 1.6213 | 0.6760 |
| Iridium | Rhodium | Ruthenium | 82 | 14 | 4 | 1.5259 | 1.9205 | −0.3576 |
| Iridium | Rhodium | Ruthenium | 44 | 28 | 28 | 1.5256 | 1.8125 | 0.0121 |
| Iridium | Ruthenium | Tungsten | 38 | 34 | 28 | 1.5246 | 1.5082 | 1.0559 |
| Iridium | Rhodium | Ruthenium | 74 | 20 | 6 | 1.5236 | 1.9034 | −0.3078 |
| Iridium | Rhodium | Ruthenium | 58 | 20 | 22 | 1.5207 | 1.9002 | −0.3095 |
| Iridium | Rhodium | Ruthenium | 12 | 62 | 26 | 1.5204 | 1.5534 | 0.8861 |
| Iridium | Ruthenium | Tungsten | 52 | 4 | 44 | 1.5197 | 1.4908 | 1.0962 |
| Iridium | Ruthenium | Tungsten | 42 | 36 | 22 | 1.5192 | 1.4630 | 1.1912 |
| Iridium | Rhodium | Ruthenium | 68 | 22 | 10 | 1.5190 | 1.8565 | −0.1659 |
| Iridium | Ruthenium | Tungsten | 50 | 4 | 46 | 1.5153 | 1.4951 | 1.0670 |
| Iridium | Rhodium | Ruthenium | 54 | 22 | 24 | 1.5143 | 1.8832 | −0.2783 |
| Iridium | Ruthenium | Tungsten | 34 | 30 | 36 | 1.5141 | 1.4379 | 1.2634 |
| Iridium | Rhodium | Ruthenium | 64 | 20 | 16 | 1.5131 | 1.8767 | −0.2612 |
| Iridium | Rhodium | Ruthenium | 66 | 22 | 12 | 1.5119 | 1.8567 | −0.1970 |
| Iridium | Ruthenium | Tungsten | 36 | 32 | 32 | 1.5116 | 1.4709 | 1.1340 |
| Iridium | Rhodium | Ruthenium | 16 | 60 | 24 | 1.5093 | 1.5673 | 0.7983 |
| Iridium | Rhodium | Ruthenium | 6 | 60 | 34 | 1.5088 | 1.5104 | 0.9962 |
| Iridium | Rhodium | Ruthenium | 6 | 58 | 36 | 1.5054 | 1.5020 | 1.0139 |
| Iridium | Rhodium | Ruthenium | 60 | 20 | 20 | 1.5044 | 1.8768 | −0.2991 |
| Iridium | Rhodium | Ruthenium | 70 | 22 | 8 | 1.5037 | 1.8457 | −0.1936 |
| Iridium | Rhodium | Ruthenium | 6 | 56 | 38 | 1.5026 | 1.4932 | 1.0346 |
| Iridium | Rhodium | Ruthenium | 80 | 16 | 4 | 1.5016 | 1.9036 | −0.4049 |
| Iridium | Rhodium | Ruthenium | 28 | 50 | 22 | 1.5007 | 1.6563 | 0.4557 |
| Iridium | Rhodium | Ruthenium | 62 | 20 | 18 | 1.5005 | 1.8667 | −0.2807 |
| Iridium | Rhodium | Ruthenium | 6 | 52 | 42 | 1.4995 | 1.4657 | 1.1202 |
| Iridium | Rhodium | Ruthenium | 6 | 62 | 32 | 1.4989 | 1.5047 | 0.9810 |
| Iridium | Rhodium | Ruthenium | 64 | 22 | 14 | 1.4979 | 1.8489 | −0.2300 |
| Iridium | Rhenium | Ruthenium | 72 | 24 | 4 | 1.4969 | 1.6842 | 0.3415 |
| Iridium | Rhodium | Ruthenium | 6 | 48 | 46 | 1.4959 | 1.4059 | 1.3161 |
| Iridium | Ruthenium | Tungsten | 58 | 16 | 26 | 1.4957 | 1.4714 | 1.0830 |
| Iridium | Rhodium | Ruthenium | 34 | 38 | 28 | 1.4950 | 1.7195 | 0.2101 |
| Iridium | Rhodium | Ruthenium | 6 | 54 | 40 | 1.4948 | 1.4768 | 1.0660 |
| Iridium | Rhodium | Ruthenium | 66 | 24 | 10 | 1.4945 | 1.8244 | −0.1586 |
| Iridium | Ruthenium | Tungsten | 52 | 12 | 36 | 1.4935 | 1.5777 | 0.7003 |
| Iridium | Ruthenium | Tungsten | 54 | 14 | 32 | 1.4920 | 1.5269 | 0.8769 |
| Iridium | Rhodium | Ruthenium | 24 | 56 | 20 | 1.4910 | 1.6180 | 0.5521 |
| Iridium | Ruthenium | Tungsten | 40 | 34 | 26 | 1.4902 | 1.4996 | 0.9670 |
| Iridium | Ruthenium | Tungsten | 60 | 18 | 22 | 1.4895 | 1.4193 | 1.2474 |
| Iridium | Rhodium | Ruthenium | 22 | 58 | 20 | 1.4891 | 1.5977 | 0.6169 |
| Iridium | Rhodium | Ruthenium | 72 | 22 | 6 | 1.4884 | 1.8407 | −0.2421 |
| Iridium | Rhodium | Ruthenium | 30 | 46 | 24 | 1.4884 | 1.6462 | 0.4421 |
| Iridium | Rhodium | Ruthenium | 8 | 64 | 28 | 1.4880 | 1.5145 | 0.9065 |
| Iridium | Rhodium | Ruthenium | 48 | 26 | 26 | 1.4865 | 1.8056 | −0.1265 |
| Iridium | Rhenium | Ruthenium | 66 | 28 | 6 | 1.4865 | 1.5486 | 0.7815 |
| Iridium | Rhodium | Ruthenium | 6 | 50 | 44 | 1.4862 | 1.4321 | 1.1946 |
| Iridium | Rhodium | Ruthenium | 64 | 24 | 12 | 1.4857 | 1.8271 | −0.2063 |
| Iridium | Rhodium | Ruthenium | 4 | 60 | 36 | 1.4854 | 1.4781 | 1.0271 |
| Iridium | Ruthenium | Tungsten | 34 | 28 | 38 | 1.4847 | 1.4362 | 1.1700 |
| Iridium | Rhodium | Ruthenium | 42 | 30 | 28 | 1.4844 | 1.7570 | 0.0351 |
| Iridium | Rhodium | Ruthenium | 26 | 54 | 20 | 1.4814 | 1.6264 | 0.4857 |
| Iridium | Ruthenium | Tungsten | 36 | 30 | 34 | 1.4804 | 1.4639 | 1.0585 |
| Iridium | Ruthenium | Tungsten | 48 | 4 | 48 | 1.4798 | 1.5139 | 0.8766 |
| Iridium | Rhodium | Ruthenium | 6 | 64 | 30 | 1.4774 | 1.4894 | 0.9587 |
| Iridium | Ruthenium | Tungsten | 60 | 20 | 20 | 1.4771 | 1.3824 | 1.3310 |
| Iridium | Rhodium | Ruthenium | 32 | 42 | 26 | 1.4765 | 1.6525 | 0.3747 |
| Iridium | Rhodium | Ruthenium | 18 | 60 | 22 | 1.4764 | 1.5538 | 0.7250 |
| Iridium | Rhodium | Ruthenium | 56 | 22 | 22 | 1.4761 | 1.8377 | −0.2857 |
| Iridium | Rhodium | Ruthenium | 68 | 24 | 8 | 1.4761 | 1.8021 | −0.1591 |
| Iridium | Rhodium | Ruthenium | 62 | 22 | 16 | 1.4757 | 1.8235 | −0.2368 |
| Iridium | Rhodium | Ruthenium | 4 | 64 | 32 | 1.4745 | 1.4774 | 0.9907 |
| Iridium | Rhodium | Ruthenium | 64 | 26 | 10 | 1.4734 | 1.7977 | −0.1553 |
| Iridium | Rhodium | Ruthenium | 10 | 64 | 26 | 1.4732 | 1.5054 | 0.8851 |
| Iridium | Rhodium | Ruthenium | 52 | 24 | 24 | 1.4725 | 1.8174 | −0.2293 |
| Iridium | Ruthenium | Tungsten | 38 | 32 | 30 | 1.4702 | 1.4891 | 0.9304 |
| Iridium | Rhodium | Ruthenium | 62 | 24 | 14 | 1.4700 | 1.8167 | −0.2377 |
| Iridium | Rhodium | Ruthenium | 36 | 36 | 28 | 1.4699 | 1.7147 | 0.1234 |
| Iridium | Rhodium | Ruthenium | 78 | 18 | 4 | 1.4699 | 1.8680 | −0.4219 |
| Iridium | Rhodium | Ruthenium | 14 | 62 | 24 | 1.4689 | 1.5166 | 0.8290 |
| Palladium | Ruthenium | None | 32 | 68 | 0 | 1.4674 | 1.4810 | 0.9517 |
| Iridium | Rhodium | Ruthenium | 4 | 56 | 40 | 1.4672 | 1.4472 | 1.0735 |
| Iridium | Ruthenium | Tungsten | 32 | 26 | 42 | 1.4668 | 1.4120 | 1.1961 |
| Iridium | Ruthenium | Tungsten | 52 | 10 | 38 | 1.4662 | 1.5786 | 0.5977 |
| Iridium | Rhodium | Ruthenium | 62 | 26 | 12 | 1.4647 | 1.8058 | −0.2224 |
| Iridium | Iron | None | 82 | 18 | 0 | 1.4621 | 1.2287 | 1.1949 |
| Iridium | Rhodium | Ruthenium | 84 | 14 | 2 | 1.4621 | 1.8534 | −0.4047 |
| Iridium | Rhodium | Ruthenium | 40 | 32 | 28 | 1.4620 | 1.7269 | 0.0482 |
| Iridium | Ruthenium | Tungsten | 46 | 4 | 50 | 1.4614 | 1.5296 | 0.7550 |
| Iridium | Ruthenium | Tungsten | 36 | 28 | 36 | 1.4605 | 1.4543 | 1.0188 |
| Iridium | Ruthenium | Tungsten | 52 | 14 | 34 | 1.4597 | 1.5361 | 0.7252 |
| Iridium | Ruthenium | Tungsten | 56 | 16 | 28 | 1.4593 | 1.4707 | 0.9536 |
| Iridium | Ruthenium | Tungsten | 30 | 24 | 46 | 1.4592 | 1.3750 | 1.3007 |
| Iridium | Rhodium | Ruthenium | 86 | 12 | 2 | 1.4591 | 1.8444 | −0.3861 |
| Iridium | Rhodium | Ruthenium | 58 | 22 | 20 | 1.4590 | 1.8134 | −0.2748 |
| Iridium | Rhodium | Ruthenium | 60 | 22 | 18 | 1.4578 | 1.8054 | −0.2515 |
| Iridium | Ruthenium | Tungsten | 42 | 34 | 24 | 1.4550 | 1.4668 | 0.9575 |
| Iridium | Rhodium | Ruthenium | 70 | 24 | 6 | 1.4546 | 1.7801 | −0.1742 |
| Iridium | Rhodium | Ruthenium | 38 | 34 | 28 | 1.4539 | 1.7127 | 0.0647 |
| Iridium | Rhodium | Ruthenium | 62 | 28 | 10 | 1.4538 | 1.7703 | −0.1425 |
| Iridium | Ruthenium | Tungsten | 34 | 26 | 40 | 1.4530 | 1.4427 | 1.0370 |
| Iridium | Ruthenium | Tungsten | 44 | 36 | 20 | 1.4527 | 1.3994 | 1.1882 |
| Iridium | Ruthenium | Tungsten | 50 | 12 | 38 | 1.4515 | 1.5868 | 0.5102 |
| Iridium | Ruthenium | Tungsten | 44 | 4 | 52 | 1.4494 | 1.5374 | 0.6812 |
| Iridium | Rhodium | Ruthenium | 66 | 26 | 8 | 1.4489 | 1.7574 | −0.1171 |
| Iridium | Rhodium | Ruthenium | 20 | 60 | 20 | 1.4482 | 1.5404 | 0.6662 |
| Iridium | Rhodium | Ruthenium | 60 | 26 | 14 | 1.4465 | 1.7937 | −0.2596 |
| Iridium | Rhodium | Ruthenium | 4 | 52 | 44 | 1.4465 | 1.3990 | 1.1746 |
| Iridium | Rhodium | Ruthenium | 60 | 28 | 12 | 1.4442 | 1.7825 | −0.2296 |
| Iridium | Manganese | Ruthenium | 62 | 32 | 6 | 1.4430 | 1.4578 | 0.9286 |
| Iridium | Rhodium | Ruthenium | 82 | 16 | 2 | 1.4430 | 1.8489 | −0.4767 |
| Iridium | Rhenium | Ruthenium | 64 | 30 | 6 | 1.4428 | 1.4589 | 0.9417 |
| Iridium | Rhodium | Ruthenium | 60 | 24 | 16 | 1.4417 | 1.7770 | −0.2204 |
| Iridium | Ruthenium | Tungsten | 54 | 8 | 38 | 1.4413 | 1.5308 | 0.6742 |
| Iridium | Ruthenium | Tungsten | 30 | 22 | 48 | 1.4413 | 1.3722 | 1.2502 |
| Iridium | Rhodium | Ruthenium | 46 | 28 | 26 | 1.4411 | 1.7372 | −0.0778 |
| Iridium | Ruthenium | Tungsten | 36 | 26 | 38 | 1.4397 | 1.4647 | 0.9089 |
| Iridium | Ruthenium | Tungsten | 38 | 30 | 32 | 1.4395 | 1.4733 | 0.8758 |
| Iridium | Ruthenium | Tungsten | 30 | 14 | 56 | 1.4395 | 1.3835 | 1.2032 |
| Iridium | Ruthenium | Tungsten | 58 | 18 | 24 | 1.4388 | 1.4218 | 1.0609 |
| Iridium | Ruthenium | Tungsten | 30 | 16 | 54 | 1.4384 | 1.3661 | 1.2627 |
| Iridium | Rhodium | Ruthenium | 76 | 20 | 4 | 1.4379 | 1.8133 | −0.3711 |
| Iridium | Rhodium | Ruthenium | 28 | 52 | 20 | 1.4367 | 1.5885 | 0.4437 |
| Iridium | Ruthenium | Tungsten | 32 | 24 | 44 | 1.4364 | 1.4158 | 1.0704 |
| Iridium | Rhodium | Ruthenium | 30 | 48 | 22 | 1.4356 | 1.5981 | 0.4054 |
| Iridium | Ruthenium | Tungsten | 40 | 32 | 28 | 1.4356 | 1.4808 | 0.8306 |
| Iridium | Ruthenium | Tungsten | 30 | 12 | 58 | 1.4352 | 1.3950 | 1.1460 |
| Iridium | Molybdenum | None | 86 | 14 | 0 | 1.4341 | 1.3803 | 1.1822 |
| Iridium | Rhodium | Ruthenium | 6 | 66 | 28 | 1.4340 | 1.4537 | 0.9286 |
| Iridium | Ruthenium | Tungsten | 56 | 6 | 38 | 1.4337 | 1.4958 | 0.7725 |
| Iridium | Rhodium | Ruthenium | 12 | 64 | 24 | 1.4333 | 1.4769 | 0.8402 |
| Iridium | Ruthenium | Tungsten | 50 | 14 | 36 | 1.4331 | 1.5538 | 0.5573 |
| Iridium | Rhodium | Ruthenium | 8 | 66 | 26 | 1.4328 | 1.4671 | 0.8745 |
| Iridium | Ruthenium | Tungsten | 30 | 20 | 50 | 1.4321 | 1.3632 | 1.2509 |
| Iridium | Rhodium | Ruthenium | 24 | 58 | 18 | 1.4318 | 1.5459 | 0.5818 |
| Iridium | Rhodium | Ruthenium | 60 | 30 | 10 | 1.4317 | 1.7354 | −0.1133 |
| Iridium | Ruthenium | Tungsten | 30 | 18 | 52 | 1.4315 | 1.3569 | 1.2720 |
| Iridium | Rhodium | Ruthenium | 54 | 24 | 22 | 1.4306 | 1.7724 | −0.2538 |
| Iridium | Rhodium | Ruthenium | 34 | 40 | 26 | 1.4302 | 1.6452 | 0.2102 |
| Iridium | Rhodium | Ruthenium | 64 | 28 | 8 | 1.4295 | 1.7241 | −0.0816 |
| Iridium | Ruthenium | Tungsten | 28 | 10 | 62 | 1.4289 | 1.3419 | 1.3193 |
| Iridium | Rhodium | Ruthenium | 32 | 44 | 24 | 1.4288 | 1.6009 | 0.3634 |
| Iridium | Ruthenium | Tungsten | 38 | 28 | 34 | 1.4281 | 1.4666 | 0.8576 |
| Iridium | Rhodium | Ruthenium | 68 | 26 | 6 | 1.4269 | 1.7278 | −0.1068 |
| Iridium | Ruthenium | Tungsten | 42 | 4 | 54 | 1.4265 | 1.5251 | 0.6373 |
| Iridium | Rhodium | Ruthenium | 50 | 26 | 24 | 1.4254 | 1.7457 | −0.1797 |
| Iridium | Ruthenium | Tungsten | 54 | 16 | 30 | 1.4252 | 1.4718 | 0.8265 |
| Iridium | Rhodium | Ruthenium | 16 | 62 | 22 | 1.4244 | 1.4888 | 0.7626 |
| Iridium | Rhodium | Ruthenium | 58 | 28 | 14 | 1.4232 | 1.7684 | −0.2731 |
| Iridium | Rhodium | Ruthenium | 58 | 30 | 12 | 1.4221 | 1.7505 | −0.2122 |
| Iridium | Ruthenium | Tungsten | 32 | 12 | 56 | 1.4202 | 1.4543 | 0.8713 |
| Iridium | Ruthenium | Tungsten | 34 | 24 | 42 | 1.4199 | 1.4522 | 0.8790 |
| Iridium | Ruthenium | Tungsten | 38 | 26 | 36 | 1.4191 | 1.4716 | 0.8054 |
| Iridium | Tungsten | None | 92 | 8 | 0 | 1.4190 | 1.3476 | 1.2621 |
| Iridium | Ruthenium | Tungsten | 58 | 20 | 22 | 1.4186 | 1.3853 | 1.1223 |
| Iridium | Rhodium | Ruthenium | 58 | 24 | 18 | 1.4185 | 1.7490 | −0.2227 |
| Iridium | Ruthenium | Tungsten | 48 | 12 | 40 | 1.4174 | 1.5962 | 0.3362 |
| Iridium | Ruthenium | Tungsten | 50 | 10 | 40 | 1.4172 | 1.5826 | 0.3863 |
| Iridium | Rhenium | Ruthenium | 62 | 32 | 6 | 1.4160 | 1.3806 | 1.1315 |
| Iridium | Rhodium | Ruthenium | 22 | 60 | 18 | 1.4159 | 1.5159 | 0.6295 |
| Iridium | Ruthenium | Tungsten | 44 | 34 | 22 | 1.4158 | 1.4207 | 0.9818 |
| Iridium | Ruthenium | Tungsten | 32 | 14 | 54 | 1.4158 | 1.4391 | 0.9136 |
| Iridium | Rhodium | Ruthenium | 56 | 24 | 20 | 1.4155 | 1.7515 | −0.2457 |
| Iridium | Ruthenium | Tungsten | 36 | 24 | 40 | 1.4148 | 1.4748 | 0.7752 |
| Iridium | Rhodium | Ruthenium | 26 | 56 | 18 | 1.4130 | 1.5418 | 0.5213 |
| Iridium | Rhodium | Ruthenium | 58 | 26 | 16 | 1.4127 | 1.7413 | −0.2205 |
| Iridium | Ruthenium | Tungsten | 28 | 8 | 64 | 1.4126 | 1.3292 | 1.3054 |
| Iridium | Rhodium | Ruthenium | 62 | 30 | 8 | 1.4105 | 1.6887 | −0.0349 |
| Iridium | Ruthenium | Tungsten | 52 | 16 | 32 | 1.4093 | 1.4894 | 0.6981 |
| Iridium | Ruthenium | Tungsten | 58 | 22 | 20 | 1.4090 | 1.3501 | 1.2184 |
| Iridium | Ruthenium | Tungsten | 32 | 22 | 46 | 1.4072 | 1.4173 | 0.9622 |
| Iridium | Ruthenium | Tungsten | 48 | 14 | 38 | 1.4070 | 1.5701 | 0.3916 |
| Iridium | Ruthenium | Tungsten | 38 | 24 | 38 | 1.4068 | 1.4898 | 0.6897 |
| Iridium | Ruthenium | Tungsten | 32 | 16 | 52 | 1.4065 | 1.4146 | 0.9657 |
| Iridium | Rhodium | Ruthenium | 66 | 28 | 6 | 1.4060 | 1.6851 | −0.0415 |
| Iridium | Iron | None | 80 | 20 | 0 | 1.4055 | 1.2544 | 0.9792 |
| Iridium | Ruthenium | Tungsten | 30 | 10 | 60 | 1.4050 | 1.3883 | 1.0619 |
| Iridium | Rhodium | Ruthenium | 74 | 22 | 4 | 1.4050 | 1.7514 | −0.2950 |
| Iridium | Rhodium | Ruthenium | 58 | 32 | 10 | 1.4040 | 1.6851 | −0.0505 |
| Iridium | Ruthenium | Tungsten | 34 | 12 | 54 | 1.4034 | 1.5098 | 0.6015 |
| Iridium | Ruthenium | Tungsten | 58 | 24 | 18 | 1.4032 | 1.3244 | 1.2941 |
| Iridium | Ruthenium | Tungsten | 42 | 32 | 26 | 1.4031 | 1.4623 | 0.7773 |
| Iridium | Rhodium | Ruthenium | 80 | 18 | 2 | 1.4029 | 1.8096 | −0.5218 |
| Iridium | Rhodium | Ruthenium | 44 | 30 | 26 | 1.4027 | 1.6813 | −0.0422 |
| Iridium | Ruthenium | Tungsten | 40 | 30 | 30 | 1.3982 | 1.4702 | 0.7298 |
| Iridium | Rhodium | Ruthenium | 36 | 38 | 26 | 1.3981 | 1.6413 | 0.0870 |
| Iridium | Ruthenium | Tungsten | 56 | 18 | 26 | 1.3972 | 1.4222 | 0.9061 |
| Iridium | Rhodium | Ruthenium | 4 | 68 | 28 | 1.3971 | 1.4167 | 0.9271 |
| Iridium | Rhenium | Ruthenium | 70 | 26 | 4 | 1.3970 | 1.5838 | 0.2937 |
| Iridium | Rhodium | Ruthenium | 10 | 66 | 24 | 1.3969 | 1.4382 | 0.8447 |
| Iridium | Rhodium | Ruthenium | 18 | 62 | 20 | 1.3967 | 1.4738 | 0.7103 |
| Iridium | Rhodium | Ruthenium | 56 | 30 | 14 | 1.3964 | 1.7313 | −0.2589 |
| Iridium | Ruthenium | Tungsten | 32 | 20 | 48 | 1.3956 | 1.4083 | 0.9467 |
| Iridium | Ruthenium | Tungsten | 40 | 4 | 56 | 1.3941 | 1.4957 | 0.6176 |
| Iridium | Ruthenium | Tungsten | 32 | 18 | 50 | 1.3926 | 1.4040 | 0.9569 |
| Iridium | Rhodium | Ruthenium | 56 | 32 | 12 | 1.3921 | 1.6964 | −0.1469 |
| Iridium | Ruthenium | Tungsten | 50 | 16 | 34 | 1.3921 | 1.5101 | 0.5541 |
| Iridium | Ruthenium | Tungsten | 34 | 14 | 52 | 1.3902 | 1.4850 | 0.6413 |
| Iridium | Ruthenium | Tungsten | 40 | 28 | 32 | 1.3900 | 1.4587 | 0.7383 |
| Iridium | Ruthenium | Tungsten | 40 | 24 | 36 | 1.3895 | 1.4848 | 0.6385 |
| Iridium | Ruthenium | Tungsten | 40 | 26 | 34 | 1.3894 | 1.4671 | 0.7066 |
| Iridium | Ruthenium | Tungsten | 58 | 26 | 16 | 1.3889 | 1.3089 | 1.3014 |
| Iridium | Rhenium | Ruthenium | 60 | 34 | 6 | 1.3888 | 1.3072 | 1.3084 |
| Iridium | Ruthenium | Tungsten | 32 | 10 | 58 | 1.3882 | 1.4423 | 0.7955 |
| Iridium | Ruthenium | Tungsten | 34 | 22 | 44 | 1.3877 | 1.4549 | 0.7456 |
| Iridium | Rhodium | Ruthenium | 64 | 30 | 6 | 1.3871 | 1.6448 | 0.0249 |
| Iridium | Ruthenium | Tungsten | 36 | 12 | 52 | 1.3866 | 1.5474 | 0.3901 |
| Iridium | Ruthenium | Tungsten | 46 | 12 | 42 | 1.3865 | 1.6041 | 0.1762 |
| Iridium | Ruthenium | Tungsten | 30 | 8 | 62 | 1.3863 | 1.3669 | 1.0725 |
| Iridium | Rhodium | Ruthenium | 14 | 64 | 22 | 1.3856 | 1.4415 | 0.7882 |
| Iridium | Rhodium | Ruthenium | 60 | 32 | 8 | 1.3849 | 1.6409 | 0.0303 |
| Iridium | Rhodium | Ruthenium | 52 | 26 | 22 | 1.3836 | 1.7036 | −0.2140 |
| Iridium | Rhodium | Ruthenium | 30 | 50 | 20 | 1.3834 | 1.5416 | 0.3993 |
| Iridium | Ruthenium | Tungsten | 46 | 14 | 40 | 1.3827 | 1.5807 | 0.2478 |
| Iridium | Rhodium | Ruthenium | 56 | 28 | 16 | 1.3825 | 1.7025 | −0.2137 |
| Iridium | Ruthenium | Tungsten | 48 | 16 | 36 | 1.3820 | 1.5344 | 0.4195 |
| Iridium | Rhodium | Ruthenium | 56 | 26 | 18 | 1.3812 | 1.6962 | −0.1969 |
| Iridium | Ruthenium | Tungsten | 44 | 32 | 24 | 1.3811 | 1.4278 | 0.8217 |
| Iridium | Rhodium | Ruthenium | 48 | 28 | 24 | 1.3807 | 1.6779 | −0.1298 |
| Iridium | Rhodium | Ruthenium | 42 | 32 | 26 | 1.3804 | 1.6489 | −0.0209 |
| Iridium | Rhodium | Ruthenium | 38 | 36 | 26 | 1.3798 | 1.6359 | 0.0260 |
| Iridium | Ruthenium | Tungsten | 52 | 8 | 40 | 1.3796 | 1.5232 | 0.4519 |
| Iridium | Ruthenium | Tungsten | 36 | 22 | 42 | 1.3795 | 1.4866 | 0.5924 |
| Iridium | Ruthenium | Tungsten | 38 | 22 | 40 | 1.3792 | 1.5058 | 0.5185 |
| Iridium | Ruthenium | Tungsten | 28 | 6 | 66 | 1.3790 | 1.2955 | 1.3179 |
| Iridium | Ruthenium | Tungsten | 56 | 20 | 24 | 1.3788 | 1.3890 | 0.9586 |
| Iridium | Ruthenium | Tungsten | 34 | 10 | 56 | 1.3782 | 1.4973 | 0.5460 |
| Iridium | Rhodium | Ruthenium | 6 | 68 | 26 | 1.3776 | 1.4069 | 0.8894 |
| Iridium | Rhodium | Ruthenium | 28 | 54 | 18 | 1.3776 | 1.5174 | 0.4676 |
| Iridium | Ruthenium | Tungsten | 40 | 22 | 38 | 1.3765 | 1.5125 | 0.4815 |
| Iridium | Ruthenium | Tungsten | 48 | 10 | 42 | 1.3759 | 1.5857 | 0.1999 |
| Iridium | Rhodium | Ruthenium | 32 | 46 | 22 | 1.3748 | 1.5435 | 0.3558 |
| Iridium | Rhodium | Ruthenium | 34 | 42 | 24 | 1.3745 | 1.5739 | 0.2374 |
| Iridium | Ruthenium | Tungsten | 46 | 34 | 20 | 1.3739 | 1.3714 | 1.0095 |
| Iridium | Rhodium | Ruthenium | 56 | 34 | 10 | 1.3733 | 1.6255 | 0.0360 |
| Iridium | Ruthenium | Tungsten | 60 | 28 | 12 | 1.3731 | 1.2900 | 1.3110 |
| Iridium | Rhodium | Ruthenium | 20 | 62 | 18 | 1.3728 | 1.4585 | 0.6726 |
| Iridium | Rhodium | Ruthenium | 54 | 26 | 20 | 1.3726 | 1.6904 | −0.2154 |
| Iridium | Ruthenium | Tungsten | 34 | 16 | 50 | 1.3724 | 1.4579 | 0.6727 |
| Iridium | Rhodium | Ruthenium | 40 | 34 | 26 | 1.3716 | 1.6339 | −0.0037 |
| Iridium | Ruthenium | Tungsten | 32 | 8 | 60 | 1.3715 | 1.4206 | 0.8091 |
| Iridium | Rhodium | Ruthenium | 72 | 24 | 4 | 1.3712 | 1.6859 | −0.2047 |
| Iridium | Ruthenium | Tungsten | 38 | 12 | 50 | 1.3710 | 1.5802 | 0.1990 |
| Iridium | Ruthenium | Tungsten | 38 | 4 | 58 | 1.3702 | 1.4629 | 0.6449 |
| Iridium | Rhodium | Ruthenium | 62 | 32 | 6 | 1.3681 | 1.6012 | 0.1059 |
| Iridium | Ruthenium | Tungsten | 54 | 18 | 28 | 1.3679 | 1.4237 | 0.7855 |
| Iridium | Ruthenium | Tungsten | 56 | 22 | 22 | 1.3678 | 1.3576 | 1.0394 |
| Iridium | Ruthenium | Tungsten | 44 | 12 | 44 | 1.3674 | 1.6050 | 0.0879 |
| Iridium | Ruthenium | Tungsten | 46 | 36 | 18 | 1.3672 | 1.3289 | 1.1456 |
| Iridium | Ruthenium | Tungsten | 36 | 14 | 50 | 1.3666 | 1.5231 | 0.3987 |
| Iridium | Ruthenium | Tungsten | 46 | 16 | 38 | 1.3661 | 1.5524 | 0.2839 |
| Iridium | Ruthenium | Tungsten | 36 | 10 | 54 | 1.3660 | 1.5402 | 0.3309 |
| Iridium | Ruthenium | Tungsten | 42 | 30 | 28 | 1.3660 | 1.4521 | 0.6690 |
| Iridium | Ruthenium | Tungsten | 56 | 24 | 20 | 1.3657 | 1.3319 | 1.1275 |
| Iridium | Ruthenium | Tungsten | 34 | 20 | 46 | 1.3648 | 1.4505 | 0.6696 |
| Iridium | Rhodium | Ruthenium | 54 | 32 | 14 | 1.3647 | 1.6757 | −0.1955 |
| Iridium | Ruthenium | Tungsten | 42 | 22 | 36 | 1.3627 | 1.5010 | 0.4671 |
| Iridium | Ruthenium | Tungsten | 42 | 24 | 34 | 1.3622 | 1.4717 | 0.5777 |
| Iridium | Ruthenium | Tungsten | 44 | 14 | 42 | 1.3614 | 1.5859 | 0.1345 |
| Iridium | Rhodium | Ruthenium | 54 | 34 | 12 | 1.3608 | 1.6353 | −0.0587 |
| Iridium | Ruthenium | Tungsten | 34 | 8 | 58 | 1.3606 | 1.4782 | 0.5456 |
| Iridium | Ruthenium | Tungsten | 40 | 12 | 48 | 1.3605 | 1.5933 | 0.1021 |
| Iridium | Ruthenium | Tungsten | 34 | 18 | 48 | 1.3597 | 1.4457 | 0.6670 |
| Iridium | Ruthenium | Tungsten | 46 | 38 | 16 | 1.3597 | 1.2942 | 1.2519 |
| Iridium | Ruthenium | Tungsten | 42 | 12 | 46 | 1.3578 | 1.6059 | 0.0407 |
| Iridium | Molybdenum | None | 84 | 16 | 0 | 1.3576 | 1.3501 | 1.0047 |
| Iridium | Rhodium | Ruthenium | 58 | 34 | 8 | 1.3569 | 1.5849 | 0.1182 |
| Iridium | Ruthenium | Tungsten | 30 | 6 | 64 | 1.3566 | 1.3311 | 1.0978 |
| Iridium | Ruthenium | Tungsten | 46 | 32 | 22 | 1.3560 | 1.3881 | 0.8754 |
| Iridium | Ruthenium | Tungsten | 54 | 6 | 40 | 1.3560 | 1.4798 | 0.5188 |
| Iridium | Rhodium | Ruthenium | 8 | 68 | 24 | 1.3559 | 1.3987 | 0.8345 |
| Iridium | Rhodium | Ruthenium | 12 | 66 | 22 | 1.3555 | 1.4073 | 0.7997 |
| Iridium | Ruthenium | Tungsten | 42 | 20 | 38 | 1.3545 | 1.5287 | 0.3247 |
| Iridium | Ruthenium | Tungsten | 40 | 20 | 40 | 1.3544 | 1.5264 | 0.3333 |
| Iridium | Ruthenium | Tungsten | 36 | 20 | 44 | 1.3539 | 1.4847 | 0.4910 |
| Iridium | Ruthenium | Tungsten | 44 | 16 | 40 | 1.3538 | 1.5593 | 0.2030 |
| Iridium | Ruthenium | Tungsten | 38 | 10 | 52 | 1.3530 | 1.5674 | 0.1682 |
| Iridium | Ruthenium | Tungsten | 42 | 26 | 32 | 1.3530 | 1.4492 | 0.6267 |
| Iridium | Rhodium | Ruthenium | 54 | 30 | 16 | 1.3525 | 1.6603 | −0.1939 |
| Iridium | Ruthenium | Tungsten | 42 | 28 | 30 | 1.3519 | 1.4457 | 0.6355 |
| Palladium | Ruthenium | None | 34 | 66 | 0 | 1.3511 | 1.3544 | 0.9870 |
| Iridium | Ruthenium | Tungsten | 38 | 14 | 48 | 1.3506 | 1.5509 | 0.2216 |
| Iridium | Ruthenium | Tungsten | 52 | 18 | 30 | 1.3505 | 1.4360 | 0.6681 |
| Iridium | Manganese | Ruthenium | 62 | 30 | 8 | 1.3504 | 1.4080 | 0.7711 |
| Iridium | Ruthenium | Tungsten | 36 | 8 | 56 | 1.3504 | 1.5214 | 0.3330 |
| Iridium | Ruthenium | Tungsten | 38 | 20 | 42 | 1.3501 | 1.5137 | 0.3636 |
| Iridium | Ruthenium | Tungsten | 56 | 26 | 18 | 1.3499 | 1.3103 | 1.1540 |
| Iridium | Ruthenium | Tungsten | 36 | 4 | 60 | 1.3495 | 1.4041 | 0.7880 |
| Iridium | Ruthenium | Tungsten | 36 | 16 | 48 | 1.3494 | 1.4927 | 0.4414 |
| Iridium | Ruthenium | Tungsten | 46 | 10 | 44 | 1.3485 | 1.5868 | 0.0724 |
| Iridium | Ruthenium | Tungsten | 44 | 20 | 36 | 1.3485 | 1.5109 | 0.3679 |
| Iridium | Ruthenium | Tungsten | 42 | 14 | 44 | 1.3483 | 1.5823 | 0.0891 |
| Iridium | Rhodium | Ruthenium | 36 | 40 | 24 | 1.3477 | 1.5731 | 0.1199 |
| Iridium | Ruthenium | Tungsten | 46 | 18 | 36 | 1.3476 | 1.5212 | 0.3240 |
| Iridium | Ruthenium | Tungsten | 44 | 18 | 38 | 1.3463 | 1.5412 | 0.2404 |
| Iridium | Ruthenium | Tungsten | 48 | 18 | 34 | 1.3463 | 1.4930 | 0.4281 |
| Iridium | Rhodium | Ruthenium | 16 | 64 | 20 | 1.3463 | 1.4126 | 0.7416 |
| Iridium | Ruthenium | Tungsten | 50 | 18 | 32 | 1.3459 | 1.4623 | 0.5461 |
| Iridium | Rhodium | Ruthenium | 54 | 28 | 18 | 1.3456 | 1.6460 | −0.1714 |
| Iridium | Ruthenium | Tungsten | 62 | 30 | 8 | 1.3454 | 1.2792 | 1.2578 |
| Iridium | Ruthenium | Tungsten | 54 | 20 | 26 | 1.3435 | 1.3910 | 0.8141 |
| Iridium | Rhodium | Ruthenium | 60 | 34 | 6 | 1.3435 | 1.5467 | 0.2063 |
| Iridium | Ruthenium | Tungsten | 44 | 30 | 26 | 1.3431 | 1.4258 | 0.6769 |
| Iridium | Ruthenium | Tungsten | 40 | 14 | 46 | 1.3431 | 1.5716 | 0.1070 |
| Iridium | Rhodium | Ruthenium | 54 | 36 | 10 | 1.3429 | 1.5593 | 0.1547 |
| Iridium | Rhodium | Ruthenium | 46 | 30 | 24 | 1.3424 | 1.6197 | −0.0841 |
| Iridium | Rhodium | Ruthenium | 70 | 26 | 4 | 1.3419 | 1.6233 | −0.1007 |
| Iridium | Ruthenium | Tungsten | 44 | 22 | 34 | 1.3407 | 1.4786 | 0.4603 |
| Iridium | Ruthenium | Tungsten | 42 | 18 | 40 | 1.3406 | 1.5452 | 0.1989 |
| Iridium | Ruthenium | Tungsten | 40 | 10 | 50 | 1.3401 | 1.5825 | 0.0505 |
| Iridium | Rhodium | Ruthenium | 50 | 28 | 22 | 1.3398 | 1.6379 | −0.1676 |
| Iridium | Ruthenium | Tungsten | 58 | 28 | 14 | 1.3397 | 1.2875 | 1.2022 |
| Iridium | Ruthenium | Tungsten | 38 | 8 | 54 | 1.3392 | 1.5565 | 0.1477 |
| Iridium | Ruthenium | Tungsten | 42 | 16 | 42 | 1.3390 | 1.5588 | 0.1383 |
| Iridium | Ruthenium | Tungsten | 34 | 4 | 62 | 1.3386 | 1.3524 | 0.9461 |
| Iridium | Ruthenium | Tungsten | 54 | 22 | 24 | 1.3379 | 1.3664 | 0.8879 |
| Iridium | Ruthenium | Tungsten | 30 | 4 | 66 | 1.3377 | 1.2558 | 1.3215 |
| Iridium | Ruthenium | Tungsten | 32 | 6 | 62 | 1.3376 | 1.3754 | 0.8516 |
| Iridium | Ruthenium | Tungsten | 36 | 18 | 46 | 1.3370 | 1.4837 | 0.4242 |
| Iridium | Rhodium | Ruthenium | 24 | 60 | 16 | 1.3368 | 1.4236 | 0.6595 |
| Iridium | Rhodium | Ruthenium | 26 | 58 | 16 | 1.3361 | 1.4341 | 0.6155 |
| Iridium | Ruthenium | Tungsten | 32 | 4 | 64 | 1.3355 | 1.2923 | 1.1696 |
| Iridium | Ruthenium | Tungsten | 54 | 24 | 22 | 1.3350 | 1.3429 | 0.9688 |
| Iridium | Rhodium | Ruthenium | 32 | 48 | 20 | 1.3350 | 1.4987 | 0.3547 |
| Iridium | Ruthenium | Tungsten | 46 | 20 | 34 | 1.3341 | 1.4848 | 0.4072 |
| Iridium | Ruthenium | Tungsten | 40 | 18 | 42 | 1.3333 | 1.5372 | 0.1973 |
| Iridium | Ruthenium | Tungsten | 40 | 16 | 44 | 1.3331 | 1.5438 | 0.1704 |
| Iridium | Ruthenium | Tungsten | 44 | 10 | 46 | 1.3330 | 1.5877 | −0.0028 |
| Iridium | Ruthenium | Tungsten | 48 | 32 | 20 | 1.3328 | 1.3514 | 0.9267 |
| Iridium | Ruthenium | Tungsten | 42 | 10 | 48 | 1.3326 | 1.5870 | −0.0021 |
| Iridium | Ruthenium | Tungsten | 44 | 24 | 32 | 1.3324 | 1.4457 | 0.5531 |
| Iridium | Rhodium | Ruthenium | 52 | 28 | 20 | 1.3324 | 1.6309 | −0.1757 |
| Iridium | Ruthenium | Tungsten | 38 | 16 | 46 | 1.3323 | 1.5239 | 0.2451 |
| Iridium | Rhodium | Ruthenium | 52 | 34 | 14 | 1.3314 | 1.6120 | −0.1058 |
| Iridium | Ruthenium | Tungsten | 38 | 18 | 44 | 1.3306 | 1.5143 | 0.2755 |
| Iridium | Ruthenium | Tungsten | 44 | 28 | 28 | 1.3294 | 1.4236 | 0.6278 |
| Iridium | Rhodium | Ruthenium | 52 | 36 | 12 | 1.3293 | 1.5676 | 0.0594 |
| Iridium | Ruthenium | Tungsten | 46 | 30 | 24 | 1.3291 | 1.3932 | 0.7471 |
| Iridium | Ruthenium | Tungsten | 56 | 28 | 16 | 1.3288 | 1.2964 | 1.1252 |
| Iridium | Ruthenium | Tungsten | 34 | 6 | 60 | 1.3284 | 1.4349 | 0.5789 |
| Iridium | Rhodium | Ruthenium | 34 | 44 | 22 | 1.3280 | 1.5139 | 0.2642 |
| Iridium | Ruthenium | Tungsten | 50 | 8 | 42 | 1.3275 | 1.5182 | 0.2460 |
| Iridium | Rhodium | Ruthenium | 30 | 52 | 18 | 1.3274 | 1.4717 | 0.4292 |
| Iridium | Ruthenium | Tungsten | 54 | 26 | 20 | 1.3272 | 1.3216 | 1.0216 |
| Iridium | Ruthenium | Tungsten | 40 | 8 | 52 | 1.3267 | 1.5705 | 0.0337 |
| Iridium | Ruthenium | Tungsten | 52 | 20 | 28 | 1.3266 | 1.4038 | 0.6935 |
| Iridium | Rhenium | Ruthenium | 68 | 28 | 4 | 1.3264 | 1.4896 | 0.3491 |
| Iridium | Rhodium | Ruthenium | 56 | 36 | 8 | 1.3263 | 1.5185 | 0.2396 |
| Iridium | Rhodium | Ruthenium | 38 | 38 | 24 | 1.3255 | 1.5702 | 0.0309 |
| Iridium | Ruthenium | Tungsten | 48 | 20 | 32 | 1.3240 | 1.4526 | 0.4901 |
| Iridium | Rhodium | Ruthenium | 52 | 32 | 16 | 1.3231 | 1.6116 | −0.1431 |
| Iridium | Rhodium | Ruthenium | 44 | 32 | 24 | 1.3226 | 1.5873 | −0.0507 |
| Iridium | Iron | None | 78 | 22 | 0 | 1.3217 | 1.2493 | 0.7771 |
| Iridium | Rhodium | Ruthenium | 22 | 62 | 16 | 1.3214 | 1.3990 | 0.6921 |
| Iridium | Ruthenium | Tungsten | 44 | 26 | 30 | 1.3213 | 1.4266 | 0.5817 |
| Iridium | Ruthenium | Tungsten | 60 | 30 | 10 | 1.3188 | 1.2743 | 1.1769 |
| Iridium | Ruthenium | Tungsten | 48 | 30 | 22 | 1.3184 | 1.3610 | 0.8305 |
| Iridium | Ruthenium | Tungsten | 36 | 6 | 58 | 1.3181 | 1.4869 | 0.3280 |
| Iridium | Ruthenium | Tungsten | 52 | 24 | 24 | 1.3178 | 1.3595 | 0.8332 |
| Iridium | Ruthenium | Tungsten | 48 | 34 | 18 | 1.3175 | 1.3174 | 1.0002 |
| Iridium | Rhodium | Ruthenium | 68 | 28 | 4 | 1.3175 | 1.5672 | 0.0049 |
| Iridium | Ruthenium | Tungsten | 46 | 22 | 32 | 1.3173 | 1.4478 | 0.4800 |
| Iridium | Rhodium | Ruthenium | 40 | 36 | 24 | 1.3170 | 1.5682 | −0.0015 |
| Iridium | Ruthenium | Tungsten | 42 | 8 | 50 | 1.3162 | 1.5793 | −0.0497 |
| Iridium | Ruthenium | Tungsten | 50 | 20 | 30 | 1.3161 | 1.4225 | 0.5754 |
| Iridium | Rhodium | Ruthenium | 52 | 38 | 10 | 1.3159 | 1.4960 | 0.2818 |
| Iridium | Ruthenium | Tungsten | 52 | 22 | 26 | 1.3158 | 1.3777 | 0.7533 |
| Iridium | Rhodium | Ruthenium | 58 | 36 | 6 | 1.3139 | 1.4814 | 0.3315 |
| Iridium | Rhodium | Ruthenium | 10 | 68 | 22 | 1.3135 | 1.3614 | 0.8085 |
| Iridium | Ruthenium | Tungsten | 46 | 28 | 26 | 1.3134 | 1.3981 | 0.6612 |
| Iridium | Ruthenium | Tungsten | 52 | 26 | 22 | 1.3127 | 1.3384 | 0.8971 |
| Iridium | Rhodium | Ruthenium | 52 | 30 | 18 | 1.3125 | 1.5969 | −0.1372 |
| Iridium | Rhodium | Ruthenium | 18 | 64 | 18 | 1.3125 | 1.3850 | 0.7105 |
| Iridium | Rhodium | Ruthenium | 42 | 34 | 24 | 1.3122 | 1.5682 | −0.0238 |
| Iridium | Ruthenium | Tungsten | 54 | 28 | 18 | 1.3119 | 1.3052 | 1.0264 |
| Iridium | Ruthenium | Tungsten | 52 | 28 | 20 | 1.3114 | 1.3245 | 0.9476 |
| Iridium | Ruthenium | Tungsten | 48 | 28 | 24 | 1.3107 | 1.3724 | 0.7532 |
| Iridium | Rhodium | Ruthenium | 28 | 56 | 16 | 1.3101 | 1.4198 | 0.5603 |
| Iridium | Ruthenium | Tungsten | 50 | 28 | 22 | 1.3078 | 1.3453 | 0.8496 |
| Iridium | Ruthenium | Tungsten | 48 | 8 | 44 | 1.3074 | 1.5315 | 0.1008 |
| Iridium | Ruthenium | Tungsten | 38 | 6 | 56 | 1.3069 | 1.5208 | 0.1408 |
| Iridium | Ruthenium | Tungsten | 46 | 24 | 30 | 1.3064 | 1.4191 | 0.5474 |
| Iridium | Ruthenium | Tungsten | 50 | 30 | 20 | 1.3062 | 1.3318 | 0.8975 |
| Iridium | Rhodium | Ruthenium | 6 | 70 | 24 | 1.3055 | 1.3415 | 0.8557 |
| Iridium | Ruthenium | Tungsten | 46 | 26 | 28 | 1.3050 | 1.4029 | 0.6060 |
| Iridium | Ruthenium | Tungsten | 50 | 26 | 24 | 1.3038 | 1.3589 | 0.7782 |
| Iridium | Ruthenium | Tungsten | 44 | 8 | 48 | 1.3037 | 1.5640 | −0.0483 |
| Iridium | Ruthenium | Tungsten | 50 | 22 | 28 | 1.3037 | 1.3946 | 0.6338 |
| Iridium | Rhodium | Ruthenium | 48 | 30 | 22 | 1.3033 | 1.5810 | −0.1179 |
| Iridium | Ruthenium | Tungsten | 50 | 24 | 26 | 1.3027 | 1.3752 | 0.7077 |
| Iridium | Rhodium | Ruthenium | 50 | 38 | 12 | 1.3026 | 1.5057 | 0.1813 |
| Iridium | Ruthenium | Tungsten | 48 | 22 | 30 | 1.3018 | 1.4176 | 0.5334 |
| Iridium | Ruthenium | Tungsten | 48 | 36 | 16 | 1.3013 | 1.2814 | 1.0770 |
| Iridium | Ruthenium | Tungsten | 48 | 24 | 28 | 1.3011 | 1.3958 | 0.6181 |
| Iridium | Rhodium | Ruthenium | 50 | 36 | 14 | 1.3009 | 1.5496 | −0.0031 |
| Iridium | Molybdenum | Ruthenium | 84 | 12 | 4 | 1.3006 | 1.2441 | 1.2271 |
| Iridium | Rhodium | Ruthenium | 54 | 38 | 8 | 1.2997 | 1.4551 | 0.3724 |
| Iridium | Rhodium | Ruthenium | 14 | 66 | 20 | 1.2995 | 1.3581 | 0.7631 |
| Iridium | Ruthenium | Tungsten | 48 | 26 | 26 | 1.2993 | 1.3803 | 0.6731 |
| Iridium | Ruthenium | Tungsten | 46 | 8 | 46 | 1.2978 | 1.5480 | −0.0118 |
| Iridium | Rhenium | Tungsten | 62 | 6 | 32 | 1.2973 | 1.2810 | 1.0589 |
| Iridium | Rhodium | Ruthenium | 50 | 30 | 20 | 1.2972 | 1.5773 | −0.1331 |
| Iridium | Rhodium | Ruthenium | 50 | 40 | 10 | 1.2955 | 1.4439 | 0.3992 |
| Iridium | Rhodium | Ruthenium | 36 | 42 | 22 | 1.2953 | 1.5099 | 0.1305 |
| Iridium | Ruthenium | Tungsten | 50 | 32 | 18 | 1.2948 | 1.3101 | 0.9379 |
| Iridium | Rhodium | Ruthenium | 50 | 34 | 16 | 1.2939 | 1.5581 | −0.0715 |
| Iridium | Ruthenium | Tungsten | 52 | 6 | 42 | 1.2937 | 1.4700 | 0.2847 |
| Iridium | Ruthenium | Tungsten | 40 | 6 | 54 | 1.2933 | 1.5397 | 0.0002 |
| Iridium | Rhodium | Ruthenium | 66 | 30 | 4 | 1.2926 | 1.5044 | 0.1409 |
| Iridium | Ruthenium | Tungsten | 52 | 30 | 18 | 1.2902 | 1.3050 | 0.9397 |
| Iridium | Rhodium | Ruthenium | 34 | 46 | 20 | 1.2887 | 1.4628 | 0.2903 |
| Iridium | Rhodium | Ruthenium | 56 | 38 | 6 | 1.2878 | 1.4198 | 0.4623 |
| Iridium | Rhodium | Ruthenium | 64 | 32 | 4 | 1.2876 | 1.4711 | 0.2526 |
| Iridium | Ruthenium | Tungsten | 58 | 30 | 12 | 1.2860 | 1.2666 | 1.0789 |
| Iridium | Rhodium | Ruthenium | 50 | 32 | 18 | 1.2860 | 1.5530 | −0.0895 |
| Iridium | Ruthenium | Tungsten | 48 | 40 | 12 | 1.2837 | 1.2310 | 1.2147 |
| Iridium | Ruthenium | Tungsten | 48 | 38 | 14 | 1.2827 | 1.2498 | 1.1344 |
| Iridium | Rhodium | Ruthenium | 38 | 40 | 22 | 1.2825 | 1.5127 | 0.0581 |
| Iridium | Molybdenum | None | 82 | 18 | 0 | 1.2822 | 1.3118 | 0.8486 |
| Iridium | Rhodium | Ruthenium | 46 | 32 | 22 | 1.2821 | 1.5437 | −0.0706 |
| Iridium | Ruthenium | Tungsten | 42 | 6 | 52 | 1.2818 | 1.5477 | −0.0890 |
| Iridium | Rhodium | Ruthenium | 48 | 40 | 12 | 1.2808 | 1.4540 | 0.2903 |
| Iridium | Rhodium | Ruthenium | 52 | 40 | 8 | 1.2796 | 1.4029 | 0.4946 |
| Iridium | Rhodium | Ruthenium | 32 | 50 | 18 | 1.2791 | 1.4308 | 0.3772 |
| Iridium | Rhodium | Ruthenium | 48 | 42 | 10 | 1.2774 | 1.3991 | 0.5000 |
| Iridium | Rhodium | Ruthenium | 8 | 70 | 22 | 1.2761 | 1.3224 | 0.8097 |
| Iridium | Rhodium | Ruthenium | 48 | 32 | 20 | 1.2753 | 1.5386 | −0.0832 |
| Iridium | Rhodium | Ruthenium | 30 | 54 | 16 | 1.2744 | 1.3944 | 0.5065 |
| Iridium | Ruthenium | Tungsten | 54 | 30 | 16 | 1.2743 | 1.2816 | 0.9700 |
| Iridium | Rhodium | Ruthenium | 40 | 38 | 22 | 1.2740 | 1.5139 | 0.0118 |
| Iridium | Rhodium | Ruthenium | 48 | 38 | 14 | 1.2737 | 1.4934 | 0.0947 |
| Iridium | Rhodium | Ruthenium | 48 | 36 | 16 | 1.2734 | 1.5175 | −0.0057 |
| Iridium | Rhodium | Ruthenium | 44 | 34 | 22 | 1.2712 | 1.5214 | −0.0326 |
| Iridium | Rhodium | Ruthenium | 20 | 64 | 16 | 1.2710 | 1.3397 | 0.7163 |
| Iridium | Rhodium | Ruthenium | 42 | 36 | 22 | 1.2706 | 1.5155 | −0.0112 |
| Iridium | Manganese | Ruthenium | 64 | 32 | 4 | 1.2705 | 1.3226 | 0.7688 |
| Iridium | Rhodium | Ruthenium | 54 | 40 | 6 | 1.2701 | 1.3713 | 0.5820 |
| Iridium | Rhodium | Ruthenium | 36 | 44 | 20 | 1.2690 | 1.4626 | 0.1979 |
| Iridium | Ruthenium | Tungsten | 56 | 30 | 14 | 1.2665 | 1.2647 | 1.0074 |
| Iridium | Rhodium | Ruthenium | 48 | 34 | 18 | 1.2656 | 1.5163 | −0.0395 |
| Iridium | Ruthenium | Tungsten | 44 | 6 | 50 | 1.2645 | 1.5372 | −0.1318 |
| Iridium | Ruthenium | Tungsten | 50 | 6 | 44 | 1.2645 | 1.4815 | 0.0987 |
| Iridium | Rhodium | Ruthenium | 50 | 42 | 8 | 1.2639 | 1.3602 | 0.6002 |
| Iridium | Rhodium | Ruthenium | 4 | 72 | 24 | 1.2636 | 1.2976 | 0.8593 |
| Iridium | Rhodium | Ruthenium | 46 | 42 | 12 | 1.2628 | 1.4093 | 0.3908 |
| Iridium | Rhenium | Ruthenium | 66 | 30 | 4 | 1.2620 | 1.3957 | 0.4360 |
| Iridium | Rhodium | Ruthenium | 62 | 34 | 4 | 1.2616 | 1.4128 | 0.3717 |
| Iridium | Rhodium | Ruthenium | 12 | 68 | 20 | 1.2608 | 1.3149 | 0.7747 |
| Iridium | Rhenium | Ruthenium | 64 | 32 | 4 | 1.2605 | 1.3067 | 0.8055 |
| Iridium | Ruthenium | Tungsten | 50 | 34 | 16 | 1.2599 | 1.2714 | 0.9517 |
| Iridium | Rhodium | Ruthenium | 46 | 34 | 20 | 1.2594 | 1.5081 | −0.0367 |
| Iridium | Ruthenium | Tungsten | 52 | 32 | 16 | 1.2582 | 1.2748 | 0.9306 |
| Iridium | Rhodium | Ruthenium | 52 | 42 | 6 | 1.2578 | 1.3337 | 0.6833 |
| Palladium | Ruthenium | None | 36 | 64 | 0 | 1.2568 | 1.2514 | 1.0228 |
| Iridium | Rhodium | Ruthenium | 50 | 44 | 6 | 1.2563 | 1.3160 | 0.7506 |
| Iridium | Rhodium | Ruthenium | 16 | 66 | 18 | 1.2553 | 1.3176 | 0.7395 |
| Iridium | Rhodium | Ruthenium | 44 | 36 | 20 | 1.2551 | 1.4955 | −0.0053 |
| Iridium | Rhodium | Ruthenium | 46 | 44 | 10 | 1.2551 | 1.3592 | 0.5647 |
| Iridium | Rhodium | Ruthenium | 38 | 42 | 20 | 1.2537 | 1.4674 | 0.1057 |
| Iridium | Rhodium | Ruthenium | 40 | 40 | 20 | 1.2532 | 1.4776 | 0.0605 |
| Iridium | Rhodium | Ruthenium | 46 | 36 | 18 | 1.2529 | 1.4906 | 0.0042 |
| Iridium | Rhodium | Ruthenium | 46 | 38 | 16 | 1.2528 | 1.4760 | 0.0646 |
| Iridium | Rhodium | Ruthenium | 48 | 44 | 8 | 1.2524 | 1.3329 | 0.6626 |
| Iridium | Rhodium | Ruthenium | 42 | 38 | 20 | 1.2513 | 1.4842 | 0.0235 |
| Iridium | Rhodium | Ruthenium | 46 | 40 | 14 | 1.2510 | 1.4470 | 0.1778 |
| Iridium | Ruthenium | Tungsten | 46 | 6 | 48 | 1.2503 | 1.5144 | −0.1086 |
| Iridium | Rhodium | Ruthenium | 34 | 48 | 18 | 1.2495 | 1.4123 | 0.3160 |
| Iridium | Rhodium | Ruthenium | 48 | 46 | 6 | 1.2486 | 1.2995 | 0.7862 |
| Iridium | Rhodium | Ruthenium | 26 | 60 | 14 | 1.2485 | 1.3230 | 0.6867 |
| Iridium | Ruthenium | Tungsten | 48 | 6 | 46 | 1.2483 | 1.4958 | −0.0406 |
| Iridium | Ruthenium | Tungsten | 60 | 32 | 8 | 1.2465 | 1.2459 | 0.9994 |
| Iridium | Rhodium | Ruthenium | 32 | 52 | 16 | 1.2453 | 1.3770 | 0.4445 |
| Iridium | Rhodium | Ruthenium | 44 | 38 | 18 | 1.2436 | 1.4703 | 0.0432 |
| Iridium | Rhodium | Ruthenium | 24 | 62 | 14 | 1.2436 | 1.3080 | 0.7281 |
| Iridium | Ruthenium | Tungsten | 58 | 32 | 10 | 1.2430 | 1.2477 | 0.9786 |
| Iridium | Ruthenium | Tungsten | 50 | 36 | 14 | 1.2417 | 1.2440 | 0.9898 |
| Iridium | Rhodium | Ruthenium | 44 | 44 | 12 | 1.2409 | 1.3709 | 0.4495 |
| Iridium | Rhodium | Ruthenium | 44 | 40 | 16 | 1.2391 | 1.4477 | 0.1165 |
| Iridium | Rhodium | Ruthenium | 28 | 58 | 14 | 1.2380 | 1.3239 | 0.6359 |
| Iridium | Rhodium | Ruthenium | 46 | 46 | 8 | 1.2376 | 1.3088 | 0.6977 |
| Iridium | Rhodium | Ruthenium | 42 | 40 | 18 | 1.2367 | 1.4538 | 0.0788 |
| Iridium | Ruthenium | Tungsten | 56 | 32 | 12 | 1.2340 | 1.2463 | 0.9464 |
| Iridium | Rhodium | Ruthenium | 60 | 36 | 4 | 1.2335 | 1.3533 | 0.4909 |
| Iridium | Rhodium | Ruthenium | 36 | 46 | 18 | 1.2313 | 1.4118 | 0.2310 |
| Iridium | Rhodium | Ruthenium | 40 | 42 | 18 | 1.2310 | 1.4374 | 0.1198 |
| Iridium | Rhodium | Ruthenium | 44 | 42 | 14 | 1.2304 | 1.4071 | 0.2460 |
| Iridium | Molybdenum | None | 80 | 20 | 0 | 1.2304 | 1.2859 | 0.7324 |
| Iridium | Rhodium | Ruthenium | 6 | 72 | 22 | 1.2303 | 1.2686 | 0.8376 |
| Iridium | Ruthenium | Tungsten | 54 | 32 | 14 | 1.2293 | 1.2490 | 0.9155 |
| Iridium | Ruthenium | Tungsten | 50 | 38 | 12 | 1.2289 | 1.2220 | 1.0290 |
| Iridium | Rhodium | Ruthenium | 38 | 44 | 18 | 1.2286 | 1.4230 | 0.1698 |
| Iridium | Rhodium | Ruthenium | 44 | 46 | 10 | 1.2277 | 1.3215 | 0.5989 |
| Iridium | Rhodium | Ruthenium | 46 | 48 | 6 | 1.2253 | 1.2784 | 0.7722 |
| Iridium | Rhodium | Ruthenium | 42 | 42 | 16 | 1.2241 | 1.4182 | 0.1679 |
| Iridium | Rhodium | Ruthenium | 10 | 70 | 20 | 1.2224 | 1.2716 | 0.7885 |
| Iridium | Rhenium | Ruthenium | 62 | 34 | 4 | 1.2214 | 1.2405 | 0.9140 |
| Iridium | Ruthenium | Tungsten | 52 | 34 | 14 | 1.2206 | 1.2425 | 0.9057 |
| Iridium | Rhodium | Ruthenium | 34 | 50 | 16 | 1.2171 | 1.3609 | 0.3801 |
| Iridium | Rhodium | Ruthenium | 18 | 66 | 16 | 1.2170 | 1.2790 | 0.7328 |
| Iridium | Rhodium | Ruthenium | 42 | 46 | 12 | 1.2162 | 1.3342 | 0.4905 |
| Iridium | Iron | None | 76 | 24 | 0 | 1.2161 | 1.2109 | 0.5973 |
| Iridium | Rhodium | Ruthenium | 30 | 56 | 14 | 1.2157 | 1.3130 | 0.5800 |
| Iridium | Rhodium | Ruthenium | 40 | 44 | 16 | 1.2154 | 1.3968 | 0.2168 |
| Iridium | Rhodium | Ruthenium | 22 | 64 | 14 | 1.2123 | 1.2710 | 0.7458 |
| Iridium | Rhodium | Ruthenium | 42 | 44 | 14 | 1.2119 | 1.3745 | 0.2958 |
| Iridium | Rhodium | Ruthenium | 36 | 48 | 16 | 1.2115 | 1.3672 | 0.3252 |
| Iridium | Rhodium | Ruthenium | 44 | 48 | 8 | 1.2090 | 1.2815 | 0.6843 |
| Iridium | Rhodium | Ruthenium | 14 | 68 | 18 | 1.2077 | 1.2645 | 0.7528 |
| Iridium | Rhodium | Ruthenium | 38 | 46 | 16 | 1.2074 | 1.3770 | 0.2631 |
| Iridium | Rhodium | Ruthenium | 58 | 38 | 4 | 1.2055 | 1.2990 | 0.5937 |
| Iridium | Rhenium | Ruthenium | 60 | 36 | 4 | 1.1999 | 1.1643 | 1.1531 |
| Iridium | Ruthenium | Tungsten | 52 | 36 | 12 | 1.1995 | 1.2200 | 0.9092 |
| Iridium | Molybdenum | None | 78 | 22 | 0 | 1.1985 | 1.2685 | 0.6672 |
| Iridium | Ruthenium | Tungsten | 54 | 34 | 12 | 1.1976 | 1.2279 | 0.8671 |
| Iridium | Rhodium | Ruthenium | 40 | 46 | 14 | 1.1954 | 1.3466 | 0.3363 |
| Iridium | Rhodium | Ruthenium | 42 | 48 | 10 | 1.1928 | 1.2860 | 0.5896 |
| Iridium | Rhodium | Ruthenium | 32 | 54 | 14 | 1.1926 | 1.3009 | 0.5234 |
| Iridium | Rhodium | Ruthenium | 56 | 40 | 4 | 1.1916 | 1.2633 | 0.6846 |
| Iridium | Rhodium | Ruthenium | 40 | 48 | 12 | 1.1909 | 1.3050 | 0.4966 |
| Iridium | Rhodium | Ruthenium | 44 | 50 | 6 | 1.1909 | 1.2546 | 0.7190 |
| Iridium | Rhodium | Ruthenium | 52 | 44 | 4 | 1.1857 | 1.2273 | 0.8162 |
| Iridium | Rhodium | Ruthenium | 38 | 48 | 14 | 1.1845 | 1.3268 | 0.3698 |
| Iridium | Rhodium | Ruthenium | 8 | 72 | 20 | 1.1844 | 1.2304 | 0.7957 |
| Iridium | Ruthenium | Tungsten | 56 | 34 | 10 | 1.1831 | 1.2184 | 0.8433 |
| Iridium | Rhodium | Ruthenium | 34 | 52 | 14 | 1.1815 | 1.3036 | 0.4575 |
| Iridium | Rhodium | Ruthenium | 50 | 46 | 4 | 1.1795 | 1.2121 | 0.8550 |
| Iridium | Rhodium | Ruthenium | 36 | 50 | 14 | 1.1789 | 1.3121 | 0.4069 |
| Iridium | Rhodium | Ruthenium | 54 | 42 | 4 | 1.1771 | 1.2321 | 0.7547 |
| Palladium | Ruthenium | None | 38 | 62 | 0 | 1.1743 | 1.1628 | 1.0514 |
| Iridium | Rhodium | Ruthenium | 42 | 50 | 8 | 1.1732 | 1.2537 | 0.6395 |
| Iridium | Rhodium | Ruthenium | 12 | 70 | 18 | 1.1682 | 1.2215 | 0.7603 |
| Iridium | Molybdenum | None | 76 | 24 | 0 | 1.1674 | 1.2322 | 0.6885 |
| Iridium | Rhodium | Ruthenium | 20 | 66 | 14 | 1.1667 | 1.2219 | 0.7518 |
| Iridium | Rhodium | Ruthenium | 48 | 48 | 4 | 1.1647 | 1.2025 | 0.8295 |
| Iridium | Rhodium | Ruthenium | 38 | 50 | 12 | 1.1638 | 1.2773 | 0.4879 |
| Iridium | Ruthenium | Tungsten | 54 | 36 | 10 | 1.1631 | 1.2043 | 0.8139 |
| Iridium | Rhenium | Ruthenium | 58 | 38 | 4 | 1.1605 | 1.1077 | 1.2352 |
| Iridium | Rhodium | Ruthenium | 16 | 68 | 16 | 1.1604 | 1.2156 | 0.7501 |
| Iridium | Molybdenum | Ruthenium | 82 | 14 | 4 | 1.1574 | 1.1556 | 1.0100 |
| Iridium | Rhodium | Ruthenium | 28 | 60 | 12 | 1.1563 | 1.2343 | 0.6443 |
| Iridium | Rhodium | Ruthenium | 40 | 50 | 10 | 1.1557 | 1.2539 | 0.5541 |
| Iridium | Rhodium | Ruthenium | 26 | 62 | 12 | 1.1528 | 1.2183 | 0.7011 |
| Iridium | Rhenium | Tungsten | 58 | 8 | 34 | 1.1520 | 1.1143 | 1.1686 |
| Iridium | Rhodium | Ruthenium | 36 | 52 | 12 | 1.1510 | 1.2628 | 0.4904 |
| Iridium | Rhodium | Ruthenium | 30 | 58 | 12 | 1.1502 | 1.2402 | 0.5887 |
| Iridium | Rhodium | Ruthenium | 32 | 56 | 12 | 1.1457 | 1.2460 | 0.5393 |
| Iridium | Rhodium | Ruthenium | 6 | 74 | 20 | 1.1439 | 1.1801 | 0.8335 |
| Iridium | Rhodium | Ruthenium | 42 | 52 | 6 | 1.1430 | 1.2260 | 0.6183 |
| Iridium | Molybdenum | None | 74 | 26 | 0 | 1.1394 | 1.1911 | 0.7472 |
| Iridium | Rhodium | Ruthenium | 34 | 54 | 12 | 1.1389 | 1.2485 | 0.4951 |
| Iridium | Rhodium | Ruthenium | 46 | 50 | 4 | 1.1370 | 1.1853 | 0.7771 |
| Iridium | Rhodium | Ruthenium | 40 | 52 | 8 | 1.1326 | 1.2252 | 0.5698 |
| Iridium | Rhodium | None | 88 | 12 | 0 | 1.1304 | 1.4829 | −0.6491 |
| Iridium | Rhodium | Ruthenium | 10 | 72 | 18 | 1.1296 | 1.1756 | 0.7865 |
| Iridium | Rhodium | None | 86 | 14 | 0 | 1.1291 | 1.4453 | −0.4670 |
| Iridium | Rhodium | Ruthenium | 24 | 64 | 12 | 1.1290 | 1.1849 | 0.7392 |
| Iridium | Rhodium | Ruthenium | 38 | 52 | 10 | 1.1242 | 1.2296 | 0.5074 |
| Iridium | Manganese | Ruthenium | 64 | 30 | 6 | 1.1234 | 1.2328 | 0.4887 |
| Iridium | Iron | None | 74 | 26 | 0 | 1.1212 | 1.1628 | 0.4549 |
| Iridium | Rhodium | None | 90 | 10 | 0 | 1.1199 | 1.4986 | −0.7899 |
| Iridium | Rhodium | None | 84 | 16 | 0 | 1.1129 | 1.3856 | −0.2567 |
| Iridium | Rhodium | Ruthenium | 18 | 68 | 14 | 1.1098 | 1.1609 | 0.7580 |
| Iridium | Rhodium | Ruthenium | 14 | 70 | 16 | 1.1072 | 1.1573 | 0.7629 |
| Iridium | Rhodium | Ruthenium | 4 | 76 | 20 | 1.1065 | 1.1365 | 0.8575 |
| Iridium | Molybdenum | None | 72 | 28 | 0 | 1.1051 | 1.1505 | 0.7705 |
| Iridium | Molybdenum | Ruthenium | 10 | 66 | 24 | 1.1044 | 1.0342 | 1.3333 |
| Iridium | Molybdenum | Ruthenium | 8 | 68 | 24 | 1.1037 | 1.0338 | 1.3325 |
| Palladium | Ruthenium | None | 40 | 60 | 0 | 1.1025 | 1.0879 | 1.0698 |
| Iridium | Rhodium | Ruthenium | 36 | 54 | 10 | 1.0989 | 1.2091 | 0.4740 |
| Iridium | Molybdenum | Ruthenium | 8 | 70 | 22 | 1.0985 | 1.0309 | 1.3229 |
| Iridium | Manganese | Ruthenium | 64 | 28 | 8 | 1.0976 | 1.2082 | 0.4379 |
| Iridium | Molybdenum | Ruthenium | 12 | 64 | 24 | 1.0962 | 1.0301 | 1.3163 |
| Iridium | Manganese | None | 80 | 20 | 0 | 1.0949 | 1.0241 | 1.3235 |
| Iridium | Rhodium | Ruthenium | 22 | 66 | 12 | 1.0947 | 1.1418 | 0.7744 |
| Iridium | Molybdenum | Ruthenium | 10 | 68 | 22 | 1.0930 | 1.0306 | 1.2992 |
| Iridium | Rhodium | Ruthenium | 40 | 54 | 6 | 1.0928 | 1.1952 | 0.5084 |
| Iridium | Rhodium | Ruthenium | 8 | 74 | 18 | 1.0927 | 1.1350 | 0.7967 |
| Iridium | Rhodium | Ruthenium | 38 | 54 | 8 | 1.0926 | 1.1982 | 0.4928 |
| Iridium | Molybdenum | Ruthenium | 14 | 62 | 24 | 1.0870 | 1.0240 | 1.3041 |
| Iridium | Molybdenum | Ruthenium | 12 | 66 | 22 | 1.0863 | 1.0289 | 1.2771 |
| Iridium | Rhodium | Ruthenium | 44 | 52 | 4 | 1.0843 | 1.1550 | 0.6570 |
| Iridium | Rhodium | None | 82 | 18 | 0 | 1.0842 | 1.3212 | −0.0959 |
| Iridium | Rhodium | Ruthenium | 34 | 56 | 10 | 1.0833 | 1.1899 | 0.4838 |
| Iridium | Molybdenum | Ruthenium | 10 | 70 | 20 | 1.0813 | 1.0297 | 1.2502 |
| Iridium | Molybdenum | Ruthenium | 8 | 72 | 20 | 1.0794 | 1.0281 | 1.2491 |
| Iridium | Molybdenum | Ruthenium | 80 | 14 | 6 | 1.0789 | 1.0270 | 1.2524 |
| Iridium | Molybdenum | Ruthenium | 14 | 64 | 22 | 1.0782 | 1.0261 | 1.2536 |
| Iridium | Molybdenum | Ruthenium | 12 | 68 | 20 | 1.0765 | 1.0316 | 1.2188 |
| Iridium | Molybdenum | Ruthenium | 8 | 74 | 18 | 1.0757 | 1.0260 | 1.2423 |
| Iridium | Molybdenum | None | 70 | 30 | 0 | 1.0753 | 1.1079 | 0.8324 |
| Iridium | Molybdenum | Ruthenium | 18 | 56 | 26 | 1.0745 | 1.0122 | 1.3046 |
| Iridium | Molybdenum | Ruthenium | 16 | 60 | 24 | 1.0730 | 1.0165 | 1.2754 |
| Iridium | Rhodium | None | 92 | 8 | 0 | 1.0723 | 1.4899 | −1.0495 |
| Iridium | Rhodium | Ruthenium | 32 | 58 | 10 | 1.0720 | 1.1698 | 0.5216 |
| Iridium | Rhenium | None | 84 | 16 | 0 | 1.0716 | 1.1546 | 0.3175 |
| Iridium | Molybdenum | Ruthenium | 14 | 66 | 20 | 1.0704 | 1.0320 | 1.1883 |
| Iridium | Molybdenum | Ruthenium | 10 | 72 | 18 | 1.0702 | 1.0281 | 1.2063 |
| Iridium | Rhodium | Ruthenium | 12 | 72 | 16 | 1.0678 | 1.1124 | 0.7811 |
| Iridium | Rhodium | Ruthenium | 36 | 56 | 8 | 1.0666 | 1.1752 | 0.4660 |
| Iridium | Rhodium | Ruthenium | 30 | 60 | 10 | 1.0659 | 1.1509 | 0.5811 |
| Iridium | Molybdenum | Ruthenium | 12 | 70 | 18 | 1.0654 | 1.0309 | 1.1699 |
| Iridium | Molybdenum | Ruthenium | 16 | 62 | 22 | 1.0644 | 1.0202 | 1.2180 |
| Iridium | Rhodium | Ruthenium | 6 | 76 | 18 | 1.0636 | 1.0958 | 0.8413 |
| Iridium | Molybdenum | Ruthenium | 8 | 76 | 16 | 1.0636 | 1.0337 | 1.1471 |
| Iridium | Molybdenum | Ruthenium | 10 | 74 | 16 | 1.0624 | 1.0317 | 1.1514 |
| Iridium | Rhenium | Tungsten | 60 | 6 | 34 | 1.0623 | 1.1085 | 0.7717 |
| Iridium | Molybdenum | Ruthenium | 14 | 68 | 18 | 1.0602 | 1.0351 | 1.1238 |
| Iridium | Molybdenum | Ruthenium | 18 | 58 | 24 | 1.0594 | 1.0103 | 1.2427 |
| Iridium | Rhodium | Ruthenium | 28 | 62 | 10 | 1.0583 | 1.1293 | 0.6478 |
| Iridium | Molybdenum | Ruthenium | 16 | 64 | 20 | 1.0582 | 1.0268 | 1.1548 |
| Iridium | Molybdenum | Ruthenium | 20 | 54 | 26 | 1.0544 | 0.9970 | 1.2855 |
| Iridium | Rhenium | None | 82 | 18 | 0 | 1.0541 | 1.1345 | 0.3714 |
| Iridium | Molybdenum | Ruthenium | 12 | 72 | 16 | 1.0538 | 1.0331 | 1.1024 |
| Iridium | Rhodium | Ruthenium | 38 | 56 | 6 | 1.0533 | 1.1687 | 0.4249 |
| Iridium | Molybdenum | Ruthenium | 8 | 78 | 14 | 1.0522 | 1.0275 | 1.1231 |
| Iridium | Rhodium | Ruthenium | 16 | 70 | 14 | 1.0521 | 1.0990 | 0.7663 |
| Iridium | Rhodium | None | 80 | 20 | 0 | 1.0511 | 1.2583 | 0.0293 |
| Iridium | Molybdenum | Ruthenium | 16 | 66 | 18 | 1.0507 | 1.0361 | 1.0729 |
| Iridium | Rhenium | None | 86 | 14 | 0 | 1.0505 | 1.1481 | 0.1952 |
| Iridium | Molybdenum | Ruthenium | 18 | 60 | 22 | 1.0485 | 1.0121 | 1.1823 |
| Iridium | Molybdenum | Ruthenium | 14 | 70 | 16 | 1.0468 | 1.0363 | 1.0519 |
| Iridium | Molybdenum | Ruthenium | 10 | 76 | 14 | 1.0468 | 1.0314 | 1.0771 |
| Iridium | Molybdenum | None | 68 | 32 | 0 | 1.0464 | 1.0621 | 0.9185 |
| Iridium | Manganese | Ruthenium | 76 | 12 | 12 | 1.0455 | 1.0074 | 1.1911 |
| Iridium | Rhodium | Ruthenium | 20 | 68 | 12 | 1.0455 | 1.0891 | 0.7812 |
| Iridium | Manganese | Ruthenium | 78 | 12 | 10 | 1.0451 | 1.0111 | 1.1706 |
| Iridium | Manganese | Ruthenium | 74 | 12 | 14 | 1.0443 | 0.9883 | 1.2811 |
| Iridium | Molybdenum | Ruthenium | 18 | 62 | 20 | 1.0426 | 1.0176 | 1.1258 |
| Iridium | Rhodium | Ruthenium | 34 | 58 | 8 | 1.0411 | 1.1490 | 0.4556 |
| Iridium | Rhodium | Ruthenium | 26 | 64 | 10 | 1.0410 | 1.0991 | 0.7075 |
| Iridium | Rhodium | Ruthenium | 42 | 54 | 4 | 1.0403 | 1.1297 | 0.5490 |
| Iridium | Molybdenum | Ruthenium | 16 | 68 | 16 | 1.0387 | 1.0378 | 1.0035 |
| Iridium | Molybdenum | Ruthenium | 18 | 64 | 18 | 1.0381 | 1.0267 | 1.0576 |
| Iridium | Molybdenum | Ruthenium | 12 | 74 | 14 | 1.0380 | 1.0310 | 1.0356 |
| Palladium | Ruthenium | None | 42 | 58 | 0 | 1.0354 | 1.0179 | 1.0885 |
| Iridium | Manganese | None | 78 | 22 | 0 | 1.0336 | 0.9850 | 1.2396 |
| Iridium | Rhodium | Ruthenium | 10 | 74 | 16 | 1.0331 | 1.0728 | 0.7983 |
| Iridium | Molybdenum | Ruthenium | 20 | 56 | 24 | 1.0316 | 0.9839 | 1.2424 |
| Iridium | Iron | None | 72 | 28 | 0 | 1.0305 | 1.1069 | 0.3393 |
| Iridium | Molybdenum | Ruthenium | 18 | 66 | 16 | 1.0301 | 1.0354 | 0.9729 |
| Iridium | Molybdenum | Ruthenium | 14 | 72 | 14 | 1.0269 | 1.0300 | 0.9840 |
| Iridium | Manganese | Ruthenium | 78 | 10 | 12 | 1.0261 | 0.9796 | 1.2374 |
| Iridium | Molybdenum | Ruthenium | 20 | 58 | 22 | 1.0242 | 0.9892 | 1.1790 |
| Iridium | Rhodium | Ruthenium | 32 | 60 | 8 | 1.0241 | 1.1213 | 0.5010 |
| Iridium | Manganese | Ruthenium | 80 | 10 | 10 | 1.0221 | 0.9792 | 1.2205 |
| Iridium | Rhodium | Ruthenium | 36 | 58 | 6 | 1.0213 | 1.1420 | 0.3797 |
| Iridium | Rhodium | None | 78 | 22 | 0 | 1.0209 | 1.2008 | 0.1430 |
| Iridium | Molybdenum | Ruthenium | 20 | 62 | 18 | 1.0177 | 1.0044 | 1.0685 |
| Iridium | Molybdenum | None | 66 | 34 | 0 | 1.0167 | 1.0127 | 1.0206 |
| Iridium | Rhenium | None | 80 | 20 | 0 | 1.0162 | 1.0998 | 0.3692 |
| Iridium | Molybdenum | Ruthenium | 20 | 60 | 20 | 1.0148 | 0.9881 | 1.1376 |
| Iridium | Molybdenum | Ruthenium | 16 | 70 | 14 | 1.0147 | 1.0300 | 0.9211 |
| Iridium | Rhodium | Ruthenium | 24 | 66 | 10 | 1.0138 | 1.0601 | 0.7603 |
| Iridium | Molybdenum | Ruthenium | 22 | 52 | 26 | 1.0114 | 0.9541 | 1.2975 |
| Iridium | Molybdenum | Ruthenium | 20 | 64 | 16 | 1.0113 | 1.0145 | 0.9829 |
| Iridium | Molybdenum | Ruthenium | 12 | 76 | 12 | 1.0093 | 1.0118 | 0.9864 |
| Iridium | Molybdenum | Ruthenium | 10 | 78 | 12 | 1.0093 | 1.0026 | 1.0347 |
| Iridium | Molybdenum | Ruthenium | 18 | 68 | 14 | 1.0083 | 1.0294 | 0.8900 |
| Iridium | Rhodium | Ruthenium | 30 | 62 | 8 | 1.0041 | 1.0869 | 0.5661 |
| Iridium | Rhodium | Ruthenium | 14 | 72 | 14 | 1.0032 | 1.0452 | 0.7808 |
| Iridium | Molybdenum | Ruthenium | 80 | 16 | 4 | 1.0013 | 1.0352 | 0.8205 |
| Iridium | Molybdenum | Ruthenium | 14 | 74 | 12 | 1.0009 | 1.0128 | 0.9372 |
| Iridium | Rhodium | None | 76 | 24 | 0 | 1.0005 | 1.1554 | 0.2534 |
| Iridium | Rhodium | Ruthenium | 8 | 76 | 16 | 0.9992 | 1.0374 | 0.7996 |
| Iridium | Molybdenum | Ruthenium | 20 | 66 | 14 | 0.9973 | 1.0189 | 0.8866 |
| Iridium | Molybdenum | Ruthenium | 8 | 80 | 12 | 0.9973 | 0.9853 | 1.0627 |
| Iridium | Molybdenum | Ruthenium | 22 | 54 | 24 | 0.9965 | 0.9485 | 1.2526 |
| Iridium | Manganese | Ruthenium | 82 | 10 | 8 | 0.9953 | 0.9511 | 1.2328 |
| Iridium | Rhodium | Ruthenium | 18 | 70 | 12 | 0.9947 | 1.0345 | 0.7904 |
| Iridium | Rhodium | Ruthenium | 40 | 56 | 4 | 0.9947 | 1.1020 | 0.4330 |
| Iridium | Rhodium | Ruthenium | 34 | 60 | 6 | 0.9946 | 1.1097 | 0.3928 |
| Iridium | Rhenium | None | 88 | 12 | 0 | 0.9930 | 1.1125 | 0.0388 |
| Iridium | Molybdenum | Ruthenium | 16 | 72 | 12 | 0.9884 | 1.0121 | 0.8732 |
| Iridium | Molybdenum | Ruthenium | 12 | 78 | 10 | 0.9862 | 0.9888 | 0.9861 |
| Iridium | Molybdenum | Ruthenium | 22 | 62 | 16 | 0.9860 | 0.9858 | 1.0009 |
| Iridium | Rhodium | Ruthenium | 28 | 64 | 8 | 0.9850 | 1.0526 | 0.6392 |
| Iridium | Molybdenum | Ruthenium | 22 | 60 | 18 | 0.9836 | 0.9658 | 1.0952 |
| Iridium | Molybdenum | Ruthenium | 22 | 56 | 22 | 0.9833 | 0.9449 | 1.2054 |
| Iridium | Molybdenum | Ruthenium | 14 | 76 | 10 | 0.9815 | 0.9966 | 0.9190 |
| Iridium | Molybdenum | Ruthenium | 22 | 58 | 20 | 0.9806 | 0.9514 | 1.1564 |
| Iridium | Rhenium | Tungsten | 56 | 4 | 40 | 0.9797 | 0.9188 | 1.3186 |
| Iridium | Rhodium | None | 74 | 26 | 0 | 0.9794 | 1.1116 | 0.3519 |
| Iridium | Molybdenum | Ruthenium | 18 | 70 | 12 | 0.9791 | 1.0122 | 0.8224 |
| Iridium | Molybdenum | Ruthenium | 10 | 80 | 10 | 0.9786 | 0.9707 | 1.0425 |
| Iridium | Molybdenum | None | 64 | 36 | 0 | 0.9778 | 0.9742 | 1.0190 |
| Iridium | Rhodium | Ruthenium | 6 | 78 | 16 | 0.9768 | 1.0032 | 0.8559 |
| Iridium | Rhodium | Ruthenium | 22 | 68 | 10 | 0.9742 | 1.0130 | 0.7913 |
| Iridium | Manganese | Ruthenium | 66 | 30 | 4 | 0.9737 | 1.0979 | 0.3305 |
| Iridium | Molybdenum | Ruthenium | 22 | 64 | 14 | 0.9736 | 0.9915 | 0.9037 |
| Palladium | Ruthenium | None | 44 | 56 | 0 | 0.9734 | 0.9512 | 1.1197 |
| Iridium | Molybdenum | Ruthenium | 6 | 82 | 12 | 0.9727 | 0.9500 | 1.1223 |
| Iridium | Rhenium | None | 78 | 22 | 0 | 0.9698 | 1.0603 | 0.3351 |
| Iridium | Molybdenum | Ruthenium | 78 | 16 | 6 | 0.9696 | 0.9528 | 1.0885 |
| Iridium | Rhodium | Ruthenium | 32 | 62 | 6 | 0.9689 | 1.0707 | 0.4487 |
| Iridium | Molybdenum | Ruthenium | 8 | 82 | 10 | 0.9687 | 0.9521 | 1.0898 |
| Iridium | Molybdenum | Ruthenium | 20 | 68 | 12 | 0.9681 | 1.0027 | 0.8120 |
| Iridium | Molybdenum | Ruthenium | 16 | 74 | 10 | 0.9676 | 0.9983 | 0.8336 |
| Iridium | Rhodium | Ruthenium | 38 | 58 | 4 | 0.9673 | 1.0821 | 0.3774 |
| Iridium | Rhodium | Ruthenium | 12 | 74 | 14 | 0.9665 | 1.0050 | 0.7908 |
| Iridium | Molybdenum | Ruthenium | 14 | 78 | 8 | 0.9638 | 0.9764 | 0.9313 |
| Iridium | Molybdenum | Ruthenium | 12 | 80 | 8 | 0.9611 | 0.9564 | 1.0255 |
| Iridium | Manganese | None | 76 | 24 | 0 | 0.9604 | 0.9380 | 1.1160 |
| Iridium | Rhodium | Ruthenium | 26 | 66 | 8 | 0.9593 | 1.0110 | 0.7169 |
| Iridium | Rhodium | None | 72 | 28 | 0 | 0.9592 | 1.0700 | 0.4441 |
| Iridium | Molybdenum | Ruthenium | 16 | 76 | 8 | 0.9587 | 0.9828 | 0.8671 |
| Iridium | Molybdenum | Ruthenium | 18 | 72 | 10 | 0.9578 | 0.9984 | 0.7775 |
| Iridium | Molybdenum | Ruthenium | 6 | 84 | 10 | 0.9573 | 0.9370 | 1.1115 |
| Iridium | Molybdenum | Ruthenium | 22 | 66 | 12 | 0.9529 | 0.9868 | 0.8129 |
| Iridium | Molybdenum | Ruthenium | 10 | 82 | 8 | 0.9496 | 0.9407 | 1.0493 |
| Iridium | Iron | None | 70 | 30 | 0 | 0.9489 | 1.0466 | 0.2635 |
| Iridium | Molybdenum | Ruthenium | 20 | 70 | 10 | 0.9489 | 0.9936 | 0.7529 |
| Iridium | Molybdenum | Ruthenium | 24 | 60 | 16 | 0.9484 | 0.9421 | 1.0346 |
| Iridium | Molybdenum | Ruthenium | 24 | 52 | 24 | 0.9481 | 0.8930 | 1.3067 |
| Iridium | Rhodium | Ruthenium | 4 | 80 | 16 | 0.9460 | 0.9610 | 0.9148 |
| Iridium | Molybdenum | Ruthenium | 24 | 58 | 18 | 0.9440 | 0.9210 | 1.1281 |
| Iridium | Rhodium | Ruthenium | 16 | 72 | 12 | 0.9436 | 0.9793 | 0.8012 |
| Iridium | Molybdenum | Ruthenium | 24 | 62 | 14 | 0.9429 | 0.9560 | 0.9270 |
| Iridium | Rhodium | Ruthenium | 30 | 64 | 6 | 0.9421 | 1.0242 | 0.5434 |
| Iridium | Molybdenum | None | 62 | 38 | 0 | 0.9416 | 0.9382 | 1.0191 |
| Iridium | Rhodium | None | 70 | 30 | 0 | 0.9405 | 1.0298 | 0.5408 |
| Iridium | Molybdenum | Ruthenium | 18 | 74 | 8 | 0.9400 | 0.9830 | 0.7597 |
| Iridium | Rhodium | Ruthenium | 36 | 60 | 4 | 0.9391 | 1.0509 | 0.3752 |
| Iridium | Molybdenum | Ruthenium | 78 | 18 | 4 | 0.9382 | 1.0029 | 0.6392 |
| Iridium | Rhodium | Ruthenium | 10 | 76 | 14 | 0.9381 | 0.9727 | 0.8063 |
| Iridium | Molybdenum | Ruthenium | 24 | 56 | 20 | 0.9364 | 0.9014 | 1.1966 |
| Iridium | Molybdenum | Ruthenium | 20 | 72 | 8 | 0.9360 | 0.9826 | 0.7388 |
| Iridium | Molybdenum | Ruthenium | 24 | 54 | 22 | 0.9353 | 0.8902 | 1.2527 |
| Iridium | Molybdenum | Ruthenium | 22 | 68 | 10 | 0.9349 | 0.9793 | 0.7508 |
| Iridium | Rhenium | Tungsten | 56 | 8 | 36 | 0.9339 | 0.9591 | 0.8538 |
| Iridium | Molybdenum | Ruthenium | 8 | 84 | 8 | 0.9317 | 0.9181 | 1.0772 |
| Iridium | Ruthenium | Tungsten | 6 | 6 | 88 | 0.9298 | 0.8708 | 1.3332 |
| Iridium | Rhodium | Ruthenium | 20 | 70 | 10 | 0.9290 | 0.9622 | 0.8123 |
| Iridium | Molybdenum | Ruthenium | 24 | 64 | 12 | 0.9267 | 0.9564 | 0.8316 |
| Iridium | Rhodium | Ruthenium | 24 | 68 | 8 | 0.9251 | 0.9660 | 0.7682 |
| Iridium | Molybdenum | Ruthenium | 22 | 70 | 8 | 0.9208 | 0.9717 | 0.7097 |
| Iridium | Rhodium | None | 68 | 32 | 0 | 0.9197 | 0.9883 | 0.6367 |
| Palladium | Ruthenium | None | 46 | 54 | 0 | 0.9177 | 0.8895 | 1.1611 |
| Iridium | Rhodium | Ruthenium | 34 | 62 | 4 | 0.9175 | 1.0202 | 0.4127 |
| Iridium | Rhenium | None | 76 | 24 | 0 | 0.9167 | 1.0246 | 0.2269 |
| Iridium | Molybdenum | Ruthenium | 24 | 66 | 10 | 0.9152 | 0.9573 | 0.7586 |
| Iridium | Molybdenum | Ruthenium | 24 | 68 | 8 | 0.9123 | 0.9626 | 0.7104 |
| Iridium | Rhodium | Ruthenium | 28 | 66 | 6 | 0.9120 | 0.9743 | 0.6416 |
| Iridium | Molybdenum | None | 60 | 40 | 0 | 0.9093 | 0.9050 | 1.0249 |
| Iridium | Manganese | Ruthenium | 66 | 28 | 6 | 0.9082 | 1.0491 | 0.1766 |
| Iridium | Molybdenum | Ruthenium | 26 | 58 | 16 | 0.9078 | 0.8956 | 1.0699 |
| Iridium | Rhodium | Ruthenium | 8 | 78 | 14 | 0.9074 | 0.9391 | 0.8162 |
| Iridium | Rhenium | None | 90 | 10 | 0 | 0.9063 | 1.0527 | −0.1406 |
| Iridium | Molybdenum | Ruthenium | 26 | 60 | 14 | 0.9060 | 0.9121 | 0.9654 |
| Iridium | Molybdenum | Ruthenium | 26 | 56 | 18 | 0.8992 | 0.8698 | 1.1715 |
| Iridium | Molybdenum | Ruthenium | 26 | 62 | 12 | 0.8973 | 0.9224 | 0.8528 |
| Iridium | Rhodium | Ruthenium | 14 | 74 | 12 | 0.8973 | 0.9291 | 0.8139 |
| Iridium | Ruthenium | Tungsten | 4 | 8 | 88 | 0.8961 | 0.8396 | 1.3325 |
| Iridium | Rhodium | None | 66 | 34 | 0 | 0.8953 | 0.9446 | 0.7293 |
| Iridium | Rhodium | Ruthenium | 6 | 80 | 14 | 0.8951 | 0.9089 | 0.9179 |
| Iridium | Manganese | Ruthenium | 84 | 12 | 4 | 0.8931 | 0.8408 | 1.3077 |
| Iridium | Manganese | None | 74 | 26 | 0 | 0.8915 | 0.8989 | 0.9511 |
| Iridium | Molybdenum | Ruthenium | 26 | 54 | 20 | 0.8896 | 0.8473 | 1.2496 |
| Iridium | Molybdenum | Ruthenium | 26 | 52 | 22 | 0.8885 | 0.8344 | 1.3200 |
| Iridium | Molybdenum | Ruthenium | 26 | 64 | 10 | 0.8882 | 0.9260 | 0.7771 |
| Iridium | Rhodium | Ruthenium | 32 | 64 | 4 | 0.8882 | 0.9703 | 0.5156 |
| Iridium | Molybdenum | Ruthenium | 76 | 18 | 6 | 0.8875 | 0.9008 | 0.9214 |
| Iridium | Rhodium | Ruthenium | 22 | 70 | 8 | 0.8872 | 0.9187 | 0.8139 |
| Iridium | Molybdenum | Ruthenium | 6 | 86 | 8 | 0.8868 | 0.8606 | 1.1548 |
| Iridium | Rhodium | Ruthenium | 18 | 72 | 10 | 0.8830 | 0.9120 | 0.8282 |
| Iridium | Molybdenum | Ruthenium | 26 | 66 | 8 | 0.8825 | 0.9317 | 0.7070 |
| Iridium | Rhodium | Ruthenium | 26 | 68 | 6 | 0.8800 | 0.9255 | 0.7289 |
| Iridium | Palladium | None | 86 | 14 | 0 | 0.8790 | 0.8516 | 1.0172 |
| Iridium | Iron | None | 68 | 32 | 0 | 0.8785 | 0.9836 | 0.2405 |
| Iridium | Molybdenum | None | 58 | 42 | 0 | 0.8781 | 0.8732 | 1.0295 |
| Iridium | Palladium | None | 84 | 16 | 0 | 0.8774 | 0.8485 | 0.9988 |
| Iridium | Palladium | None | 82 | 18 | 0 | 0.8750 | 0.8470 | 0.9824 |
| Iridium | Molybdenum | Ruthenium | 76 | 20 | 4 | 0.8745 | 0.9552 | 0.5153 |
| Iridium | Palladium | None | 88 | 12 | 0 | 0.8742 | 0.8532 | 1.0231 |
| Palladium | Ruthenium | None | 48 | 52 | 0 | 0.8713 | 0.8349 | 1.2195 |
| Iridium | Rhenium | Tungsten | 58 | 6 | 36 | 0.8696 | 0.9713 | 0.3727 |
| Iridium | Molybdenum | Ruthenium | 28 | 58 | 14 | 0.8686 | 0.8689 | 0.9979 |
| Iridium | Palladium | None | 80 | 20 | 0 | 0.8677 | 0.8423 | 0.9694 |
| Iridium | Rhodium | Ruthenium | 12 | 76 | 12 | 0.8673 | 0.8969 | 0.8217 |
| Iridium | Ruthenium | Tungsten | 16 | 78 | 6 | 0.8655 | 0.8180 | 1.2881 |
| Iridium | Molybdenum | Ruthenium | 28 | 56 | 16 | 0.8652 | 0.8448 | 1.1241 |
| Iridium | Molybdenum | Ruthenium | 28 | 64 | 8 | 0.8646 | 0.9100 | 0.7244 |
| Iridium | Rhodium | None | 64 | 36 | 0 | 0.8644 | 0.9005 | 0.7920 |
| Iridium | Molybdenum | Ruthenium | 28 | 60 | 12 | 0.8632 | 0.8820 | 0.8857 |
| Iridium | Rhodium | Ruthenium | 30 | 66 | 4 | 0.8630 | 0.9280 | 0.6051 |
| Iridium | Rhenium | None | 74 | 26 | 0 | 0.8606 | 0.9878 | 0.0793 |
| Iridium | Molybdenum | Ruthenium | 28 | 62 | 10 | 0.8597 | 0.8944 | 0.7883 |
| Iridium | Molybdenum | Ruthenium | 28 | 54 | 18 | 0.8576 | 0.8211 | 1.2234 |
| Iridium | Palladium | None | 90 | 10 | 0 | 0.8550 | 0.8543 | 0.9475 |
| Iridium | Palladium | None | 78 | 22 | 0 | 0.8545 | 0.8331 | 0.9514 |
| Iridium | Manganese | None | 58 | 42 | 0 | 0.8532 | 0.9128 | 0.4517 |
| Iridium | Rhenium | Tungsten | 52 | 10 | 38 | 0.8489 | 0.8176 | 1.1933 |
| Iridium | Molybdenum | Ruthenium | 28 | 52 | 20 | 0.8486 | 0.7969 | 1.3205 |
| Iridium | Molybdenum | None | 56 | 44 | 0 | 0.8475 | 0.8440 | 1.0219 |
| Iridium | Ruthenium | Tungsten | 14 | 78 | 8 | 0.8471 | 0.8039 | 1.2671 |
| Iridium | Rhodium | Ruthenium | 24 | 70 | 6 | 0.8466 | 0.8785 | 0.8024 |
| Iridium | Ruthenium | Tungsten | 14 | 80 | 6 | 0.8458 | 0.8265 | 1.1192 |
| Iridium | Rhodium | Ruthenium | 20 | 72 | 8 | 0.8451 | 0.8716 | 0.8353 |
| Iridium | Rhodium | Ruthenium | 10 | 78 | 12 | 0.8422 | 0.8697 | 0.8291 |
| Iridium | Manganese | None | 72 | 28 | 0 | 0.8396 | 0.8755 | 0.7650 |
| Iridium | Molybdenum | Ruthenium | 72 | 20 | 8 | 0.8384 | 0.7965 | 1.2638 |
| Iridium | Manganese | None | 56 | 44 | 0 | 0.8379 | 0.9033 | 0.4255 |
| Iridium | Rhodium | Ruthenium | 16 | 74 | 10 | 0.8372 | 0.8631 | 0.8379 |
| Iridium | Manganese | Ruthenium | 68 | 28 | 4 | 0.8345 | 0.9680 | 0.1564 |
| Iridium | Molybdenum | Ruthenium | 74 | 22 | 4 | 0.8343 | 0.9183 | 0.4715 |
| Iridium | Molybdenum | Ruthenium | 74 | 20 | 6 | 0.8328 | 0.8688 | 0.7724 |
| Iridium | Palladium | None | 76 | 24 | 0 | 0.8324 | 0.8236 | 0.8957 |
| Iridium | Rhodium | None | 62 | 38 | 0 | 0.8312 | 0.8603 | 0.8239 |
| Iridium | Manganese | Ruthenium | 82 | 14 | 4 | 0.8311 | 0.7955 | 1.2247 |
| Iridium | Rhodium | Ruthenium | 28 | 68 | 4 | 0.8275 | 0.8728 | 0.7134 |
| Palladium | Ruthenium | None | 50 | 50 | 0 | 0.8267 | 0.7810 | 1.2898 |
| Iridium | Molybdenum | Ruthenium | 30 | 58 | 12 | 0.8248 | 0.8340 | 0.9410 |
| Iridium | Molybdenum | Ruthenium | 30 | 56 | 14 | 0.8244 | 0.8117 | 1.0823 |
| Iridium | Molybdenum | Ruthenium | 30 | 60 | 10 | 0.8241 | 0.8514 | 0.8264 |
| Iridium | Molybdenum | Ruthenium | 30 | 62 | 8 | 0.8233 | 0.8662 | 0.7264 |
| Iridium | Ruthenium | Tungsten | 12 | 78 | 10 | 0.8227 | 0.7862 | 1.2328 |
| Iridium | Molybdenum | Ruthenium | 30 | 54 | 16 | 0.8225 | 0.7921 | 1.1940 |
| Iridium | Palladium | None | 92 | 8 | 0 | 0.8213 | 0.8667 | 0.7011 |
| Iridium | Iron | None | 66 | 34 | 0 | 0.8191 | 0.9204 | 0.2721 |
| Iridium | Rhodium | Ruthenium | 8 | 80 | 12 | 0.8164 | 0.8385 | 0.8581 |
| Iridium | Molybdenum | Ruthenium | 30 | 52 | 18 | 0.8161 | 0.7691 | 1.3029 |
| Iridium | Molybdenum | None | 54 | 46 | 0 | 0.8157 | 0.8157 | 0.9998 |
| Iridium | Manganese | None | 60 | 40 | 0 | 0.8125 | 0.8898 | 0.3932 |
| Iridium | Rhenium | None | 72 | 28 | 0 | 0.8119 | 0.9513 | −0.0539 |
| Iridium | Rhodium | Ruthenium | 22 | 72 | 6 | 0.8110 | 0.8359 | 0.8391 |
| Iridium | Palladium | None | 74 | 26 | 0 | 0.8105 | 0.8152 | 0.8307 |
| Iridium | Ruthenium | Tungsten | 8 | 24 | 68 | 0.8096 | 0.7623 | 1.2936 |
| Iridium | Rhodium | Ruthenium | 6 | 82 | 12 | 0.8088 | 0.8122 | 0.9710 |
| Iridium | Ruthenium | Tungsten | 12 | 80 | 8 | 0.8055 | 0.8089 | 0.9717 |
| Iridium | Manganese | None | 70 | 30 | 0 | 0.8051 | 0.8692 | 0.5722 |
| Iridium | Rhodium | Ruthenium | 18 | 74 | 8 | 0.8043 | 0.8276 | 0.8479 |
| Iridium | Rhodium | Ruthenium | 26 | 70 | 4 | 0.7997 | 0.8319 | 0.7889 |
| Iridium | Manganese | None | 54 | 46 | 0 | 0.7991 | 0.8819 | 0.3498 |
| Iridium | Rhodium | Ruthenium | 14 | 76 | 10 | 0.7985 | 0.8216 | 0.8482 |
| Iridium | Rhodium | None | 60 | 40 | 0 | 0.7975 | 0.8247 | 0.8265 |
| Iridium | Ruthenium | Tungsten | 10 | 78 | 12 | 0.7966 | 0.7640 | 1.2146 |
| Iridium | Molybdenum | Ruthenium | 32 | 60 | 8 | 0.7964 | 0.8274 | 0.7964 |
| Iridium | Rhodium | Ruthenium | 4 | 84 | 12 | 0.7936 | 0.7756 | 1.1073 |
| Iridium | Ruthenium | Tungsten | 8 | 26 | 66 | 0.7922 | 0.7542 | 1.2521 |
| Iridium | Palladium | None | 72 | 28 | 0 | 0.7895 | 0.8076 | 0.7614 |
| Iridium | Molybdenum | Ruthenium | 72 | 24 | 4 | 0.7893 | 0.8735 | 0.4403 |
| Iridium | Molybdenum | Ruthenium | 70 | 22 | 8 | 0.7882 | 0.7645 | 1.1570 |
| Iridium | Molybdenum | Ruthenium | 72 | 22 | 6 | 0.7868 | 0.8368 | 0.6665 |
| Iridium | Ruthenium | Tungsten | 8 | 28 | 64 | 0.7842 | 0.7484 | 1.2302 |
| Iridium | Molybdenum | None | 52 | 48 | 0 | 0.7815 | 0.7880 | 0.9557 |
| Iridium | Ruthenium | Tungsten | 8 | 30 | 62 | 0.7794 | 0.7398 | 1.2666 |
| Iridium | Molybdenum | Ruthenium | 32 | 58 | 10 | 0.7789 | 0.7878 | 0.9399 |
| Iridium | Ruthenium | Tungsten | 8 | 32 | 60 | 0.7788 | 0.7332 | 1.2997 |
| Iridium | Ruthenium | Tungsten | 6 | 20 | 74 | 0.7782 | 0.7315 | 1.3110 |
| Iridium | Molybdenum | Ruthenium | 32 | 52 | 16 | 0.7769 | 0.7314 | 1.3109 |
| Iridium | Ruthenium | Tungsten | 10 | 80 | 10 | 0.7768 | 0.7899 | 0.9087 |
| Iridium | Molybdenum | Ruthenium | 32 | 54 | 14 | 0.7767 | 0.7468 | 1.2014 |
| Iridium | Molybdenum | Ruthenium | 32 | 56 | 12 | 0.7754 | 0.7642 | 1.0794 |
| Iridium | Rhodium | Ruthenium | 20 | 74 | 6 | 0.7742 | 0.7963 | 0.8503 |
| Iridium | Rhenium | None | 70 | 30 | 0 | 0.7738 | 0.9193 | −0.1561 |
| Iridium | Palladium | None | 70 | 30 | 0 | 0.7727 | 0.8021 | 0.7032 |
| Iridium | Rhenium | Tungsten | 54 | 8 | 38 | 0.7726 | 0.8418 | 0.5243 |
| Iridium | Manganese | None | 68 | 32 | 0 | 0.7725 | 0.8586 | 0.4068 |
| Iridium | Iron | None | 64 | 36 | 0 | 0.7718 | 0.8574 | 0.3753 |
| Iridium | Rhodium | Ruthenium | 12 | 78 | 10 | 0.7717 | 0.7934 | 0.8521 |
| Iridium | Manganese | None | 62 | 38 | 0 | 0.7678 | 0.8672 | 0.2963 |
| Iridium | Rhodium | Ruthenium | 16 | 76 | 8 | 0.7665 | 0.7873 | 0.8579 |
| Iridium | Rhodium | None | 58 | 42 | 0 | 0.7661 | 0.7911 | 0.8335 |
| Iridium | Ruthenium | Tungsten | 10 | 82 | 8 | 0.7648 | 0.8135 | 0.6659 |
| Iridium | Manganese | Ruthenium | 80 | 16 | 4 | 0.7645 | 0.7429 | 1.1454 |
| Iridium | Rhodium | Ruthenium | 24 | 72 | 4 | 0.7630 | 0.7858 | 0.8433 |
| Iridium | Ruthenium | Tungsten | 4 | 20 | 76 | 0.7623 | 0.7172 | 1.3104 |
| Iridium | Ruthenium | Tungsten | 6 | 22 | 72 | 0.7594 | 0.7276 | 1.2192 |
| Iridium | Ruthenium | Tungsten | 8 | 78 | 14 | 0.7591 | 0.7302 | 1.1998 |
| Iridium | Palladium | None | 68 | 32 | 0 | 0.7590 | 0.7964 | 0.6608 |
| Iridium | Rhodium | Ruthenium | 10 | 80 | 10 | 0.7565 | 0.7740 | 0.8786 |

TABLE 15
High Overall Performance Data

| | | | Metal A | Metal B | Metal C | Relative | Relative | Relative |
|---|---|---|---|---|---|---|---|---|
| Metal A | Metal B | Metal C | Composition | Composition | Composition | BOL | EOL | Stability |
| Iridium | Rhodium | Ruthenium | 42 | 16 | 42 | 2.3706 | 2.3860 | 0.9596 |
| Iridium | Rhodium | Ruthenium | 42 | 18 | 40 | 2.3476 | 2.3756 | 0.9305 |
| Iridium | Rhodium | Ruthenium | 42 | 14 | 44 | 2.3374 | 2.3558 | 0.9529 |
| Iridium | Rhodium | Ruthenium | 42 | 20 | 38 | 2.2864 | 2.3346 | 0.8855 |
| Iridium | Rhodium | Ruthenium | 40 | 24 | 36 | 2.2161 | 2.2239 | 0.9712 |
| Iridium | Rhodium | Ruthenium | 42 | 22 | 36 | 2.1822 | 2.2595 | 0.8075 |
| Iridium | Rhodium | Ruthenium | 44 | 16 | 40 | 2.1723 | 2.3422 | 0.5661 |
| Iridium | Rhenium | Ruthenium | 78 | 16 | 6 | 2.1324 | 2.1353 | 0.9917 |
| Iridium | Rhodium | Ruthenium | 44 | 18 | 38 | 2.1283 | 2.3164 | 0.5361 |
| Iridium | Rhodium | Ruthenium | 36 | 28 | 36 | 2.0932 | 2.1060 | 0.9643 |
| Iridium | Rhodium | Ruthenium | 44 | 20 | 36 | 2.0889 | 2.2728 | 0.5209 |
| Iridium | Rhenium | Tungsten | 86 | 6 | 8 | 2.0517 | 2.1710 | 0.6948 |
| Iridium | Rhenium | Tungsten | 84 | 6 | 10 | 2.0481 | 2.1946 | 0.6247 |
| Iridium | Rhenium | Tungsten | 78 | 6 | 16 | 2.0456 | 2.0979 | 0.8639 |
| Iridium | Rhenium | Ruthenium | 76 | 18 | 6 | 2.0123 | 2.0624 | 0.8695 |
| Iridium | Rhodium | Ruthenium | 34 | 30 | 36 | 2.0043 | 2.0464 | 0.8863 |
| Iridium | Rhenium | Ruthenium | 82 | 14 | 4 | 2.0035 | 2.0284 | 0.9316 |
| Iridium | Rhodium | Ruthenium | 42 | 24 | 34 | 1.9967 | 2.1482 | 0.6018 |
| Iridium | Rhodium | Ruthenium | 46 | 14 | 40 | 1.9965 | 2.3121 | 0.1666 |
| Iridium | Rhodium | Ruthenium | 46 | 16 | 38 | 1.9956 | 2.3008 | 0.1938 |
| Iridium | Rhenium | Tungsten | 82 | 6 | 12 | 1.9781 | 2.1481 | 0.5480 |
| Iridium | Rhodium | Ruthenium | 40 | 26 | 34 | 1.9754 | 2.0937 | 0.6859 |
| Iridium | Rhodium | Ruthenium | 44 | 22 | 34 | 1.9750 | 2.1906 | 0.4269 |
| Iridium | Rhodium | Ruthenium | 46 | 18 | 36 | 1.9743 | 2.2761 | 0.1944 |
| Iridium | Rhenium | Tungsten | 80 | 6 | 14 | 1.9556 | 2.1173 | 0.5661 |
| Iridium | Rhenium | Ruthenium | 72 | 20 | 8 | 1.9410 | 1.9659 | 0.9320 |
| Iridium | Rhodium | Ruthenium | 32 | 32 | 36 | 1.9406 | 2.0045 | 0.8246 |
| Iridium | Rhodium | Ruthenium | 28 | 36 | 36 | 1.9241 | 1.9596 | 0.8987 |
| Iridium | Rhenium | Tungsten | 80 | 4 | 16 | 1.9218 | 2.0562 | 0.6148 |
| Iridium | Rhodium | Ruthenium | 46 | 20 | 34 | 1.9190 | 2.2184 | 0.1799 |
| Iridium | Rhodium | Ruthenium | 30 | 34 | 36 | 1.9146 | 1.9791 | 0.8206 |
| Iridium | Rhodium | Ruthenium | 38 | 28 | 34 | 1.9126 | 2.0322 | 0.6716 |
| Iridium | Rhodium | Ruthenium | 48 | 12 | 40 | 1.9120 | 2.3067 | −0.0841 |
| Iridium | Rhenium | Ruthenium | 80 | 16 | 4 | 1.9109 | 1.9891 | 0.7832 |
| Iridium | Rhodium | Ruthenium | 48 | 16 | 36 | 1.9030 | 2.2823 | −0.0524 |
| Iridium | Rhenium | Ruthenium | 74 | 20 | 6 | 1.8970 | 1.9815 | 0.7652 |
| Iridium | Rhodium | Ruthenium | 48 | 14 | 38 | 1.8935 | 2.2982 | −0.1219 |
| Iridium | Rhenium | Tungsten | 80 | 2 | 18 | 1.8709 | 1.9668 | 0.7309 |
| Iridium | Rhenium | Tungsten | 86 | 4 | 10 | 1.8681 | 2.1080 | 0.3199 |
| Iridium | Rhodium | Ruthenium | 48 | 18 | 34 | 1.8665 | 2.2467 | −0.0691 |
| Iridium | Rhodium | Ruthenium | 26 | 40 | 34 | 1.8637 | 1.8859 | 0.9373 |
| Iridium | Rhodium | Ruthenium | 50 | 12 | 38 | 1.8562 | 2.3026 | −0.2620 |
| Iridium | Rhodium | Ruthenium | 36 | 30 | 34 | 1.8462 | 1.9769 | 0.6285 |
| Iridium | Rhodium | Ruthenium | 50 | 14 | 36 | 1.8403 | 2.2855 | −0.2703 |
| Iridium | Rhodium | Ruthenium | 44 | 24 | 32 | 1.8368 | 2.0876 | 0.2778 |
| Iridium | Rhodium | Ruthenium | 28 | 38 | 34 | 1.8352 | 1.9031 | 0.8057 |
| Iridium | Rhodium | Ruthenium | 46 | 22 | 32 | 1.8345 | 2.1376 | 0.1302 |
| Iridium | Rhenium | Tungsten | 82 | 4 | 14 | 1.8335 | 2.0740 | 0.3055 |
| Iridium | Rhodium | Ruthenium | 50 | 16 | 34 | 1.8284 | 2.2613 | −0.2430 |
| Iridium | Rhodium | Ruthenium | 22 | 46 | 32 | 1.8176 | 1.8247 | 0.9790 |
| Iridium | Rhodium | Ruthenium | 48 | 20 | 32 | 1.8174 | 2.1751 | −0.0372 |
| Iridium | Rhodium | Ruthenium | 52 | 12 | 36 | 1.8155 | 2.2853 | −0.3589 |
| Iridium | Rhodium | Ruthenium | 24 | 44 | 32 | 1.8145 | 1.8377 | 0.9314 |
| Iridium | Rhenium | Ruthenium | 78 | 18 | 4 | 1.8138 | 1.9309 | 0.6585 |
| Iridium | Rhodium | Ruthenium | 16 | 50 | 34 | 1.8122 | 1.8128 | 0.9981 |
| Iridium | Rhodium | Ruthenium | 42 | 26 | 32 | 1.8086 | 2.0259 | 0.3657 |
| Iridium | Rhodium | Ruthenium | 30 | 36 | 34 | 1.8049 | 1.9156 | 0.6777 |
| Iridium | Rhodium | Ruthenium | 34 | 32 | 34 | 1.8027 | 1.9433 | 0.5905 |
| Iridium | Rhenium | Ruthenium | 70 | 22 | 8 | 1.8015 | 1.8550 | 0.8426 |
| Iridium | Rhodium | Ruthenium | 26 | 42 | 32 | 1.8005 | 1.8485 | 0.8585 |
| Iridium | Rhodium | Ruthenium | 52 | 14 | 34 | 1.8000 | 2.2656 | −0.3575 |
| Iridium | Rhodium | Ruthenium | 20 | 48 | 32 | 1.7999 | 1.8081 | 0.9760 |
| Iridium | Rhenium | Ruthenium | 84 | 14 | 2 | 1.7953 | 1.9024 | 0.6869 |
| Iridium | Rhodium | Ruthenium | 50 | 18 | 32 | 1.7939 | 2.2106 | −0.2198 |
| Iridium | Rhenium | Tungsten | 84 | 4 | 12 | 1.7895 | 2.0695 | 0.1635 |
| Iridium | Rhodium | Ruthenium | 32 | 34 | 34 | 1.7870 | 1.9250 | 0.5945 |
| Iridium | Rhodium | Ruthenium | 14 | 52 | 34 | 1.7821 | 1.7923 | 0.9698 |
| Iridium | Rhenium | Tungsten | 82 | 2 | 16 | 1.7816 | 2.0486 | 0.2092 |
| Iridium | Rhenium | Ruthenium | 86 | 12 | 2 | 1.7808 | 1.8730 | 0.7283 |
| Iridium | Rhodium | Ruthenium | 52 | 16 | 32 | 1.7804 | 2.2278 | −0.3200 |
| Iridium | Rhodium | Ruthenium | 54 | 12 | 34 | 1.7794 | 2.2605 | −0.4189 |
| Iridium | Rhodium | Ruthenium | 54 | 10 | 36 | 1.7786 | 2.2651 | −0.4354 |
| Iridium | Rhodium | Ruthenium | 18 | 50 | 32 | 1.7778 | 1.7861 | 0.9753 |
| Iridium | Rhodium | Ruthenium | 24 | 46 | 30 | 1.7725 | 1.8194 | 0.8609 |
| Iridium | Rhodium | Ruthenium | 22 | 48 | 30 | 1.7689 | 1.8071 | 0.8866 |
| Iridium | Rhenium | Ruthenium | 72 | 22 | 6 | 1.7664 | 1.8771 | 0.6713 |
| Palladium | Ruthenium | None | 28 | 72 | 0 | 1.7586 | 1.7738 | 0.9543 |
| Iridium | Rhodium | Ruthenium | 54 | 14 | 32 | 1.7584 | 2.2281 | −0.4019 |
| Iridium | Rhodium | Ruthenium | 28 | 40 | 32 | 1.7583 | 1.8467 | 0.7309 |
| Iridium | Rhodium | Ruthenium | 40 | 28 | 32 | 1.7566 | 1.9613 | 0.3851 |
| Iridium | Rhodium | Ruthenium | 12 | 52 | 36 | 1.7561 | 1.7614 | 0.9840 |
| Iridium | Rhodium | Ruthenium | 20 | 50 | 30 | 1.7545 | 1.7847 | 0.9097 |
| Iridium | Rhodium | Ruthenium | 56 | 10 | 34 | 1.7535 | 2.2415 | −0.4607 |
| Iridium | Rhodium | Ruthenium | 16 | 52 | 32 | 1.7527 | 1.7679 | 0.9545 |
| Iridium | Rhodium | Ruthenium | 26 | 44 | 30 | 1.7481 | 1.8202 | 0.7832 |
| Iridium | Rhenium | Ruthenium | 82 | 16 | 2 | 1.7458 | 1.8842 | 0.5827 |
| Iridium | Rhodium | Ruthenium | 56 | 12 | 32 | 1.7397 | 2.2175 | −0.4416 |
| Iridium | Rhodium | Ruthenium | 12 | 54 | 34 | 1.7364 | 1.7510 | 0.9559 |
| Iridium | Rhodium | Ruthenium | 52 | 18 | 30 | 1.7308 | 2.1635 | −0.3124 |
| Iridium | Rhodium | Ruthenium | 22 | 50 | 28 | 1.7302 | 1.8024 | 0.7805 |
| Iridium | Rhodium | Ruthenium | 54 | 16 | 30 | 1.7300 | 2.1857 | −0.3826 |
| Iridium | Rhodium | Ruthenium | 14 | 54 | 32 | 1.7268 | 1.7457 | 0.9426 |
| Iridium | Rhodium | Ruthenium | 50 | 20 | 30 | 1.7266 | 2.1213 | −0.1997 |
| Iridium | Rhodium | Ruthenium | 48 | 22 | 30 | 1.7251 | 2.0774 | −0.0717 |
| Iridium | Rhodium | Ruthenium | 18 | 52 | 30 | 1.7234 | 1.7473 | 0.9272 |
| Iridium | Rhodium | Ruthenium | 24 | 48 | 28 | 1.7216 | 1.8006 | 0.7580 |
| Iridium | Rhodium | Ruthenium | 30 | 38 | 32 | 1.7188 | 1.8545 | 0.5830 |
| Iridium | Rhodium | Ruthenium | 56 | 14 | 30 | 1.7166 | 2.1836 | −0.4278 |
| Iridium | Rhenium | Ruthenium | 76 | 20 | 4 | 1.7161 | 1.8641 | 0.5451 |
| Iridium | Rhodium | Ruthenium | 80 | 4 | 16 | 1.7151 | 2.0390 | 0.0086 |
| Iridium | Rhodium | Ruthenium | 76 | 4 | 20 | 1.7131 | 2.0601 | −0.0632 |
| Iridium | Rhodium | Ruthenium | 58 | 10 | 32 | 1.7121 | 2.1959 | −0.4831 |
| Iridium | Rhodium | Ruthenium | 78 | 4 | 18 | 1.7113 | 2.0405 | −0.0096 |
| Iridium | Rhodium | Ruthenium | 78 | 6 | 16 | 1.7109 | 2.0476 | −0.0327 |
| Iridium | Rhodium | Ruthenium | 46 | 24 | 30 | 1.7084 | 2.0217 | 0.0379 |
| Iridium | Rhodium | Ruthenium | 76 | 6 | 18 | 1.7082 | 2.0535 | −0.0608 |
| Iridium | Rhodium | Ruthenium | 74 | 4 | 22 | 1.7081 | 2.0657 | −0.0987 |
| Iridium | Rhodium | Ruthenium | 28 | 42 | 30 | 1.7074 | 1.8119 | 0.6788 |
| Iridium | Rhodium | Ruthenium | 74 | 6 | 20 | 1.7062 | 2.0646 | −0.1023 |
| Iridium | Rhodium | Ruthenium | 80 | 6 | 14 | 1.7058 | 2.0326 | −0.0052 |
| Iridium | Rhodium | Ruthenium | 20 | 52 | 28 | 1.7054 | 1.7627 | 0.8238 |
| Iridium | Rhodium | Ruthenium | 38 | 30 | 32 | 1.7045 | 1.9060 | 0.3767 |
| Iridium | Rhodium | Ruthenium | 26 | 46 | 28 | 1.7032 | 1.7961 | 0.7124 |
| Iridium | Rhodium | Ruthenium | 72 | 6 | 22 | 1.7013 | 2.0717 | −0.1424 |
| Iridium | Rhodium | Ruthenium | 58 | 12 | 30 | 1.7007 | 2.1711 | −0.4517 |
| Iridium | Rhodium | Ruthenium | 82 | 6 | 12 | 1.6997 | 2.0201 | 0.0106 |
| Iridium | Rhodium | Ruthenium | 76 | 8 | 16 | 1.6990 | 2.0633 | −0.1255 |
| Iridium | Rhodium | Ruthenium | 74 | 8 | 18 | 1.6987 | 2.0701 | −0.1475 |
| Iridium | Rhenium | Ruthenium | 68 | 24 | 8 | 1.6980 | 1.7420 | 0.8637 |
| Iridium | Rhodium | Ruthenium | 78 | 8 | 14 | 1.6980 | 2.0543 | −0.1014 |
| Iridium | Rhodium | Ruthenium | 16 | 54 | 30 | 1.6956 | 1.7202 | 0.9238 |
| Iridium | Rhodium | Ruthenium | 72 | 8 | 20 | 1.6948 | 2.0768 | −0.1830 |
| Iridium | Rhodium | Ruthenium | 72 | 4 | 24 | 1.6947 | 2.0608 | −0.1340 |
| Iridium | Rhodium | Ruthenium | 24 | 50 | 26 | 1.6936 | 1.8023 | 0.6633 |
| Iridium | Rhodium | Ruthenium | 80 | 8 | 12 | 1.6907 | 2.0343 | −0.0665 |
| Iridium | Rhodium | Ruthenium | 60 | 8 | 32 | 1.6906 | 2.1742 | −0.5012 |
| Iridium | Rhodium | Ruthenium | 56 | 16 | 28 | 1.6873 | 2.1369 | −0.3986 |
| Iridium | Rhodium | Ruthenium | 76 | 10 | 14 | 1.6861 | 2.0623 | −0.1709 |
| Iridium | Rhodium | Ruthenium | 32 | 36 | 32 | 1.6848 | 1.8572 | 0.4578 |
| Iridium | Rhodium | Ruthenium | 22 | 52 | 26 | 1.6844 | 1.7846 | 0.6877 |
| Iridium | Rhodium | Ruthenium | 74 | 10 | 16 | 1.6839 | 2.0680 | −0.1973 |
| Iridium | Rhodium | Ruthenium | 82 | 8 | 10 | 1.6837 | 2.0191 | −0.0454 |
| Iridium | Rhodium | Ruthenium | 78 | 10 | 12 | 1.6829 | 2.0471 | −0.1358 |
| Iridium | Rhodium | Ruthenium | 72 | 10 | 18 | 1.6827 | 2.0715 | −0.2127 |
| Iridium | Rhenium | Tungsten | 84 | 2 | 14 | 1.6827 | 2.0593 | −0.1746 |
| Iridium | Rhodium | Ruthenium | 58 | 14 | 28 | 1.6826 | 2.1416 | −0.4317 |
| Iridium | Rhodium | Ruthenium | 70 | 8 | 22 | 1.6813 | 2.0744 | −0.2271 |
| Iridium | Rhodium | Ruthenium | 70 | 10 | 20 | 1.6787 | 2.0781 | −0.2490 |
| Iridium | Rhodium | Ruthenium | 80 | 10 | 10 | 1.6779 | 2.0356 | −0.1188 |
| Iridium | Rhodium | Ruthenium | 84 | 8 | 8 | 1.6770 | 2.0222 | −0.0804 |
| Iridium | Rhodium | Ruthenium | 60 | 10 | 30 | 1.6767 | 2.1476 | −0.4739 |
| Iridium | Rhodium | Ruthenium | 54 | 18 | 28 | 1.6754 | 2.1069 | −0.3515 |
| Iridium | Rhodium | Ruthenium | 44 | 26 | 30 | 1.6751 | 1.9554 | 0.1219 |
| Iridium | Rhodium | Ruthenium | 60 | 12 | 28 | 1.6736 | 2.1303 | −0.4321 |
| Iridium | Rhodium | Ruthenium | 70 | 12 | 18 | 1.6735 | 2.0878 | −0.2994 |
| Iridium | Rhodium | Ruthenium | 12 | 56 | 32 | 1.6729 | 1.6917 | 0.9412 |
| Iridium | Rhodium | Ruthenium | 10 | 54 | 36 | 1.6727 | 1.6818 | 0.9717 |
| Iridium | Rhodium | Ruthenium | 68 | 12 | 20 | 1.6727 | 2.0899 | −0.3093 |
| Iridium | Rhodium | Ruthenium | 14 | 56 | 30 | 1.6726 | 1.6964 | 0.9254 |
| Iridium | Rhodium | Ruthenium | 36 | 32 | 32 | 1.6723 | 1.8752 | 0.3602 |
| Iridium | Rhodium | Ruthenium | 18 | 54 | 28 | 1.6719 | 1.7121 | 0.8736 |
| Iridium | Rhodium | Ruthenium | 68 | 8 | 24 | 1.6705 | 2.0778 | −0.2798 |
| Iridium | Rhodium | Ruthenium | 70 | 6 | 24 | 1.6694 | 2.0526 | −0.2051 |
| Iridium | Rhodium | Ruthenium | 68 | 10 | 22 | 1.6692 | 2.0798 | −0.2910 |
| Iridium | Rhodium | Ruthenium | 72 | 12 | 16 | 1.6673 | 2.0748 | −0.2830 |
| Iridium | Rhodium | Ruthenium | 74 | 12 | 14 | 1.6667 | 2.0653 | −0.2555 |
| Iridium | Rhodium | Ruthenium | 66 | 10 | 24 | 1.6646 | 2.0888 | −0.3376 |
| Iridium | Rhodium | Ruthenium | 66 | 12 | 22 | 1.6645 | 2.0881 | −0.3355 |
| Iridium | Rhodium | Ruthenium | 82 | 10 | 8 | 1.6642 | 2.0300 | −0.1538 |
| Iridium | Rhodium | Ruthenium | 76 | 12 | 12 | 1.6638 | 2.0465 | −0.2075 |
| Iridium | Rhodium | Ruthenium | 34 | 34 | 32 | 1.6629 | 1.8608 | 0.3731 |
| Iridium | Rhodium | Ruthenium | 78 | 12 | 10 | 1.6618 | 2.0387 | −0.1907 |
| Iridium | Rhodium | Ruthenium | 26 | 48 | 26 | 1.6606 | 1.7788 | 0.6261 |
| Iridium | Rhodium | Ruthenium | 66 | 8 | 26 | 1.6606 | 2.0872 | −0.3482 |
| Iridium | Rhodium | Ruthenium | 62 | 10 | 28 | 1.6605 | 2.1143 | −0.4342 |
| Iridium | Rhodium | Ruthenium | 52 | 20 | 28 | 1.6595 | 2.0598 | −0.2665 |
| Iridium | Rhodium | Ruthenium | 64 | 12 | 24 | 1.6586 | 2.0912 | −0.3689 |
| Iridium | Rhodium | Ruthenium | 64 | 10 | 26 | 1.6584 | 2.0959 | −0.3847 |
| Iridium | Rhodium | Ruthenium | 60 | 14 | 26 | 1.6582 | 2.1058 | −0.4166 |
| Iridium | Rhodium | Ruthenium | 20 | 54 | 26 | 1.6576 | 1.7332 | 0.7608 |
| Iridium | Rhodium | Ruthenium | 62 | 12 | 26 | 1.6560 | 2.1000 | −0.4073 |
| Iridium | Rhenium | Ruthenium | 80 | 18 | 2 | 1.6558 | 1.8345 | 0.4337 |
| Iridium | Rhodium | Ruthenium | 64 | 8 | 28 | 1.6551 | 2.1018 | −0.4166 |
| Iridium | Rhodium | Ruthenium | 62 | 8 | 30 | 1.6540 | 2.1231 | −0.4888 |
| Iridium | Rhodium | Ruthenium | 30 | 40 | 30 | 1.6508 | 1.7965 | 0.5358 |
| Iridium | Rhodium | Ruthenium | 28 | 44 | 28 | 1.6498 | 1.7653 | 0.6282 |
| Iridium | Rhodium | Ruthenium | 10 | 56 | 34 | 1.6497 | 1.6642 | 0.9537 |
| Iridium | Rhodium | Ruthenium | 68 | 6 | 26 | 1.6488 | 2.0520 | −0.2834 |
| Iridium | Rhodium | Ruthenium | 58 | 16 | 26 | 1.6487 | 2.0880 | −0.3980 |
| Iridium | Rhodium | Ruthenium | 86 | 8 | 6 | 1.6477 | 2.0034 | −0.1332 |
| Iridium | Rhodium | Ruthenium | 12 | 58 | 30 | 1.6458 | 1.6667 | 0.9334 |
| Iridium | Rhodium | Ruthenium | 62 | 14 | 24 | 1.6447 | 2.0782 | −0.3832 |
| Iridium | Rhodium | Ruthenium | 16 | 56 | 28 | 1.6428 | 1.6792 | 0.8836 |
| Iridium | Rhodium | Ruthenium | 80 | 12 | 8 | 1.6426 | 2.0283 | −0.2322 |
| Iridium | Rhenium | Ruthenium | 70 | 24 | 6 | 1.6410 | 1.7559 | 0.6324 |
| Iridium | Rhodium | Ruthenium | 50 | 22 | 28 | 1.6390 | 2.0091 | −0.1859 |
| Iridium | Rhodium | Ruthenium | 84 | 10 | 6 | 1.6361 | 2.0065 | −0.1883 |
| Iridium | Rhodium | Ruthenium | 64 | 14 | 22 | 1.6351 | 2.0549 | −0.3475 |
| Iridium | Rhodium | Ruthenium | 76 | 14 | 10 | 1.6341 | 2.0270 | −0.2616 |
| Iridium | Rhodium | Ruthenium | 74 | 14 | 12 | 1.6337 | 2.0270 | −0.2635 |
| Iridium | Rhenium | Tungsten | 86 | 2 | 12 | 1.6313 | 2.0424 | −0.3226 |
| Iridium | Rhodium | Ruthenium | 56 | 18 | 26 | 1.6279 | 2.0505 | −0.3622 |
| Iridium | Rhodium | Ruthenium | 66 | 14 | 20 | 1.6269 | 2.0384 | −0.3274 |
| Iridium | Rhodium | Ruthenium | 72 | 14 | 14 | 1.6268 | 2.0290 | −0.2976 |
| Iridium | Rhodium | Ruthenium | 42 | 28 | 30 | 1.6267 | 1.8883 | 0.1561 |
| Iridium | Rhodium | Ruthenium | 60 | 16 | 24 | 1.6245 | 2.0482 | −0.3688 |
| Iridium | Rhodium | Ruthenium | 22 | 54 | 24 | 1.6230 | 1.7369 | 0.6313 |
| Iridium | Rhodium | Ruthenium | 24 | 52 | 24 | 1.6220 | 1.7496 | 0.5859 |
| Iridium | Rhodium | Ruthenium | 68 | 14 | 18 | 1.6218 | 2.0307 | −0.3232 |
| Iridium | Rhodium | Ruthenium | 70 | 14 | 16 | 1.6210 | 2.0285 | −0.3192 |
| Iridium | Rhodium | Ruthenium | 78 | 14 | 8 | 1.6210 | 2.0274 | −0.3159 |
| Iridium | Rhodium | Ruthenium | 10 | 58 | 32 | 1.6195 | 1.6373 | 0.9423 |
| Iridium | Rhodium | Ruthenium | 18 | 56 | 26 | 1.6177 | 1.6746 | 0.8155 |
| Iridium | Rhenium | Ruthenium | 74 | 22 | 4 | 1.6152 | 1.7911 | 0.4255 |
| Iridium | Rhodium | Ruthenium | 82 | 12 | 6 | 1.6140 | 2.0036 | −0.2671 |
| Iridium | Rhodium | Ruthenium | 14 | 58 | 28 | 1.6126 | 1.6435 | 0.8995 |
| Iridium | Rhodium | Ruthenium | 48 | 24 | 28 | 1.6124 | 1.9490 | −0.0967 |
| Iridium | Rhodium | Ruthenium | 28 | 46 | 26 | 1.6117 | 1.7476 | 0.5571 |
| Iridium | Rhenium | Ruthenium | 66 | 26 | 8 | 1.6082 | 1.6285 | 0.9307 |
| Iridium | Rhodium | Ruthenium | 26 | 50 | 24 | 1.6060 | 1.7410 | 0.5578 |
| Iridium | Rhodium | Ruthenium | 8 | 54 | 38 | 1.6060 | 1.6078 | 0.9941 |
| Iridium | Rhodium | Ruthenium | 62 | 16 | 22 | 1.6037 | 2.0141 | −0.3429 |
| Iridium | Rhodium | Ruthenium | 32 | 38 | 30 | 1.6036 | 1.7940 | 0.3767 |
| Palladium | Ruthenium | None | 30 | 70 | 0 | 1.6031 | 1.6238 | 0.9322 |
| Iridium | Rhodium | Ruthenium | 72 | 16 | 12 | 1.6014 | 1.9853 | −0.2583 |
| Iridium | Rhodium | Ruthenium | 74 | 16 | 10 | 1.6010 | 1.9840 | −0.2554 |
| Iridium | Rhodium | Ruthenium | 54 | 20 | 26 | 1.5980 | 1.9972 | −0.3108 |
| Iridium | Rhodium | Ruthenium | 70 | 16 | 14 | 1.5952 | 1.9871 | −0.2894 |
| Iridium | Rhodium | Ruthenium | 80 | 14 | 6 | 1.5933 | 2.0004 | −0.3410 |
| Iridium | Rhodium | Ruthenium | 30 | 42 | 28 | 1.5933 | 1.7376 | 0.5228 |
| Iridium | Rhodium | Ruthenium | 58 | 18 | 24 | 1.5932 | 2.0023 | −0.3474 |
| Iridium | Rhodium | Ruthenium | 20 | 56 | 24 | 1.5914 | 1.6813 | 0.7037 |
| Iridium | Rhodium | Ruthenium | 64 | 16 | 20 | 1.5908 | 1.9936 | −0.3288 |
| Iridium | Rhodium | Ruthenium | 76 | 16 | 8 | 1.5895 | 1.9909 | −0.3254 |
| Iridium | Rhodium | Ruthenium | 8 | 56 | 36 | 1.5870 | 1.5958 | 0.9710 |
| Iridium | Rhodium | Ruthenium | 68 | 16 | 16 | 1.5862 | 1.9827 | −0.3117 |
| Iridium | Rhodium | Ruthenium | 10 | 60 | 30 | 1.5853 | 1.6054 | 0.9333 |
| Iridium | Rhodium | Ruthenium | 66 | 16 | 18 | 1.5835 | 1.9826 | −0.3226 |
| Iridium | Rhodium | Ruthenium | 8 | 58 | 34 | 1.5829 | 1.5964 | 0.9552 |
| Iridium | Rhodium | Ruthenium | 40 | 30 | 30 | 1.5813 | 1.8333 | 0.1638 |
| Iridium | Rhodium | Ruthenium | 16 | 58 | 26 | 1.5771 | 1.6233 | 0.8462 |
| Iridium | Rhodium | Ruthenium | 78 | 16 | 6 | 1.5740 | 1.9901 | −0.3876 |
| Iridium | Rhodium | Ruthenium | 12 | 60 | 28 | 1.5733 | 1.6007 | 0.9087 |
| Iridium | Rhodium | Ruthenium | 72 | 18 | 10 | 1.5728 | 1.9384 | −0.2199 |
| Iridium | Rhodium | Ruthenium | 70 | 18 | 12 | 1.5724 | 1.9416 | −0.2322 |
| Iridium | Rhodium | Ruthenium | 46 | 26 | 28 | 1.5722 | 1.8798 | −0.0281 |
| Iridium | Rhodium | Ruthenium | 34 | 36 | 30 | 1.5700 | 1.7919 | 0.2581 |
| Iridium | Rhodium | Ruthenium | 24 | 54 | 22 | 1.5680 | 1.7051 | 0.5412 |
| Iridium | Rhodium | Ruthenium | 52 | 22 | 26 | 1.5667 | 1.9411 | −0.2540 |
| Iridium | Rhodium | Ruthenium | 60 | 18 | 22 | 1.5663 | 1.9633 | −0.3301 |
| Iridium | Rhodium | Ruthenium | 68 | 18 | 14 | 1.5649 | 1.9430 | −0.2679 |
| Iridium | Rhodium | Ruthenium | 74 | 18 | 8 | 1.5639 | 1.9497 | −0.2947 |
| Iridium | Rhodium | Ruthenium | 8 | 60 | 32 | 1.5602 | 1.5770 | 0.9435 |
| Iridium | Rhodium | Ruthenium | 22 | 56 | 22 | 1.5574 | 1.6737 | 0.6082 |
| Iridium | Rhodium | Ruthenium | 38 | 32 | 30 | 1.5558 | 1.8035 | 0.1645 |
| Iridium | Rhodium | Ruthenium | 56 | 20 | 24 | 1.5553 | 1.9442 | −0.3122 |
| Iridium | Rhodium | Ruthenium | 66 | 18 | 16 | 1.5522 | 1.9339 | −0.2906 |
| Iridium | Rhodium | Ruthenium | 18 | 58 | 24 | 1.5520 | 1.6213 | 0.7652 |
| Iridium | Rhodium | Ruthenium | 28 | 48 | 24 | 1.5507 | 1.6960 | 0.5048 |
| Iridium | Rhodium | Ruthenium | 62 | 18 | 20 | 1.5506 | 1.9403 | −0.3191 |
| Iridium | Rhodium | Ruthenium | 76 | 18 | 6 | 1.5502 | 1.9550 | −0.3704 |
| Iridium | Rhodium | Ruthenium | 36 | 34 | 30 | 1.5493 | 1.7904 | 0.1833 |
| Iridium | Rhodium | Ruthenium | 86 | 10 | 4 | 1.5474 | 1.9176 | −0.2558 |
| Iridium | Rhodium | Ruthenium | 70 | 20 | 10 | 1.5463 | 1.8958 | −0.1861 |
| Iridium | Rhodium | Ruthenium | 14 | 60 | 26 | 1.5455 | 1.5839 | 0.8697 |
| Iridium | Rhodium | Ruthenium | 26 | 52 | 22 | 1.5452 | 1.6924 | 0.4999 |
| Iridium | Rhenium | Ruthenium | 68 | 26 | 6 | 1.5449 | 1.6443 | 0.6621 |
| Iridium | Rhodium | Ruthenium | 64 | 18 | 18 | 1.5445 | 1.9292 | −0.3075 |
| Iridium | Rhodium | Ruthenium | 68 | 20 | 12 | 1.5417 | 1.8968 | −0.2090 |
| Iridium | Rhodium | Ruthenium | 30 | 44 | 26 | 1.5403 | 1.6914 | 0.4842 |
| Iridium | Rhodium | Ruthenium | 32 | 40 | 28 | 1.5391 | 1.7242 | 0.3628 |
| Iridium | Rhodium | Ruthenium | 72 | 20 | 8 | 1.5375 | 1.9012 | −0.2416 |
| Iridium | Rhodium | Ruthenium | 8 | 62 | 30 | 1.5371 | 1.5571 | 0.9318 |
| Iridium | Ruthenium | Tungsten | 54 | 12 | 34 | 1.5367 | 1.5718 | 0.8790 |
| Iridium | Rhodium | Ruthenium | 10 | 62 | 28 | 1.5334 | 1.5583 | 0.9149 |
| Iridium | Rhodium | Ruthenium | 66 | 20 | 14 | 1.5315 | 1.8943 | −0.2435 |
| Iridium | Rhodium | Ruthenium | 50 | 24 | 26 | 1.5299 | 1.8767 | −0.1893 |
| Iridium | Ruthenium | Tungsten | 56 | 8 | 36 | 1.5289 | 1.5506 | 0.9202 |
| Iridium | Ruthenium | Tungsten | 54 | 10 | 36 | 1.5281 | 1.5805 | 0.8185 |
| Iridium | Rhodium | Ruthenium | 84 | 12 | 4 | 1.5280 | 1.9107 | −0.3148 |
| Iridium | Rhodium | Ruthenium | 20 | 58 | 22 | 1.5271 | 1.6213 | 0.6760 |
| Iridium | Rhodium | Ruthenium | 82 | 14 | 4 | 1.5259 | 1.9205 | −0.3576 |
| Iridium | Rhodium | Ruthenium | 44 | 28 | 28 | 1.5256 | 1.8125 | 0.0121 |
| Iridium | Rhodium | Ruthenium | 74 | 20 | 6 | 1.5236 | 1.9034 | −0.3078 |
| Iridium | Rhodium | Ruthenium | 58 | 20 | 22 | 1.5207 | 1.9002 | −0.3095 |
| Iridium | Rhodium | Ruthenium | 12 | 62 | 26 | 1.5204 | 1.5534 | 0.8861 |
| Iridium | Rhodium | Ruthenium | 68 | 22 | 10 | 1.5190 | 1.8565 | −0.1659 |
| Iridium | Rhodium | Ruthenium | 54 | 22 | 24 | 1.5143 | 1.8832 | −0.2783 |
| Iridium | Rhodium | Ruthenium | 64 | 20 | 16 | 1.5131 | 1.8767 | −0.2612 |
| Iridium | Rhodium | Ruthenium | 66 | 22 | 12 | 1.5119 | 1.8567 | −0.1970 |
| Iridium | Rhodium | Ruthenium | 16 | 60 | 24 | 1.5093 | 1.5673 | 0.7983 |
| Iridium | Rhodium | Ruthenium | 6 | 60 | 34 | 1.5088 | 1.5104 | 0.9962 |
| Iridium | Rhodium | Ruthenium | 60 | 20 | 20 | 1.5044 | 1.8768 | −0.2991 |
| Iridium | Rhodium | Ruthenium | 70 | 22 | 8 | 1.5037 | 1.8457 | −0.1936 |
| Iridium | Rhodium | Ruthenium | 80 | 16 | 4 | 1.5016 | 1.9036 | −0.4049 |
| Iridium | Rhodium | Ruthenium | 28 | 50 | 22 | 1.5007 | 1.6563 | 0.4557 |
| Iridium | Rhodium | Ruthenium | 62 | 20 | 18 | 1.5005 | 1.8667 | −0.2807 |
| Iridium | Rhodium | Ruthenium | 6 | 62 | 32 | 1.4989 | 1.5047 | 0.9810 |
| Iridium | Rhodium | Ruthenium | 64 | 22 | 14 | 1.4979 | 1.8489 | −0.2300 |
| Iridium | Rhenium | Ruthenium | 72 | 24 | 4 | 1.4969 | 1.6842 | 0.3415 |
| Iridium | Rhodium | Ruthenium | 34 | 38 | 28 | 1.4950 | 1.7195 | 0.2101 |
| Iridium | Rhodium | Ruthenium | 66 | 24 | 10 | 1.4945 | 1.8244 | −0.1586 |
| Iridium | Ruthenium | Tungsten | 52 | 12 | 36 | 1.4935 | 1.5777 | 0.7003 |
| Iridium | Ruthenium | Tungsten | 54 | 14 | 32 | 1.4920 | 1.5269 | 0.8769 |
| Iridium | Rhodium | Ruthenium | 24 | 56 | 20 | 1.4910 | 1.6180 | 0.5521 |
| Iridium | Ruthenium | Tungsten | 40 | 34 | 26 | 1.4902 | 1.4996 | 0.9670 |
| Iridium | Rhodium | Ruthenium | 22 | 58 | 20 | 1.4891 | 1.5977 | 0.6169 |
| Iridium | Rhodium | Ruthenium | 72 | 22 | 6 | 1.4884 | 1.8407 | −0.2421 |
| Iridium | Rhodium | Ruthenium | 30 | 46 | 24 | 1.4884 | 1.6462 | 0.4421 |
| Iridium | Rhodium | Ruthenium | 8 | 64 | 28 | 1.4880 | 1.5145 | 0.9065 |
| Iridium | Rhodium | Ruthenium | 48 | 26 | 26 | 1.4865 | 1.8056 | −0.1265 |
| Iridium | Rhenium | Ruthenium | 66 | 28 | 6 | 1.4865 | 1.5486 | 0.7815 |
| Iridium | Rhodium | Ruthenium | 64 | 24 | 12 | 1.4857 | 1.8271 | −0.2063 |
| Iridium | Rhodium | Ruthenium | 42 | 30 | 28 | 1.4844 | 1.7570 | 0.0351 |
| Iridium | Rhodium | Ruthenium | 26 | 54 | 20 | 1.4814 | 1.6264 | 0.4857 |
| Iridium | Ruthenium | Tungsten | 48 | 4 | 48 | 1.4798 | 1.5139 | 0.8766 |
| Iridium | Rhodium | Ruthenium | 6 | 64 | 30 | 1.4774 | 1.4894 | 0.9587 |
| Iridium | Rhodium | Ruthenium | 32 | 42 | 26 | 1.4765 | 1.6525 | 0.3747 |
| Iridium | Rhodium | Ruthenium | 18 | 60 | 22 | 1.4764 | 1.5538 | 0.7250 |
| Iridium | Rhodium | Ruthenium | 56 | 22 | 22 | 1.4761 | 1.8377 | −0.2857 |
| Iridium | Rhodium | Ruthenium | 68 | 24 | 8 | 1.4761 | 1.8021 | −0.1591 |
| Iridium | Rhodium | Ruthenium | 62 | 22 | 16 | 1.4757 | 1.8235 | −0.2368 |
| Iridium | Rhodium | Ruthenium | 4 | 64 | 32 | 1.4745 | 1.4774 | 0.9907 |
| Iridium | Rhodium | Ruthenium | 64 | 26 | 10 | 1.4734 | 1.7977 | −0.1553 |
| Iridium | Rhodium | Ruthenium | 10 | 64 | 26 | 1.4732 | 1.5054 | 0.8851 |
| Iridium | Rhodium | Ruthenium | 52 | 24 | 24 | 1.4725 | 1.8174 | −0.2293 |
| Iridium | Ruthenium | Tungsten | 38 | 32 | 30 | 1.4702 | 1.4891 | 0.9304 |
| Iridium | Rhodium | Ruthenium | 62 | 24 | 14 | 1.4700 | 1.8167 | −0.2377 |
| Iridium | Rhodium | Ruthenium | 36 | 36 | 28 | 1.4699 | 1.7147 | 0.1234 |
| Iridium | Rhodium | Ruthenium | 78 | 18 | 4 | 1.4699 | 1.8680 | −0.4219 |
| Iridium | Rhodium | Ruthenium | 14 | 62 | 24 | 1.4689 | 1.5166 | 0.8290 |
| Palladium | Ruthenium | None | 32 | 68 | 0 | 1.4674 | 1.4810 | 0.9517 |
| Iridium | Ruthenium | Tungsten | 52 | 10 | 38 | 1.4662 | 1.5786 | 0.5977 |
| Iridium | Rhodium | Ruthenium | 62 | 26 | 12 | 1.4647 | 1.8058 | −0.2224 |
| Iridium | Rhodium | Ruthenium | 84 | 14 | 2 | 1.4621 | 1.8534 | −0.4047 |
| Iridium | Rhodium | Ruthenium | 40 | 32 | 28 | 1.4620 | 1.7269 | 0.0482 |
| Iridium | Ruthenium | Tungsten | 46 | 4 | 50 | 1.4614 | 1.5296 | 0.7550 |
| Iridium | Ruthenium | Tungsten | 52 | 14 | 34 | 1.4597 | 1.5361 | 0.7252 |
| Iridium | Ruthenium | Tungsten | 56 | 16 | 28 | 1.4593 | 1.4707 | 0.9536 |
| Iridium | Rhodium | Ruthenium | 86 | 12 | 2 | 1.4591 | 1.8444 | −0.3861 |
| Iridium | Rhodium | Ruthenium | 58 | 22 | 20 | 1.4590 | 1.8134 | −0.2748 |
| Iridium | Rhodium | Ruthenium | 60 | 22 | 18 | 1.4578 | 1.8054 | −0.2515 |
| Iridium | Ruthenium | Tungsten | 42 | 34 | 24 | 1.4550 | 1.4668 | 0.9575 |
| Iridium | Rhodium | Ruthenium | 70 | 24 | 6 | 1.4546 | 1.7801 | −0.1742 |
| Iridium | Rhodium | Ruthenium | 38 | 34 | 28 | 1.4539 | 1.7127 | 0.0647 |
| Iridium | Rhodium | Ruthenium | 62 | 28 | 10 | 1.4538 | 1.7703 | −0.1425 |
| Iridium | Ruthenium | Tungsten | 50 | 12 | 38 | 1.4515 | 1.5868 | 0.5102 |
| Iridium | Ruthenium | Tungsten | 44 | 4 | 52 | 1.4494 | 1.5374 | 0.6812 |
| Iridium | Rhodium | Ruthenium | 66 | 26 | 8 | 1.4489 | 1.7574 | −0.1171 |
| Iridium | Rhodium | Ruthenium | 20 | 60 | 20 | 1.4482 | 1.5404 | 0.6662 |
| Iridium | Rhodium | Ruthenium | 60 | 26 | 14 | 1.4465 | 1.7937 | −0.2596 |
| Iridium | Rhodium | Ruthenium | 60 | 28 | 12 | 1.4442 | 1.7825 | −0.2296 |
| Iridium | Manganese | Ruthenium | 62 | 32 | 6 | 1.4430 | 1.4578 | 0.9286 |
| Iridium | Rhodium | Ruthenium | 82 | 16 | 2 | 1.4430 | 1.8489 | −0.4767 |
| Iridium | Rhenium | Ruthenium | 64 | 30 | 6 | 1.4428 | 1.4589 | 0.9417 |
| Iridium | Rhodium | Ruthenium | 60 | 24 | 16 | 1.4417 | 1.7770 | −0.2204 |
| Iridium | Ruthenium | Tungsten | 54 | 8 | 38 | 1.4413 | 1.5308 | 0.6742 |
| Iridium | Rhodium | Ruthenium | 46 | 28 | 26 | 1.4411 | 1.7372 | −0.0778 |
| Iridium | Ruthenium | Tungsten | 36 | 26 | 38 | 1.4397 | 1.4647 | 0.9089 |
| Iridium | Ruthenium | Tungsten | 38 | 30 | 32 | 1.4395 | 1.4733 | 0.8758 |
| Iridium | Rhodium | Ruthenium | 76 | 20 | 4 | 1.4379 | 1.8133 | −0.3711 |
| Iridium | Rhodium | Ruthenium | 28 | 52 | 20 | 1.4367 | 1.5885 | 0.4437 |
| Iridium | Rhodium | Ruthenium | 30 | 48 | 22 | 1.4356 | 1.5981 | 0.4054 |
| Iridium | Ruthenium | Tungsten | 40 | 32 | 28 | 1.4356 | 1.4808 | 0.8306 |
| Iridium | Rhodium | Ruthenium | 6 | 66 | 28 | 1.4340 | 1.4537 | 0.9286 |
| Iridium | Ruthenium | Tungsten | 56 | 6 | 38 | 1.4337 | 1.4958 | 0.7725 |
| Iridium | Rhodium | Ruthenium | 12 | 64 | 24 | 1.4333 | 1.4769 | 0.8402 |
| Iridium | Ruthenium | Tungsten | 50 | 14 | 36 | 1.4331 | 1.5538 | 0.5573 |
| Iridium | Rhodium | Ruthenium | 8 | 66 | 26 | 1.4328 | 1.4671 | 0.8745 |
| Iridium | Rhodium | Ruthenium | 24 | 58 | 18 | 1.4318 | 1.5459 | 0.5818 |
| Iridium | Rhodium | Ruthenium | 60 | 30 | 10 | 1.4317 | 1.7354 | −0.1133 |
| Iridium | Rhodium | Ruthenium | 54 | 24 | 22 | 1.4306 | 1.7724 | −0.2538 |
| Iridium | Rhodium | Ruthenium | 34 | 40 | 26 | 1.4302 | 1.6452 | 0.2102 |
| Iridium | Rhodium | Ruthenium | 64 | 28 | 8 | 1.4295 | 1.7241 | −0.0816 |
| Iridium | Rhodium | Ruthenium | 32 | 44 | 24 | 1.4288 | 1.6009 | 0.3634 |
| Iridium | Ruthenium | Tungsten | 38 | 28 | 34 | 1.4281 | 1.4666 | 0.8576 |
| Iridium | Rhodium | Ruthenium | 68 | 26 | 6 | 1.4269 | 1.7278 | −0.1068 |
| Iridium | Ruthenium | Tungsten | 42 | 4 | 54 | 1.4265 | 1.5251 | 0.6373 |
| Iridium | Rhodium | Ruthenium | 50 | 26 | 24 | 1.4254 | 1.7457 | −0.1797 |
| Iridium | Ruthenium | Tungsten | 54 | 16 | 30 | 1.4252 | 1.4718 | 0.8265 |
| Iridium | Rhodium | Ruthenium | 16 | 62 | 2 | 1.4244 | 1.4888 | 0.7626 |
| Iridium | Rhodium | Ruthenium | 58 | 28 | 14 | 1.4232 | 1.7684 | −0.2731 |
| Iridium | Rhodium | Ruthenium | 58 | 30 | 12 | 1.4221 | 1.7505 | −0.2122 |
| Iridium | Ruthenium | Tungsten | 32 | 12 | 56 | 1.4202 | 1.4543 | 0.8713 |
| Iridium | Ruthenium | Tungsten | 34 | 24 | 42 | 1.4199 | 1.4522 | 0.8790 |
| Iridium | Ruthenium | Tungsten | 38 | 26 | 36 | 1.4191 | 1.4716 | 0.8054 |
| Iridium | Rhodium | Ruthenium | 58 | 24 | 18 | 1.4185 | 1.7490 | −0.2227 |
| Iridium | Ruthenium | Tungsten | 48 | 12 | 40 | 1.4174 | 1.5962 | 0.3362 |
| Iridium | Ruthenium | Tungsten | 50 | 10 | 40 | 1.4172 | 1.5826 | 0.3863 |
| Iridium | Rhodium | Ruthenium | 22 | 60 | 18 | 1.4159 | 1.5159 | 0.6295 |
| Iridium | Ruthenium | Tungsten | 44 | 34 | 22 | 1.4158 | 1.4207 | 0.9818 |
| Iridium | Ruthenium | Tungsten | 32 | 14 | 54 | 1.4158 | 1.4391 | 0.9136 |
| Iridium | Rhodium | Ruthenium | 56 | 24 | 20 | 1.4155 | 1.7515 | −0.2457 |
| Iridium | Ruthenium | Tungsten | 36 | 24 | 40 | 1.4148 | 1.4748 | 0.7752 |
| Iridium | Rhodium | Ruthenium | 26 | 56 | 18 | 1.4130 | 1.5418 | 0.5213 |
| Iridium | Rhodium | Ruthenium | 58 | 26 | 16 | 1.4127 | 1.7413 | −0.2205 |
| Iridium | Rhodium | Ruthenium | 62 | 30 | 8 | 1.4105 | 1.6887 | −0.0349 |
| Iridium | Ruthenium | Tungsten | 52 | 16 | 32 | 1.4093 | 1.4894 | 0.6981 |
| Iridium | Ruthenium | Tungsten | 32 | 22 | 46 | 1.4072 | 1.4173 | 0.9622 |
| Iridium | Ruthenium | Tungsten | 48 | 14 | 38 | 1.4070 | 1.5701 | 0.3916 |
| Iridium | Ruthenium | Tungsten | 38 | 24 | 38 | 1.4068 | 1.4898 | 0.6897 |
| Iridium | Ruthenium | Tungsten | 32 | 16 | 52 | 1.4065 | 1.4146 | 0.9657 |
| Iridium | Rhodium | Ruthenium | 66 | 28 | 6 | 1.4060 | 1.6851 | −0.0415 |
| Iridium | Iron | None | 80 | 20 | 0 | 1.4055 | 1.2544 | 0.9792 |
| Iridium | Rhodium | Ruthenium | 74 | 22 | 4 | 1.4050 | 1.7514 | −0.2950 |
| Iridium | Rhodium | Ruthenium | 58 | 32 | 10 | 1.4040 | 1.6851 | −0.0505 |
| Iridium | Ruthenium | Tungsten | 34 | 12 | 54 | 1.4034 | 1.5098 | 0.6015 |
| Iridium | Ruthenium | Tungsten | 42 | 32 | 26 | 1.4031 | 1.4623 | 0.7773 |
| Iridium | Rhodium | Ruthenium | 80 | 18 | 2 | 1.4029 | 1.8096 | −0.5218 |
| Iridium | Rhodium | Ruthenium | 44 | 30 | 26 | 1.4027 | 1.6813 | −0.0422 |
| Iridium | Ruthenium | Tungsten | 40 | 30 | 30 | 1.3982 | 1.4702 | 0.7298 |
| Iridium | Rhodium | Ruthenium | 36 | 38 | 26 | 1.3981 | 1.6413 | 0.0870 |
| Iridium | Ruthenium | Tungsten | 56 | 18 | 26 | 1.3972 | 1.4222 | 0.9061 |
| Iridium | Rhodium | Ruthenium | 4 | 68 | 28 | 1.3971 | 1.4167 | 0.9271 |
| Iridium | Rhenium | Ruthenium | 70 | 26 | 4 | 1.3970 | 1.5838 | 0.2937 |
| Iridium | Rhodium | Ruthenium | 10 | 66 | 24 | 1.3969 | 1.4382 | 0.8447 |
| Iridium | Rhodium | Ruthenium | 18 | 62 | 20 | 1.3967 | 1.4738 | 0.7103 |
| Iridium | Rhodium | Ruthenium | 56 | 30 | 14 | 1.3964 | 1.7313 | −0.2589 |
| Iridium | Ruthenium | Tungsten | 32 | 20 | 48 | 1.3956 | 1.4083 | 0.9467 |
| Iridium | Ruthenium | Tungsten | 40 | 4 | 56 | 1.3941 | 1.4957 | 0.6176 |
| Iridium | Ruthenium | Tungsten | 32 | 18 | 50 | 1.3926 | 1.4040 | 0.9569 |
| Iridium | Rhodium | Ruthenium | 56 | 32 | 12 | 1.3921 | 1.6964 | −0.1469 |
| Iridium | Ruthenium | Tungsten | 50 | 16 | 34 | 1.3921 | 1.5101 | 0.5541 |
| Iridium | Ruthenium | Tungsten | 34 | 14 | 52 | 1.3902 | 1.4850 | 0.6413 |
| Iridium | Ruthenium | Tungsten | 40 | 28 | 32 | 1.3900 | 1.4587 | 0.7383 |
| Iridium | Ruthenium | Tungsten | 40 | 24 | 36 | 1.3895 | 1.4848 | 0.6385 |
| Iridium | Ruthenium | Tungsten | 40 | 26 | 34 | 1.3894 | 1.4671 | 0.7066 |
| Iridium | Ruthenium | Tungsten | 32 | 10 | 58 | 1.3882 | 1.4423 | 0.7955 |
| Iridium | Ruthenium | Tungsten | 34 | 22 | 44 | 1.3877 | 1.4549 | 0.7456 |
| Iridium | Rhodium | Ruthenium | 64 | 30 | 6 | 1.3871 | 1.6448 | 0.0249 |
| Iridium | Ruthenium | Tungsten | 36 | 12 | 52 | 1.3866 | 1.5474 | 0.3901 |
| Iridium | Ruthenium | Tungsten | 46 | 12 | 42 | 1.3865 | 1.6041 | 0.1762 |
| Iridium | Rhodium | Ruthenium | 14 | 64 | 22 | 1.3856 | 1.4415 | 0.7882 |
| Iridium | Rhodium | Ruthenium | 60 | 32 | 8 | 1.3849 | 1.6409 | 0.0303 |
| Iridium | Rhodium | Ruthenium | 52 | 26 | 22 | 1.3836 | 1.7036 | −0.2140 |
| Iridium | Rhodium | Ruthenium | 30 | 50 | 20 | 1.3834 | 1.5416 | 0.3993 |
| Iridium | Ruthenium | Tungsten | 46 | 14 | 40 | 1.3827 | 1.5807 | 0.2478 |
| Iridium | Rhodium | Ruthenium | 56 | 28 | 16 | 1.3825 | 1.7025 | −0.2137 |
| Iridium | Ruthenium | Tungsten | 48 | 16 | 36 | 1.3820 | 1.5344 | 0.4195 |
| Iridium | Rhodium | Ruthenium | 56 | 26 | 18 | 1.3812 | 1.6962 | −0.1969 |
| Iridium | Ruthenium | Tungsten | 44 | 32 | 24 | 1.3811 | 1.4278 | 0.8217 |
| Iridium | Rhodium | Ruthenium | 48 | 28 | 24 | 1.3807 | 1.6779 | −0.1298 |
| Iridium | Rhodium | Ruthenium | 42 | 32 | 26 | 1.3804 | 1.6489 | −0.0209 |
| Iridium | Rhodium | Ruthenium | 38 | 36 | 26 | 1.3798 | 1.6359 | 0.0260 |
| Iridium | Ruthenium | Tungsten | 52 | 8 | 40 | 1.3796 | 1.5232 | 0.4519 |
| Iridium | Ruthenium | Tungsten | 36 | 22 | 42 | 1.3795 | 1.4866 | 0.5924 |
| Iridium | Ruthenium | Tungsten | 38 | 22 | 40 | 1.3792 | 1.5058 | 0.5185 |
| Iridium | Ruthenium | Tungsten | 56 | 20 | 24 | 1.3788 | 1.3890 | 0.9586 |
| Iridium | Ruthenium | Tungsten | 34 | 10 | 56 | 1.3782 | 1.4973 | 0.5460 |
| Iridium | Rhodium | Ruthenium | 6 | 68 | 26 | 1.3776 | 1.4069 | 0.8894 |
| Iridium | Rhodium | Ruthenium | 28 | 54 | 18 | 1.3776 | 1.5174 | 0.4676 |
| Iridium | Ruthenium | Tungsten | 40 | 22 | 38 | 1.3765 | 1.5125 | 0.4815 |
| Iridium | Ruthenium | Tungsten | 48 | 10 | 42 | 1.3759 | 1.5857 | 0.1999 |
| Iridium | Rhodium | Ruthenium | 32 | 46 | 22 | 1.3748 | 1.5435 | 0.3558 |
| Iridium | Rhodium | Ruthenium | 34 | 42 | 24 | 1.3745 | 1.5739 | 0.2374 |
| Iridium | Rhodium | Ruthenium | 56 | 34 | 10 | 1.3733 | 1.6255 | 0.0360 |
| Iridium | Rhodium | Ruthenium | 20 | 62 | 18 | 1.3728 | 1.4585 | 0.6726 |
| Iridium | Rhodium | Ruthenium | 54 | 26 | 20 | 1.3726 | 1.6904 | −0.2154 |
| Iridium | Ruthenium | Tungsten | 34 | 16 | 50 | 1.3724 | 1.4579 | 0.6727 |
| Iridium | Rhodium | Ruthenium | 40 | 34 | 26 | 1.3716 | 1.6339 | −0.0037 |
| Iridium | Ruthenium | Tungsten | 32 | 8 | 60 | 1.3715 | 1.4206 | 0.8091 |
| Iridium | Rhodium | Ruthenium | 72 | 24 | 4 | 1.3712 | 1.6859 | −0.2047 |
| Iridium | Ruthenium | Tungsten | 38 | 12 | 50 | 1.3710 | 1.5802 | 0.1990 |
| Iridium | Ruthenium | Tungsten | 38 | 4 | 58 | 1.3702 | 1.4629 | 0.6449 |
| Iridium | Rhodium | Ruthenium | 62 | 32 | 6 | 1.3681 | 1.6012 | 0.1059 |
| Iridium | Ruthenium | Tungsten | 54 | 18 | 28 | 1.3679 | 1.4237 | 0.7855 |
| Iridium | Ruthenium | Tungsten | 44 | 12 | 44 | 1.3674 | 1.6050 | 0.0879 |
| Iridium | Ruthenium | Tungsten | 36 | 14 | 50 | 1.3666 | 1.5231 | 0.3987 |
| Iridium | Ruthenium | Tungsten | 46 | 16 | 38 | 1.3661 | 1.5524 | 0.2839 |
| Iridium | Ruthenium | Tungsten | 36 | 10 | 54 | 1.3660 | 1.5402 | 0.3309 |
| Iridium | Ruthenium | Tungsten | 42 | 30 | 28 | 1.3660 | 1.4521 | 0.6690 |
| Iridium | Ruthenium | Tungsten | 34 | 20 | 46 | 1.3648 | 1.4505 | 0.6696 |
| Iridium | Rhodium | Ruthenium | 54 | 32 | 14 | 1.3647 | 1.6757 | −0.1955 |
| Iridium | Ruthenium | Tungsten | 42 | 22 | 36 | 1.3627 | 1.5010 | 0.4671 |
| Iridium | Ruthenium | Tungsten | 42 | 24 | 34 | 1.3622 | 1.4717 | 0.5777 |
| Iridium | Ruthenium | Tungsten | 44 | 14 | 42 | 1.3614 | 1.5859 | 0.1345 |
| Iridium | Rhodium | Ruthenium | 54 | 34 | 12 | 1.3608 | 1.6353 | −0.0587 |
| Iridium | Ruthenium | Tungsten | 34 | 8 | 58 | 1.3606 | 1.4782 | 0.5456 |
| Iridium | Ruthenium | Tungsten | 40 | 12 | 48 | 1.3605 | 1.5933 | 0.1021 |
| Iridium | Ruthenium | Tungsten | 34 | 18 | 48 | 1.3597 | 1.4457 | 0.6670 |
| Iridium | Ruthenium | Tungsten | 42 | 12 | 46 | 1.3578 | 1.6059 | 0.0407 |
| Iridium | Rhodium | Ruthenium | 58 | 34 | 8 | 1.3569 | 1.5849 | 0.1182 |
| Iridium | Ruthenium | Tungsten | 46 | 32 | 22 | 1.3560 | 1.3881 | 0.8754 |
| Iridium | Ruthenium | Tungsten | 54 | 6 | 40 | 1.3560 | 1.4798 | 0.5188 |
| Iridium | Rhodium | Ruthenium | 8 | 68 | 24 | 1.3559 | 1.3987 | 0.8345 |
| Iridium | Rhodium | Ruthenium | 12 | 66 | 22 | 1.3555 | 1.4073 | 0.7997 |
| Iridium | Ruthenium | Tungsten | 42 | 20 | 38 | 1.3545 | 1.5287 | 0.3247 |
| Iridium | Ruthenium | Tungsten | 40 | 20 | 40 | 1.3544 | 1.5264 | 0.3333 |
| Iridium | Ruthenium | Tungsten | 36 | 20 | 44 | 1.3539 | 1.4847 | 0.4910 |
| Iridium | Ruthenium | Tungsten | 44 | 16 | 40 | 1.3538 | 1.5593 | 0.2030 |
| Iridium | Ruthenium | Tungsten | 38 | 10 | 52 | 1.3530 | 1.5674 | 0.1682 |
| Iridium | Ruthenium | Tungsten | 42 | 26 | 32 | 1.3530 | 1.4492 | 0.6267 |
| Iridium | Rhodium | Ruthenium | 54 | 30 | 16 | 1.3525 | 1.6603 | −0.1939 |
| Iridium | Ruthenium | Tungsten | 42 | 28 | 30 | 1.3519 | 1.4457 | 0.6355 |
| Palladium | Ruthenium | None | 34 | 66 | 0 | 1.3511 | 1.3544 | 0.9870 |
| Iridium | Ruthenium | Tungsten | 38 | 14 | 48 | 1.3506 | 1.5509 | 0.2216 |
| Iridium | Ruthenium | Tungsten | 52 | 18 | 30 | 1.3505 | 1.4360 | 0.6681 |
| Iridium | Manganese | Ruthenium | 62 | 30 | 8 | 1.3504 | 1.4080 | 0.7711 |
| Iridium | Ruthenium | Tungsten | 36 | 8 | 56 | 1.3504 | 1.5214 | 0.3330 |
| Iridium | Ruthenium | Tungsten | 38 | 20 | 42 | 1.3501 | 1.5137 | 0.3636 |
| Iridium | Ruthenium | Tungsten | 36 | 4 | 60 | 1.3495 | 1.4041 | 0.7880 |
| Iridium | Ruthenium | Tungsten | 36 | 16 | 48 | 1.3494 | 1.4927 | 0.4414 |
| Iridium | Ruthenium | Tungsten | 46 | 10 | 44 | 1.3485 | 1.5868 | 0.0724 |
| Iridium | Ruthenium | Tungsten | 44 | 20 | 36 | 1.3485 | 1.5109 | 0.3679 |
| Iridium | Ruthenium | Tungsten | 42 | 14 | 44 | 1.3483 | 1.5823 | 0.0891 |
| Iridium | Rhodium | Ruthenium | 36 | 40 | 24 | 1.3477 | 1.5731 | 0.1199 |
| Iridium | Ruthenium | Tungsten | 46 | 18 | 36 | 1.3476 | 1.5212 | 0.3240 |
| Iridium | Ruthenium | Tungsten | 44 | 18 | 38 | 1.3463 | 1.5412 | 0.2404 |
| Iridium | Ruthenium | Tungsten | 48 | 18 | 34 | 1.3463 | 1.4930 | 0.4281 |
| Iridium | Rhodium | Ruthenium | 16 | 64 | 20 | 1.3463 | 1.4126 | 0.7416 |
| Iridium | Ruthenium | Tungsten | 50 | 18 | 32 | 1.3459 | 1.4623 | 0.5461 |
| Iridium | Rhodium | Ruthenium | 54 | 28 | 18 | 1.3456 | 1.6460 | −0.1714 |
| Iridium | Ruthenium | Tungsten | 54 | 20 | 26 | 1.3435 | 1.3910 | 0.8141 |
| Iridium | Rhodium | Ruthenium | 60 | 34 | 6 | 1.3435 | 1.5467 | 0.2063 |
| Iridium | Ruthenium | Tungsten | 44 | 30 | 26 | 1.3431 | 1.4258 | 0.6769 |
| Iridium | Ruthenium | Tungsten | 40 | 14 | 46 | 1.3431 | 1.5716 | 0.1070 |
| Iridium | Rhodium | Ruthenium | 54 | 36 | 10 | 1.3429 | 1.5593 | 0.1547 |
| Iridium | Rhodium | Ruthenium | 46 | 30 | 24 | 1.3424 | 1.6197 | −0.0841 |
| Iridium | Rhodium | Ruthenium | 70 | 26 | 4 | 1.3419 | 1.6233 | −0.1007 |
| Iridium | Ruthenium | Tungsten | 44 | 22 | 34 | 1.3407 | 1.4786 | 0.4603 |
| Iridium | Ruthenium | Tungsten | 42 | 18 | 40 | 1.3406 | 1.5452 | 0.1989 |
| Iridium | Ruthenium | Tungsten | 40 | 10 | 50 | 1.3401 | 1.5825 | 0.0505 |
| Iridium | Rhodium | Ruthenium | 50 | 28 | 22 | 1.3398 | 1.6379 | −0.1676 |
| Iridium | Ruthenium | Tungsten | 38 | 8 | 54 | 1.3392 | 1.5565 | 0.1477 |
| Iridium | Ruthenium | Tungsten | 42 | 16 | 42 | 1.3390 | 1.5588 | 0.1383 |
| Iridium | Ruthenium | Tungsten | 34 | 4 | 62 | 1.3386 | 1.3524 | 0.9461 |
| Iridium | Ruthenium | Tungsten | 54 | 22 | 24 | 1.3379 | 1.3664 | 0.8879 |
| Iridium | Ruthenium | Tungsten | 32 | 6 | 62 | 1.3376 | 1.3754 | 0.8516 |
| Iridium | Ruthenium | Tungsten | 36 | 18 | 46 | 1.3370 | 1.4837 | 0.4242 |
| Iridium | Rhodium | Ruthenium | 24 | 60 | 16 | 1.3368 | 1.4236 | 0.6595 |
| Iridium | Rhodium | Ruthenium | 26 | 58 | 16 | 1.3361 | 1.4341 | 0.6155 |
| Iridium | Ruthenium | Tungsten | 54 | 24 | 22 | 1.3350 | 1.3429 | 0.9688 |
| Iridium | Rhodium | Ruthenium | 32 | 48 | 20 | 1.3350 | 1.4987 | 0.3547 |
| Iridium | Ruthenium | Tungsten | 46 | 20 | 34 | 1.3341 | 1.4848 | 0.4072 |
| Iridium | Ruthenium | Tungsten | 40 | 18 | 42 | 1.3333 | 1.5372 | 0.1973 |
| Iridium | Ruthenium | Tungsten | 40 | 16 | 44 | 1.3331 | 1.5438 | 0.1704 |
| Iridium | Ruthenium | Tungsten | 44 | 10 | 46 | 1.3330 | 1.5877 | −0.0028 |
| Iridium | Ruthenium | Tungsten | 48 | 32 | 20 | 1.3328 | 1.3514 | 0.9267 |
| Iridium | Ruthenium | Tungsten | 42 | 10 | 48 | 1.3326 | 1.5870 | −0.0021 |
| Iridium | Ruthenium | Tungsten | 44 | 24 | 32 | 1.3324 | 1.4457 | 0.5531 |
| Iridium | Rhodium | Ruthenium | 52 | 28 | 20 | 1.3324 | 1.6309 | −0.1757 |
| Iridium | Ruthenium | Tungsten | 38 | 16 | 46 | 1.3323 | 1.5239 | 0.2451 |
| Iridium | Rhodium | Ruthenium | 52 | 34 | 14 | 1.3314 | 1.6120 | −0.1058 |
| Iridium | Ruthenium | Tungsten | 38 | 18 | 44 | 1.3306 | 1.5143 | 0.2755 |
| Iridium | Ruthenium | Tungsten | 44 | 28 | 28 | 1.3294 | 1.4236 | 0.6278 |
| Iridium | Rhodium | Ruthenium | 52 | 36 | 12 | 1.3293 | 1.5676 | 0.0594 |
| Iridium | Ruthenium | Tungsten | 46 | 30 | 24 | 1.3291 | 1.3932 | 0.7471 |
| Iridium | Ruthenium | Tungsten | 34 | 6 | 60 | 1.3284 | 1.4349 | 0.5789 |
| Iridium | Rhodium | Ruthenium | 34 | 44 | 22 | 1.3280 | 1.5139 | 0.2642 |
| Iridium | Ruthenium | Tungsten | 50 | 8 | 42 | 1.3275 | 1.5182 | 0.2460 |
| Iridium | Rhodium | Ruthenium | 30 | 52 | 18 | 1.3274 | 1.4717 | 0.4292 |
| Iridium | Ruthenium | Tungsten | 40 | 8 | 52 | 1.3267 | 1.5705 | 0.0337 |
| Iridium | Ruthenium | Tungsten | 52 | 20 | 28 | 1.3266 | 1.4038 | 0.6935 |
| Iridium | Rhenium | Ruthenium | 68 | 28 | 4 | 1.3264 | 1.4896 | 0.3491 |
| Iridium | Rhodium | Ruthenium | 56 | 36 | 8 | 1.3263 | 1.5185 | 0.2396 |
| Iridium | Rhodium | Ruthenium | 38 | 38 | 24 | 1.3255 | 1.5702 | 0.0309 |
| Iridium | Ruthenium | Tungsten | 48 | 20 | 32 | 1.3240 | 1.4526 | 0.4901 |
| Iridium | Rhodium | Ruthenium | 52 | 32 | 16 | 1.3231 | 1.6116 | −0.1431 |
| Iridium | Rhodium | Ruthenium | 44 | 32 | 24 | 1.3226 | 1.5873 | −0.0507 |
| Iridium | Iron | None | 78 | 22 | 0 | 1.3217 | 1.2493 | 0.7771 |
| Iridium | Rhodium | Ruthenium | 22 | 62 | 16 | 1.3214 | 1.3990 | 0.6921 |
| Iridium | Ruthenium | Tungsten | 44 | 26 | 30 | 1.3213 | 1.4266 | 0.5817 |
| Iridium | Ruthenium | Tungsten | 48 | 30 | 22 | 1.3184 | 1.3610 | 0.8305 |
| Iridium | Ruthenium | Tungsten | 36 | 6 | 58 | 1.3181 | 1.4869 | 0.3280 |
| Iridium | Ruthenium | Tungsten | 52 | 24 | 24 | 1.3178 | 1.3595 | 0.8332 |
| Iridium | Rhodium | Ruthenium | 68 | 28 | 4 | 1.3175 | 1.5672 | 0.0049 |
| Iridium | Ruthenium | Tungsten | 46 | 22 | 32 | 1.3173 | 1.4478 | 0.4800 |
| Iridium | Rhodium | Ruthenium | 40 | 36 | 24 | 1.3170 | 1.5682 | −0.0015 |
| Iridium | Ruthenium | Tungsten | 42 | 8 | 50 | 1.3162 | 1.5793 | −0.0497 |
| Iridium | Ruthenium | Tungsten | 50 | 20 | 30 | 1.3161 | 1.4225 | 0.5754 |
| Iridium | Rhodium | Ruthenium | 52 | 38 | 10 | 1.3159 | 1.4960 | 0.2818 |
| Iridium | Ruthenium | Tungsten | 52 | 22 | 26 | 1.3158 | 1.3777 | 0.7533 |
| Iridium | Rhodium | Ruthenium | 58 | 36 | 6 | 1.3139 | 1.4814 | 0.3315 |
| Iridium | Rhodium | Ruthenium | 10 | 68 | 22 | 1.3135 | 1.3614 | 0.8085 |
| Iridium | Ruthenium | Tungsten | 46 | 28 | 26 | 1.3134 | 1.3981 | 0.6612 |
| Iridium | Ruthenium | Tungsten | 52 | 26 | 22 | 1.3127 | 1.3384 | 0.8971 |
| Iridium | Rhodium | Ruthenium | 52 | 30 | 18 | 1.3125 | 1.5969 | −0.1372 |
| Iridium | Rhodium | Ruthenium | 18 | 64 | 18 | 1.3125 | 1.3850 | 0.7105 |
| Iridium | Rhodium | Ruthenium | 42 | 34 | 24 | 1.3122 | 1.5682 | −0.0238 |
| Iridium | Ruthenium | Tungsten | 52 | 28 | 20 | 1.3114 | 1.3245 | 0.9476 |
| Iridium | Ruthenium | Tungsten | 48 | 28 | 24 | 1.3107 | 1.3724 | 0.7532 |
| Iridium | Rhodium | Ruthenium | 28 | 56 | 16 | 1.3101 | 1.4198 | 0.5603 |
| Iridium | Ruthenium | Tungsten | 50 | 28 | 22 | 1.3078 | 1.3453 | 0.8496 |
| Iridium | Ruthenium | Tungsten | 48 | 8 | 44 | 1.3074 | 1.5315 | 0.1008 |
| Iridium | Ruthenium | Tungsten | 38 | 6 | 56 | 1.3069 | 1.5208 | 0.1408 |
| Iridium | Ruthenium | Tungsten | 46 | 24 | 30 | 1.3064 | 1.4191 | 0.5474 |
| Iridium | Ruthenium | Tungsten | 50 | 30 | 20 | 1.3062 | 1.3318 | 0.8975 |
| Iridium | Rhodium | Ruthenium | 6 | 70 | 24 | 1.3055 | 1.3415 | 0.8557 |
| Iridium | Ruthenium | Tungsten | 46 | 26 | 28 | 1.3050 | 1.4029 | 0.6060 |
| Iridium | Ruthenium | Tungsten | 50 | 26 | 24 | 1.3038 | 1.3589 | 0.7782 |
| Iridium | Ruthenium | Tungsten | 44 | 8 | 48 | 1.3037 | 1.5640 | −0.0483 |
| Iridium | Ruthenium | Tungsten | 50 | 22 | 28 | 1.3037 | 1.3946 | 0.6338 |
| Iridium | Rhodium | Ruthenium | 48 | 30 | 22 | 1.3033 | 1.5810 | −0.1179 |
| Iridium | Ruthenium | Tungsten | 50 | 24 | 26 | 1.3027 | 1.3752 | 0.7077 |
| Iridium | Rhodium | Ruthenium | 50 | 38 | 12 | 1.3026 | 1.5057 | 0.1813 |
| Iridium | Ruthenium | Tungsten | 48 | 22 | 30 | 1.3018 | 1.4176 | 0.5334 |
| Iridium | Ruthenium | Tungsten | 48 | 24 | 28 | 1.3011 | 1.3958 | 0.6181 |
| Iridium | Rhodium | Ruthenium | 50 | 36 | 14 | 1.3009 | 1.5496 | −0.0031 |
| Iridium | Rhodium | Ruthenium | 54 | 38 | 8 | 1.2997 | 1.4551 | 0.3724 |
| Iridium | Rhodium | Ruthenium | 14 | 66 | 20 | 1.2995 | 1.3581 | 0.7631 |
| Iridium | Ruthenium | Tungsten | 48 | 26 | 26 | 1.2993 | 1.3803 | 0.6731 |
| Iridium | Ruthenium | Tungsten | 46 | 8 | 46 | 1.2978 | 1.5480 | −0.0118 |
| Iridium | Rhodium | Ruthenium | 50 | 30 | 20 | 1.2972 | 1.5773 | −0.1331 |
| Iridium | Rhodium | Ruthenium | 50 | 40 | 10 | 1.2955 | 1.4439 | 0.3992 |
| Iridium | Rhodium | Ruthenium | 36 | 42 | 22 | 1.2953 | 1.5099 | 0.1305 |
| Iridium | Ruthenium | Tungsten | 50 | 32 | 18 | 1.2948 | 1.3101 | 0.9379 |
| Iridium | Rhodium | Ruthenium | 50 | 34 | 16 | 1.2939 | 1.5581 | −0.0715 |
| Iridium | Ruthenium | Tungsten | 52 | 6 | 42 | 1.2937 | 1.4700 | 0.2847 |
| Iridium | Ruthenium | Tungsten | 40 | 6 | 54 | 1.2933 | 1.5397 | 0.0002 |
| Iridium | Rhodium | Ruthenium | 66 | 30 | 4 | 1.2926 | 1.5044 | 0.1409 |
| Iridium | Ruthenium | Tungsten | 52 | 30 | 18 | 1.2902 | 1.3050 | 0.9397 |
| Iridium | Rhodium | Ruthenium | 34 | 46 | 20 | 1.2887 | 1.4628 | 0.2903 |
| Iridium | Rhodium | Ruthenium | 56 | 38 | 6 | 1.2878 | 1.4198 | 0.4623 |
| Iridium | Rhodium | Ruthenium | 64 | 32 | 4 | 1.2876 | 1.4711 | 0.2526 |
| Iridium | Rhodium | Ruthenium | 50 | 32 | 18 | 1.2860 | 1.5530 | −0.0895 |
| Iridium | Rhodium | Ruthenium | 38 | 40 | 22 | 1.2825 | 1.5127 | 0.0581 |
| Iridium | Molybdenum | None | 82 | 18 | 0 | 1.2822 | 1.3118 | 0.8486 |
| Iridium | Rhodium | Ruthenium | 46 | 32 | 22 | 1.2821 | 1.5437 | −0.0706 |
| Iridium | Ruthenium | Tungsten | 42 | 6 | 52 | 1.2818 | 1.5477 | −0.0890 |
| Iridium | Rhodium | Ruthenium | 48 | 40 | 12 | 1.2808 | 1.4540 | 0.2903 |
| Iridium | Rhodium | Ruthenium | 52 | 40 | 8 | 1.2796 | 1.4029 | 0.4946 |
| Iridium | Rhodium | Ruthenium | 32 | 50 | 18 | 1.2791 | 1.4308 | 0.3772 |
| Iridium | Rhodium | Ruthenium | 48 | 42 | 10 | 1.2774 | 1.3991 | 0.5000 |
| Iridium | Rhodium | Ruthenium | 8 | 70 | 22 | 1.2761 | 1.3224 | 0.8097 |
| Iridium | Rhodium | Ruthenium | 48 | 32 | 20 | 1.2753 | 1.5386 | −0.0832 |
| Iridium | Rhodium | Ruthenium | 30 | 54 | 16 | 1.2744 | 1.3944 | 0.5065 |
| Iridium | Ruthenium | Tungsten | 54 | 30 | 16 | 1.2743 | 1.2816 | 0.9700 |
| Iridium | Rhodium | Ruthenium | 40 | 38 | 22 | 1.2740 | 1.5139 | 0.0118 |
| Iridium | Rhodium | Ruthenium | 48 | 38 | 14 | 1.2737 | 1.4934 | 0.0947 |
| Iridium | Rhodium | Ruthenium | 48 | 36 | 16 | 1.2734 | 1.5175 | −0.0057 |
| Iridium | Rhodium | Ruthenium | 44 | 34 | 22 | 1.2712 | 1.5214 | −0.0326 |
| Iridium | Rhodium | Ruthenium | 20 | 64 | 16 | 1.2710 | 1.3397 | 0.7163 |
| Iridium | Rhodium | Ruthenium | 42 | 36 | 22 | 1.2706 | 1.5155 | −0.0112 |
| Iridium | Manganese | Ruthenium | 64 | 32 | 4 | 1.2705 | 1.3226 | 0.7688 |
| Iridium | Rhodium | Ruthenium | 54 | 40 | 6 | 1.2701 | 1.3713 | 0.5820 |
| Iridium | Rhodium | Ruthenium | 36 | 44 | 20 | 1.2690 | 1.4626 | 0.1979 |
| Iridium | Rhodium | Ruthenium | 48 | 34 | 18 | 1.2656 | 1.5163 | −0.0395 |
| Iridium | Ruthenium | Tungsten | 44 | 6 | 50 | 1.2645 | 1.5372 | −0.1318 |
| Iridium | Ruthenium | Tungsten | 50 | 6 | 44 | 1.2645 | 1.4815 | 0.0987 |
| Iridium | Rhodium | Ruthenium | 50 | 42 | 8 | 1.2639 | 1.3602 | 0.6002 |
| Iridium | Rhodium | Ruthenium | 4 | 72 | 24 | 1.2636 | 1.2976 | 0.8593 |
| Iridium | Rhodium | Ruthenium | 46 | 42 | 12 | 1.2628 | 1.4093 | 0.3908 |
| Iridium | Rhenium | Ruthenium | 66 | 30 | 4 | 1.2620 | 1.3957 | 0.4360 |
| Iridium | Rhodium | Ruthenium | 62 | 34 | 4 | 1.2616 | 1.4128 | 0.3717 |
| Iridium | Rhodium | Ruthenium | 12 | 68 | 20 | 1.2608 | 1.3149 | 0.7747 |
| Iridium | Rhenium | Ruthenium | 64 | 32 | 4 | 1.2605 | 1.3067 | 0.8055 |
| Iridium | Ruthenium | Tungsten | 50 | 34 | 16 | 1.2599 | 1.2714 | 0.9517 |
| Iridium | Rhodium | Ruthenium | 46 | 34 | 20 | 1.2594 | 1.5081 | −0.0367 |
| Iridium | Ruthenium | Tungsten | 52 | 32 | 16 | 1.2582 | 1.2748 | 0.9306 |
| Iridium | Rhodium | Ruthenium | 52 | 42 | 6 | 1.2578 | 1.3337 | 0.6833 |
| Iridium | Rhodium | Ruthenium | 50 | 44 | 6 | 1.2563 | 1.3160 | 0.7506 |
| Iridium | Rhodium | Ruthenium | 16 | 66 | 18 | 1.2553 | 1.3176 | 0.7395 |
| Iridium | Rhodium | Ruthenium | 44 | 36 | 20 | 1.2551 | 1.4955 | −0.0053 |
| Iridium | Rhodium | Ruthenium | 46 | 44 | 10 | 1.2551 | 1.3592 | 0.5647 |
| Iridium | Rhodium | Ruthenium | 38 | 42 | 20 | 1.2537 | 1.4674 | 0.1057 |
| Iridium | Rhodium | Ruthenium | 40 | 40 | 20 | 1.2532 | 1.4776 | 0.0605 |
| Iridium | Rhodium | Ruthenium | 46 | 36 | 18 | 1.2529 | 1.4906 | 0.0042 |
| Iridium | Rhodium | Ruthenium | 46 | 38 | 16 | 1.2528 | 1.4760 | 0.0646 |
| Iridium | Rhodium | Ruthenium | 48 | 44 | 8 | 1.2524 | 1.3329 | 0.6626 |
| Iridium | Rhodium | Ruthenium | 42 | 38 | 20 | 1.2513 | 1.4842 | 0.0235 |
| Iridium | Rhodium | Ruthenium | 46 | 40 | 14 | 1.2510 | 1.4470 | 0.1778 |
| Iridium | Ruthenium | Tungsten | 46 | 6 | 48 | 1.2503 | 1.5144 | −0.1086 |
| Iridium | Rhodium | Ruthenium | 34 | 48 | 18 | 1.2495 | 1.4123 | 0.3160 |
| Iridium | Rhodium | Ruthenium | 48 | 46 | 6 | 1.2486 | 1.2995 | 0.7862 |
| Iridium | Rhodium | Ruthenium | 26 | 60 | 14 | 1.2485 | 1.3230 | 0.6867 |
| Iridium | Ruthenium | Tungsten | 48 | 6 | 46 | 1.2483 | 1.4958 | −0.0406 |
| Iridium | Ruthenium | Tungsten | 60 | 32 | 8 | 1.2465 | 1.2459 | 0.9994 |
| Iridium | Rhodium | Ruthenium | 32 | 52 | 16 | 1.2453 | 1.3770 | 0.4445 |
| Iridium | Rhodium | Ruthenium | 44 | 38 | 18 | 1.2436 | 1.4703 | 0.0432 |
| Iridium | Rhodium | Ruthenium | 24 | 62 | 14 | 1.2436 | 1.3080 | 0.7281 |
| Iridium | Ruthenium | Tungsten | 58 | 32 | 10 | 1.2430 | 1.2477 | 0.9786 |
| Iridium | Ruthenium | Tungsten | 50 | 36 | 14 | 1.2417 | 1.2440 | 0.9898 |
| Iridium | Rhodium | Ruthenium | 44 | 44 | 12 | 1.2409 | 1.3709 | 0.4495 |
| Iridium | Rhodium | Ruthenium | 44 | 40 | 16 | 1.2391 | 1.4477 | 0.1165 |
| Iridium | Rhodium | Ruthenium | 28 | 58 | 14 | 1.2380 | 1.3239 | 0.6359 |
| Iridium | Rhodium | Ruthenium | 46 | 46 | 8 | 1.2376 | 1.3088 | 0.6977 |
| Iridium | Rhodium | Ruthenium | 42 | 40 | 18 | 1.2367 | 1.4538 | 0.0788 |
| Iridium | Ruthenium | Tungsten | 56 | 32 | 12 | 1.2340 | 1.2463 | 0.9464 |
| Iridium | Rhodium | Ruthenium | 60 | 36 | 4 | 1.2335 | 1.3533 | 0.4909 |
| Iridium | Rhodium | Ruthenium | 36 | 46 | 18 | 1.2313 | 1.4118 | 0.2310 |
| Iridium | Rhodium | Ruthenium | 40 | 42 | 18 | 1.2310 | 1.4374 | 0.1198 |
| Iridium | Rhodium | Ruthenium | 44 | 42 | 14 | 1.2304 | 1.4071 | 0.2460 |
| Iridium | Molybdenum | None | 80 | 20 | 0 | 1.2304 | 1.2859 | 0.7324 |
| Iridium | Rhodium | Ruthenium | 6 | 72 | 22 | 1.2303 | 1.2686 | 0.8376 |
| Iridium | Ruthenium | Tungsten | 54 | 32 | 14 | 1.2293 | 1.2490 | 0.9155 |
| Iridium | Rhodium | Ruthenium | 38 | 44 | 18 | 1.2286 | 1.4230 | 0.1698 |
| Iridium | Rhodium | Ruthenium | 44 | 46 | 10 | 1.2277 | 1.3215 | 0.5989 |
| Iridium | Rhodium | Ruthenium | 46 | 48 | 6 | 1.2253 | 1.2784 | 0.7722 |
| Iridium | Rhodium | Ruthenium | 42 | 42 | 16 | 1.2241 | 1.4182 | 0.1679 |
| Iridium | Rhodium | Ruthenium | 10 | 70 | 20 | 1.2224 | 1.2716 | 0.7885 |
| Iridium | Rhenium | Ruthenium | 62 | 34 | 4 | 1.2214 | 1.2405 | 0.9140 |
| Iridium | Ruthenium | Tungsten | 52 | 34 | 14 | 1.2206 | 1.2425 | 0.9057 |
| Iridium | Rhodium | Ruthenium | 34 | 50 | 16 | 1.2171 | 1.3609 | 0.3801 |
| Iridium | Rhodium | Ruthenium | 18 | 66 | 16 | 1.2170 | 1.2790 | 0.7328 |
| Iridium | Rhodium | Ruthenium | 42 | 46 | 12 | 1.2162 | 1.3342 | 0.4905 |
| Iridium | Iron | None | 76 | 24 | 0 | 1.2161 | 1.2109 | 0.5973 |
| Iridium | Rhodium | Ruthenium | 30 | 56 | 14 | 1.2157 | 1.3130 | 0.5800 |
| Iridium | Rhodium | Ruthenium | 40 | 44 | 16 | 1.2154 | 1.3968 | 0.2168 |
| Iridium | Rhodium | Ruthenium | 22 | 64 | 14 | 1.2123 | 1.2710 | 0.7458 |
| Iridium | Rhodium | Ruthenium | 42 | 44 | 14 | 1.2119 | 1.3745 | 0.2958 |
| Iridium | Rhodium | Ruthenium | 36 | 48 | 16 | 1.2115 | 1.3672 | 0.3252 |
| Iridium | Rhodium | Ruthenium | 44 | 48 | 8 | 1.2090 | 1.2815 | 0.6843 |
| Iridium | Rhodium | Ruthenium | 14 | 68 | 18 | 1.2077 | 1.2645 | 0.7528 |
| Iridium | Rhodium | Ruthenium | 38 | 46 | 16 | 1.2074 | 1.3770 | 0.2631 |
| Iridium | Rhodium | Ruthenium | 58 | 38 | 4 | 1.2055 | 1.2990 | 0.5937 |
| Iridium | Ruthenium | Tungsten | 52 | 36 | 12 | 1.1995 | 1.2200 | 0.9092 |
| Iridium | Molybdenum | None | 78 | 22 | 0 | 1.1985 | 1.2685 | 0.6672 |
| Iridium | Ruthenium | Tungsten | 54 | 34 | 12 | 1.1976 | 1.2279 | 0.8671 |
| Iridium | Rhodium | Ruthenium | 40 | 46 | 14 | 1.1954 | 1.3466 | 0.3363 |
| Iridium | Rhodium | Ruthenium | 42 | 48 | 10 | 1.1928 | 1.2860 | 0.5896 |
| Iridium | Rhodium | Ruthenium | 32 | 54 | 14 | 1.1926 | 1.3009 | 0.5234 |
| Iridium | Rhodium | Ruthenium | 56 | 40 | 4 | 1.1916 | 1.2633 | 0.6846 |
| Iridium | Rhodium | Ruthenium | 40 | 48 | 12 | 1.1909 | 1.3050 | 0.4966 |
| Iridium | Rhodium | Ruthenium | 44 | 50 | 6 | 1.1909 | 1.2546 | 0.7190 |
| Iridium | Rhodium | Ruthenium | 52 | 44 | 4 | 1.1857 | 1.2273 | 0.8162 |
| Iridium | Rhodium | Ruthenium | 38 | 48 | 14 | 1.1845 | 1.3268 | 0.3698 |
| Iridium | Rhodium | Ruthenium | 8 | 72 | 20 | 1.1844 | 1.2304 | 0.7957 |
| Iridium | Ruthenium | Tungsten | 56 | 34 | 10 | 1.1831 | 1.2184 | 0.8433 |
| Iridium | Rhodium | Ruthenium | 34 | 52 | 14 | 1.1815 | 1.3036 | 0.4575 |
| Iridium | Rhodium | Ruthenium | 50 | 46 | 4 | 1.1795 | 1.2121 | 0.8550 |
| Iridium | Rhodium | Ruthenium | 36 | 50 | 14 | 1.1789 | 1.3121 | 0.4069 |
| Iridium | Rhodium | Ruthenium | 54 | 42 | 4 | 1.1771 | 1.2321 | 0.7547 |
| Iridium | Rhodium | Ruthenium | 42 | 50 | 8 | 1.1732 | 1.2537 | 0.6395 |
| Iridium | Rhodium | Ruthenium | 12 | 70 | 18 | 1.1682 | 1.2215 | 0.7603 |
| Iridium | Molybdenum | None | 76 | 24 | 0 | 1.1674 | 1.2322 | 0.6885 |
| Iridium | Rhodium | Ruthenium | 20 | 66 | 14 | 1.1667 | 1.2219 | 0.7518 |
| Iridium | Rhodium | Ruthenium | 48 | 48 | 4 | 1.1647 | 1.2025 | 0.8295 |
| Iridium | Rhodium | Ruthenium | 38 | 50 | 12 | 1.1638 | 1.2773 | 0.4879 |
| Iridium | Ruthenium | Tungsten | 54 | 36 | 10 | 1.1631 | 1.2043 | 0.8139 |
| Iridium | Rhodium | Ruthenium | 16 | 68 | 16 | 1.1604 | 1.2156 | 0.7501 |
| Iridium | Rhodium | Ruthenium | 28 | 60 | 12 | 1.1563 | 1.2343 | 0.6443 |
| Iridium | Rhodium | Ruthenium | 40 | 50 | 10 | 1.1557 | 1.2539 | 0.5541 |
| Iridium | Rhodium | Ruthenium | 26 | 62 | 12 | 1.1528 | 1.2183 | 0.7011 |
| Iridium | Rhodium | Ruthenium | 36 | 52 | 12 | 1.1510 | 1.2628 | 0.4904 |
| Iridium | Rhodium | Ruthenium | 30 | 58 | 12 | 1.1502 | 1.2402 | 0.5887 |
| Iridium | Rhodium | Ruthenium | 32 | 56 | 12 | 1.1457 | 1.2460 | 0.5393 |
| Iridium | Rhodium | Ruthenium | 6 | 74 | 20 | 1.1439 | 1.1801 | 0.8335 |
| Iridium | Rhodium | Ruthenium | 42 | 52 | 6 | 1.1430 | 1.2260 | 0.6183 |
| Iridium | Molybdenum | None | 74 | 26 | 0 | 1.1394 | 1.1911 | 0.7472 |
| Iridium | Rhodium | Ruthenium | 34 | 54 | 12 | 1.1389 | 1.2485 | 0.4951 |
| Iridium | Rhodium | Ruthenium | 46 | 50 | 4 | 1.1370 | 1.1853 | 0.7771 |
| Iridium | Rhodium | Ruthenium | 40 | 52 | 8 | 1.1326 | 1.2252 | 0.5698 |
| Iridium | Rhodium | None | 88 | 12 | 0 | 1.1304 | 1.4829 | −0.6491 |
| Iridium | Rhodium | Ruthenium | 10 | 72 | 18 | 1.1296 | 1.1756 | 0.7865 |
| Iridium | Rhodium | None | 86 | 14 | 0 | 1.1291 | 1.4453 | −0.4670 |
| Iridium | Rhodium | Ruthenium | 24 | 64 | 12 | 1.1290 | 1.1849 | 0.7392 |
| Iridium | Rhodium | Ruthenium | 38 | 52 | 10 | 1.1242 | 1.2296 | 0.5074 |
| Iridium | Manganese | Ruthenium | 64 | 30 | 6 | 1.1234 | 1.2328 | 0.4887 |
| Iridium | Iron | None | 74 | 26 | 0 | 1.1212 | 1.1628 | 0.4549 |
| Iridium | Rhodium | None | 90 | 10 | 0 | 1.1199 | 1.4986 | −0.7899 |
| Iridium | Rhodium | None | 84 | 16 | 0 | 1.1129 | 1.3856 | −0.2567 |
| Iridium | Rhodium | Ruthenium | 18 | 68 | 14 | 1.1098 | 1.1609 | 0.7580 |
| Iridium | Rhodium | Ruthenium | 14 | 70 | 16 | 1.1072 | 1.1573 | 0.7629 |
| Iridium | Rhodium | Ruthenium | 4 | 76 | 20 | 1.1065 | 1.1365 | 0.8575 |
| Iridium | Molybdenum | None | 72 | 28 | 0 | 1.1051 | 1.1505 | 0.7705 |
| Iridium | Rhodium | Ruthenium | 36 | 54 | 10 | 1.0989 | 1.2091 | 0.4740 |
| Iridium | Manganese | Ruthenium | 64 | 28 | 8 | 1.0976 | 1.2082 | 0.4379 |
| Iridium | Rhodium | Ruthenium | 22 | 66 | 12 | 1.0947 | 1.1418 | 0.7744 |
| Iridium | Rhodium | Ruthenium | 40 | 54 | 6 | 1.0928 | 1.1952 | 0.5084 |
| Iridium | Rhodium | Ruthenium | 8 | 74 | 18 | 1.0927 | 1.1350 | 0.7967 |
| Iridium | Rhodium | Ruthenium | 38 | 54 | 8 | 1.0926 | 1.1982 | 0.4928 |
| Iridium | Rhodium | Ruthenium | 44 | 52 | 4 | 1.0843 | 1.1550 | 0.6570 |
| Iridium | Rhodium | None | 82 | 18 | 0 | 1.0842 | 1.3212 | −0.0959 |
| Iridium | Rhodium | Ruthenium | 34 | 56 | 10 | 1.0833 | 1.1899 | 0.4838 |
| Iridium | Molybdenum | None | 70 | 30 | 0 | 1.0753 | 1.1079 | 0.8324 |
| Iridium | Rhodium | None | 92 | 8 | 0 | 1.0723 | 1.4899 | −1.0495 |
| Iridium | Rhodium | Ruthenium | 32 | 58 | 10 | 1.0720 | 1.1698 | 0.5216 |
| Iridium | Rhenium | None | 84 | 16 | 0 | 1.0716 | 1.1546 | 0.3175 |
| Iridium | Rhodium | Ruthenium | 12 | 72 | 16 | 1.0678 | 1.1124 | 0.7811 |
| Iridium | Rhodium | Ruthenium | 36 | 56 | 8 | 1.0666 | 1.1752 | 0.4660 |
| Iridium | Rhodium | Ruthenium | 30 | 60 | 10 | 1.0659 | 1.1509 | 0.5811 |
| Iridium | Rhodium | Ruthenium | 6 | 76 | 18 | 1.0636 | 1.0958 | 0.8413 |
| Iridium | Rhenium | Tungsten | 60 | 6 | 34 | 1.0623 | 1.1085 | 0.7717 |
| Iridium | Rhodium | Ruthenium | 28 | 62 | 10 | 1.0583 | 1.1293 | 0.6478 |
| Iridium | Rhenium | None | 82 | 18 | 0 | 1.0541 | 1.1345 | 0.3714 |
| Iridium | Rhodium | Ruthenium | 38 | 56 | 6 | 1.0533 | 1.1687 | 0.4249 |
| Iridium | Rhodium | Ruthenium | 16 | 70 | 14 | 1.0521 | 1.0990 | 0.7663 |
| Iridium | Rhodium | None | 80 | 20 | 0 | 1.0511 | 1.2583 | 0.0293 |
| Iridium | Rhenium | None | 86 | 14 | 0 | 1.0505 | 1.1481 | 0.1952 |
| Iridium | Molybdenum | None | 68 | 32 | 0 | 1.0464 | 1.0621 | 0.9185 |
| Iridium | Rhodium | Ruthenium | 20 | 68 | 12 | 1.0455 | 1.0891 | 0.7812 |
| Iridium | Rhodium | Ruthenium | 34 | 58 | 8 | 1.0411 | 1.1490 | 0.4556 |
| Iridium | Rhodium | Ruthenium | 26 | 64 | 10 | 1.0410 | 1.0991 | 0.7075 |
| Iridium | Rhodium | Ruthenium | 42 | 54 | 4 | 1.0403 | 1.1297 | 0.5490 |
| Iridium | Rhodium | Ruthenium | 10 | 74 | 16 | 1.0331 | 1.0728 | 0.7983 |
| Iridium | Iron | None | 72 | 28 | 0 | 1.0305 | 1.1069 | 0.3393 |
| Iridium | Molybdenum | Ruthenium | 18 | 66 | 16 | 1.0301 | 1.0354 | 0.9729 |
| Iridium | Molybdenum | Ruthenium | 14 | 72 | 14 | 1.0269 | 1.0300 | 0.9840 |
| Iridium | Rhodium | Ruthenium | 32 | 60 | 8 | 1.0241 | 1.1213 | 0.5010 |
| Iridium | Rhodium | Ruthenium | 36 | 58 | 6 | 1.0213 | 1.1420 | 0.3797 |
| Iridium | Rhodium | None | 78 | 22 | 0 | 1.0209 | 1.2008 | 0.1430 |
| Iridium | Rhenium | None | 80 | 20 | 0 | 1.0162 | 1.0998 | 0.3692 |
| Iridium | Molybdenum | Ruthenium | 16 | 70 | 14 | 1.0147 | 1.0300 | 0.9211 |
| Iridium | Rhodium | Ruthenium | 24 | 66 | 10 | 1.0138 | 1.0601 | 0.7603 |
| Iridium | Molybdenum | Ruthenium | 20 | 64 | 16 | 1.0113 | 1.0145 | 0.9829 |
| Iridium | Molybdenum | Ruthenium | 12 | 76 | 12 | 1.0093 | 1.0118 | 0.9864 |
| Iridium | Molybdenum | Ruthenium | 18 | 68 | 14 | 1.0083 | 1.0294 | 0.8900 |
| Iridium | Rhodium | Ruthenium | 30 | 62 | 8 | 1.0041 | 1.0869 | 0.5661 |
| Iridium | Rhodium | Ruthenium | 14 | 72 | 14 | 1.0032 | 1.0452 | 0.7808 |
| Iridium | Molybdenum | Ruthenium | 80 | 16 | 4 | 1.0013 | 1.0352 | 0.8205 |
| Iridium | Molybdenum | Ruthenium | 14 | 74 | 12 | 1.0009 | 1.0128 | 0.9372 |
| Iridium | Rhodium | None | 76 | 24 | 0 | 1.0005 | 1.1554 | 0.2534 |

TABLE 16
Higher Overall Performance Data

| | | | Metal A | Metal B | Metal C | Relative | Relative | Relative |
|---|---|---|---|---|---|---|---|---|
| Metal A | Metal B | Metal C | Composition | Composition | Composition | BOL | EOL | Stability |
| Iridium | Rhodium | Ruthenium | 44 | 16 | 40 | 2.17228442 | 2.34217148 | 0.56610562 |
| Iridium | Rhodium | Ruthenium | 44 | 18 | 38 | 2.12832853 | 2.31644527 | 0.53612494 |
| Iridium | Rhodium | Ruthenium | 44 | 20 | 36 | 2.08887233 | 2.27281563 | 0.52088469 |
| Iridium | Rhenium | Tungsten | 86 | 6 | 8 | 2.05165425 | 2.17097451 | 0.69477347 |
| Iridium | Rhenium | Tungsten | 84 | 6 | 10 | 2.04811596 | 2.19456089 | 0.6247402 |
| Iridium | Rhodium | Ruthenium | 42 | 24 | 34 | 1.99671285 | 2.14819625 | 0.60183355 |
| Iridium | Rhodium | Ruthenium | 46 | 14 | 40 | 1.99648495 | 2.31214955 | 0.16663931 |
| Iridium | Rhodium | Ruthenium | 46 | 16 | 38 | 1.99555659 | 2.30080037 | 0.193796 |
| Iridium | Rhenium | Tungsten | 82 | 6 | 12 | 1.97813012 | 2.14809606 | 0.54804675 |
| Iridium | Rhodium | Ruthenium | 40 | 26 | 34 | 1.97542752 | 2.09365529 | 0.68589804 |
| Iridium | Rhodium | Ruthenium | 44 | 22 | 34 | 1.9749834 | 2.1906411 | 0.42692197 |
| Iridium | Rhodium | Ruthenium | 46 | 18 | 36 | 1.97429919 | 2.2760881 | 0.19440983 |
| Iridium | Rhenium | Tungsten | 80 | 6 | 14 | 1.9556048 | 2.11726752 | 0.56614857 |
| Iridium | Rhenium | Tungsten | 80 | 4 | 16 | 1.92184701 | 2.05620927 | 0.61484852 |
| Iridium | Rhodium | Ruthenium | 46 | 20 | 34 | 1.91902185 | 2.21839877 | 0.17990406 |
| Iridium | Rhodium | Ruthenium | 38 | 28 | 34 | 1.91256283 | 2.03218693 | 0.67155842 |
| Iridium | Rhodium | Ruthenium | 48 | 12 | 40 | 1.91197551 | 2.30669924 | −0.0840851 |
| Iridium | Rhenium | Ruthenium | 80 | 16 | 4 | 1.91086084 | 1.98913156 | 0.78318803 |
| Iridium | Rhodium | Ruthenium | 48 | 16 | 36 | 1.90300007 | 2.28227995 | −0.0524348 |
| Iridium | Rhenium | Ruthenium | 74 | 20 | 6 | 1.89699921 | 1.98147428 | 0.76519304 |
| Iridium | Rhodium | Ruthenium | 48 | 14 | 38 | 1.89347109 | 2.29822756 | −0.1218825 |
| Iridium | Rhenium | Tungsten | 80 | 2 | 18 | 1.87086426 | 1.96678924 | 0.73090746 |
| Iridium | Rhenium | Tungsten | 86 | 4 | 10 | 1.86809211 | 2.10803669 | 0.31986084 |
| Iridium | Rhodium | Ruthenium | 48 | 18 | 34 | 1.86648593 | 2.24670458 | −0.0691064 |
| Iridium | Rhodium | Ruthenium | 50 | 12 | 38 | 1.85624759 | 2.30255935 | −0.2620178 |
| Iridium | Rhodium | Ruthenium | 36 | 30 | 34 | 1.84621108 | 1.97691328 | 0.62845297 |
| Iridium | Rhodium | Ruthenium | 50 | 14 | 36 | 1.84027979 | 2.28554749 | −0.2702783 |
| Iridium | Rhodium | Ruthenium | 44 | 24 | 32 | 1.83678362 | 2.08763256 | 0.27775823 |
| Iridium | Rhodium | Ruthenium | 46 | 22 | 32 | 1.83452607 | 2.13761536 | 0.13016471 |
| Iridium | Rhenium | Tungsten | 82 | 4 | 14 | 1.83352214 | 2.07403779 | 0.30550561 |
| Iridium | Rhodium | Ruthenium | 50 | 16 | 34 | 1.8284103 | 2.26130904 | −0.2430386 |
| Iridium | Rhodium | Ruthenium | 48 | 20 | 32 | 1.8174021 | 2.17506844 | −0.0371677 |
| Iridium | Rhodium | Ruthenium | 52 | 12 | 36 | 1.81547759 | 2.28531204 | −0.358942 |
| Iridium | Rhenium | Ruthenium | 78 | 18 | 4 | 1.8137985 | 1.93088676 | 0.65847885 |
| Iridium | Rhodium | Ruthenium | 42 | 26 | 32 | 1.80864694 | 2.02592169 | 0.36569498 |
| Iridium | Rhodium | Ruthenium | 30 | 36 | 34 | 1.80485386 | 1.91561429 | 0.6776601 |
| Iridium | Rhodium | Ruthenium | 34 | 32 | 34 | 1.80270178 | 1.94334712 | 0.59047074 |
| Iridium | Rhodium | Ruthenium | 52 | 14 | 34 | 1.79997888 | 2.26555665 | −0.3574914 |
| Iridium | Rhenium | Ruthenium | 84 | 14 | 2 | 1.79532723 | 1.90244332 | 0.68687098 |
| Iridium | Rhodium | Ruthenium | 50 | 18 | 32 | 1.79393012 | 2.21064442 | −0.2198353 |
| Iridium | Rhenium | Tungsten | 84 | 4 | 12 | 1.78946512 | 2.06951337 | 0.16351941 |
| Iridium | Rhodium | Ruthenium | 32 | 34 | 34 | 1.78697069 | 1.9250362 | 0.59451013 |
| Iridium | Rhenium | Tungsten | 82 | 2 | 16 | 1.78162322 | 2.04864093 | 0.20922332 |
| Iridium | Rhenium | Ruthenium | 86 | 12 | 2 | 1.78076695 | 1.8729626 | 0.72828375 |
| Iridium | Rhodium | Ruthenium | 52 | 16 | 32 | 1.78039688 | 2.22781594 | −0.3200185 |
| Iridium | Rhodium | Ruthenium | 54 | 12 | 34 | 1.77941718 | 2.26046207 | −0.4188805 |
| Iridium | Rhodium | Ruthenium | 54 | 10 | 36 | 1.77862143 | 2.26507485 | −0.4353903 |
| Iridium | Rhenium | Ruthenium | 72 | 22 | 6 | 1.76644167 | 1.8770645 | 0.67133179 |
| Iridium | Rhodium | Ruthenium | 54 | 14 | 32 | 1.75841783 | 2.22806746 | −0.401869 |
| Iridium | Rhodium | Ruthenium | 28 | 40 | 32 | 1.75828641 | 1.84666381 | 0.73091434 |
| Iridium | Rhodium | Ruthenium | 40 | 28 | 32 | 1.75664923 | 1.96132841 | 0.3851086 |
| Iridium | Rhodium | Ruthenium | 56 | 10 | 34 | 1.75345186 | 2.24146972 | −0.4606768 |
| Iridium | Rhodium | Ruthenium | 26 | 44 | 30 | 1.74808841 | 1.82019093 | 0.78323435 |
| Iridium | Rhenium | Ruthenium | 82 | 16 | 2 | 1.74576629 | 1.88423436 | 0.58272895 |
| Iridium | Rhodium | Ruthenium | 56 | 12 | 32 | 1.73970664 | 2.21745666 | −0.4415978 |
| Iridium | Rhodium | Ruthenium | 52 | 18 | 30 | 1.73075233 | 2.16354308 | −0.312367 |
| Iridium | Rhodium | Ruthenium | 22 | 50 | 28 | 1.73020588 | 1.80244005 | 0.78049764 |
| Iridium | Rhodium | Ruthenium | 54 | 16 | 30 | 1.7299668 | 2.18570207 | −0.3826144 |
| Iridium | Rhodium | Ruthenium | 50 | 20 | 30 | 1.72656861 | 2.12126333 | −0.1997295 |
| Iridium | Rhodium | Ruthenium | 48 | 22 | 30 | 1.72513789 | 2.07741354 | −0.0716946 |
| Iridium | Rhodium | Ruthenium | 24 | 48 | 28 | 1.72161296 | 1.80063318 | 0.75796381 |
| Iridium | Rhodium | Ruthenium | 30 | 38 | 32 | 1.71877086 | 1.85453741 | 0.58302329 |
| Iridium | Rhodium | Ruthenium | 56 | 14 | 30 | 1.71656339 | 2.18355886 | −0.4277924 |
| Iridium | Rhenium | Ruthenium | 76 | 20 | 4 | 1.7160546 | 1.86414227 | 0.54509077 |
| Iridium | Rhodium | Ruthenium | 80 | 4 | 16 | 1.71508216 | 2.03904873 | 0.00864886 |
| Iridium | Rhodium | Ruthenium | 76 | 4 | 20 | 1.71309484 | 2.06013594 | −0.0631922 |
| Iridium | Rhodium | Ruthenium | 58 | 10 | 32 | 1.71206142 | 2.19586112 | −0.4831006 |
| Iridium | Rhodium | Ruthenium | 78 | 4 | 18 | 1.71127567 | 2.04046034 | −0.0095594 |
| Iridium | Rhodium | Ruthenium | 78 | 6 | 16 | 1.71092042 | 2.04757128 | −0.0326636 |
| Iridium | Rhodium | Ruthenium | 46 | 24 | 30 | 1.70843934 | 2.02170706 | 0.03790241 |
| Iridium | Rhodium | Ruthenium | 76 | 6 | 18 | 1.70818265 | 2.0534641 | −0.0608432 |
| Iridium | Rhodium | Ruthenium | 74 | 4 | 22 | 1.70808558 | 2.06567697 | −0.0987267 |
| Iridium | Rhodium | Ruthenium | 28 | 42 | 30 | 1.70743614 | 1.81193563 | 0.67879528 |
| Iridium | Rhodium | Ruthenium | 74 | 6 | 20 | 1.70622362 | 2.0645863 | −0.1023047 |
| Iridium | Rhodium | Ruthenium | 80 | 6 | 14 | 1.70584958 | 2.03257558 | −0.0052063 |
| Iridium | Rhodium | Ruthenium | 38 | 30 | 32 | 1.70453087 | 1.90595505 | 0.37671827 |
| Iridium | Rhodium | Ruthenium | 26 | 46 | 28 | 1.70316438 | 1.79610749 | 0.71243775 |
| Iridium | Rhodium | Ruthenium | 72 | 6 | 22 | 1.70133673 | 2.07168214 | −0.1424283 |
| Iridium | Rhodium | Ruthenium | 58 | 12 | 30 | 1.70069685 | 2.17112418 | −0.4517406 |
| Iridium | Rhodium | Ruthenium | 82 | 6 | 12 | 1.69967471 | 2.02009135 | 0.01062371 |
| Iridium | Rhodium | Ruthenium | 76 | 8 | 16 | 1.69902263 | 2.06332286 | −0.125485 |
| Iridium | Rhodium | Ruthenium | 74 | 8 | 18 | 1.69874432 | 2.0701299 | −0.1474677 |
| Iridium | Rhodium | Ruthenium | 78 | 8 | 14 | 1.69797587 | 2.0542791 | −0.1013763 |
| Iridium | Rhodium | Ruthenium | 72 | 8 | 20 | 1.69483192 | 2.07676202 | −0.1830005 |
| Iridium | Rhodium | Ruthenium | 72 | 4 | 24 | 1.69467543 | 2.06083815 | −0.1339655 |
| Iridium | Rhodium | Ruthenium | 24 | 50 | 26 | 1.69361621 | 1.80227672 | 0.66327993 |
| Iridium | Rhodium | Ruthenium | 80 | 8 | 12 | 1.69073201 | 2.03431535 | −0.066522 |
| Iridium | Rhodium | Ruthenium | 60 | 8 | 32 | 1.6906284 | 2.17419258 | −0.5011887 |
| Iridium | Rhodium | Ruthenium | 56 | 16 | 28 | 1.68731394 | 2.13690504 | −0.3985703 |
| Iridium | Rhodium | Ruthenium | 76 | 10 | 14 | 1.68612791 | 2.06231424 | −0.1709133 |
| Iridium | Rhodium | Ruthenium | 32 | 36 | 32 | 1.68481552 | 1.85720573 | 0.45780457 |
| Iridium | Rhodium | Ruthenium | 22 | 52 | 26 | 1.68436827 | 1.7846441 | 0.68768939 |
| Iridium | Rhodium | Ruthenium | 74 | 10 | 16 | 1.68387781 | 2.06802831 | −0.1973027 |
| Iridium | Rhodium | Ruthenium | 82 | 8 | 10 | 1.68371493 | 2.01909549 | −0.0454282 |
| Iridium | Rhodium | Ruthenium | 78 | 10 | 12 | 1.68288329 | 2.0470829 | −0.135774 |
| Iridium | Rhodium | Ruthenium | 72 | 10 | 18 | 1.68269262 | 2.07151788 | −0.2127239 |
| Iridium | Rhenium | Tungsten | 84 | 2 | 14 | 1.68265967 | 2.05925014 | −0.1745872 |
| Iridium | Rhodium | Ruthenium | 58 | 14 | 28 | 1.68257535 | 2.14159445 | −0.4317405 |
| Iridium | Rhodium | Ruthenium | 70 | 8 | 22 | 1.68133764 | 2.07442659 | −0.2271295 |
| Iridium | Rhodium | Ruthenium | 70 | 10 | 20 | 1.67865872 | 2.07814655 | −0.2490148 |
| Iridium | Rhodium | Ruthenium | 80 | 10 | 10 | 1.67791964 | 2.03561133 | −0.1187935 |
| Iridium | Rhodium | Ruthenium | 84 | 8 | 8 | 1.67700845 | 2.02220616 | −0.0803746 |
| Iridium | Rhodium | Ruthenium | 60 | 10 | 30 | 1.67672957 | 2.14760398 | −0.4738535 |
| Iridium | Rhodium | Ruthenium | 54 | 18 | 28 | 1.67543554 | 2.10685451 | −0.3515197 |
| Iridium | Rhodium | Ruthenium | 44 | 26 | 30 | 1.67512393 | 1.95538648 | 0.12192751 |
| Iridium | Rhodium | Ruthenium | 60 | 12 | 28 | 1.67359037 | 2.13029331 | −0.4320949 |
| Iridium | Rhodium | Ruthenium | 70 | 12 | 18 | 1.67350795 | 2.08778426 | −0.2993908 |
| Iridium | Rhodium | Ruthenium | 68 | 12 | 20 | 1.672689 | 2.08991388 | −0.3092842 |
| Iridium | Rhodium | Ruthenium | 36 | 32 | 32 | 1.67232684 | 1.87524807 | 0.36017512 |
| Iridium | Rhodium | Ruthenium | 68 | 8 | 24 | 1.67050992 | 2.07781528 | −0.2797722 |
| Iridium | Rhodium | Ruthenium | 70 | 6 | 24 | 1.66935319 | 2.05262425 | −0.2051442 |
| Iridium | Rhodium | Ruthenium | 68 | 10 | 22 | 1.66918598 | 2.07979542 | −0.2910304 |
| Iridium | Rhodium | Ruthenium | 72 | 12 | 16 | 1.66732565 | 2.07483412 | −0.2830308 |
| Iridium | Rhodium | Ruthenium | 74 | 12 | 14 | 1.66668981 | 2.06534614 | −0.2555342 |
| Iridium | Rhodium | Ruthenium | 66 | 10 | 24 | 1.66455061 | 2.08877478 | −0.3375762 |
| Iridium | Rhodium | Ruthenium | 66 | 12 | 22 | 1.66452946 | 2.08808621 | −0.3354978 |
| Iridium | Rhodium | Ruthenium | 82 | 10 | 8 | 1.66421083 | 2.03001602 | −0.1537928 |
| Iridium | Rhodium | Ruthenium | 76 | 12 | 12 | 1.66381121 | 2.04652322 | −0.2074616 |
| Iridium | Rhodium | Ruthenium | 34 | 34 | 32 | 1.66293388 | 1.86076715 | 0.37314611 |
| Iridium | Rhodium | Ruthenium | 78 | 12 | 10 | 1.66176853 | 2.03873545 | −0.1907118 |
| Iridium | Rhodium | Ruthenium | 26 | 48 | 26 | 1.66060457 | 1.77883691 | 0.62607859 |
| Iridium | Rhodium | Ruthenium | 66 | 8 | 26 | 1.66060236 | 2.08720922 | −0.3482479 |
| Iridium | Rhodium | Ruthenium | 62 | 10 | 28 | 1.66053565 | 2.11431964 | −0.4341797 |
| Iridium | Rhodium | Ruthenium | 52 | 20 | 28 | 1.6595446 | 2.05982443 | −0.2665261 |
| Iridium | Rhodium | Ruthenium | 64 | 12 | 24 | 1.65860956 | 2.09119353 | −0.3688544 |
| Iridium | Rhodium | Ruthenium | 64 | 10 | 26 | 1.65836321 | 2.09589525 | −0.3846578 |
| Iridium | Rhodium | Ruthenium | 60 | 14 | 26 | 1.65818848 | 2.10577105 | −0.4166139 |
| Iridium | Rhodium | Ruthenium | 20 | 54 | 26 | 1.65763163 | 1.73318967 | 0.76077591 |
| Iridium | Rhodium | Ruthenium | 62 | 12 | 26 | 1.65600034 | 2.10004886 | −0.4072872 |
| Iridium | Rhenium | Ruthenium | 80 | 18 | 2 | 1.65583948 | 1.83451907 | 0.43367079 |
| Iridium | Rhodium | Ruthenium | 64 | 8 | 28 | 1.65505463 | 2.10177631 | −0.4165661 |
| Iridium | Rhodium | Ruthenium | 62 | 8 | 30 | 1.6539706 | 2.12314978 | −0.4887682 |
| Iridium | Rhodium | Ruthenium | 30 | 40 | 30 | 1.65076986 | 1.79652608 | 0.53576667 |
| Iridium | Rhodium | Ruthenium | 28 | 44 | 28 | 1.64979471 | 1.76532274 | 0.62821994 |
| Iridium | Rhodium | Ruthenium | 68 | 6 | 26 | 1.64875405 | 2.05195003 | −0.2834311 |
| Iridium | Rhodium | Ruthenium | 58 | 16 | 26 | 1.64874967 | 2.08796167 | −0.3980372 |
| Iridium | Rhodium | Ruthenium | 86 | 8 | 6 | 1.64765208 | 2.00340063 | −0.1331564 |
| Iridium | Rhodium | Ruthenium | 62 | 14 | 24 | 1.64472198 | 2.07821196 | −0.3832028 |
| Iridium | Rhodium | Ruthenium | 80 | 12 | 8 | 1.6426447 | 2.02826715 | −0.2321928 |
| Iridium | Rhenium | Ruthenium | 70 | 24 | 6 | 1.64102989 | 1.75593985 | 0.63235706 |
| Iridium | Rhodium | Ruthenium | 50 | 22 | 28 | 1.63899718 | 2.00912572 | −0.1858795 |
| Iridium | Rhodium | Ruthenium | 84 | 10 | 6 | 1.63608146 | 2.00652594 | −0.1883119 |
| Iridium | Rhodium | Ruthenium | 64 | 14 | 22 | 1.63511273 | 2.05494245 | −0.3475278 |
| Iridium | Rhodium | Ruthenium | 76 | 14 | 10 | 1.63413551 | 2.02695004 | −0.2615711 |
| Iridium | Rhodium | Ruthenium | 74 | 14 | 12 | 1.63370878 | 2.02702014 | −0.2635064 |
| Iridium | Rhenium | Tungsten | 86 | 2 | 12 | 1.63127162 | 2.04237615 | −0.3226296 |
| Iridium | Rhodium | Ruthenium | 56 | 18 | 26 | 1.62792874 | 2.0504704 | −0.3622173 |
| Iridium | Rhodium | Ruthenium | 66 | 14 | 20 | 1.62694643 | 2.03842897 | −0.327357 |
| Iridium | Rhodium | Ruthenium | 72 | 14 | 14 | 1.6267995 | 2.02902836 | −0.2976317 |
| Iridium | Rhodium | Ruthenium | 42 | 28 | 30 | 1.62672361 | 1.88833682 | 0.15605858 |
| Iridium | Rhodium | Ruthenium | 60 | 16 | 24 | 1.6244877 | 2.0481802 | −0.3687778 |
| Iridium | Rhodium | Ruthenium | 22 | 54 | 24 | 1.62304778 | 1.73690736 | 0.63129271 |
| Iridium | Rhodium | Ruthenium | 24 | 52 | 24 | 1.62195295 | 1.74958148 | 0.58591117 |
| Iridium | Rhodium | Ruthenium | 68 | 14 | 18 | 1.62183189 | 2.0307413 | −0.3232244 |
| Iridium | Rhodium | Ruthenium | 70 | 14 | 16 | 1.62104712 | 2.0285229 | −0.3192281 |
| Iridium | Rhodium | Ruthenium | 78 | 14 | 8 | 1.62099979 | 2.02736665 | −0.3158599 |
| Iridium | Rhenium | Ruthenium | 74 | 22 | 4 | 1.6151792 | 1.79107306 | 0.42547763 |
| Iridium | Rhodium | Ruthenium | 82 | 12 | 6 | 1.61398385 | 2.00360809 | −0.2671138 |
| Iridium | Rhodium | Ruthenium | 48 | 24 | 28 | 1.612427 | 1.94897861 | −0.0966745 |
| Iridium | Rhodium | Ruthenium | 28 | 46 | 26 | 1.61165331 | 1.74764642 | 0.5571491 |
| Iridium | Rhodium | Ruthenium | 26 | 50 | 24 | 1.60604844 | 1.74104925 | 0.5577723 |
| Iridium | Rhodium | Ruthenium | 62 | 16 | 22 | 1.60374537 | 2.01411088 | −0.3428879 |
| Iridium | Rhodium | Ruthenium | 32 | 38 | 30 | 1.60355501 | 1.79398663 | 0.37674257 |
| Iridium | Rhodium | Ruthenium | 72 | 16 | 12 | 1.60139705 | 1.98534758 | −0.2583166 |
| Iridium | Rhodium | Ruthenium | 74 | 16 | 10 | 1.60101865 | 1.98400872 | −0.2553884 |
| Iridium | Rhodium | Ruthenium | 54 | 20 | 26 | 1.59804188 | 1.99723624 | −0.3108457 |
| Iridium | Rhodium | Ruthenium | 70 | 16 | 14 | 1.59517616 | 1.98708635 | −0.2893607 |
| Iridium | Rhodium | Ruthenium | 80 | 14 | 6 | 1.59330744 | 2.00042272 | −0.341004 |
| Iridium | Rhodium | Ruthenium | 30 | 42 | 28 | 1.59330206 | 1.73760037 | 0.52278897 |
| Iridium | Rhodium | Ruthenium | 58 | 18 | 24 | 1.59324085 | 2.00229536 | −0.3473871 |
| Iridium | Rhodium | Ruthenium | 20 | 56 | 24 | 1.59143644 | 1.68130354 | 0.70371905 |
| Iridium | Rhodium | Ruthenium | 64 | 16 | 20 | 1.59083178 | 1.99361071 | −0.328792 |
| Iridium | Rhodium | Ruthenium | 76 | 16 | 8 | 1.58948413 | 1.99089146 | −0.3254105 |
| Iridium | Rhodium | Ruthenium | 68 | 16 | 16 | 1.58623749 | 1.98269794 | −0.3117216 |
| Iridium | Rhodium | Ruthenium | 66 | 16 | 18 | 1.58352324 | 1.98260254 | −0.3226281 |
| Iridium | Rhodium | Ruthenium | 40 | 30 | 30 | 1.58132666 | 1.8332752 | 0.16381476 |
| Iridium | Rhodium | Ruthenium | 78 | 16 | 6 | 1.57399289 | 1.99013788 | −0.3875948 |
| Iridium | Rhodium | Ruthenium | 72 | 18 | 10 | 1.57282322 | 1.93840051 | −0.2198644 |
| Iridium | Rhodium | Ruthenium | 70 | 18 | 12 | 1.57244579 | 1.94162407 | −0.2321885 |
| Iridium | Rhodium | Ruthenium | 46 | 26 | 28 | 1.57220395 | 1.87982184 | −0.0280789 |
| Iridium | Rhodium | Ruthenium | 34 | 36 | 30 | 1.57002375 | 1.79187621 | 0.25811006 |
| Iridium | Rhodium | Ruthenium | 24 | 54 | 22 | 1.56800366 | 1.70507711 | 0.54120518 |
| Iridium | Rhodium | Ruthenium | 52 | 22 | 26 | 1.56673807 | 1.9410771 | −0.2539521 |
| Iridium | Rhodium | Ruthenium | 60 | 18 | 22 | 1.56629528 | 1.96326251 | −0.3301275 |
| Iridium | Rhodium | Ruthenium | 68 | 18 | 14 | 1.56489231 | 1.94295153 | −0.2679077 |
| Iridium | Rhodium | Ruthenium | 74 | 18 | 8 | 1.56392903 | 1.94969304 | −0.2946978 |
| Iridium | Rhodium | Ruthenium | 22 | 56 | 22 | 1.55739077 | 1.67371169 | 0.60816026 |
| Iridium | Rhodium | Ruthenium | 38 | 32 | 30 | 1.55583204 | 1.80352707 | 0.16447046 |
| Iridium | Rhodium | Ruthenium | 56 | 20 | 24 | 1.55529929 | 1.94418043 | −0.3121767 |
| Iridium | Rhodium | Ruthenium | 66 | 18 | 16 | 1.5522038 | 1.93389269 | −0.2905679 |
| Iridium | Rhodium | Ruthenium | 18 | 58 | 24 | 1.55196501 | 1.62133922 | 0.76517519 |
| Iridium | Rhodium | Ruthenium | 28 | 48 | 24 | 1.55073206 | 1.69601287 | 0.50481005 |
| Iridium | Rhodium | Ruthenium | 62 | 18 | 20 | 1.55061088 | 1.94033921 | −0.319068 |
| Iridium | Rhodium | Ruthenium | 76 | 18 | 6 | 1.5502151 | 1.95499373 | −0.3703701 |
| Iridium | Rhodium | Ruthenium | 36 | 34 | 30 | 1.54933227 | 1.79042513 | 0.18331979 |
| Iridium | Rhodium | Ruthenium | 86 | 10 | 4 | 1.54740994 | 1.91761643 | −0.2558076 |
| Iridium | Rhodium | Ruthenium | 70 | 20 | 10 | 1.54631209 | 1.89581086 | −0.1861289 |
| Iridium | Rhodium | Ruthenium | 26 | 52 | 22 | 1.54518049 | 1.69237867 | 0.49990978 |
| Iridium | Rhenium | Ruthenium | 68 | 26 | 6 | 1.54488396 | 1.64433686 | 0.66214231 |
| Iridium | Rhodium | Ruthenium | 64 | 18 | 18 | 1.54445633 | 1.92921905 | −0.3074636 |
| Iridium | Rhodium | Ruthenium | 68 | 20 | 12 | 1.54168745 | 1.89681939 | −0.2089886 |
| Iridium | Rhodium | Ruthenium | 30 | 44 | 26 | 1.54026424 | 1.69144206 | 0.48424758 |
| Iridium | Rhodium | Ruthenium | 32 | 40 | 28 | 1.5391242 | 1.72419563 | 0.36284166 |
| Iridium | Rhodium | Ruthenium | 72 | 20 | 8 | 1.53746929 | 1.90123907 | −0.241565 |
| Iridium | Rhodium | Ruthenium | 66 | 20 | 14 | 1.53145517 | 1.89432698 | −0.2434694 |
| Iridium | Rhodium | Ruthenium | 50 | 24 | 26 | 1.52992856 | 1.87671988 | −0.1893354 |
| Iridium | Rhodium | Ruthenium | 84 | 12 | 4 | 1.52800617 | 1.91071555 | −0.3147622 |
| Iridium | Rhodium | Ruthenium | 20 | 58 | 22 | 1.52706036 | 1.62133001 | 0.67601275 |
| Iridium | Rhodium | Ruthenium | 82 | 14 | 4 | 1.52585196 | 1.92049188 | −0.3576015 |
| Iridium | Rhodium | Ruthenium | 44 | 28 | 28 | 1.5256084 | 1.81247878 | 0.01209441 |
| Iridium | Rhodium | Ruthenium | 74 | 20 | 6 | 1.5236137 | 1.90335177 | −0.3078065 |
| Iridium | Rhodium | Ruthenium | 58 | 20 | 22 | 1.5207313 | 1.9002139 | −0.3095267 |
| Iridium | Rhodium | Ruthenium | 68 | 22 | 10 | 1.51902142 | 1.85647575 | −0.1659055 |
| Iridium | Rhodium | Ruthenium | 54 | 22 | 24 | 1.5143321 | 1.88316915 | −0.2783488 |
| Iridium | Rhodium | Ruthenium | 64 | 20 | 16 | 1.51307395 | 1.8766987 | −0.2611681 |
| Iridium | Rhodium | Ruthenium | 66 | 22 | 12 | 1.51187703 | 1.85668811 | −0.1969958 |
| Iridium | Rhodium | Ruthenium | 16 | 60 | 24 | 1.50925159 | 1.56725675 | 0.79833428 |
| Iridium | Rhodium | Ruthenium | 60 | 20 | 20 | 1.50438323 | 1.87679378 | −0.2991178 |
| Iridium | Rhodium | Ruthenium | 70 | 22 | 8 | 1.50369122 | 1.84565673 | −0.1936317 |
| Iridium | Rhodium | Ruthenium | 80 | 16 | 4 | 1.50163817 | 1.90355634 | −0.4049076 |
| Iridium | Rhodium | Ruthenium | 28 | 50 | 22 | 1.50065526 | 1.65628738 | 0.45570976 |
| Iridium | Rhodium | Ruthenium | 62 | 20 | 18 | 1.50053902 | 1.8667493 | −0.2807059 |
| Iridium | Rhodium | Ruthenium | 64 | 22 | 14 | 1.49787329 | 1.8489122 | −0.2299641 |
| Iridium | Rhenium | Ruthenium | 72 | 24 | 4 | 1.49687157 | 1.68424671 | 0.34150179 |
| Iridium | Rhodium | Ruthenium | 34 | 38 | 28 | 1.49497107 | 1.71950404 | 0.21006947 |
| Iridium | Rhodium | Ruthenium | 66 | 24 | 10 | 1.49450183 | 1.82442103 | −0.1585642 |
| Iridium | Ruthenium | Tungsten | 52 | 12 | 36 | 1.49345824 | 1.57773304 | 0.70025434 |
| Iridium | Rhodium | Ruthenium | 24 | 56 | 20 | 1.49102329 | 1.61797772 | 0.55207791 |
| Iridium | Rhodium | Ruthenium | 22 | 58 | 20 | 1.48911283 | 1.59774215 | 0.61691983 |
| Iridium | Rhodium | Ruthenium | 72 | 22 | 6 | 1.48841248 | 1.84067435 | −0.2420943 |
| Iridium | Rhodium | Ruthenium | 30 | 46 | 24 | 1.48838562 | 1.64621103 | 0.44211323 |
| Iridium | Rhodium | Ruthenium | 48 | 26 | 26 | 1.48653519 | 1.80560814 | −0.1264892 |
| Iridium | Rhenium | Ruthenium | 66 | 28 | 6 | 1.48647816 | 1.54859825 | 0.78148024 |
| Iridium | Rhodium | Ruthenium | 64 | 24 | 12 | 1.48566107 | 1.82706634 | −0.2062928 |
| Iridium | Rhodium | Ruthenium | 42 | 30 | 28 | 1.48435351 | 1.75697639 | 0.0351137 |
| Iridium | Rhodium | Ruthenium | 26 | 54 | 20 | 1.48139135 | 1.62642596 | 0.48568718 |
| Iridium | Rhodium | Ruthenium | 32 | 42 | 26 | 1.47653705 | 1.65247022 | 0.37466084 |
| Iridium | Rhodium | Ruthenium | 18 | 60 | 22 | 1.47635495 | 1.55378078 | 0.72502187 |
| Iridium | Rhodium | Ruthenium | 56 | 22 | 22 | 1.47609957 | 1.83771517 | −0.2857122 |
| Iridium | Rhodium | Ruthenium | 68 | 24 | 8 | 1.47608633 | 1.80210075 | −0.1590818 |
| Iridium | Rhodium | Ruthenium | 62 | 22 | 16 | 1.47572899 | 1.82350118 | −0.2368193 |
| Iridium | Rhodium | Ruthenium | 64 | 26 | 10 | 1.47338336 | 1.79771181 | −0.1552648 |
| Iridium | Rhodium | Ruthenium | 52 | 24 | 24 | 1.47248801 | 1.81737536 | −0.2292573 |
| Iridium | Rhodium | Ruthenium | 62 | 24 | 14 | 1.47001925 | 1.81667554 | −0.2376724 |
| Iridium | Rhodium | Ruthenium | 36 | 36 | 28 | 1.46992555 | 1.71466144 | 0.12343211 |
| Iridium | Rhodium | Ruthenium | 78 | 18 | 4 | 1.46992405 | 1.86800407 | −0.4218597 |
| Iridium | Ruthenium | Tungsten | 52 | 10 | 38 | 1.46619954 | 1.57859374 | 0.59768794 |
| Iridium | Rhodium | Ruthenium | 62 | 26 | 12 | 1.46472274 | 1.80584164 | −0.2223524 |
| Iridium | Rhodium | Ruthenium | 84 | 14 | 2 | 1.46206285 | 1.85338911 | −0.4047052 |
| Iridium | Rhodium | Ruthenium | 40 | 32 | 28 | 1.46202974 | 1.72686886 | 0.04819364 |
| Iridium | Ruthenium | Tungsten | 46 | 4 | 50 | 1.46141722 | 1.52964789 | 0.75497091 |
| Iridium | Ruthenium | Tungsten | 52 | 14 | 34 | 1.45969441 | 1.53612528 | 0.7251985 |
| Iridium | Rhodium | Ruthenium | 86 | 12 | 2 | 1.45905678 | 1.84440142 | −0.3860834 |
| Iridium | Rhodium | Ruthenium | 58 | 22 | 20 | 1.459001 | 1.81338709 | −0.2747569 |
| Iridium | Rhodium | Ruthenium | 60 | 22 | 18 | 1.45777418 | 1.80539698 | −0.2514982 |
| Iridium | Rhodium | Ruthenium | 70 | 24 | 6 | 1.45463201 | 1.78014614 | −0.1741656 |
| Iridium | Rhodium | Ruthenium | 38 | 34 | 28 | 1.45391084 | 1.71274067 | 0.06472884 |
| Iridium | Rhodium | Ruthenium | 62 | 28 | 10 | 1.45377819 | 1.77026998 | −0.1425064 |
| Iridium | Ruthenium | Tungsten | 50 | 12 | 38 | 1.45150432 | 1.5868455 | 0.51018706 |
| Iridium | Ruthenium | Tungsten | 44 | 4 | 52 | 1.44936842 | 1.53736662 | 0.68121665 |
| Iridium | Rhodium | Ruthenium | 66 | 26 | 8 | 1.44894051 | 1.75736932 | −0.1170747 |
| Iridium | Rhodium | Ruthenium | 20 | 60 | 20 | 1.44824654 | 1.5404078 | 0.66624093 |
| Iridium | Rhodium | Ruthenium | 60 | 26 | 14 | 1.44652115 | 1.79369182 | −0.2595937 |
| Iridium | Rhodium | Ruthenium | 60 | 28 | 12 | 1.44420361 | 1.78247699 | −0.2296053 |
| Iridium | Rhodium | Ruthenium | 82 | 16 | 2 | 1.44298646 | 1.84891544 | −0.4766677 |
| Iridium | Rhodium | Ruthenium | 60 | 24 | 16 | 1.44172706 | 1.77702034 | −0.2203642 |
| Iridium | Ruthenium | Tungsten | 54 | 8 | 38 | 1.44129317 | 1.53076119 | 0.67418659 |
| Iridium | Rhodium | Ruthenium | 46 | 28 | 26 | 1.44113308 | 1.73716183 | −0.0778483 |
| Iridium | Rhodium | Ruthenium | 76 | 20 | 4 | 1.43785836 | 1.81330181 | −0.3710664 |
| Iridium | Rhodium | Ruthenium | 28 | 52 | 20 | 1.43668278 | 1.58854227 | 0.44365404 |
| Iridium | Rhodium | Ruthenium | 30 | 48 | 22 | 1.43559183 | 1.5981432 | 0.40537055 |
| Iridium | Ruthenium | Tungsten | 56 | 6 | 38 | 1.43365688 | 1.49580897 | 0.77247833 |
| Iridium | Ruthenium | Tungsten | 50 | 14 | 36 | 1.43305181 | 1.55378351 | 0.55732787 |
| Iridium | Rhodium | Ruthenium | 24 | 58 | 18 | 1.43183604 | 1.54592285 | 0.58182853 |
| Iridium | Rhodium | Ruthenium | 60 | 30 | 10 | 1.43172879 | 1.73543888 | −0.1132962 |
| Iridium | Rhodium | Ruthenium | 54 | 24 | 22 | 1.43058602 | 1.77239496 | −0.2537599 |
| Iridium | Rhodium | Ruthenium | 34 | 40 | 26 | 1.43017226 | 1.64520246 | 0.21023317 |
| Iridium | Rhodium | Ruthenium | 64 | 28 | 8 | 1.42948512 | 1.72412112 | −0.081634 |
| Iridium | Rhodium | Ruthenium | 32 | 44 | 24 | 1.42877336 | 1.60092681 | 0.36340967 |
| Iridium | Rhodium | Ruthenium | 68 | 26 | 6 | 1.42689987 | 1.7278162 | −0.1067881 |
| Iridium | Ruthenium | Tungsten | 42 | 4 | 54 | 1.42648435 | 1.52506337 | 0.63731488 |
| Iridium | Rhodium | Ruthenium | 50 | 26 | 24 | 1.42536545 | 1.74568902 | −0.1796991 |
| Iridium | Rhodium | Ruthenium | 16 | 62 | 22 | 1.42438016 | 1.48882347 | 0.76255439 |
| Iridium | Rhodium | Ruthenium | 58 | 28 | 14 | 1.42318182 | 1.76842529 | −0.2731495 |
| Iridium | Rhodium | Ruthenium | 58 | 30 | 12 | 1.42208506 | 1.75051058 | −0.2122394 |
| Iridium | Rhodium | Ruthenium | 58 | 24 | 18 | 1.41848956 | 1.74900147 | −0.2227281 |
| Iridium | Ruthenium | Tungsten | 48 | 12 | 40 | 1.41744537 | 1.59623456 | 0.33616612 |
| Iridium | Ruthenium | Tungsten | 50 | 10 | 40 | 1.41716523 | 1.58258992 | 0.3862879 |
| Iridium | Rhodium | Ruthenium | 22 | 60 | 18 | 1.41591324 | 1.51590176 | 0.62953071 |
| Iridium | Rhodium | Ruthenium | 56 | 24 | 20 | 1.41546584 | 1.75146899 | −0.2457046 |
| Iridium | Ruthenium | Tungsten | 36 | 24 | 40 | 1.41477061 | 1.47483695 | 0.77517695 |
| Iridium | Rhodium | Ruthenium | 26 | 56 | 18 | 1.41300202 | 1.54182269 | 0.52130149 |
| Iridium | Rhodium | Ruthenium | 58 | 26 | 16 | 1.41272403 | 1.74130597 | −0.2204707 |
| Iridium | Rhodium | Ruthenium | 62 | 30 | 8 | 1.41050969 | 1.6886768 | −0.034889 |
| Iridium | Ruthenium | Tungsten | 52 | 16 | 32 | 1.40933292 | 1.48942702 | 0.69812546 |
| Iridium | Ruthenium | Tungsten | 48 | 14 | 38 | 1.40695656 | 1.57006904 | 0.3915586 |
| Iridium | Ruthenium | Tungsten | 38 | 24 | 38 | 1.40682338 | 1.48979002 | 0.68970863 |
| Iridium | Rhodium | Ruthenium | 66 | 28 | 6 | 1.40600984 | 1.68508181 | −0.0415374 |
| Iridium | Rhodium | Ruthenium | 74 | 22 | 4 | 1.40496995 | 1.75144636 | −0.2949535 |
| Iridium | Rhodium | Ruthenium | 58 | 32 | 10 | 1.40401023 | 1.68511901 | −0.0505291 |
| Iridium | Ruthenium | Tungsten | 34 | 12 | 54 | 1.40337191 | 1.509802 | 0.60150535 |
| Iridium | Ruthenium | Tungsten | 42 | 32 | 26 | 1.40312772 | 1.46232542 | 0.77732478 |
| Iridium | Rhodium | Ruthenium | 80 | 18 | 2 | 1.40285682 | 1.80964483 | −0.5218331 |
| Iridium | Rhodium | Ruthenium | 44 | 30 | 26 | 1.40274821 | 1.68131316 | −0.042219 |
| Iridium | Ruthenium | Tungsten | 40 | 30 | 30 | 1.39821331 | 1.47020803 | 0.72976631 |
| Iridium | Rhodium | Ruthenium | 36 | 38 | 26 | 1.39812477 | 1.64134518 | 0.08700934 |
| Iridium | Rhenium | Ruthenium | 70 | 26 | 4 | 1.3969578 | 1.58378241 | 0.29374551 |
| Iridium | Rhodium | Ruthenium | 18 | 62 | 20 | 1.39670768 | 1.47377417 | 0.71027759 |
| Iridium | Rhodium | Ruthenium | 56 | 30 | 14 | 1.39640062 | 1.73134746 | −0.258862 |
| Iridium | Ruthenium | Tungsten | 40 | 4 | 56 | 1.39413486 | 1.49571332 | 0.61759579 |
| Iridium | Rhodium | Ruthenium | 56 | 32 | 12 | 1.39213156 | 1.69635614 | −0.1469091 |
| Iridium | Ruthenium | Tungsten | 50 | 16 | 34 | 1.39211802 | 1.51010692 | 0.5540565 |
| Iridium | Ruthenium | Tungsten | 34 | 14 | 52 | 1.39017505 | 1.48499643 | 0.64125136 |
| Iridium | Ruthenium | Tungsten | 40 | 28 | 32 | 1.39001861 | 1.45866808 | 0.73834159 |
| Iridium | Ruthenium | Tungsten | 40 | 24 | 36 | 1.38947457 | 1.48479119 | 0.63847897 |
| Iridium | Ruthenium | Tungsten | 40 | 26 | 34 | 1.38936941 | 1.46705111 | 0.70656413 |
| Iridium | Ruthenium | Tungsten | 32 | 10 | 58 | 1.38821479 | 1.44230133 | 0.79552286 |
| Iridium | Ruthenium | Tungsten | 34 | 22 | 44 | 1.38772549 | 1.45491909 | 0.745585 |
| Iridium | Rhodium | Ruthenium | 64 | 30 | 6 | 1.38706684 | 1.64477612 | 0.02490954 |
| Iridium | Ruthenium | Tungsten | 36 | 12 | 52 | 1.3865982 | 1.54738566 | 0.39006297 |
| Iridium | Ruthenium | Tungsten | 46 | 12 | 42 | 1.38647214 | 1.6040698 | 0.17624137 |
| Iridium | Rhodium | Ruthenium | 14 | 64 | 22 | 1.38555262 | 1.44149818 | 0.78817148 |
| Iridium | Rhodium | Ruthenium | 60 | 32 | 8 | 1.38494855 | 1.64087683 | 0.03033643 |
| Iridium | Rhodium | Ruthenium | 52 | 26 | 22 | 1.3835944 | 1.70364262 | −0.2140005 |
| Iridium | Rhodium | Ruthenium | 30 | 50 | 20 | 1.38341168 | 1.54161336 | 0.39926358 |
| Iridium | Ruthenium | Tungsten | 46 | 14 | 40 | 1.38267792 | 1.58074332 | 0.24784345 |
| Iridium | Rhodium | Ruthenium | 56 | 28 | 16 | 1.38251708 | 1.702456 | −0.2137433 |
| Iridium | Ruthenium | Tungsten | 48 | 16 | 36 | 1.3820324 | 1.53438028 | 0.41950096 |
| Iridium | Rhodium | Ruthenium | 56 | 26 | 18 | 1.38120657 | 1.69620788 | −0.1969223 |
| Iridium | Rhodium | Ruthenium | 48 | 28 | 24 | 1.38069375 | 1.67789604 | −0.1298041 |
| Iridium | Rhodium | Ruthenium | 42 | 32 | 26 | 1.3803934 | 1.6489161 | −0.020883 |
| Iridium | Rhodium | Ruthenium | 38 | 36 | 26 | 1.37979668 | 1.63585035 | 0.02599616 |
| Iridium | Ruthenium | Tungsten | 52 | 8 | 40 | 1.37963015 | 1.52322094 | 0.45188039 |
| Iridium | Ruthenium | Tungsten | 36 | 22 | 42 | 1.37949815 | 1.48662333 | 0.59244833 |
| Iridium | Ruthenium | Tungsten | 38 | 22 | 40 | 1.37921147 | 1.50575246 | 0.51848118 |
| Iridium | Ruthenium | Tungsten | 34 | 10 | 56 | 1.37815811 | 1.49729009 | 0.54601623 |
| Iridium | Rhodium | Ruthenium | 28 | 54 | 18 | 1.37760503 | 1.51735051 | 0.46761564 |
| Iridium | Ruthenium | Tungsten | 40 | 22 | 38 | 1.37654317 | 1.51253896 | 0.48150106 |
| Iridium | Ruthenium | Tungsten | 48 | 10 | 42 | 1.37594955 | 1.58572662 | 0.19985675 |
| Iridium | Rhodium | Ruthenium | 32 | 46 | 22 | 1.37476904 | 1.54351068 | 0.35582367 |
| Iridium | Rhodium | Ruthenium | 34 | 42 | 24 | 1.37454829 | 1.57387328 | 0.2373857 |
| Iridium | Rhodium | Ruthenium | 56 | 34 | 10 | 1.37327732 | 1.62552467 | 0.03599209 |
| Iridium | Rhodium | Ruthenium | 20 | 62 | 18 | 1.37284478 | 1.4584984 | 0.67255637 |
| Iridium | Rhodium | Ruthenium | 54 | 26 | 20 | 1.37258539 | 1.69044574 | −0.2153723 |
| Iridium | Ruthenium | Tungsten | 34 | 16 | 50 | 1.37241053 | 1.45788015 | 0.67271775 |
| Iridium | Rhodium | Ruthenium | 40 | 34 | 26 | 1.37155538 | 1.63386451 | −0.0037194 |
| Iridium | Rhodium | Ruthenium | 72 | 24 | 4 | 1.37124034 | 1.68590419 | −0.2047146 |
| Iridium | Ruthenium | Tungsten | 38 | 12 | 50 | 1.37099569 | 1.58024159 | 0.19895604 |
| Iridium | Ruthenium | Tungsten | 38 | 4 | 58 | 1.37018748 | 1.46288899 | 0.64492588 |
| Iridium | Rhodium | Ruthenium | 62 | 32 | 6 | 1.36809887 | 1.60121831 | 0.10593414 |
| Iridium | Ruthenium | Tungsten | 54 | 18 | 28 | 1.36785708 | 1.42367847 | 0.78550539 |
| Iridium | Ruthenium | Tungsten | 44 | 12 | 44 | 1.36738013 | 1.60495351 | 0.08791582 |
| Iridium | Ruthenium | Tungsten | 36 | 14 | 50 | 1.36655799 | 1.52313884 | 0.39865623 |
| Iridium | Ruthenium | Tungsten | 46 | 16 | 38 | 1.36606835 | 1.55238101 | 0.28389204 |
| Iridium | Ruthenium | Tungsten | 36 | 10 | 54 | 1.36600614 | 1.5401712 | 0.33085439 |
| Iridium | Ruthenium | Tungsten | 42 | 30 | 28 | 1.36596756 | 1.4520987 | 0.66898943 |
| Iridium | Ruthenium | Tungsten | 34 | 20 | 46 | 1.36484696 | 1.45045536 | 0.66963198 |
| Iridium | Rhodium | Ruthenium | 54 | 32 | 14 | 1.36470746 | 1.67565065 | −0.1954713 |
| Iridium | Ruthenium | Tungsten | 42 | 22 | 36 | 1.36265977 | 1.5010299 | 0.46705105 |
| Iridium | Ruthenium | Tungsten | 42 | 24 | 34 | 1.36222331 | 1.47174395 | 0.577669 |
| Iridium | Ruthenium | Tungsten | 44 | 14 | 42 | 1.36143348 | 1.58593856 | 0.13454995 |
| Iridium | Rhodium | Ruthenium | 54 | 34 | 12 | 1.36082211 | 1.63527589 | −0.0587019 |
| Iridium | Ruthenium | Tungsten | 34 | 8 | 58 | 1.36063475 | 1.47819426 | 0.54562982 |
| Iridium | Ruthenium | Tungsten | 40 | 12 | 48 | 1.36053929 | 1.59327226 | 0.10210559 |
| Iridium | Ruthenium | Tungsten | 34 | 18 | 48 | 1.35970592 | 1.44572696 | 0.66703513 |
| Iridium | Ruthenium | Tungsten | 42 | 12 | 46 | 1.35776106 | 1.60594676 | 0.04070047 |
| Iridium | Rhodium | Ruthenium | 58 | 34 | 8 | 1.35686837 | 1.58485412 | 0.11822929 |
| Iridium | Ruthenium | Tungsten | 54 | 6 | 40 | 1.35596706 | 1.47976988 | 0.51876025 |
| Iridium | Rhodium | Ruthenium | 12 | 66 | 22 | 1.35554682 | 1.40729156 | 0.79966172 |
| Iridium | Ruthenium | Tungsten | 42 | 20 | 38 | 1.35449627 | 1.52870447 | 0.32474469 |
| Iridium | Ruthenium | Tungsten | 40 | 20 | 40 | 1.35442341 | 1.52635061 | 0.3332895 |
| Iridium | Ruthenium | Tungsten | 36 | 20 | 44 | 1.3539298 | 1.48474082 | 0.49101127 |
| Iridium | Ruthenium | Tungsten | 44 | 16 | 40 | 1.35381045 | 1.55927753 | 0.20296858 |
| Iridium | Ruthenium | Tungsten | 38 | 10 | 52 | 1.35304237 | 1.56742845 | 0.16820085 |
| Iridium | Ruthenium | Tungsten | 42 | 26 | 32 | 1.35303341 | 1.44920536 | 0.6266735 |
| Iridium | Rhodium | Ruthenium | 54 | 30 | 16 | 1.35248244 | 1.66027117 | −0.1938986 |
| Iridium | Ruthenium | Tungsten | 42 | 28 | 30 | 1.35192579 | 1.44574015 | 0.63549891 |
| Iridium | Ruthenium | Tungsten | 38 | 14 | 48 | 1.35061505 | 1.55087064 | 0.22162947 |
| Iridium | Ruthenium | Tungsten | 52 | 18 | 30 | 1.35053463 | 1.43595377 | 0.66805835 |
| Iridium | Manganese | Ruthenium | 62 | 30 | 8 | 1.35044444 | 1.40804238 | 0.77114409 |
| Iridium | Ruthenium | Tungsten | 36 | 8 | 56 | 1.35036536 | 1.52137599 | 0.33298495 |
| Iridium | Ruthenium | Tungsten | 38 | 20 | 42 | 1.35013707 | 1.51371153 | 0.36355212 |
| Iridium | Ruthenium | Tungsten | 36 | 4 | 60 | 1.34954694 | 1.40413122 | 0.78803572 |
| Iridium | Ruthenium | Tungsten | 36 | 16 | 48 | 1.34943249 | 1.49269987 | 0.44135096 |
| Iridium | Ruthenium | Tungsten | 46 | 10 | 44 | 1.34853293 | 1.58680487 | 0.07242301 |
| Iridium | Ruthenium | Tungsten | 44 | 20 | 36 | 1.34851958 | 1.51090447 | 0.36792873 |
| Iridium | Ruthenium | Tungsten | 42 | 14 | 44 | 1.34827104 | 1.58228694 | 0.08905964 |
| Iridium | Rhodium | Ruthenium | 36 | 40 | 24 | 1.34765253 | 1.57306193 | 0.11989234 |
| Iridium | Ruthenium | Tungsten | 46 | 18 | 36 | 1.34760192 | 1.52117029 | 0.32404354 |
| Iridium | Ruthenium | Tungsten | 44 | 18 | 38 | 1.34633426 | 1.54120638 | 0.24035783 |
| Iridium | Ruthenium | Tungsten | 48 | 18 | 34 | 1.3462762 | 1.49296894 | 0.42814399 |
| Iridium | Rhodium | Ruthenium | 16 | 64 | 20 | 1.34626051 | 1.41256199 | 0.7416251 |
| Iridium | Ruthenium | Tungsten | 50 | 18 | 32 | 1.34585966 | 1.46225793 | 0.54608066 |
| Iridium | Rhodium | Ruthenium | 54 | 28 | 18 | 1.34560795 | 1.64597264 | −0.1713758 |
| Iridium | Rhodium | Ruthenium | 60 | 34 | 6 | 1.34349243 | 1.54668378 | 0.20625276 |
| Iridium | Ruthenium | Tungsten | 44 | 30 | 26 | 1.34314096 | 1.42583176 | 0.67689191 |
| Iridium | Ruthenium | Tungsten | 40 | 14 | 46 | 1.34308135 | 1.57160323 | 0.10702824 |
| Iridium | Rhodium | Ruthenium | 54 | 36 | 10 | 1.34289816 | 1.55930064 | 0.15472298 |
| Iridium | Rhodium | Ruthenium | 46 | 30 | 24 | 1.34242105 | 1.61966431 | −0.0841108 |
| Iridium | Rhodium | Ruthenium | 70 | 26 | 4 | 1.34190461 | 1.62328191 | −0.1007432 |
| Iridium | Ruthenium | Tungsten | 44 | 22 | 34 | 1.34068943 | 1.47856881 | 0.46026154 |
| Iridium | Ruthenium | Tungsten | 42 | 18 | 40 | 1.34055721 | 1.54516739 | 0.19893965 |
| Iridium | Ruthenium | Tungsten | 40 | 10 | 50 | 1.34005175 | 1.58248344 | 0.05053259 |
| Iridium | Rhodium | Ruthenium | 50 | 28 | 22 | 1.33975811 | 1.63788383 | −0.1676004 |
| Iridium | Ruthenium | Tungsten | 38 | 8 | 54 | 1.33923522 | 1.55653951 | 0.14769712 |
| Iridium | Ruthenium | Tungsten | 42 | 16 | 42 | 1.33895422 | 1.5588002 | 0.13832371 |
| Iridium | Ruthenium | Tungsten | 36 | 18 | 46 | 1.33702383 | 1.48372527 | 0.42415249 |
| Iridium | Rhodium | Ruthenium | 24 | 60 | 16 | 1.33679018 | 1.42357134 | 0.65945846 |
| Iridium | Rhodium | Ruthenium | 26 | 58 | 16 | 1.33608426 | 1.43409637 | 0.61546115 |
| Iridium | Rhodium | Ruthenium | 32 | 48 | 20 | 1.33495394 | 1.49866385 | 0.35473705 |
| Iridium | Ruthenium | Tungsten | 46 | 20 | 34 | 1.33414313 | 1.48484511 | 0.40717047 |
| Iridium | Ruthenium | Tungsten | 40 | 18 | 42 | 1.3332592 | 1.5371745 | 0.1973107 |
| Iridium | Ruthenium | Tungsten | 40 | 16 | 44 | 1.333051 | 1.54384101 | 0.17035741 |
| Iridium | Ruthenium | Tungsten | 44 | 10 | 46 | 1.33301956 | 1.5877267 | −0.0028058 |
| Iridium | Ruthenium | Tungster | 42 | 10 | 48 | 1.33260829 | 1.58704314 | −0.002059 |
| Iridium | Ruthenium | Tungsten | 44 | 24 | 32 | 1.33242794 | 1.44573662 | 0.553089 |
| Iridium | Rhodium | Ruthenium | 52 | 28 | 20 | 1.33240747 | 1.63094814 | −0.1756665 |
| Iridium | Ruthenium | Tungsten | 38 | 16 | 46 | 1.33230193 | 1.52394327 | 0.24514961 |
| Iridium | Rhodium | Ruthenium | 52 | 34 | 14 | 1.33143034 | 1.61196076 | −0.1057928 |
| Iridium | Ruthenium | Tungsten | 38 | 18 | 44 | 1.33061686 | 1.51428664 | 0.27554986 |
| Iridium | Ruthenium | Tungsten | 44 | 28 | 28 | 1.32938953 | 1.42364072 | 0.62781327 |
| Iridium | Rhodium | Ruthenium | 52 | 36 | 12 | 1.32929471 | 1.56760357 | 0.05936587 |
| Iridium | Ruthenium | Tungsten | 46 | 30 | 24 | 1.32912723 | 1.39320126 | 0.74711703 |
| Iridium | Ruthenium | Tungsten | 34 | 6 | 60 | 1.32837052 | 1.43486495 | 0.57893444 |
| Iridium | Rhodium | Ruthenium | 34 | 44 | 22 | 1.3279507 | 1.51392969 | 0.26423496 |
| Iridium | Ruthenium | Tungsten | 50 | 8 | 42 | 1.32748313 | 1.51822878 | 0.24601292 |
| Iridium | Rhodium | Ruthenium | 30 | 52 | 18 | 1.32740752 | 1.47168176 | 0.42924017 |
| Iridium | Ruthenium | Tungsten | 40 | 8 | 52 | 1.32665199 | 1.5705389 | 0.03372258 |
| Iridium | Ruthenium | Tungsten | 52 | 20 | 28 | 1.32663162 | 1.40381977 | 0.69352877 |
| Iridium | Rhenium | Ruthenium | 68 | 28 | 4 | 1.32636994 | 1.48963768 | 0.34913552 |
| Iridium | Rhodium | Ruthenium | 56 | 36 | 8 | 1.32627784 | 1.51852896 | 0.23961837 |
| Iridium | Rhodium | Ruthenium | 38 | 38 | 24 | 1.32553437 | 1.57023076 | 0.03088312 |
| Iridium | Ruthenium | Tungsten | 48 | 20 | 32 | 1.32398761 | 1.45262638 | 0.49005374 |
| Iridium | Rhodium | Ruthenium | 52 | 32 | 16 | 1.32306507 | 1.61156177 | −0.1431033 |
| Iridium | Rhodium | Ruthenium | 44 | 32 | 24 | 1.32255938 | 1.58728617 | −0.0507354 |
| Iridium | Iron | None | 78 | 22 | 0 | 1.32168865 | 1.2493235 | 0.77706713 |
| Iridium | Rhodium | Ruthenium | 22 | 62 | 16 | 1.32140205 | 1.39901673 | 0.69205917 |
| Iridium | Ruthenium | Tungsten | 44 | 26 | 30 | 1.32129776 | 1.42661944 | 0.58166007 |
| Iridium | Ruthenium | Tungsten | 36 | 6 | 58 | 1.31807665 | 1.4868553 | 0.32796932 |
| Iridium | Rhodium | Ruthenium | 68 | 28 | 4 | 1.31745035 | 1.56718921 | 0.00490178 |
| Iridium | Ruthenium | Tungsten | 46 | 22 | 32 | 1.31729503 | 1.44784255 | 0.4799767 |
| Iridium | Rhodium | Ruthenium | 40 | 36 | 24 | 1.31697879 | 1.56820334 | −0.0014893 |
| Iridium | Ruthenium | Tungsten | 42 | 8 | 50 | 1.31615782 | 1.57930296 | −0.0496777 |
| Iridium | Ruthenium | Tungsten | 50 | 20 | 30 | 1.31609326 | 1.42252985 | 0.57536657 |
| Iridium | Rhodium | Ruthenium | 52 | 38 | 10 | 1.31589036 | 1.49597703 | 0.28175251 |
| Iridium | Ruthenium | Tungsten | 52 | 22 | 26 | 1.31581185 | 1.37765954 | 0.75331549 |
| Iridium | Rhodium | Ruthenium | 58 | 36 | 6 | 1.31390613 | 1.48138619 | 0.33148641 |
| Iridium | Ruthenium | Tungsten | 46 | 28 | 26 | 1.31336692 | 1.39814824 | 0.66121698 |
| Iridium | Rhodium | Ruthenium | 52 | 30 | 18 | 1.31253318 | 1.59694172 | −0.1372202 |
| Iridium | Rhodium | Ruthenium | 18 | 64 | 18 | 1.31250408 | 1.38496291 | 0.71052592 |
| Iridium | Rhodium | Ruthenium | 42 | 34 | 24 | 1.31222691 | 1.56819125 | −0.0237968 |
| Iridium | Ruthenium | Tungsten | 48 | 28 | 24 | 1.3106985 | 1.3723857 | 0.75319047 |
| Iridium | Rhodium | Ruthenium | 28 | 56 | 16 | 1.31008353 | 1.41981841 | 0.56029082 |
| Iridium | Ruthenium | Tungsten | 48 | 8 | 44 | 1.30744899 | 1.53149127 | 0.10082898 |
| Iridium | Ruthenium | Tungsten | 38 | 6 | 56 | 1.30687802 | 1.52076115 | 0.1408185 |
| Iridium | Ruthenium | Tungsten | 46 | 24 | 30 | 1.30641526 | 1.41906452 | 0.54742152 |
| Iridium | Ruthenium | Tungsten | 46 | 26 | 28 | 1.30496083 | 1.40293119 | 0.60604973 |
| Iridium | Ruthenium | Tungsten | 50 | 26 | 24 | 1.30378852 | 1.35887259 | 0.77816669 |
| Iridium | Ruthenium | Tungsten | 44 | 8 | 48 | 1.30368371 | 1.56402747 | −0.0483303 |
| Iridium | Ruthenium | Tungsten | 50 | 22 | 28 | 1.30367169 | 1.39459739 | 0.63384321 |
| Iridium | Rhodium | Ruthenium | 48 | 30 | 22 | 1.30334599 | 1.58096619 | −0.1179016 |
| Iridium | Ruthenium | Tungsten | 50 | 24 | 26 | 1.30265558 | 1.37519964 | 0.70768174 |
| Iridium | Rhodium | Ruthenium | 50 | 38 | 12 | 1.3025741 | 1.50569883 | 0.18126818 |
| Iridium | Ruthenium | Tungsten | 48 | 22 | 30 | 1.30184946 | 1.41758609 | 0.53342408 |
| Iridium | Ruthenium | Tungsten | 48 | 24 | 28 | 1.30109068 | 1.39577944 | 0.61806521 |
| Iridium | Rhodium | Ruthenium | 50 | 36 | 14 | 1.30087635 | 1.54961054 | −0.0031074 |
| Iridium | Rhodium | Ruthenium | 54 | 38 | 8 | 1.29970464 | 1.45513496 | 0.37241976 |
| Iridium | Rhodium | Ruthenium | 14 | 66 | 20 | 1.29945367 | 1.35805942 | 0.76310084 |
| Iridium | Ruthenium | Tungsten | 48 | 26 | 26 | 1.29933149 | 1.38026433 | 0.6730984 |
| Iridium | Ruthenium | Tungsten | 46 | 8 | 46 | 1.29782372 | 1.54800087 | −0.0117651 |
| Iridium | Rhodium | Ruthenium | 50 | 30 | 20 | 1.2971954 | 1.57726423 | −0.1331064 |
| Iridium | Rhodium | Ruthenium | 50 | 40 | 10 | 1.29552585 | 1.44389263 | 0.39922875 |
| Iridium | Rhodium | Ruthenium | 36 | 42 | 22 | 1.29528206 | 1.50987751 | 0.13050239 |
| Iridium | Rhodium | Ruthenium | 50 | 34 | 16 | 1.29392117 | 1.55814729 | −0.0715184 |
| Iridium | Ruthenium | Tungsten | 52 | 6 | 42 | 1.29370569 | 1.47002183 | 0.28473194 |
| Iridium | Ruthenium | Tungsten | 40 | 6 | 54 | 1.2932838 | 1.53965613 | 0.00020641 |
| Iridium | Rhodium | Ruthenium | 66 | 30 | 4 | 1.29261902 | 1.50435298 | 0.14091472 |
| Iridium | Rhodium | Ruthenium | 34 | 46 | 20 | 1.2887446 | 1.46280989 | 0.29034801 |
| Iridium | Rhodium | Ruthenium | 56 | 38 | 6 | 1.28784962 | 1.41980503 | 0.46225756 |
| Iridium | Rhodium | Ruthenium | 64 | 32 | 4 | 1.2876101 | 1.47111993 | 0.25255518 |
| Iridium | Rhodium | Ruthenium | 50 | 32 | 18 | 1.28596692 | 1.55295662 | −0.0894705 |
| Iridium | Rhodium | Ruthenium | 38 | 40 | 22 | 1.28251693 | 1.51266396 | 0.05813444 |
| Iridium | Rhodium | Ruthenium | 46 | 32 | 22 | 1.28213422 | 1.54369099 | −0.0705529 |
| Iridium | Ruthenium | Tungsten | 42 | 6 | 52 | 1.28178063 | 1.54772152 | −0.0889855 |
| Iridium | Rhodium | Ruthenium | 48 | 40 | 12 | 1.28079377 | 1.45396437 | 0.29027615 |
| Iridium | Rhodium | Ruthenium | 52 | 40 | 8 | 1.27960078 | 1.40286618 | 0.49460796 |
| Iridium | Rhodium | Ruthenium | 32 | 50 | 18 | 1.27905211 | 1.43083223 | 0.3772139 |
| Iridium | Rhodium | Ruthenium | 48 | 42 | 10 | 1.27736971 | 1.39907503 | 0.4999595 |
| Iridium | Rhodium | Ruthenium | 48 | 32 | 20 | 1.27531887 | 1.53858929 | −0.0832314 |
| Iridium | Rhodium | Ruthenium | 30 | 54 | 16 | 1.27443785 | 1.39437093 | 0.5065289 |
| Iridium | Rhodium | Ruthenium | 40 | 38 | 22 | 1.27402607 | 1.51391092 | 0.01181843 |
| Iridium | Rhodium | Ruthenium | 48 | 38 | 14 | 1.27372054 | 1.49344202 | 0.09466228 |
| Iridium | Rhodium | Ruthenium | 48 | 36 | 16 | 1.27339959 | 1.51753201 | −0.0056732 |
| Iridium | Rhodium | Ruthenium | 44 | 34 | 22 | 1.27124582 | 1.52136158 | −0.0325801 |
| Iridium | Rhodium | Ruthenium | 20 | 64 | 16 | 1.27100329 | 1.33974033 | 0.71629697 |
| Iridium | Rhodium | Ruthenium | 42 | 36 | 22 | 1.27063849 | 1.51546847 | −0.0112453 |
| Iridium | Manganese | Ruthenium | 64 | 32 | 4 | 1.2705091 | 1.32263671 | 0.76883543 |
| Iridium | Rhodium | Ruthenium | 54 | 40 | 6 | 1.2701002 | 1.37130535 | 0.5820212 |
| Iridium | Rhodium | Ruthenium | 36 | 44 | 20 | 1.26902816 | 1.46264473 | 0.19785641 |
| Iridium | Rhodium | Ruthenium | 48 | 34 | 18 | 1.26559873 | 1.51626676 | −0.0394777 |
| Iridium | Ruthenium | Tungsten | 44 | 6 | 50 | 1.26449303 | 1.53719777 | −0.131849 |
| Iridium | Ruthenium | Tungsten | 50 | 6 | 44 | 1.26449262 | 1.4815313 | 0.09868362 |
| Iridium | Rhodium | Ruthenium | 50 | 42 | 8 | 1.26389605 | 1.36016804 | 0.60023151 |
| Iridium | Rhodium | Ruthenium | 46 | 42 | 12 | 1.26281398 | 1.40927115 | 0.3908093 |
| Iridium | Rhenium | Ruthenium | 66 | 30 | 4 | 1.26204408 | 1.39573488 | 0.43602734 |
| Iridium | Rhodium | Ruthenium | 62 | 34 | 4 | 1.26157515 | 1.41277848 | 0.37174526 |
| Iridium | Rhodium | Ruthenium | 12 | 68 | 20 | 1.26081291 | 1.31491663 | 0.77465361 |
| Iridium | Rhodium | Ruthenium | 46 | 34 | 20 | 1.25935567 | 1.50813201 | −0.0367481 |
| Iridium | Rhodium | Ruthenium | 52 | 42 | 6 | 1.25776117 | 1.33365008 | 0.68334061 |
| Iridium | Rhodium | Ruthenium | 50 | 44 | 6 | 1.25626708 | 1.3159793 | 0.75056707 |
| Iridium | Rhodium | Ruthenium | 16 | 66 | 18 | 1.25533045 | 1.3176488 | 0.73946258 |
| Iridium | Rhodium | Ruthenium | 44 | 36 | 20 | 1.25512603 | 1.49554074 | −0.0052761 |
| Iridium | Rhodium | Ruthenium | 46 | 44 | 10 | 1.25509269 | 1.35922057 | 0.56474742 |
| Iridium | Rhodium | Ruthenium | 38 | 42 | 20 | 1.25371966 | 1.46735619 | 0.10568726 |
| Iridium | Rhodium | Ruthenium | 40 | 40 | 20 | 1.2532398 | 1.4775638 | 0.06052799 |
| Iridium | Rhodium | Ruthenium | 46 | 36 | 18 | 1.25287777 | 1.49061213 | 0.00420495 |
| Iridium | Rhodium | Ruthenium | 46 | 38 | 16 | 1.25275883 | 1.47603371 | 0.06458624 |
| Iridium | Rhodium | Ruthenium | 48 | 44 | 8 | 1.2524329 | 1.33291958 | 0.66261766 |
| Iridium | Rhodium | Ruthenium | 42 | 38 | 20 | 1.25134224 | 1.48417503 | 0.02351652 |
| Iridium | Rhodium | Ruthenium | 46 | 40 | 14 | 1.25096978 | 1.44700251 | 0.17779924 |
| Iridium | Ruthenium | Tungsten | 46 | 6 | 48 | 1.25027794 | 1.51439318 | −0.1086118 |

TABLE 17
Outstanding Overall Performance Data

| | | | Metal A | Metal B | Metal C | Relative | Relative | Relative |
|---|---|---|---|---|---|---|---|---|
| Metal A | Metal B | Metal C | Composition | Composition | Composition | BOL | EOL | Stability |
| Iridium | Rhodium | Ruthenium | 44 | 16 | 40 | 2.1723 | 2.3422 | 0.5661 |
| Iridium | Rhodium | Ruthenium | 44 | 18 | 38 | 2.1283 | 2.3164 | 0.5361 |
| Iridium | Rhodium | Ruthenium | 44 | 20 | 36 | 2.0889 | 2.2728 | 0.5209 |
| Iridium | Rhenium | Tungsten | 84 | 6 | 10 | 2.0481 | 2.1946 | 0.6247 |
| Iridium | Rhodium | Ruthenium | 42 | 24 | 34 | 1.9967 | 2.1482 | 0.6018 |
| Iridium | Rhodium | Ruthenium | 46 | 14 | 40 | 1.9965 | 2.3121 | 0.1666 |
| Iridium | Rhodium | Ruthenium | 46 | 16 | 38 | 1.9956 | 2.3008 | 0.1938 |
| Iridium | Rhenium | Tungsten | 82 | 6 | 12 | 1.9781 | 2.1481 | 0.5480 |
| Iridium | Rhodium | Ruthenium | 44 | 22 | 34 | 1.9750 | 2.1906 | 0.4269 |
| Iridium | Rhodium | Ruthenium | 46 | 18 | 36 | 1.9743 | 2.2761 | 0.1944 |
| Iridium | Rhenium | Tungsten | 80 | 6 | 14 | 1.9556 | 2.1173 | 0.5661 |
| Iridium | Rhenium | Tungsten | 80 | 4 | 16 | 1.9218 | 2.0562 | 0.6148 |
| Iridium | Rhodium | Ruthenium | 46 | 20 | 34 | 1.9190 | 2.2184 | 0.1799 |
| Iridium | Rhodium | Ruthenium | 48 | 12 | 40 | 1.9120 | 2.3067 | −0.0841 |
| Iridium | Rhodium | Ruthenium | 48 | 16 | 36 | 1.9030 | 2.2823 | −0.0524 |
| Iridium | Rhodium | Ruthenium | 48 | 14 | 38 | 1.8935 | 2.2982 | −0.1219 |
| Iridium | Rhenium | Tungsten | 86 | 4 | 10 | 1.8681 | 2.1080 | 0.3199 |
| Iridium | Rhodium | Ruthenium | 48 | 18 | 34 | 1.8665 | 2.2467 | −0.0691 |
| Iridium | Rhodium | Ruthenium | 50 | 12 | 38 | 1.8562 | 2.3026 | −0.2620 |
| Iridium | Rhodium | Ruthenium | 36 | 30 | 34 | 1.8462 | 1.9769 | 0.6285 |
| Iridium | Rhodium | Ruthenium | 50 | 14 | 36 | 1.8403 | 2.2855 | −0.2703 |
| Iridium | Rhodium | Ruthenium | 44 | 24 | 32 | 1.8368 | 2.0876 | 0.2778 |
| Iridium | Rhodium | Ruthenium | 46 | 22 | 32 | 1.8345 | 2.1376 | 0.1302 |
| Iridium | Rhenium | Tungsten | 82 | 4 | 14 | 1.8335 | 2.0740 | 0.3055 |
| Iridium | Rhodium | Ruthenium | 50 | 16 | 34 | 1.8284 | 2.2613 | −0.2430 |
| Iridium | Rhodium | Ruthenium | 48 | 20 | 32 | 1.8174 | 2.1751 | −0.0372 |
| Iridium | Rhodium | Ruthenium | 52 | 12 | 36 | 1.8155 | 2.2853 | −0.3589 |
| Iridium | Rhenium | Ruthenium | 78 | 18 | 4 | 1.8138 | 1.9309 | 0.6585 |
| Iridium | Rhodium | Ruthenium | 42 | 26 | 32 | 1.8086 | 2.0259 | 0.3657 |
| Iridium | Rhodium | Ruthenium | 34 | 32 | 34 | 1.8027 | 1.9433 | 0.5905 |
| Iridium | Rhodium | Ruthenium | 52 | 14 | 34 | 1.8000 | 2.2656 | −0.3575 |
| Iridium | Rhodium | Ruthenium | 50 | 18 | 32 | 1.7939 | 2.2106 | −0.2198 |
| Iridium | Rhenium | Tungsten | 84 | 4 | 12 | 1.7895 | 2.0695 | 0.1635 |
| Iridium | Rhodium | Ruthenium | 32 | 34 | 34 | 1.7870 | 1.9250 | 0.5945 |
| Iridium | Rhenium | Tungsten | 82 | 2 | 16 | 1.7816 | 2.0486 | 0.2092 |
| Iridium | Rhodium | Ruthenium | 52 | 16 | 32 | 1.7804 | 2.2278 | −0.3200 |
| Iridium | Rhodium | Ruthenium | 54 | 12 | 34 | 1.7794 | 2.2605 | −0.4189 |
| Iridium | Rhodium | Ruthenium | 54 | 10 | 36 | 1.7786 | 2.2651 | −0.4354 |
| Iridium | Rhodium | Ruthenium | 54 | 14 | 32 | 1.7584 | 2.2281 | −0.4019 |
| Iridium | Rhodium | Ruthenium | 40 | 28 | 32 | 1.7566 | 1.9613 | 0.3851 |
| Iridium | Rhodium | Ruthenium | 56 | 10 | 34 | 1.7535 | 2.2415 | −0.4607 |
| Iridium | Rhenium | Ruthenium | 82 | 16 | 2 | 1.7458 | 1.8842 | 0.5827 |
| Iridium | Rhodium | Ruthenium | 56 | 12 | 32 | 1.7397 | 2.2175 | −0.4416 |
| Iridium | Rhodium | Ruthenium | 52 | 18 | 30 | 1.7308 | 2.1635 | −0.3124 |
| Iridium | Rhodium | Ruthenium | 54 | 16 | 30 | 1.7300 | 2.1857 | −0.3826 |
| Iridium | Rhodium | Ruthenium | 50 | 20 | 30 | 1.7266 | 2.1213 | −0.1997 |
| Iridium | Rhodium | Ruthenium | 48 | 22 | 30 | 1.7251 | 2.0774 | −0.0717 |
| Iridium | Rhodium | Ruthenium | 30 | 38 | 32 | 1.7188 | 1.8545 | 0.5830 |
| Iridium | Rhodium | Ruthenium | 56 | 14 | 30 | 1.7166 | 2.1836 | −0.4278 |
| Iridium | Rhenium | Ruthenium | 76 | 20 | 4 | 1.7161 | 1.8641 | 0.5451 |
| Iridium | Rhodium | Ruthenium | 80 | 4 | 16 | 1.7151 | 2.0390 | 0.0086 |
| Iridium | Rhodium | Ruthenium | 76 | 4 | 20 | 1.7131 | 2.0601 | −0.0632 |
| Iridium | Rhodium | Ruthenium | 58 | 10 | 32 | 1.7121 | 2.1959 | −0.4831 |
| Iridium | Rhodium | Ruthenium | 78 | 4 | 18 | 1.7113 | 2.0405 | −0.0096 |
| Iridium | Rhodium | Ruthenium | 78 | 6 | 16 | 1.7109 | 2.0476 | −0.0327 |
| Iridium | Rhodium | Ruthenium | 46 | 24 | 30 | 1.7084 | 2.0217 | 0.0379 |
| Iridium | Rhodium | Ruthenium | 76 | 6 | 18 | 1.7082 | 2.0535 | −0.0608 |
| Iridium | Rhodium | Ruthenium | 74 | 4 | 22 | 1.7081 | 2.0657 | −0.0987 |
| Iridium | Rhodium | Ruthenium | 74 | 6 | 20 | 1.7062 | 2.0646 | −0.1023 |
| Iridium | Rhodium | Ruthenium | 80 | 6 | 14 | 1.7058 | 2.0326 | −0.0052 |
| Iridium | Rhodium | Ruthenium | 38 | 30 | 32 | 1.7045 | 1.9060 | 0.3767 |
| Iridium | Rhodium | Ruthenium | 72 | 6 | 22 | 1.7013 | 2.0717 | −0.1424 |
| Iridium | Rhodium | Ruthenium | 58 | 12 | 30 | 1.7007 | 2.1711 | −0.4517 |
| Iridium | Rhodium | Ruthenium | 82 | 6 | 12 | 1.6997 | 2.0201 | 0.0106 |
| Iridium | Rhodium | Ruthenium | 76 | 8 | 16 | 1.6990 | 2.0633 | −0.1255 |
| Iridium | Rhodium | Ruthenium | 74 | 8 | 18 | 1.6987 | 2.0701 | −0.1475 |
| Iridium | Rhodium | Ruthenium | 78 | 8 | 14 | 1.6980 | 2.0543 | −0.1014 |
| Iridium | Rhodium | Ruthenium | 72 | 8 | 20 | 1.6948 | 2.0768 | −0.1830 |
| Iridium | Rhodium | Ruthenium | 72 | 4 | 24 | 1.6947 | 2.0608 | −0.1340 |
| Iridium | Rhodium | Ruthenium | 24 | 50 | 26 | 1.6936 | 1.8023 | 0.6633 |
| Iridium | Rhodium | Ruthenium | 80 | 8 | 12 | 1.6907 | 2.0343 | −0.0665 |
| Iridium | Rhodium | Ruthenium | 60 | 8 | 32 | 1.6906 | 2.1742 | −0.5012 |
| Iridium | Rhodium | Ruthenium | 56 | 16 | 28 | 1.6873 | 2.1369 | −0.3986 |
| Iridium | Rhodium | Ruthenium | 76 | 10 | 14 | 1.6861 | 2.0623 | −0.1709 |
| Iridium | Rhodium | Ruthenium | 32 | 36 | 32 | 1.6848 | 1.8572 | 0.4578 |
| Iridium | Rhodium | Ruthenium | 74 | 10 | 16 | 1.6839 | 2.0680 | −0.1973 |
| Iridium | Rhodium | Ruthenium | 82 | 8 | 10 | 1.6837 | 2.0191 | −0.0454 |
| Iridium | Rhodium | Ruthenium | 78 | 10 | 12 | 1.6829 | 2.0471 | −0.1358 |
| Iridium | Rhodium | Ruthenium | 72 | 10 | 18 | 1.6827 | 2.0715 | −0.2127 |
| Iridium | Rhenium | Tungsten | 84 | 2 | 14 | 1.6827 | 2.0593 | −0.1746 |
| Iridium | Rhodium | Ruthenium | 58 | 14 | 28 | 1.6826 | 2.1416 | −0.4317 |
| Iridium | Rhodium | Ruthenium | 70 | 8 | 22 | 1.6813 | 2.0744 | −0.2271 |
| Iridium | Rhodium | Ruthenium | 70 | 10 | 20 | 1.6787 | 2.0781 | −0.2490 |
| Iridium | Rhodium | Ruthenium | 80 | 10 | 10 | 1.6779 | 2.0356 | −0.1188 |
| Iridium | Rhodium | Ruthenium | 84 | 8 | 8 | 1.6770 | 2.0222 | −0.0804 |
| Iridium | Rhodium | Ruthenium | 60 | 10 | 30 | 1.6767 | 2.1476 | −0.4739 |
| Iridium | Rhodium | Ruthenium | 54 | 18 | 28 | 1.6754 | 2.1069 | −0.3515 |
| Iridium | Rhodium | Ruthenium | 44 | 26 | 30 | 1.6751 | 1.9554 | 0.1219 |
| Iridium | Rhodium | Ruthenium | 60 | 12 | 28 | 1.6736 | 2.1303 | −0.4321 |
| Iridium | Rhodium | Ruthenium | 70 | 12 | 18 | 1.6735 | 2.0878 | −0.2994 |
| Iridium | Rhodium | Ruthenium | 68 | 12 | 20 | 1.6727 | 2.0899 | −0.3093 |
| Iridium | Rhodium | Ruthenium | 36 | 32 | 32 | 1.6723 | 1.8752 | 0.3602 |
| Iridium | Rhodium | Ruthenium | 68 | 8 | 24 | 1.6705 | 2.0778 | −0.2798 |
| Iridium | Rhodium | Ruthenium | 70 | 6 | 24 | 1.6694 | 2.0526 | −0.2051 |
| Iridium | Rhodium | Ruthenium | 68 | 10 | 22 | 1.6692 | 2.0798 | −0.2910 |
| Iridium | Rhodium | Ruthenium | 72 | 12 | 16 | 1.6673 | 2.0748 | −0.2830 |
| Iridium | Rhodium | Ruthenium | 74 | 12 | 14 | 1.6667 | 2.0653 | −0.2555 |
| Iridium | Rhodium | Ruthenium | 66 | 10 | 24 | 1.6646 | 2.0888 | −0.3376 |
| Iridium | Rhodium | Ruthenium | 66 | 12 | 22 | 1.6645 | 2.0881 | −0.3355 |
| Iridium | Rhodium | Ruthenium | 82 | 10 | 8 | 1.6642 | 2.0300 | −0.1538 |
| Iridium | Rhodium | Ruthenium | 76 | 12 | 12 | 1.6638 | 2.0465 | −0.2075 |
| Iridium | Rhodium | Ruthenium | 34 | 34 | 32 | 1.6629 | 1.8608 | 0.3731 |
| Iridium | Rhodium | Ruthenium | 78 | 12 | 10 | 1.6618 | 2.0387 | −0.1907 |
| Iridium | Rhodium | Ruthenium | 26 | 48 | 26 | 1.6606 | 1.7788 | 0.6261 |
| Iridium | Rhodium | Ruthenium | 66 | 8 | 26 | 1.6606 | 2.0872 | −0.3482 |
| Iridium | Rhodium | Ruthenium | 62 | 10 | 28 | 1.6605 | 2.1143 | −0.4342 |
| Iridium | Rhodium | Ruthenium | 52 | 20 | 28 | 1.6595 | 2.0598 | −0.2665 |
| Iridium | Rhodium | Ruthenium | 64 | 12 | 24 | 1.6586 | 2.0912 | −0.3689 |
| Iridium | Rhodium | Ruthenium | 64 | 10 | 26 | 1.6584 | 2.0959 | −0.3847 |
| Iridium | Rhodium | Ruthenium | 60 | 14 | 26 | 1.6582 | 2.1058 | −0.4166 |
| Iridium | Rhodium | Ruthenium | 62 | 12 | 26 | 1.6560 | 2.1000 | −0.4073 |
| Iridium | Rhenium | Ruthenium | 80 | 18 | 2 | 1.6558 | 1.8345 | 0.4337 |
| Iridium | Rhodium | Ruthenium | 64 | 8 | 28 | 1.6551 | 2.1018 | −0.4166 |
| Iridium | Rhodium | Ruthenium | 62 | 8 | 30 | 1.6540 | 2.1231 | −0.4888 |
| Iridium | Rhodium | Ruthenium | 30 | 40 | 30 | 1.6508 | 1.7965 | 0.5358 |
| Iridium | Rhodium | Ruthenium | 28 | 44 | 28 | 1.6498 | 1.7653 | 0.6282 |
| Iridium | Rhodium | Ruthenium | 68 | 6 | 26 | 1.6488 | 2.0520 | −0.2834 |
| Iridium | Rhodium | Ruthenium | 58 | 16 | 26 | 1.6487 | 2.0880 | −0.3980 |
| Iridium | Rhodium | Ruthenium | 86 | 8 | 6 | 1.6477 | 2.0034 | −0.1332 |
| Iridium | Rhodium | Ruthenium | 62 | 14 | 24 | 1.6447 | 2.0782 | −0.3832 |
| Iridium | Rhodium | Ruthenium | 80 | 12 | 8 | 1.6426 | 2.0283 | −0.2322 |
| Iridium | Rhenium | Ruthenium | 70 | 24 | 6 | 1.6410 | 1.7559 | 0.6324 |
| Iridium | Rhodium | Ruthenium | 50 | 22 | 28 | 1.6390 | 2.0091 | −0.1859 |
| Iridium | Rhodium | Ruthenium | 84 | 10 | 6 | 1.6361 | 2.0065 | −0.1883 |
| Iridium | Rhodium | Ruthenium | 64 | 14 | 22 | 1.6351 | 2.0549 | −0.3475 |
| Iridium | Rhodium | Ruthenium | 76 | 14 | 10 | 1.6341 | 2.0270 | −0.2616 |
| Iridium | Rhodium | Ruthenium | 74 | 14 | 12 | 1.6337 | 2.0270 | −0.2635 |
| Iridium | Rhenium | Tungsten | 86 | 2 | 12 | 1.6313 | 2.0424 | −0.3226 |
| Iridium | Rhodium | Ruthenium | 56 | 18 | 26 | 1.6279 | 2.0505 | −0.3622 |
| Iridium | Rhodium | Ruthenium | 66 | 14 | 20 | 1.6269 | 2.0384 | −0.3274 |
| Iridium | Rhodium | Ruthenium | 72 | 14 | 14 | 1.6268 | 2.0290 | −0.2976 |
| Iridium | Rhodium | Ruthenium | 42 | 28 | 30 | 1.6267 | 1.8883 | 0.1561 |
| Iridium | Rhodium | Ruthenium | 60 | 16 | 24 | 1.6245 | 2.0482 | −0.3688 |
| Iridium | Rhodium | Ruthenium | 22 | 54 | 24 | 1.6230 | 1.7369 | 0.6313 |
| Iridium | Rhodium | Ruthenium | 24 | 52 | 24 | 1.6220 | 1.7496 | 0.5859 |
| Iridium | Rhodium | Ruthenium | 68 | 14 | 18 | 1.6218 | 2.0307 | −0.3232 |
| Iridium | Rhodium | Ruthenium | 70 | 14 | 16 | 1.6210 | 2.0285 | −0.3192 |
| Iridium | Rhodium | Ruthenium | 78 | 14 | 8 | 1.6210 | 2.0274 | −0.3159 |
| Iridium | Rhenium | Ruthenium | 74 | 22 | 4 | 1.6152 | 1.7911 | 0.4255 |
| Iridium | Rhodium | Ruthenium | 82 | 12 | 6 | 1.6140 | 2.0036 | −0.2671 |
| Iridium | Rhodium | Ruthenium | 48 | 24 | 28 | 1.6124 | 1.9490 | −0.0967 |
| Iridium | Rhodium | Ruthenium | 28 | 46 | 26 | 1.6117 | 1.7476 | 0.5571 |
| Iridium | Rhodium | Ruthenium | 26 | 50 | 24 | 1.6060 | 1.7410 | 0.5578 |
| Iridium | Rhodium | Ruthenium | 62 | 16 | 22 | 1.6037 | 2.0141 | −0.3429 |
| Iridium | Rhodium | Ruthenium | 32 | 38 | 30 | 1.6036 | 1.7940 | 0.3767 |
| Iridium | Rhodium | Ruthenium | 72 | 16 | 12 | 1.6014 | 1.9853 | −0.2583 |
| Iridium | Rhodium | Ruthenium | 74 | 16 | 10 | 1.6010 | 1.9840 | −0.2554 |
| Iridium | Rhodium | Ruthenium | 54 | 20 | 26 | 1.5980 | 1.9972 | −0.3108 |
| Iridium | Rhodium | Ruthenium | 70 | 16 | 14 | 1.5952 | 1.9871 | −0.2894 |
| Iridium | Rhodium | Ruthenium | 80 | 14 | 6 | 1.5933 | 2.0004 | −0.3410 |
| Iridium | Rhodium | Ruthenium | 30 | 42 | 28 | 1.5933 | 1.7376 | 0.5228 |
| Iridium | Rhodium | Ruthenium | 58 | 18 | 24 | 1.5932 | 2.0023 | −0.3474 |
| Iridium | Rhodium | Ruthenium | 64 | 16 | 20 | 1.5908 | 1.9936 | −0.3288 |
| Iridium | Rhodium | Ruthenium | 76 | 16 | 8 | 1.5895 | 1.9909 | −0.3254 |
| Iridium | Rhodium | Ruthenium | 68 | 16 | 16 | 1.5862 | 1.9827 | −0.3117 |
| Iridium | Rhodium | Ruthenium | 66 | 16 | 18 | 1.5835 | 1.9826 | −0.3226 |
| Iridium | Rhodium | Ruthenium | 40 | 30 | 30 | 1.5813 | 1.8333 | 0.1638 |
| Iridium | Rhodium | Ruthenium | 78 | 16 | 6 | 1.5740 | 1.9901 | −0.3876 |
| Iridium | Rhodium | Ruthenium | 72 | 18 | 10 | 1.5728 | 1.9384 | −0.2199 |
| Iridium | Rhodium | Ruthenium | 70 | 18 | 12 | 1.5724 | 1.9416 | −0.2322 |
| Iridium | Rhodium | Ruthenium | 46 | 26 | 28 | 1.5722 | 1.8798 | −0.0281 |
| Iridium | Rhodium | Ruthenium | 34 | 36 | 30 | 1.5700 | 1.7919 | 0.2581 |
| Iridium | Rhodium | Ruthenium | 24 | 54 | 22 | 1.5680 | 1.7051 | 0.5412 |
| Iridium | Rhodium | Ruthenium | 52 | 22 | 26 | 1.5667 | 1.9411 | −0.2540 |
| Iridium | Rhodium | Ruthenium | 60 | 18 | 22 | 1.5663 | 1.9633 | −0.3301 |
| Iridium | Rhodium | Ruthenium | 68 | 18 | 14 | 1.5649 | 1.9430 | −0.2679 |
| Iridium | Rhodium | Ruthenium | 74 | 18 | 8 | 1.5639 | 1.9497 | −0.2947 |
| Iridium | Rhodium | Ruthenium | 22 | 56 | 22 | 1.5574 | 1.6737 | 0.6082 |
| Iridium | Rhodium | Ruthenium | 38 | 32 | 30 | 1.5558 | 1.8035 | 0.1645 |
| Iridium | Rhodium | Ruthenium | 56 | 20 | 24 | 1.5553 | 1.9442 | −0.3122 |
| Iridium | Rhodium | Ruthenium | 66 | 18 | 16 | 1.5522 | 1.9339 | −0.2906 |
| Iridium | Rhodium | Ruthenium | 28 | 48 | 24 | 1.5507 | 1.6960 | 0.5048 |
| Iridium | Rhodium | Ruthenium | 62 | 18 | 20 | 1.5506 | 1.9403 | −0.3191 |
| Iridium | Rhodium | Ruthenium | 76 | 18 | 6 | 1.5502 | 1.9550 | −0.3704 |
| Iridium | Rhodium | Ruthenium | 36 | 34 | 30 | 1.5493 | 1.7904 | 0.1833 |
| Iridium | Rhodium | Ruthenium | 86 | 10 | 4 | 1.5474 | 1.9176 | −0.2558 |
| Iridium | Rhodium | Ruthenium | 70 | 20 | 10 | 1.5463 | 1.8958 | −0.1861 |
| Iridium | Rhodium | Ruthenium | 26 | 52 | 22 | 1.5452 | 1.6924 | 0.4999 |
| Iridium | Rhenium | Ruthenium | 68 | 26 | 6 | 1.5449 | 1.6443 | 0.6621 |
| Iridium | Rhodium | Ruthenium | 64 | 18 | 18 | 1.5445 | 1.9292 | −0.3075 |
| Iridium | Rhodium | Ruthenium | 68 | 20 | 12 | 1.5417 | 1.8968 | −0.2090 |
| Iridium | Rhodium | Ruthenium | 30 | 44 | 26 | 1.5403 | 1.6914 | 0.4842 |
| Iridium | Rhodium | Ruthenium | 32 | 40 | 28 | 1.5391 | 1.7242 | 0.3628 |
| Iridium | Rhodium | Ruthenium | 72 | 20 | 8 | 1.5375 | 1.9012 | −0.2416 |
| Iridium | Rhodium | Ruthenium | 66 | 20 | 14 | 1.5315 | 1.8943 | −0.2435 |
| Iridium | Rhodium | Ruthenium | 50 | 24 | 26 | 1.5299 | 1.8767 | −0.1893 |
| Iridium | Rhodium | Ruthenium | 84 | 12 | 4 | 1.5280 | 1.9107 | −0.3148 |
| Iridium | Rhodium | Ruthenium | 82 | 14 | 4 | 1.5259 | 1.9205 | −0.3576 |
| Iridium | Rhodium | Ruthenium | 44 | 28 | 28 | 1.5256 | 1.8125 | 0.0121 |
| Iridium | Rhodium | Ruthenium | 74 | 20 | 6 | 1.5236 | 1.9034 | −0.3078 |
| Iridium | Rhodium | Ruthenium | 58 | 20 | 22 | 1.5207 | 1.9002 | −0.3095 |
| Iridium | Rhodium | Ruthenium | 68 | 22 | 10 | 1.5190 | 1.8565 | −0.1659 |
| Iridium | Rhodium | Ruthenium | 54 | 22 | 24 | 1.5143 | 1.8832 | −0.2783 |
| Iridium | Rhodium | Ruthenium | 64 | 20 | 16 | 1.5131 | 1.8767 | −0.2612 |
| Iridium | Rhodium | Ruthenium | 66 | 22 | 12 | 1.5119 | 1.8567 | −0.1970 |
| Iridium | Rhodium | Ruthenium | 60 | 20 | 20 | 1.5044 | 1.8768 | −0.2991 |
| Iridium | Rhodium | Ruthenium | 70 | 22 | 8 | 1.5037 | 1.8457 | −0.1936 |
| Iridium | Rhodium | Ruthenium | 80 | 16 | 4 | 1.5016 | 1.9036 | −0.4049 |
| Iridium | Rhodium | Ruthenium | 28 | 50 | 22 | 1.5007 | 1.6563 | 0.4557 |
| Iridium | Rhodium | Ruthenium | 62 | 20 | 18 | 1.5005 | 1.8667 | −0.2807 |

TABLE 18
Scaled up catalyst material ranges in at % that show preferred characteristics.

| | | Min | Max | | Min | Max | | Min | Max | | Min | Max |
|---|---|---|---|---|---|---|---|---|---|---|---|---|
| | | Metal | Metal | | Metal | Metal | | Metal | Metal | | Metal | Metal |
| Materials | Metal | 1 | 1 | Metal | 2 | 2 | Metal | 3 | 3 | Metal | 4 | 4 |
| Space | 1 | at % | at % | 2 | at % | at % | 3 | at % | at % | 4 | at % | at % |
| IrMo | Ir | 16 | 89 | Mo | 10 | 84 | | | | | | |
| IrRe | Ir | 70 | 85 | Re | 15 | 30 | | | | | | |
| IrReW | Ir | 55 | 87 | Re | 3 | 13 | W | 4 | 39 | | | |
| IrRuMo | Ir | 4 | 24 | Ru | 61 | 79 | Mo | 13 | 19 | | | |
| IrRuPd | Ir | 8 | 36 | Ru | 35 | 85 | Pd | 2 | 50 | | | |
| IrRuPdCr | Ir | 1 | 1 | Ru | 29 | 59 | Pd | 3.7 | 40 | Cr | 5 | 28 |
| IrRuRe | Ir | 13 | 52 | Ru | 17 | 61 | Re | 10 | 49 | | | |
| IrRuRh | Ir | 14 | 41 | Ru | 23 | 42 | Rh | 29 | 56 | | | |
| IrRuW | Ir | 11 | 69 | Ru | 14 | 84 | W | 1 | 38 | | | |
| IrW | Ir | 34 | 92 | W | 2 | 65 | | | | | | |
| RuMoPd | Ru | 42 | 85 | Mo | 8 | 16 | Pd | 7 | 46 | | | |
| RuPd | Ru | 58 | 87 | Pd | 14 | 42 | | | | | | |

TABLE 19
Scaled up catalyst samples and their characteristics.

| | | | Max | Min | | | Max | Min | | | Max | Min | | | Max | Min |
|---|---|---|---|---|---|---|---|---|---|---|---|---|---|---|---|---|
| | | Metal | Metal | Metal | | Metal | Metal | Metal | | Metal | Metal | Metal | | Metal | Metal | Metal |
| Materials | Metal | 1 | 1 | 1 | Metal | 2 | 2 | 2 | Metal | 3 | 3 | 3 | Metal | 4 | 4 | 4 |
| Space | 1 | at % | at % | at % | 2 | at % | at % | at % | 3 | at % | at % | at % | 4 | at % | at % | at % |
| Ir | Ir | 100.0 | 100.0 | 100.0 | | | | | | | | | | | | |
| Benchmark | | | | | | | | | | | | | | | | |
| IrMo | Ir | 39.1 | 61.9 | 16.3 | Mo | 60.9 | 84 | 15.2 | | | | | | | | |
| IrMo | Ir | 84.7 | 88.9 | 80.5 | Mo | 15.3 | 20.1 | 10.4 | | | | | | | | |
| IrMo | Ir | 80.5 | 86.0 | 75.0 | Mo | 19.5 | 23.2 | 15.8 | | | | | | | | |
| IrRe | Ir | 77.7 | 85.1 | 70.2 | Re | 22.3 | 30.0 | 14.7 | | | | | | | | |
| IrReW | Ir | 71.1 | 87.1 | 55.0 | Re | 7.8 | 12.6 | 3.0 | W | 21.2 | 38.6 | 3.8 | | | | |
| IrReW | Ir | 79.8 | 84.3 | 75.3 | Re | 4.0 | 5.4 | 2.6 | W | 16.2 | 20.8 | 11.6 | | | | |
| IrRuMo | Ir | 15.8 | 20.4 | 11.2 | Ru | 68.8 | 76.3 | 61.2 | Mo | 15.5 | 18.3 | 12.6 | | | | |
| IrRuMo | Ir | 14.1 | 19.7 | 8.6 | Ru | 69.4 | 78.2 | 60.7 | Mo | 16.5 | 18.9 | 14.0 | | | | |
| IrRuMo | Ir | 14.2 | 24.2 | 4.2 | Ru | 70.6 | 78.5 | 62.7 | Mo | 17.1 | 19.2 | 16.8 | | | | |
| IrRuPd | Ir | 20.8 | 26.2 | 15.5 | Ru | 57.1 | 65.6 | 48.6 | Pd | 22.1 | 30.9 | 13.3 | | | | |
| IrRuPd | Ir | 18.3 | 23.7 | 12.8 | Ru | 53.7 | 63.6 | 43.8 | Pd | 28.0 | 35.1 | 20.8 | | | | |
| IrRuPd | Ir | 24.9 | 31.4 | 18.4 | Ru | 51.6 | 61.1 | 42.1 | Pd | 23.5 | 30.5 | 16.4 | | | | |
| IrRuPd | Ir | 19.8 | 27.5 | 12.2 | Ru | 62.3 | 77.0 | 47.7 | Pd | 17.8 | 28.8 | 6.9 | | | | |
| IrRuPd | Ir | 21.6 | 27.5 | 15.8 | Ru | 57.2 | 69.5 | 44.9 | Pd | 21.2 | 33.2 | 9.2 | | | | |
| IrRuPd | Ir | 15.6 | 23.7 | 7.5 | Ru | 56.2 | 74.9 | 37.4 | Pd | 28.2 | 48.8 | 7.6 | | | | |
| IrRuPd | Ir | 21.2 | 28.3 | 14.1 | Ru | 52.6 | 63.6 | 41.5 | Pd | 26.2 | 38.3 | 14.1 | | | | |
| IrRuPd | Ir | 20.5 | 27.5 | 13.4 | Ru | 55.3 | 68.1 | 42.5 | Pd | 24.2 | 35.4 | 12.9 | | | | |
| IrRuPd | Ir | 24.8 | 33.5 | 16.2 | Ru | 50.4 | 65.5 | 35.4 | Pd | 24.8 | 34.8 | 14.7 | | | | |
| IrRuPd | Ir | 22.7 | 30.2 | 15.3 | Ru | 53.0 | 67.2 | 38.9 | Pd | 24.2 | 33.7 | 14.8 | | | | |
| IrRuPd | Ir | 24.3 | 31.1 | 17.6 | Ru | 52.8 | 64.8 | 40.9 | Pd | 22.8 | 32.9 | 12.8 | | | | |
| IrRuPd | Ir | 25.7 | 35.7 | 15.7 | Ru | 51.0 | 65.8 | 36.2 | Pd | 23.3 | 38.2 | 8.4 | | | | |
| IrRuPd | Ir | 20.8 | 27.9 | 13.7 | Ru | 55.0 | 69.3 | 40.8 | Pd | 24.1 | 39.7 | 8.5 | | | | |
| IrRuPd | Ir | 20.6 | 27.0 | 14.3 | Ru | 48.5 | 61.9 | 35.1 | Pd | 30.8 | 50.4 | 11.2 | | | | |
| IrRuPd | Ir | 20.8 | 26.7 | 15.0 | Ru | 47.7 | 60.5 | 34.8 | Pd | 31.5 | 48.9 | 14.1 | | | | |
| IrRuPd | Ir | 19.9 | 31.3 | 8.4 | Ru | 62.9 | 85.3 | 40.4 | Pd | 17.3 | 27.1 | 7.4 | | | | |
| IrRuPd | Ir | 25.6 | 33.8 | 17.4 | Ru | 51.0 | 65.0 | 37.0 | Pd | 23.4 | 32.2 | 14.7 | | | | |
| IrRuPd | Ir | 28.0 | 33.5 | 22.4 | Ru | 49.6 | 59.2 | 40.0 | Pd | 22.4 | 29.0 | 15.8 | | | | |
| IrRuPd | Ir | 27.2 | 34.9 | 19.5 | Ru | 48.8 | 60.3 | 37.2 | Pd | 24.1 | 32.0 | 16.1 | | | | |
| IrRuPd | Ir | 26.0 | 34.4 | 17.6 | Ru | 51.3 | 65.5 | 37.1 | Pd | 22.7 | 31.6 | 13.8 | | | | |
| IrRuPd | Ir | 22.1 | 28.2 | 16.0 | Ru | 55.2 | 69.0 | 41.4 | Pd | 22.7 | 36.2 | 9.3 | | | | |
| IrRuPd | Ir | 23.4 | 28.3 | 18.5 | Ru | 58.8 | 68.4 | 49.2 | Pd | 17.8 | 26.1 | 9.5 | | | | |
| IrRuPd | Ir | 21.7 | 27.7 | 15.7 | Ru | 57.6 | 68.6 | 46.6 | Pd | 20.7 | 32.0 | 9.3 | | | | |
| IrRuPd | Ir | 23.5 | 32.8 | 14.2 | Ru | 58.8 | 79.8 | 37.8 | Pd | 17.8 | 37.6 | 2 | | | | |
| IrRuPd | Ir | 21.0 | 28.9 | 13.2 | Ru | 56.3 | 75.1 | 37.4 | Pd | 22.7 | 48.8 | 2 | | | | |
| IrRuPdCr | Ir | 1.0 | 1.4 | 0.6 | Ru | 44.1 | 58.8 | 29.4 | Pd | 21.6 | 39.5 | 3.7 | Cr | 16.3 | 27.8 | 4.8 |
| IrRuRe | Ir | 19.1 | 25.5 | 12.6 | Ru | 47.0 | 61.2 | 32.8 | Re | 33.9 | 48.7 | 19.2 | | | | |
| IrRuRe | Ir | 42.3 | 52.3 | 32.3 | Ru | 37.0 | 57.5 | 16.5 | Re | 20.7 | 31.7 | 9.7 | | | | |
| IrRuRe | Ir | 41.0 | 49.4 | 32.6 | Ru | 39.3 | 51.7 | 26.8 | Re | 19.7 | 26.0 | 13.5 | | | | |
| IrRuRh | Ir | 34.0 | 40.7 | 27.3 | Ru | 32.2 | 41.5 | 22.8 | Rh | 33.8 | 38.8 | 28.8 | | | | |
| IrRuRh | Ir | 28.4 | 36.3 | 20.5 | Ru | 32.7 | 39.4 | 26.1 | Rh | 38.8 | 47.0 | 30.7 | | | | |
| IrRuRh | Ir | 22.2 | 30.8 | 13.5 | Ru | 32.9 | 39.7 | 26.1 | Rh | 44.9 | 55.9 | 34.0 | | | | |
| IrRuW | Ir | 30.7 | 36.2 | 25.2 | Ru | 42.0 | 54.6 | 29.4 | W | 27.3 | 37.6 | 17.0 | | | | |
| IrRuW | Ir | 23.2 | 29.2 | 17.2 | Ru | 59.4 | 71.9 | 46.8 | W | 17.5 | 24.3 | 10.6 | | | | |
| IrRuW | Ir | 43.0 | 51.9 | 34.0 | Ru | 41.4 | 53.8 | 28.9 | W | 15.7 | 22.1 | 9.2 | | | | |
| IrRuW | Ir | 26.8 | 32.6 | 21.0 | Ru | 68.1 | 80.2 | 56.0 | W | 5.1 | 8.9 | 1.3 | | | | |
| IrRuW | Ir | 41.7 | 47.8 | 35.6 | Ru | 47.3 | 64.8 | 29.7 | W | 11.0 | 18.9 | 3.1 | | | | |
| IrRuW | Ir | 40.1 | 52.8 | 27.4 | Ru | 38.9 | 51.1 | 26.6 | W | 21.0 | 38.2 | 3.9 | | | | |
| IrRuW | Ir | 33.5 | 40.7 | 26.3 | Ru | 39.3 | 49.2 | 29.5 | W | 27.2 | 37.2 | 17.2 | | | | |
| IrRuW | Ir | 25.0 | 30.6 | 19.4 | Ru | 69.6 | 79.9 | 59.3 | W | 5.4 | 9.0 | 1.7 | | | | |
| IrRuW | Ir | 25.8 | 31.9 | 19.7 | Ru | 68.3 | 80.9 | 55.7 | W | 5.9 | 8.8 | 3.0 | | | | |
| IrRuW | Ir | 24.5 | 29.1 | 19.8 | Ru | 67.1 | 76.4 | 57.7 | W | 8.5 | 12.9 | 4.1 | | | | |
| IrRuW | Ir | 27.1 | 32.9 | 21.3 | Ru | 64.0 | 82.0 | 46.0 | W | 8.9 | 20.2 | 2 | | | | |
| IrRuW | Ir | 24.1 | 31.6 | 16.6 | Ru | 61.4 | 78.8 | 43.9 | W | 14.5 | 24.6 | 4.5 | | | | |
| IrRuW | Ir | 26.6 | 34.7 | 18.4 | Ru | 59.7 | 74.5 | 44.9 | W | 13.8 | 21.1 | 6.4 | | | | |
| IrRuW | Ir | 27.1 | 34.3 | 19.8 | Ru | 63.6 | 80.2 | 47.0 | W | 9.4 | 19.4 | 2 | | | | |
| IrRuW | Ir | 23.7 | 29.0 | 18.4 | Ru | 65.3 | 77.5 | 53.1 | W | 11.0 | 17.8 | 4.1 | | | | |
| IrRuW | Ir | 37.5 | 43.4 | 31.5 | Ru | 58.6 | 70.9 | 46.3 | W | 3.9 | 6.4 | 1.4 | | | | |
| IrRuW | Ir | 26.2 | 33.5 | 18.8 | Ru | 60.7 | 75.4 | 45.9 | W | 13.1 | 18.2 | 8.0 | | | | |
| IrRuW | Ir | 25.2 | 31.8 | 18.6 | Ru | 62.9 | 73.0 | 52.9 | W | 11.9 | 16.2 | 7.5 | | | | |
| IrRuW | Ir | 25.4 | 32.8 | 18.0 | Ru | 60.1 | 74.6 | 45.6 | W | 14.5 | 21.0 | 8.0 | | | | |
| IrRuW | Ir | 23.3 | 29.9 | 16.7 | Ru | 62.5 | 83.6 | 41.4 | W | 14.2 | 23.3 | 5.0 | | | | |
| IrRuW | Ir | 25.1 | 32.0 | 18.1 | Ru | 61.3 | 75.3 | 47.4 | W | 13.6 | 21.4 | 5.9 | | | | |
| IrRuW | Ir | 26.1 | 31.3 | 20.8 | Ru | 71.8 | 81.4 | 62.1 | W | 2.1 | 4.0 | 2 | | | | |
| IrRuW | Ir | 23.9 | 29.5 | 18.3 | Ru | 71.8 | 81.4 | 62.2 | W | 4.3 | 7.3 | 1.4 | | | | |
| IrRuW | Ir | 27.4 | 34.0 | 20.9 | Ru | 62.9 | 75.9 | 49.9 | W | 9.6 | 17.5 | 1.8 | | | | |
| IrRuW | Ir | 23.7 | 32.7 | 14.6 | Ru | 62.7 | 79.7 | 45.8 | W | 13.6 | 22.2 | 5.0 | | | | |
| IrRuW | Ir | 21.8 | 26.9 | 16.7 | Ru | 61.9 | 72.8 | 50.9 | W | 16.4 | 24.5 | 8.2 | | | | |
| IrRuW | Ir | 25.0 | 30.1 | 20.0 | Ru | 69.6 | 79.5 | 59.8 | W | 5.3 | 9.2 | 1.5 | | | | |
| IrRuW | Ir | 26.3 | 33.4 | 19.2 | Ru | 65.8 | 79.6 | 51.9 | W | 8.0 | 14.7 | 1.2 | | | | |
| IrRuW | Ir | 16.4 | 22.2 | 10.7 | Ru | 65.1 | 81.2 | 49.0 | W | 18.5 | 26.2 | 10.7 | | | | |
| IrRuW | Ir | 27.4 | 34.8 | 20.0 | Ru | 62.2 | 76.6 | 47.7 | W | 10.4 | 17.6 | 3.2 | | | | |
| IrRuW | Ir | 27.0 | 33.6 | 20.3 | Ru | 65.9 | 78.9 | 52.9 | W | 7.2 | 12.5 | 1.9 | | | | |
| IrRuW | Ir | 23.9 | 34.3 | 13.5 | Ru | 63.0 | 81.9 | 44.2 | W | 13.1 | 24.1 | 2.0 | | | | |
| IrRuW | Ir | 19.7 | 26.5 | 12.8 | Ru | 63.1 | 81.5 | 44.7 | W | 17.2 | 38.1 | 2 | | | | |
| IrRuW | Ir | 52.7 | 68.9 | 36.6 | Ru | 31.5 | 48.8 | 14.1 | W | 15.8 | 24.2 | 7.4 | | | | |
| IrW | Ir | 42.6 | 51.2 | 34.0 | W | 57.4 | 64.9 | 50.0 | | | | | | | | |
| IrW | Ir | 77.7 | 91.7 | 63.8 | W | 22.3 | 42.6 | 2.0 | | | | | | | | |
| RuMoPd | Ru | 56.1 | 69.8 | 42.3 | Mo | 11.9 | 15.5 | 8.2 | Pd | 32.0 | 46.0 | 18.0 | | | | |
| RuMoPd | Ru | 67.8 | 85.1 | 50.4 | Mo | 12.2 | 15.9 | 8.5 | Pd | 20.1 | 33.5 | 6.7 | | | | |
| RuPd | Ru | 72.4 | 87.4 | 57.5 | Pd | 27.6 | 41.5 | 13.6 | | | | | | | | |

| | | | 3- | | | | | AST | |
|---|---|---|---|---|---|---|---|---|---|
| | | | Electrode | | CCM | | CCM | Degradation | |
| | | | Activity | 3- | Catalyst | | BOL | Rate (% | Max |
| | | ECD | (uA/ug @ | Electrode | Loading | CCM | Activity | Activity | AST |
| Materials | ECD | St. | 1.8 V | Durability | (mg/ | HFR | (A/ | Loss/ | Duration |
| Space | (um) | Dev | vs RHE) | (% loss) | cm²) | (mΩ) | cm²) | hr) | (hrs) |
| Ir | 0.09 | 0.07 | 2436 | −0.01 | 0.47 | 38 | 1.68 | 0.03 | 479 |
| Benchmark | | | | | | | | | |
| IrMo | | | 2619 | 0.14 | 0.35 | 108 | 0.12 | | |
| IrMo | 0.17 | 0.18 | 4529 | 0.31 | | | | | |
| IrMo | 0.21 | 0.27 | 5909 | 0.23 | | | | | |
| IrRe | | | 6653 | 0.09 | | | | | |
| IrReW | 0.2 | 0.25 | 6617 | 0.15 | 0.36 | 72 | 1.74 | | |
| IrReW | 0.22 | 0.3 | 5131 | 0.34 | 0.36 | 0 | | | |
| IrRuMo | 0.17 | 0.2 | 4736 | 0.22 | | | | | |
| IrRuMo | 0.13 | 0.2 | 5379 | 0.10 | | | | | |
| IrRuMo | 0.13 | 0.20 | 5879 | 0.09 | 0.53 | | 3.07 | −0.02 | 992 |
| IrRuPd | 0.24 | 0.24 | 4547 | 0.16 | 0.36 | 38 | 2.30 | | |
| IrRuPd | 0.15 | 0.28 | 2555 | 0.07 | 0.46 | 40 | 0.83 | | |
| IrRuPd | 0.16 | 0.26 | 5874 | 0.19 | | | | | |
| IrRuPd | 0.2 | 0.24 | 5449 | 0.19 | | | | | |
| IrRuPd | 0.25 | 0.34 | 4742 | 0.06 | 0.39 | 79 | 1.80 | 0.11 | 129 |
| IrRuPd | 0.2 | 0.28 | 5530 | 0.11 | 0.38 | 36 | 2.59 | 0.04 | 924 |
| IrRuPd | 0.27 | 0.4 | 9908 | 0.24 | | | 2.12 | 0.05 | |
| IrRuPd | 0.2 | 0.26 | 4529 | 0.30 | 0.51 | | 1.75 | 0.04 | 298 |
| IrRuPd | 0.37 | 0.48 | 2746 | 0.22 | | | | | |
| IrRuPd | 0.22 | 0.35 | 4095 | 0.16 | | | | | |
| IrRuPd | 0.26 | 0.37 | 4069 | −0.03 | | | | | |
| IrRuPd | 0.22 | 0.29 | 3255 | 0.12 | | | | | |
| IrRuPd | 0.31 | 0.37 | 2619 | 0.14 | | | | | |
| IrRuPd | 0.17 | 0.18 | 1345 | 0.24 | | | | | |
| IrRuPd | 0.41 | 0.41 | 7962 | 0.13 | | | | | |
| IrRuPd | 0.13 | 0.17 | 5202 | 0.35 | | | | | |
| IrRuPd | 0.18 | 0.28 | 3928 | 0.32 | | | | | |
| IrRuPd | 0.17 | 0.21 | 8422 | 0.20 | 0.57 | 25 | 1.88 | 0.03 | 607 |
| IrRuPd | 0.14 | 0.19 | 3079 | 0.03 | | | | | |
| IrRuPd | 0.15 | 0.21 | 2595 | 0.20 | | | | | |
| IrRuPd | 0.13 | 0.16 | 4932 | 0.17 | | | | | |
| IrRuPd | 0.25 | 0.31 | 4848 | 0.27 | | | | | |
| IrRuPd | 0.15 | 0.2 | 1420 | −0.03 | | | | | |
| IrRuPd | 0.2 | 0.26 | 10050 | 0.31 | 0.35 | 0 | 2.12 | 0.05 | 462 |
| IrRuPd | 0.15 | 0.21 | 3769 | 0.08 | | | | | |
| IrRuPdCr | 0.22 | 0.26 | 5291 | 0.23 | 0.52 | 60 | 2.25 | | |
| IrRuRe | 0.1 | 0.12 | 3521 | 0.29 | | | | | |
| IrRuRe | 0.12 | 0.14 | 8386 | 0.49 | 0.82 | 63 | 2.04 | 0.06 | 529 |
| IrRuRe | | | 3999 | 0.17 | 0.59 | 0 | 1.42 | 0.27 | 67 |
| IrRuRh | 0.22 | 0.19 | 4087 | 0.11 | 0.36 | 75 | 0.22 | | |
| IrRuRh | 0.2 | 0.27 | 4883 | 0.27 | 0.51 | 0 | 1.40 | 0.03 | 319 |
| IrRuRh | 0.1 | 0.18 | 3727 | 0.19 | 0.53 | 34 | 1.36 | 0.23 | 66 |
| IrRuW | | | 4459 | 0.11 | 0.36 | 70 | 1.12 | | |
| IrRuW | 0.31 | 0.37 | 5803 | 0.10 | | | | | |
| IrRuW | 0.33 | 0.33 | 2784 | 0.12 | | | | | |
| IrRuW | 0.14 | 0.2 | 8669 | 0.22 | 0.42 | 53 | 2.04 | 0.10 | 442 |
| IrRuW | 0.18 | 0.27 | 7531 | 0.18 | | | | | |
| IrRuW | 0.18 | 0.24 | 5225 | 0.15 | 0.38 | 0 | 1.85 | 0.08 | 102 |
| IrRuW | 0.66 | 0.56 | 3034 | 0.10 | | | | | |
| IrRuW | 0.21 | 0.22 | 7997 | 0.08 | | | | | |
| IrRuW | 0.27 | 0.26 | | | 0.49 | 22 | 2.74 | 0.08 | 178 |
| IrRuW | 0.31 | 0.33 | 6374 | 0.19 | 0.46 | 49 | 2.04 | 0.10 | 497 |
| IrRuW | 0.25 | 0.34 | | | 0.49 | 32 | 2.28 | 0.06 | 261 |
| IrRuW | 0.4 | 0.54 | 3524 | 0.13 | | | | | |
| IrRuW | 0.26 | 0.3 | 5486 | 0.15 | | | | | |
| IrRuW | 0.19 | 0.19 | 4131 | 0.12 | | | | | |
| IrRuW | 0.27 | 0.34 | 2757 | 0.15 | | | | | |
| IrRuW | 0.16 | 0.24 | 7453 | 0.22 | | | | | |
| IrRuW | 0.23 | 0.4 | 3674 | 0.15 | | | | | |
| IrRuW | 0.25 | 0.27 | 4171 | 0.18 | 0.39 | 38 | 1.96 | 0.55 | 51 |
| IrRuW | 0.32 | 0.39 | 6528 | 0.23 | 0.50 | 31 | 2.25 | 0.12 | 181 |
| IrRuW | 0.3 | 0.32 | 3564 | 0.08 | 0.44 | 43 | 1.83 | | 9 |
| IrRuW | 0.47 | 0.34 | 3415 | 0.25 | | | | | |
| IrRuW | 0.18 | 0.17 | 2535 | 0.06 | | | | | |
| IrRuW | 0.13 | 0.14 | 4294 | 0.28 | | | | | |
| IrRuW | 0.29 | 0.44 | 7552 | 0.19 | 0.17 | 40 | 2.18 | 0.28 | 178 |
| IrRuW | 0.38 | 0.64 | 5468 | 0.28 | | | | | |
| IrRuW | 0.21 | 0.27 | 4399 | 0.12 | 0.47 | 0 | 2.10 | 0.12 | 312 |
| IrRuW | 0.15 | 0.2 | 4625 | 0.09 | | | | | |
| IrRuW | 0.13 | 0.22 | 3793 | 0.13 | | | | | |
| IrRuW | 0.32 | 0.43 | 2907 | 0.04 | | | | | |
| IrRuW | 0.43 | 0.52 | 4565 | 0.19 | | | | | |
| IrRuW | 0.37 | 0.5 | 7421 | 0.19 | 0.51 | 54 | 2.45 | 0.07 | 322 |
| IrRuW | 0.75 | 1.03 | 6160 | 0.12 | | | | | |
| IrRuW | 0.19 | 0.24 | 3313 | 0.12 | | | | | |
| IrRuW | | | 4459 | 0.33 | | | | | |
| IrW | | | 4954 | 0.14 | 0.36 | 48 | 2.46 | 0.37 | 35 |
| IrW | 0.18 | 0.16 | 7643 | 0.27 | | | | | |
| RuMoPd | 0.11 | 0.14 | 2445 | 0.20 | | | | | |
| RuMoPd | 0.14 | 0.19 | 4137 | 0.31 | | | | | |
| RuPd | 0.2 | 0.29 | 2028 | 0.03 | 0.22 | 0 | 2.10 | 0.93 | 83 |

CLAUSES, within the present disclosure:

CLAUSE [1]: A catalyst comprising:
a multimetallic including a first metallic as Ir; and
at least one other metallic selected from the group consisting of W, Mo, Re, Ru, Fe, Pd, Rh, Mn, and Cr.

CLAUSE [2]: The catalyst of any preceding clause, wherein the composition of the catalyst and the atomic ratio of the metallics is defined from at least one of those disclosed within the collection of the Tables 1-19 and FIGS. 2A-22.

CLAUSE [3]: The catalyst of any preceding clause, wherein one or more metallics within the catalyst are oxidized.

CLAUSE [4]: The catalyst of any preceding clause, wherein the oxide can vary in crystallinity from amorphous to fully crystalline.

CLAUSE [5]: The catalyst of any preceding clause, wherein a ratio of oxide to metallic is fully oxidized, partially oxidized, or fully metallic.

CLAUSE [6]: The catalyst of any preceding clause, wherein the oxide is created via thermal annealing, calcination, chemically, or electrochemically.

CLAUSE [7]: The catalyst of any preceding clause, wherein the metallics comprise a single phase.

CLAUSE [8]: The catalyst of any preceding clause, wherein the metallics comprise mixed phase(s).

CLAUSE [9]: The catalyst of any preceding clause, wherein the catalyst is unsupported, or supported on carbon, silicon carbide, alumina, silica, titanium, titania, tungsten, tungsten oxide, niobium oxide, indium tin oxide, fluorine-doped tin oxide, graphene, or others.

CLAUSE [10]: The catalyst of any preceding clause, wherein the catalyst contains up to 10 atomic % of additional elements, such as Pt, Os, Ta, Ce, Ba, Hf, In, Sn, Sb, Au, Ag, Sr, Y, Sc, Nb, La, Pr, Sm, Cu.

CLAUSE [11]: The catalyst of any preceding clause, wherein the catalyst contains up to 10 atomic % of additional elements, such as Ni and Co excluding compositions exclusively comprised of Ir, Ru, Ni, and Co.

CLAUSE [12]: The catalyst of any preceding clause, wherein a surface of the catalyst is nanostructured.

CLAUSE [13]: The catalyst of any preceding clause, wherein the metallics or metallic oxides are deposited onto a template via at least one of electrodeposition, chemical vapor deposition, physical vapor deposition, and atomic layer deposition.

CLAUSE [14]: The catalyst of any preceding clause, wherein the catalyst is synthesized via polymer pen lithography.

CLAUSE [15]: The catalyst of any preceding clause, wherein the catalyst synthesis includes one or more of Adams Fusion, colloidal synthesis, precipitation, and spray pyrolysis.

CLAUSE [16]: A method of catalyzing electrochemical reaction, comprising:
providing a multimetallic including at least two metallics, wherein a first of the metallics is Ir, and one or more other metallics of the at least two metallics are from the group consisting of W, Mo, Re, Ru, Fe, Pd, Rh, Mn, and Cr; and
applying the multimetallic as a catalyst in a reaction.

CLAUSE [17]: The method of any preceding clause, wherein the composition of the catalyst and the atomic ratio of the metallics is defined from at least one of those disclosed within the collection of the Tables 1-19 and FIGS. 2A-22.

CLAUSE [18]: The method of any preceding clause, wherein one or more metallics within the catalyst are oxidized.

CLAUSE [19]: The method of any preceding clause, wherein the oxide can vary in crystallinity from amorphous to fully crystalline.

CLAUSE [20]: The method of any preceding clause, wherein a ratio of oxide to metallic is fully oxidized, partially oxidized, or fully metallic.

CLAUSE [21]: The method of any preceding clause, wherein the oxide is created via thermal annealing, calcination, chemically, or electrochemically.

CLAUSE [22]: The method of any preceding clause, wherein the catalyst is unsupported, or supported on carbon, silicon carbide, alumina, silica, titanium, titania, tungsten, tungsten oxide, niobium oxide, indium tin oxide, fluorine-doped tin oxide, graphene or others.

CLAUSE [23]: The method of any preceding clause, wherein the catalyst contains up to 10 atomic % of additional elements, such as Pt, Os, Ta, Ce, Ba, Hf, In, Sn, Sb, Au, Ag, Sr, Y, Sc, Nb, La, Pr, Sm, Cu.

CLAUSE [24]: The method of any preceding clause, wherein the catalyst contains up to 10 atomic % of additional elements, such as Ni and Co excluding compositions exclusively comprised of Ir, Ru, Ni, and Co.

CLAUSE [25]: The method of any preceding clause, wherein a surface of the catalyst is nanostructured.

CLAUSE [26]: The method of any preceding clause, wherein the metallics or metallic oxides are deposited onto a template via at least one of electrodeposition, chemical vapor deposition, physical vapor deposition, and atomic layer deposition.

CLAUSE [27]: The method of any preceding clause, wherein the catalyst is synthesized via polymer pen lithography.

CLAUSE [28]: The method of any preceding clause, wherein the catalyst synthesis includes one or more of Adams Fusion, colloidal synthesis, precipitation, and spray pyrolysis.

CLAUSE [29]: A method of catalyzing electrochemical reaction, comprising:
providing a multimetallic including at least two metallics, wherein a first metallic of the at least two metallics is Ru, and one or more other metallics of the at least two metallics are from the group consisting of W, Mo, Re, Ir, Fe, Pd, Rh, Mn, and Cr; and
applying the multimetallic as a catalyst in a reaction.

CLAUSE [30]: The method of any preceding clause, wherein applying the catalyst in a reaction includes applying the catalyst for Oxygen Evolution Reaction (OER).

CLAUSE [31]: The method of any preceding clause, wherein the OER reaction is an acidic OER.

CLAUSE [32]: The method of any preceding clause, wherein the OER reaction is an alkaline OER.

CLAUSE [33]: The method of any preceding clause, wherein applying the catalyst in a reaction includes applying the catalyst for hydrogen generation and/or oxidation.

CLAUSE [34]: The method of any preceding clause, wherein applying the catalyst in a reaction includes applying the catalyst for oxygen generation and reduction.

CLAUSE [35]: The method of any preceding clause, wherein applying the catalyst in a reaction includes applying the catalyst for CO₂ conversion.

CLAUSE [36]: The method of any preceding clause, wherein applying the catalyst in a reaction includes applying the catalyst for biomass conversion to organic products.

CLAUSE [37]: The method of any preceding clause, wherein applying the catalyst in a reaction includes applying the catalyst for hydrogenation and/or de-hydrogenation.

CLAUSE [38]: The method of any preceding clause, wherein applying the catalyst in a reaction includes applying the catalyst for organic oxidation reactions.

CLAUSE [39]: The method of any preceding clause, wherein applying the catalyst in a reaction includes applying the catalyst for the generation of halogen gases.

CLAUSE [40]: The method of any preceding clause, wherein applying the catalyst in a reaction includes applying the catalyst for ammonia generation and/or conversion.

CLAUSE [41]: The method of any preceding clause, wherein applying the catalyst in a reaction includes applying the catalyst for gas purification.

CLAUSE [42]: The method of any preceding clause, wherein applying the catalyst in a reaction includes applying the catalyst for deoxygenation, dehydrogenation, and/or CO₂ cleaning.

CLAUSE [43]: A method of catalyzing non-electrochemical reaction, comprising:
a multimetallic of two or more elements, wherein a first metallic thereof is Ir, and one or more other metallics thereof are from the group consisting of W, Mo, Re, Ru, Fe, Pd, Rh, Mn, and Cr; and
applying the catalyst in a reaction.

CLAUSE [44]: The method of any preceding clause, wherein the composition of the catalyst and the atomic ratio of the metallics is defined from at least one of those disclosed within the collection of the Tables 1-19 and FIGS. 2A-22.

CLAUSE [45]: The method of any preceding clause, wherein one or more metallics within the catalyst are oxidized.

CLAUSE [46]: The method of any preceding clause, wherein the oxide can vary in crystallinity from amorphous to fully crystalline.

CLAUSE [47]: The method of any preceding clause, wherein a ratio of oxide to metallic is fully oxidized, partially oxidized, or fully metallic.

CLAUSE [48]: The method of any preceding clause, wherein the oxide is created via thermal annealing, calcination, chemically, or electrochemically.

CLAUSE [49]: The method of any preceding clause, wherein the catalyst is unsupported, supported on carbon, silicon carbide, alumina, silica, titanium, titania, tungsten, tungsten oxide, niobium oxide, indium tin oxide, fluorine-doped tin oxide, graphene or others.

CLAUSE [50]: The method of any preceding clause, wherein the catalyst contains up to 10 atomic % of one or more additional elements selected from the group consisting of Pt, Os, Ta, Ce, Ba, Hf, In, Sn, Sb, Au, Ag, Sr, Y, Sc, Nb, La, Pr, Sm, Cu.

CLAUSE [51]: The method of any preceding clause, wherein the catalyst contains up to 10 atomic % of one or more additional elements selected from the group consisting of Ni and Co excluding compositions exclusively comprised of Ir, Ru, Ni, and Co.

CLAUSE [52]: The method of any preceding clause, wherein a surface of the catalyst is nanostructured.

CLAUSE [53]: The method of any preceding clause, wherein the metallics or metallic oxides are deposited onto a template via at least one of electrodeposition, chemical vapor deposition, physical vapor deposition, and atomic layer deposition.

CLAUSE [54]: The method of any preceding clause, wherein the catalyst is synthesized via polymer pen lithography.

CLAUSE [55]: The method of any preceding clause, wherein the catalyst synthesis includes one or more of Adams Fusion, colloidal synthesis, precipitation, and spray pyrolysis.

CLAUSE [56]: A method of catalyzing non-electrochemical reaction, comprising:
providing a multimetallic comprising two or more elements, wherein the first metallic thereof is Ru, and one or more other metallic thereof is from the group consisting of W, Mo, Re, Ir, Fe, Pd, Rh, Mn, and Cr; and
applying the catalyst in a reaction.

CLAUSE [57]: The method of any preceding clause, wherein applying the catalyst in a reaction includes applying the catalyst for CO₂ or CO conversion.

CLAUSE [58]: The method of any preceding clause, wherein applying the catalyst in a reaction includes applying the catalyst for biomass conversion to organic products.

CLAUSE [59]: The method of any preceding clause, wherein applying the catalyst in a reaction includes applying the catalyst for hydrogenation and/or de-hydrogenation.

CLAUSE [60]: The method of any preceding clause, wherein applying the catalyst in a reaction includes applying the catalyst for organic oxidation reactions.

CLAUSE [61]: The method of any preceding clause, wherein applying the catalyst in a reaction includes applying the catalyst for ammonia generation and/or conversion.

CLAUSE [62]: The method of any preceding clause, wherein applying the catalyst in a reaction includes applying the catalyst for gas purification.

CLAUSE [63]: An electrocatalyst comprising:
a multimetallic of two or more metallics,
wherein a first metallic of the two or more metallics is Ru; and
one or more other metallics of the two or more metallic is selected from the group consisting of W, Mo, Re, Ir, Fe, Pd, Rh, Mn, and Cr.

CLAUSE [64]: The electrocatalyst of any preceding clause, wherein the composition of the catalyst and the atomic ratio of the metallics is defined from at least one of those disclosed within the collection of the Tables 1-19 and FIGS. 2A-22.

CLAUSE [65]: The electrocatalyst of any preceding clause, wherein one or more metallics within the catalyst are oxidized.

CLAUSE [66]: The electrocatalyst of any preceding clause, wherein the oxide can vary in crystallinity from amorphous to fully crystalline.

CLAUSE [67]: The electrocatalyst of any preceding clause, wherein a ratio of oxide to metallic is fully oxidized, partially oxidized, or fully metallic.

CLAUSE [68]: The electrocatalyst of any preceding clause, wherein the oxide is created via thermal annealing, calcination, chemically, or electrochemically.

CLAUSE [69]: The electrocatalyst of any preceding clause, wherein the catalyst is unsupported, or supported on carbon, silicon carbide, alumina, silica, titanium, titania, tungsten, tungsten oxide, niobium oxide, indium tin oxide, fluorine-doped tin oxide, graphene or others.

CLAUSE [70]: The electrocatalyst of any preceding clause, wherein the catalyst contains up to 10 atomic % of one or more additional elements selected from the group consisting of Pt, Os, Ta, Ce, Ba, Hf, In, Sn, Sb, Au, Ag, Sr, Y, Sc, Nb, La, Pr, Sm, Cu.

CLAUSE [71]: The electrocatalyst of any preceding clause, wherein the catalyst contains up to 10 atomic % of one or more additional elements selected from the group consisting of Ni and Co excluding compositions exclusively comprised of Ir, Ru, Ni, and Co.

CLAUSE [72]: The electrocatalyst of any preceding clause, wherein a surface of the catalyst is nanostructured.

CLAUSE [73]: The electrocatalyst of any preceding clause, wherein the metallics or metallic oxides are deposited onto a template via at least one of electrodeposition, chemical vapor deposition, physical vapor deposition, and atomic layer deposition.

CLAUSE [74]: The electrocatalyst of any preceding clause, wherein the catalyst is synthesized via polymer pen lithography.

CLAUSE [75]: The electrocatalyst of any preceding clause, wherein the catalyst synthesis includes one or more of Adams Fusion, colloidal synthesis, precipitation, and spray pyrolysis.

CLAUSE [76]: The method any preceeding clause, wherein applying the catalyst in a reaction includes applying the catalyst for the process of cathodic electrodeposition, electrowinning, electroplating of metals, chlorine production causing anodic evolution of oxygen on the surface of an electrode.

CLAUSE [77]: The catalyst or method of any preceding claim, wherein the concentration of one of Ir, Ru, W, Mo, Re, Ir, Fe, Pd, Rh, Mn, and/or Cr is zero.

CLAUSE [78]: The catalyst or method of any preceding claim, wherein the concentration of Ir, Ru, W, Mo, Re, Ir, Fe, Pd, Rh, Mn, and/or Cr is defined as an average concentration within the catalyst.

Accordingly, the various embodiments of the invention, as disclosed above, are intended to be illustrative, not limiting. Various changes may be made without departing from the spirit and scope of the invention. As a result, it will be apparent for those skilled in the art that the illustrative embodiments described are only examples and that various modifications can be made within the scope of the invention as defined in the appended claims.

We claim:

1. A catalyst comprising:
a multimetallic including a first metallic as Ir; and
at least one other metallic selected from the group consisting of W, Mo, Re, Ru, Fe, Pd, Rh, Mn, and Cr.

2. The catalyst of claim 1, wherein the composition of the catalyst and the atomic ratio of the metallics is defined from at least one of those disclosed within the collection of the Tables 1-19 and FIGS. 2A-22.

3. The catalyst of claim 1, wherein one or more metallics within the catalyst are oxidized.

4. The catalyst of claim 3, wherein the oxide can vary in crystallinity from amorphous to fully crystalline.

5. The catalyst of claim 3, wherein a ratio of oxide to metallic is fully oxidized, partially oxidized, or fully metallic.

6. The catalyst of claim 3, wherein the oxide is created via thermal annealing, calcination, chemically, or electrochemically.

7. The catalyst of claim 1, wherein the catalyst is unsupported, or supported on carbon, silicon carbide, alumina, silica, titanium, titania, tungsten, tungsten oxide, niobium oxide, indium tin oxide, fluorine-doped tin oxide, graphene, or others.

8. The catalyst of claim 1, wherein the catalyst contains up to 10 atomic % of additional elements, such as Pt, Os, Ta, Ce, Ba, Hf, In, Sn, Sb, Au, Ag, Sr, Y, Sc, Nb, La, Pr, Sm, Cu.

9. The catalyst of claim 1, wherein the catalyst contains up to 10 atomic % of additional elements, such as Ni and Co excluding compositions exclusively comprised of Ir, Ru, Ni, and Co.

10. The catalyst of claim 1, wherein a surface of the catalyst is nanostructured.

11. The catalyst of claim 1, wherein the metallics or metallic oxides are deposited onto a template via at least one of electrodeposition, chemical vapor deposition, physical vapor deposition, and atomic layer deposition.

12. The catalyst of claim 1, wherein the catalyst is synthesized via polymer pen lithography.

13. The catalyst of claim 13, wherein the catalyst synthesis includes one or more of Adams Fusion, colloidal synthesis, precipitation, and spray pyrolysis.

14. A method of catalyzing electrochemical reaction, comprising:
providing a multimetallic including at least two metallics, wherein a first of the metallics is Ir, and one or more other metallics of the at least two metallics are from the group consisting of W, Mo, Re, Ru, Fe, Pd, Rh, Mn, and Cr; and
applying the multimetallic as a catalyst in a reaction.

15. The method of claim 14, wherein the composition of the catalyst and the atomic ratio of the metallics is defined from at least one of those disclosed within the collection of the Tables 1-19 and FIGS. 2A-22.

16. The method of claim 14, wherein one or more metallics within the catalyst are oxidized.

17. The method of claim 16, wherein the oxide can vary in crystallinity from amorphous to fully crystalline.

18. The method of claim 16, wherein a ratio of oxide to metallic is fully oxidized, partially oxidized, or fully metallic.

19. The method of claim 16, wherein the oxide is created via thermal annealing, calcination, chemically, or electrochemically.

20. The method of claim 14, wherein the catalyst is unsupported, or supported on carbon, silicon carbide, alumina, silica, titanium, titania, tungsten, tungsten oxide, niobium oxide, indium tin oxide, fluorine-doped tin oxide, graphene or others.

21. The method of claim 14, wherein the catalyst contains up to 10 atomic % of additional elements, such as Pt, Os, Ta, Ce, Ba, Hf, In, Sn, Sb, Au, Ag, Sr, Y, Sc, Nb, La, Pr, Sm, Cu.

22. The method of claim 11, wherein the catalyst contains up to 10 atomic % of additional elements, such as Ni and Co excluding compositions exclusively comprised of Ir, Ru, Ni, and Co.

23. The method of claim 14, wherein a surface of the catalyst is nanostructured.

24. The method of claim 14, wherein the metallics or metallic oxides are deposited onto a template via at least one of electrodeposition, chemical vapor deposition, physical vapor deposition, and atomic layer deposition.

25. The method of claim 14, wherein the catalyst is synthesized via polymer pen lithography.

26. The method of claim 14, wherein the catalyst synthesis includes one or more of Adams Fusion, colloidal synthesis, precipitation, and spray pyrolysis.

27. A method of catalyzing electrochemical reaction, comprising:
providing a multimetallic including at least two metallics, wherein a first metallic of the at least two metallics is Ru, and one or more other metallics of the at least two metallics are from the group consisting of W, Mo, Re, Ir, Fe, Pd, Rh, Mn, and Cr; and
applying the multimetallic as a catalyst in a reaction.

28. The method of claim 27, wherein applying the catalyst in a reaction includes applying the catalyst for Oxygen Evolution Reaction (OER).

29. The method of claim 28, wherein the OER reaction is an acidic OER.

30. The method of claim 28, wherein the OER reaction is an alkaline OER.

31. The method of claim 27, wherein applying the catalyst in a reaction includes applying the catalyst for hydrogen generation and/or oxidation.

32. The method of claim 27, wherein applying the catalyst in a reaction includes applying the catalyst for oxygen generation and reduction.

33. The method of claim 27, wherein applying the catalyst in a reaction includes applying the catalyst for CO₂ conversion.

34. The method of claim 27, wherein applying the catalyst in a reaction includes applying the catalyst for biomass conversion to organic products.

35. The method of claim 27, wherein applying the catalyst in a reaction includes applying the catalyst for hydrogenation and/or de-hydrogenation.

36. The method of claim 27, wherein applying the catalyst in a reaction includes applying the catalyst for organic oxidation reactions.

37. The method of claim 27, wherein applying the catalyst in a reaction includes applying the catalyst for the generation of halogen gases.

38. The method of claim 27, wherein applying the catalyst in a reaction includes applying the catalyst for ammonia generation and/or conversion.

39. The method of claim 27, wherein applying the catalyst in a reaction includes applying the catalyst for gas purification.

40. The method of claim 27, wherein applying the catalyst in a reaction includes applying the catalyst for deoxygenation, dehydrogenation, and/or CO₂ cleaning.

41. A method of catalyzing non-electrochemical reaction, comprising:
a multimetallic of two or more elements, wherein a first metallic thereof is Ir, and one or more other metallics thereof are from the group consisting of W, Mo, Re, Ru, Fe, Pd, Rh, Mn, and Cr; and
applying the catalyst in a reaction.

42. The method of claim 41, wherein the composition of the catalyst and the atomic ratio of the metallics is defined from at least one of those disclosed within the collection of the Tables 1-19 and FIGS. 2A-22.

43. The method of claim 42, wherein one or more metallics within the catalyst are oxidized.

44. The method of claim 43, wherein the oxide can vary in crystallinity from amorphous to fully crystalline.

45. The method of claim 43, wherein a ratio of oxide to metallic is fully oxidized, partially oxidized, or fully metallic.

46. The method of claim 43, wherein the oxide is created via thermal annealing, calcination, chemically, or electrochemically.

47. The method of claim 41, wherein the catalyst is unsupported, supported on carbon, silicon carbide, alumina, silica, titanium, titania, tungsten, tungsten oxide, niobium oxide, indium tin oxide, fluorine-doped tin oxide, graphene or others.

48. The method of claim 41, wherein the catalyst contains up to 10 atomic % of one or more additional elements selected from the group consisting of Pt, Os, Ta, Ce, Ba, Hf, In, Sn, Sb, Au, Ag, Sr, Y, Sc, Nb, La, Pr, Sm, Cu.

49. The method of claim 41, wherein the catalyst contains up to 10 atomic % of one or more additional elements selected from the group consisting of Ni and Co excluding compositions exclusively comprised of Ir, Ru, Ni, and Co.

50. The method of claim 41, wherein a surface of the catalyst is nanostructured.

51. The method of claim 41, wherein the metallics or metallic oxides are deposited onto a template via at least one of electrodeposition, chemical vapor deposition, physical vapor deposition, and atomic layer deposition.

52. The method of claim 41, wherein the catalyst is synthesized via polymer pen lithography.

53. The method of claim 41, wherein the catalyst synthesis includes one or more of Adams Fusion, colloidal synthesis, precipitation, and spray pyrolysis.

54. A method of catalyzing non-electrochemical reaction, comprising:
providing a multimetallic comprising two or more elements, wherein the first metallic thereof is Ru, and one or more other metallic thereof is from the group consisting of W, Mo, Re, Ir, Fe, Pd, Rh, Mn, and Cr; and
applying the catalyst in a reaction.

55. The method of claim 54, wherein applying the catalyst in a reaction includes applying the catalyst for CO₂ or CO conversion.

56. The method of claim 54, wherein applying the catalyst in a reaction includes applying the catalyst for biomass conversion to organic products.

57. The method of claim 54, wherein applying the catalyst in a reaction includes applying the catalyst for hydrogenation and/or de-hydrogenation.

58. The method of claim 54, wherein applying the catalyst in a reaction includes applying the catalyst for organic oxidation reactions.

59. The method of claim 54, wherein applying the catalyst in a reaction includes applying the catalyst for ammonia generation and/or conversion.

60. The method of claim 54, wherein applying the catalyst in a reaction includes applying the catalyst for gas purification.

61. An electrocatalyst comprising:
a multimetallic of two or more metallics,
wherein a first metallic of the two or more metallics is Ru; and
one or more other metallics of the two or more metallic is selected from the group consisting of W, Mo, Re, Ir, Fe, Pd, Rh, Mn, and Cr.

62. The electrocatalyst of claim 61, wherein the composition of the catalyst and the atomic ratio of the metallics is defined from at least one of those disclosed within the collection of the Tables 1-17 and FIGS. 2A-14B.

63. The electrocatalyst of claim 61, wherein one or more metallics within the catalyst are oxidized.

64. The electrocatalyst of claim 63, wherein the oxide can vary in crystallinity from amorphous to fully crystalline.

65. The electrocatalyst of claim 63, wherein a ratio of oxide to metallic is fully oxidized, partially oxidized, or fully metallic.

66. The electrocatalyst of claim 63, wherein the oxide is created via thermal annealing, calcination, chemically, or electrochemically.

67. The electrocatalyst of claim 61, wherein the catalyst is unsupported, or supported on carbon, silicon carbide, alumina, silica, titanium, titania, tungsten, tungsten oxide, niobium oxide, indium tin oxide, fluorine-doped tin oxide, graphene or others.

68. The electrocatalyst of claim 61, wherein the catalyst contains up to 10 atomic % of one or more additional elements selected from the group consisting of Pt, Os, Ta, Ce, Ba, Hf, In, Sn, Sb, Au, Ag, Sr, Y, Sc, Nb, La, Pr, Sm, Cu.

69. The electrocatalyst of claim 61, wherein the catalyst contains up to 10 atomic % of one or more additional elements selected from the group consisting of Ni and Co excluding compositions exclusively comprised of Ir, Ru, Ni, and Co.

70. The electrocatalyst of claim 61, wherein a surface of the catalyst is nanostructured.

71. The electrocatalyst of claim 61, wherein the metallics or metallic oxides are deposited onto a template via at least one of electrodeposition, chemical vapor deposition, physical vapor deposition, and atomic layer deposition.

72. The electrocatalyst of claim 61, wherein the catalyst is synthesized via polymer pen lithography.

73. The electrocatalyst of claim 61, wherein the catalyst synthesis includes one or more of Adams Fusion, colloidal synthesis, precipitation, and spray pyrolysis.

74. The method of claim 27, wherein applying the catalyst in a reaction includes applying the catalyst for the process of cathodic electrodeposition, electrowinning, electroplating of metals, chlorine production causing anodic evolution of oxygen on the surface of an electrode.
